(19) United States
(12) Patent Application Publication
(10) Pub. No.: US 2026/0243196 A1
(43) Pub. Date: Aug. 20, 2026

(54) INTERNAL COMBUSTION ENGINE

(71) Applicants: Philip Franklin Gaziano, Wilbraham, MA (US); Anna Felicitas Thurmayr, Wilbraham, MA (US); Fabian Aloys Gaziano, Wilbraham, MA (US)

(72) Inventors: Philip Franklin Gaziano, Wilbraham, MA (US); Anna Felicitas Thurmayr, Wilbraham, MA (US); Fabian Aloys Gaziano, Wilbraham, MA (US)

(21) Appl. No.: 19/637,594

(22) Filed: Apr. 2, 2026

Related U.S. Application Data
(63) Continuation of application No. PCT/US2026/015340, filed on Feb. 13, 2026.
(60) Provisional application No. 63/758,654, filed on Feb. 14, 2025.
(60) Provisional application No. 63/768,430, filed on Mar. 7, 2025.
(60) Provisional application No. 63/821,948, filed on Jun. 11, 2025.
(60) Provisional application No. 63/967,001, filed on Jan. 23, 2026.

(51) Int. Cl. F02B 75/32; F02B 25/02; F02B 75/22; F02B 75/24

(52) U.S. Cl. CPC F02B 75/32; F02B 25/02; F02B 75/222; F02B 75/24

(57) ABSTRACT

An assembly includes a pair of crankshafts, a piston, and a plurality of connecting rods. The pair of crankshafts includes a first crankshaft and a second crankshaft. The first crankshaft is engaged with the second crankshaft such that rotation of the first crankshaft causes counterrotation of the second crankshaft. The plurality of connecting rods couple the pair of crankshafts to the piston such that rotation of the pair of crankshafts causes reciprocating motion of the piston. The plurality of connecting rods include at least one connecting rod coupling the first crankshaft to the piston and at least one connecting rod coupling the second crankshaft to the piston.

### PRIORITY APPLICATIONS

The present application is a continuation of International Application No. PCT/US2026/015340, filed Feb. 13, 2026, entitled “INTERNAL COMBUSTION ENGINE,” which claims priority benefit to U.S. Provisional Application No. 63/967,001, filed Jan. 23, 2026, entitled “INTERNAL COMBUSTION ENGINE,” U.S. Provisional Application No. 63/821,948, filed Jun. 11, 2025, entitled “INTERNAL COMBUSTION ENGINE,” U.S. Provisional Application No. 63/768,430, filed Mar. 7, 2025, entitled “INTERNAL COMBUSTION ENGINE,” and U.S. Provisional Application No. 63/758,654, filed Feb. 14, 2025, entitled “INTERNAL COMBUSTION ENGINE,” each of which is hereby incorporated by reference herein in its entirety.

### BACKGROUND

### Field

The present disclosure generally relates to internal combustion engines. More particularly, the present disclosure relates to layouts, components, construction techniques, and materials for internal combustion engines.

### Description of the Related Art

In reciprocating internal combustion engines, a cylinder block is a main structural component. The cylinder block contains one or more cylinder bores. A cylinder head typically connects to the upper end of the cylinder block. Together, the cylinder block and the cylinder head house the cylinder bores, the pistons, and combustion chambers. Each piston moves up and down inside a respective cylinder bore. Connecting rods connect the pistons to a crankshaft. The crankshaft can be positioned within a crankcase that is attached to the bottom end of the cylinder block or can be positioned within the cylinder block itself. The connecting rods convert the translational movement of the pistons to rotational movement of the crankshaft.

### SUMMARY

The systems, methods, assemblies, and devices described herein have innovative aspects, no single one of which is indispensable or solely responsible for their desirable attributes. Without limiting the scope of the claims, some of the advantageous features will now be summarized.

Various internal combustion engines and components, assemblies, and sub-assemblies that can be included in such engines are described herein. The engines can include one or more pairs of crankshafts. Pairs of crankshafts can be in-mesh with each other such that they counterrotate with each other. The pairs of crankshafts can be connected to one or more pistons by connecting rods. In some engines, the combination of the connecting rods and/or crankshafts can allow pairs of pistons to reciprocate along a shared axis.

Although several configurations, examples, and illustrations are disclosed below, the disclosure extends beyond the specifically disclosed configurations, examples, and illustrations and includes other uses of the disclosure. The terminology used in the description presented herein is not intended to be interpreted in any limited or restrictive manner simply because it is being used in conjunction with a detailed description of some specific configurations of the disclosure.

### BRIEF DESCRIPTION OF THE DRAWINGS

Throughout the drawings, reference numbers may be reused to indicate general correspondence between referenced elements. The drawings are provided to illustrate example configurations described herein and are not intended to limit the scope of the disclosure.

FIG. 1 illustrates a schematic cross-sectional view of an embodiment of an internal combustion engine having two crankshafts and employing a linkage assembly.

FIGS. 2-4 illustrate schematic isolation cross-sectional views of embodiments of linkage assemblies connected to a pair of crankshafts.

FIG. 5A illustrates a schematic cross-sectional view of an embodiment of a piston connected to a pair of crankshafts via a linkage assembly.

FIG. 5B illustrates a partial exploded schematic cross-sectional view of the piston and linkage assembly of FIG. 5A.

FIG. 6A illustrates a perspective view of an embodiment of a linkage assembly connected to portions of a pair of crankshafts.

FIG. 6B illustrates a top isolation view of a piston connecting rod of the linkage assembly of FIG. 6A.

FIG. 6C illustrates a perspective exploded view of the linkage assembly and crankshafts of FIG. 6A.

FIGS. 7A and 7B illustrate schematic isolation cross-sectional views of a piston and a pair of crankshafts in a toed-in and toed-out configuration respectively.

FIGS. 8A-8D illustrate schematic cross-sectional views of various coupling locations for connecting rods on a pair of crankshafts.

FIG. 9 illustrates a schematic cross-sectional view of a portion of an embodiment of an internal combustion engine employing a translating wrist pin.

FIG. 10 illustrates a schematic cross-sectional view of an embodiment of an internal combustion engine having four crankshafts and employing a linkage assembly.

FIGS. 11A-11D illustrate schematic isolation cross-sectional views of embodiments of linkage assemblies connected to four crankshafts.

FIG. 12 illustrates a schematic cross-sectional view of an embodiment of an internal combustion engine having four crankshafts and employing a translating wrist pin.

FIGS. 13A-13C illustrate schematic cross-sectional views of embodiments of internal combustion engines having four crankshafts and an auxiliary piston.

FIGS. 14A and 14B illustrate schematic isolation cross-sectional views of four pistons coupled to four crankshafts in a first position and a second position respectively.

FIG. 15A illustrates a schematic top view of an embodiment of an internal combustion engine with various components not shown.

FIG. 15B illustrates a schematic isolation view of an embodiment of an auxiliary chamber and a portion of an embodiment on an auxiliary housing.

FIG. 16A illustrates a schematic top view of an embodiment of an internal combustion engine with various components not shown.

FIG. 16B illustrates a schematic top view of a conventional internal combustion engine with various components not shown.

FIG. 17A illustrates a schematic cross-sectional view of an embodiment of a translating wrist pin and piston assembly in an assembled configuration.

FIGS. 17B and 17C illustrate schematic cross-sectional views of the translating wrist pin and piston assembly of FIG. 17A in a first exploded view and a second exploded view respectively.

FIGS. 17D and 17E illustrate schematic end views of embodiments of translating wrist pins.

FIGS. 17F and 17G illustrate schematic side views of embodiments of translating wrist pins.

FIGS. 18A and 18B illustrate a schematic top view and exploded view respectively of another embodiment of a translating wrist pin.

FIGS. 19A and 19B show schematic cross-sectional views of the translating wrist pin of FIG. 18A with embodiments of connecting rods coupled thereto.

FIGS. 20A and 20B illustrate schematic cross-sectional views of another embodiment of a translating wrist pin and piston assembly in an assembled configuration and exploded configuration respectively.

FIGS. 21 and 22 illustrate schematic cross-sectional views of another embodiment of a translating wrist pin and piston assembly in an assembled configuration and exploded configuration respectively.

FIG. 23A illustrates a schematic cross-sectional view of an arrangement of six counterrotating crankshafts and associated connecting rods according to an embodiment.

FIG. 23B illustrates a schematic cross-sectional view of another arrangement of six counterrotating crankshafts and associated connecting rods according to an embodiment.

FIG. 23C illustrates a schematic cross-sectional view of an arrangement of eight counterrotating crankshafts and associated connecting rods according to an embodiment.

FIGS. 24-28 illustrate schematic cross-sectional views of various embodiments of internal combustion engines with six counterrotating crankshafts arranged in a radial configuration.

FIG. 29 illustrates a schematic cross-sectional view of an embodiment of an internal combustion engine including rotary valves.

FIG. 30 illustrates a schematic cross-sectional view of a portion of an embodiment of an internal combustion engine including rotary valves.

FIG. 31-35 illustrate schematic cross-sectional views of a portion of embodiments of an internal combustion engine including rotary valves.

FIGS. 36A and 36B illustrate a perspective view and a side view of an embodiment of a rotary valve in isolation.

FIG. 37 illustrates a cross-sectional view of an internal combustion engine including the rotary valves of FIGS. 36A and 36B.

FIG. 38A illustrates a schematic cross-sectional view of an example arrangement of camshafts, timing gears, and an output shaft according to an embodiment.

FIG. 38B illustrates a schematic cross-sectional view of an example arrangement of four crankshafts configured for use with the arrangement of FIG. 38A.

FIG. 38C illustrates a schematic cross-sectional view of the arrangement of FIG. 38A together with the arrangement of four crankshafts of FIG. 38B.

FIG. 39A illustrates a schematic cross-sectional view of an example arrangement of camshafts, timing gears, and an output shaft according to an embodiment.

FIG. 39B illustrates a schematic cross-sectional view of an example arrangement of four crankshafts configured for use with the arrangement of FIG. 39A.

FIG. 39C illustrates a schematic cross-sectional view of the arrangement of FIG. 39A together with the arrangement of four crankshafts of FIG. 39B.

FIG. 40 illustrates a perspective view of an embodiment of camshafts, timing gears, and an output shaft with four crankshaft and six pistons.

FIG. 41 illustrates a perspective isolation view of an embodiment of a crankshaft of FIG. 40.

FIG. 42 illustrates a perspective view of an embodiment of a modular internal combustion engine.

FIG. 43 illustrates a schematic cross-sectional side view of the internal combustion engine of FIG. 42.

FIGS. 44A and 44B illustrate a top partial-section view and a partial-exploded-section view of portions of the internal combustion engine of FIG. 42.

FIG. 44C illustrates a schematic cross-sectional side view of the crankshafts of the internal combustion engine of FIG. 42.

FIG. 44D illustrates a schematic cross-sectional side view of the camshaft and output shaft arrangement of the internal combustion engine of FIG. 42.

FIG. 45 illustrates an exploded schematic side view of embodiments of two crankshafts of the internal combustion engine of FIG. 42.

FIG. 46A illustrates a schematic cross-sectional view of a pair of counter rotating crankshafts and associate connecting rods.

FIGS. 46B and 46C illustrate schematic cross-sectional views of embodiments of crankshafts that can be included in the arrangement of FIG. 46A.

FIGS. 47A and 47B illustrate a perspective view and a partial exploded side view respectively of an embodiment of a pair of crankshafts and their associated gears.

FIGS. 48A and 48B illustrate a perspective view and a side view respectively of an embodiment of a crankshaft in isolation.

FIGS. 49A and 49B illustrate a perspective view and a side view respectively of another embodiment of a crankshaft in isolation.

FIGS. 50A-50C illustrate a perspective view, a front view, and a cross-sectional side view respectively of an embodiment of a gear for a crankshaft.

FIG. 51 illustrates a schematic cross-sectional view of embodiments of connecting rod and piston assemblies connected to a crankshaft.

FIG. 52A illustrates a perspective exploded view of an embodiment of a connecting rod and piston assembly.

FIG. 52B illustrates a side view of a connecting rod of the assembly of FIG. 52A.

FIG. 53A illustrates a side view of the assembly of FIG. 52A connected to a pair of crankshafts along with a portion of another embodiment of a connecting rod and piston assembly.

FIG. 53B illustrates a bottom perspective view of a portion of an embodiment of a connecting rod and piston assembly.

FIG. 53C illustrates a bottom perspective view of an embodiment of a piston of the assembly of FIG. 53B.

FIG. 54 illustrates a schematic cross-sectional view of embodiments of connecting rod and piston assemblies connected to a crankshaft.

FIG. 55 illustrates a perspective view of embodiments of connecting rod and piston assemblies connected to a pair of crankshafts.

FIGS. 56A and 56B illustrate a perspective view and an exploded view respectively of an embodiment of a connecting rod and piston assembly of FIG. 55 in isolation.

FIGS. 57A and 57B illustrate a perspective view and a side view respectively of an embodiment of a connecting rod of the assembly of FIGS. 56A and 56B.

FIGS. 58A and 58B illustrate a perspective view and an exploded view respectively of another embodiment of a connecting rod and piston assembly of FIG. 55.

FIGS. 59A and 59B illustrate a perspective view and a side view respectively of an embodiment of a connecting rod of the assembly of FIGS. 58A and 58B.

FIGS. 60-63 illustrates schematic cross-sectional views of embodiments of connecting rod and piston assemblies connected to crankshafts.

FIGS. 64A-64D illustrate a perspective view, a first side view, a second side view, and a bottom view respectively of an embodiment of a piston.

FIGS. 65A-65D illustrate a perspective view, a first side view, a second side view, and a bottom view respectively of another embodiment of a piston.

FIGS. 66A-66D illustrate various schematic views of embodiments of connecting rods.

FIGS. 67A-67C illustrate a perspective view, a first side view, and a second side view respectively of another embodiment of a connecting rod.

FIGS. 68A-68D illustrate a first perspective view, a first side view, a second perspective view, and a second side view respectively of an embodiment of a pair of connecting rods.

FIGS. 69A-69C illustrate a perspective view, a first side view, and a second side view respectively of pairs of the connecting rods of FIGS. 68A-68C connected to a pair of crankshafts, according to an embodiment.

FIGS. 70A-70C illustrate a perspective view, a first side view, and a second side view respectively of pairs of the connecting rods of FIGS. 68A-68C connected to another pair of crankshafts, according to an embodiment.

FIGS. 71A and 71B illustrate a schematic partial cross-sectional side view and a schematic partial cross-sectional top view of an embodiment of an internal combustion engine.

FIGS. 72 and 73 illustrate schematic cross-sectional side views of select components of an embodiment of an internal combustion engine.

FIG. 74A illustrates a schematic partial cross-sectional side view of an embodiment of an internal combustion engine.

FIG. 74B shows a schematic partial side view of the internal combustion engine of FIG. 74A, illustrating the combustion piston/cylinder side of the engine.

FIG. 74C shows a schematic partial side view of the internal combustion engine of FIG. 74A, illustrating the auxiliary piston/cylinder side of the engine.

FIG. 74D illustrates a schematic cross-sectional side view of an embodiment of a crankshaft, connecting rods, and piston assembly for an internal combustion engine.

FIG. 74E illustrates various schematic views of an embodiment of a crankshaft and portions thereof, showing that an angle may exist between different crankpins on the crankshaft that connect different connecting rods to a piston.

FIG. 75A illustrates a schematic cross-sectional side view of an embodiment of a crankshaft, connecting rods, and piston assemblies for an engine.

FIG. 75B shows a schematic partial side view of the engine of FIG. 75A, illustrating the combustion piston/cylinder side of the engine.

FIG. 75C shows another schematic partial side view of the internal combustion engine of FIG. 75A, illustrating the auxiliary piston/cylinder side of the engine.

FIG. 76 illustrates a schematic cross-sectional side view an embodiment of a crankshaft that includes an indexable and adjustable cam.

FIG. 77A illustrates a schematic cross-sectional side view an embodiment with a piston that comprises two components that can be fastened together around a wrist pin and translating portion.

FIG. 77B illustrates a schematic cross-sectional side view of an embodiment where a piston comprises a single component and the wrist pin and translating portion can be slid into and through an opening in the piston from the side.

FIG. 77C illustrates a schematic cross-sectional side view of an embodiment of a single-piece piston.

FIGS. 77D and 77E illustrate schematic cross-sectional side views of embodiments of multi-piece pistons.

FIGS. 77F-77K illustrate various schematic views of configurations for coupling a wrist pin to a piston in a manner that provides one or more degrees of freedom.

FIGS. 78A-78G illustrate various schematic views of an embodiment of an internal combustion engine and various components thereof.

FIG. 79A-79D illustrate various schematic views of components of an internal combustion engine.

FIGS. 80A-80C illustrate a first perspective view, a second perspective view, and a side view respectively of an embodiment of an internal combustion engine.

FIG. 81A illustrates a perspective view of the engine of FIG. 80A with a block and various other components removed.

FIG. 81B illustrates a cross-sectional view of the engine of FIG. 80A.

FIGS. 81C and 81D illustrate a perspective exploded view and a cross-sectional exploded view respectively of portions of the engine of FIG. 80A.

FIGS. 82A-82C illustrate a perspective view, a partial exploded view, and a side view respectively of embodiments of pistons, connecting rods, and crankshafts that may be included in the engine of FIG. 80A.

FIG. 83 illustrates a side view of an embodiment of a pair of intermeshed crankshafts that may be included in the engine of FIG. 80A.

FIGS. 84A and 84B illustrate a perspective view and a side view respectively of an embodiment of one crankshaft of the pair of crankshafts of FIG. 83.

FIGS. 85A and 85B illustrate perspective views of the pair of crankshafts of FIG. 83 connected to six-connecting rods.

FIGS. 86A-86C illustrate a perspective view, a first side view, and a second side view respectively of an embodiment of a connecting rod.

FIGS. 87A-87C illustrate a perspective view, a first side view, and a second side view respectively of another embodiment of a connecting rod.

FIG. 88 illustrates a schematic cross-sectional view of an embodiment of an internal combustion engine.

FIG. 89 illustrates a perspective view of an embodiment of an assembly including four crankshafts and four piston and connecting rod sub-assemblies.

FIG. 90A illustrates a perspective view of the connecting rods of the assembly of FIG. 89 arranged in a neutral configuration.

FIG. 90B illustrates a perspective view of the connecting rods of the assembly of FIG. 89 arranged in a complete toed-in configuration.

FIGS. 91A and 91B illustrate cross-sectional views of the assembly of FIG. 89.

FIGS. 92A-92C illustrate schematic cross-sectional views of embodiments of internal combustion engines with four crankshafts.

FIGS. 93A and 93B illustrate a perspective view and a side view respectively of an embodiment of an assembly including six crankshafts and six piston and connecting rod sub-assemblies.

FIGS. 94A and 94B illustrate cross-sectional views of the assembly of FIGS. 93A and 93B.

FIGS. 95A and 95B illustrate a perspective view and a side view respectively of an embodiment of an assembly including eight crankshafts and eight piston and connecting rod sub-assemblies.

### DETAILED DESCRIPTION

Various features and advantages of this disclosure will now be described with reference to the accompanying figures. The following description is merely illustrative in nature and is in no way intended to limit the disclosure, its application, or uses. This disclosure extends beyond the specifically disclosed implementations and/or uses and obvious modifications and equivalents thereof. Thus, it is intended that the scope of this disclosure should not be limited by any particular implementations described below. The features of the illustrated implementations can be modified, combined, removed, and/or substituted as will be apparent to those of ordinary skill in the art upon consideration of the principles disclosed herein. Furthermore, implementations disclosed herein can include several novel features, no single one of which is solely responsible for its desirable attributes or which is essential to practicing the systems, devices, and/or methods disclosed herein.

Parts, components, features, and/or elements of the internal combustion engines described herein that can function the same or similarly across various implementations are identified using the same reference numerals with a different letter added after the reference numerals. Differences between the various implementations are discussed herein.

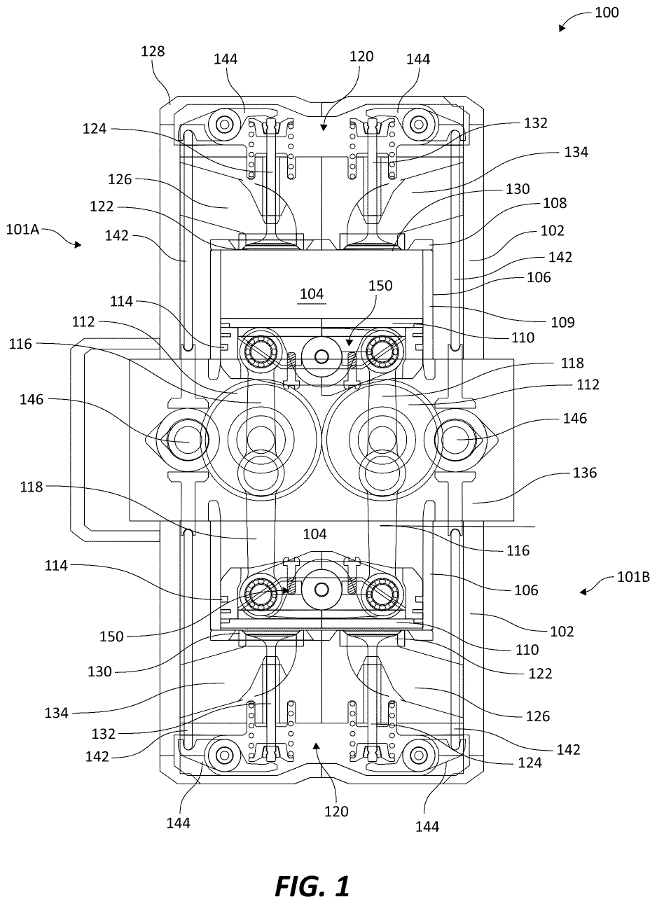

Various drawings shown and described herein include schematic views, schematic cross-sectional views, and/or partial schematic cross-sectional views. In drawings including schematic cross-sectional views, the cross-sectional line can vary to extend along multiple planes to show various components that may not be visible in a traditional cross-sectional view. In these drawings and in other schematic drawings, herein, various lines and components can be shown as overlapping with each other or transparent for illustrative purposes. In some of these drawings, rotational components like gears and shafts (e.g., crankshafts, camshafts, etc.) can be shown as one or more circles. Generally, the outermost circle indicates the maximum diameter of these rotational components instead of a true cross-sectional view of the component when not rotating. Additionally, in these drawings, various components are not shown or are shown geometrically for illustrative purposes. Examples of drawings including schematic cross-sectional views may include but is not limited to FIGS. 1-5B, 7A-14B, 17A-17C, 19A-35, 38A-39C, 43, 44C, 44D, 46A-46C, 51, 54, 60-63, 66A-66D, 71A-74B, 74D-75B, 76, 77A-77E, 78A, 78B, 78D-79D, 88, and 92A-92C.

As used herein, directional terms such as “upper,” “lower,” “top,” “bottom,” “left,” “right,” “front,” “rear,” and similar terms are used solely for ease of description with reference to the orientation of the elements as illustrated in the drawings. Such terms are not intended to be limiting and should be understood to encompass different orientations of the device or components in use or manufacture.

Many figures and examples described herein provide details for internal combustion engines having at least one combustion chamber configured to provide a power stroke to cause rotation of a crankshaft. In these examples, however, the combustion chamber can be replaced with a non-combustion chamber that can be used to pump or compress a fluid. In such embodiments, a power input can be provided to the crankshaft to cause a pumping or compressing stroke in the non-combustion chamber. Thus, although the systems and devices described throughout the application are described using internal combustion engines as the primary example, the systems and devices are also applicable to pumps and compressors.

FIG. 1 illustrates an embodiment of an internal combustion engine 100 that includes a linkage assembly 150. The linkage assembly 150 can include multiple connecting rods that are used to couple the piston to the crankshafts and may be referred to herein as a “connecting rod linkage assembly.” Use of the linkage assembly 150 in the internal combustion engine 100 can provide one or more advantages, including improved engine efficiency, weight, and/or output, as described further herein.

The internal combustion engine 100 and any internal combustion engine or component thereof described herein may include any and/or all of the implementations and/or features of the internal combustion engine systems described and/or illustrated in PCT Application No. US2024/015639, filed Feb. 13, 2024, titled “INTERNAL COMBUSTION ENGINE,” PCT Application No. US2024/054996, filed Nov. 7, 2024, titled “INTERNAL COMBUSTION ENGINE,” and PCT Application No. US2025/041540, filed Aug. 11, 2025, titled “INTERNAL COMBUSTION ENGINE,” the entire contents of each are hereby incorporated by reference in their entireties.

In the illustrated example, the internal combustion engine 100 is a stacked dual-chamber assembly, including an upper or first engine assembly 101A and a lower or second engine assembly 101B (collectively “engine assemblies 101”). The first engine assembly 101A and the second engine assembly 101B are substantially identical to each other, with the second engine assembly 101B being inverted relative to the first engine assembly 101A. Accordingly, the second engine assembly 101B is understood to include the same features and functions as the first engine assembly 101A, as described herein. Other embodiments of the internal combustion engine 100 can include only a single engine assembly, as described further herein.

Each engine assembly 101 comprises a uniblock 102. The internal combustion engine 100 of FIG. 1 includes two uniblocks 102. The construction of the uniblock 102 is distinct from separable cylinder block and cylinder head assemblies commonly employed in conventional reciprocating internal combustion engines. In those conventional reciprocating internal combustion engines, the cylinder head assemblies are bolted to the cylinder block with a gasket positioned between the two. Together, the cylinder head assembly and the cylinder block define the combustion chambers while the cylinder block defines the cylinder bores. In some implementations, the internal combustion engine 100 can comprise a conventional reciprocating internal combustion engine design with one or more linkage assemblies 150. For example, the internal combustion engine 100 may include one or more cylinder head assemblies and one or more cylinder blocks coupled together.

In the illustrated construction, however, what would be considered the cylinder head and the cylinder block in conventional reciprocating internal combustion engines are integrated into a single component to define at least a portion of the uniblock 102. Each uniblock 102 illustrated in FIG. 1 can be formed as a single component that defines a combustion chamber 104 and a cylinder bore 106. In some configurations, the uniblock 102 can be a monolithic component that defines the combustion chamber 104 and the cylinder bore 106. In some configurations, the uniblock 102 can define more than one combustion chamber and/or more than one cylinder bore.

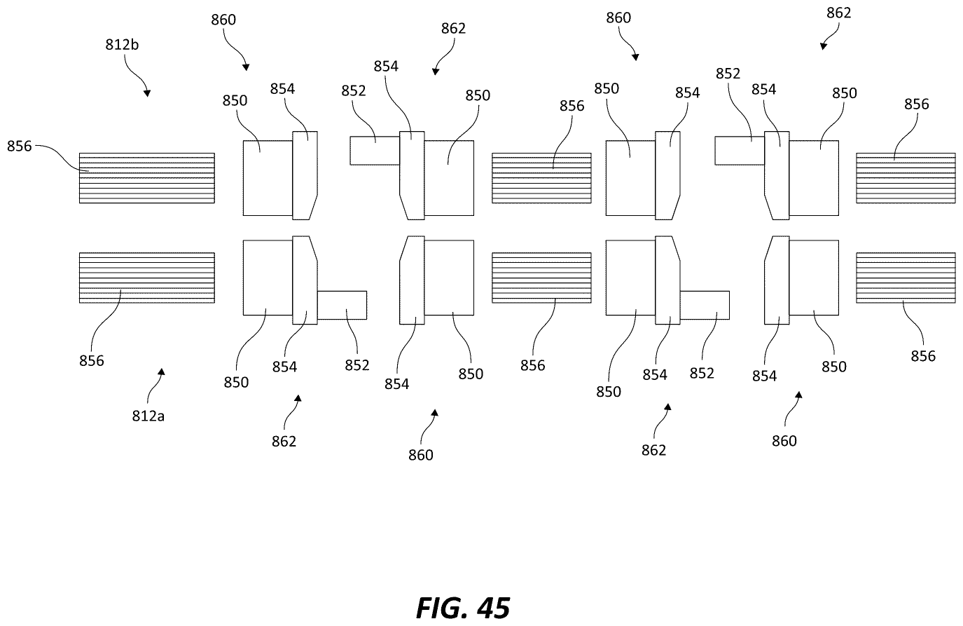

As shown in FIG. 1, two or more uniblocks 102 can be paired in various configurations for the internal combustion engine 100 using the uniblocks 102. The multiple uniblocks 102 can be positioned side-by-side and/or end-to-end (as shown in FIG. 1). The modular nature afforded by the uniblock design facilitates engines of a multitude of constructions. For example, the internal combustion engine 100 shown in FIG. 1 can be configured to be modular as described further herein. In one example, the two crankshafts 112 can be configured to be modular like the crankshafts 812 of FIG. 45.

Referring now to the first engine assembly 101A, the uniblock 102 that is illustrated encloses, envelopes, and/or surrounds both of the combustion chamber 104 and at least a portion of the cylinder bore 106 that is associated with the combustion chamber 104. In some configurations, the uniblock 102 encloses, envelopes, and/or surrounds the combustion chamber 104 and at least a majority of the cylinder bore 106. In some configurations, the uniblock 102 encloses, envelopes, and/or surrounds the combustion chamber 104 and all of the cylinder bore 106. In other words, the combustion chamber 104 and the cylinder bore 106 can be defined within the uniblock 102.

A piston 110 is positioned within the cylinder bore 106. The piston 110 is configured to reciprocate within the cylinder bore 106. In some configurations, the piston 110 is inserted into the uniblock 102 from the bottom of the uniblock 102. In other words, because the combustion chamber 104 and the cylinder bore 106 are formed inwardly from the bottom of the uniblock 102 (i.e., similar to a blind hole), the piston 110 is inserted into the cylinder bore 106 from the bottom of the uniblock 102. Several optional constructions for the piston 110 are described in PCT Application No. US2024/015639 and in PCT Application No. US2025/041540.

According to some configurations, a top end of the cylinder bore(s) 106 can be lined with a cylinder top plate 108. In some configurations, the side wall of the cylinder bore(s) 106 can be lined with a cylinder liner 109. The cylinder liner 109 and the cylinder top plate 108 can be integrated or separately formed. In some configurations, the cylinder liner 109 can abut the cylinder top plate 108 and hold the cylinder top plate 108 adjacent to the top end of the cylinder bore 106. In some configurations, the cylinder liner 109 and/or the cylinder top plate 108 can be formed from, or can comprise a layer of, Inconel or similar materials that have a very low thermal conductivity.

The piston 110 is connected to two crankshafts 112 in the illustrated configuration. The two crankshafts 112 in the internal combustion engine 100 are positioned below (in the orientation of the page) the cylinder bore 106 of the first engine assembly 101A. As such, the two crankshafts 112 are disposed between the cylinder bores 106 of the first engine assembly 101A and the second engine assembly 101B.

Depending upon the configuration of the internal combustion engine 100, the number of crankshafts 112 and/or their rotation relative to one another can vary. In the illustrated configuration, the internal combustion engine 100 carries two counter-rotating crankshafts 112. The two crankshafts 112 can be at least partially housed or enclosed within a housing 136. The housing 136 is positioned between the two uniblocks 102 of the engine assemblies 101. The housing 136 can join the two uniblocks 102 of the engine assemblies 101 together.

In the illustrated configuration, the housing 136 carries two counter-rotating crankshafts 112. A first crankshaft 112 can rotate in a first direction and a second crankshaft 112 can rotate in a second direction, with the second direction being opposite the first direction. The two crankshafts 112 can be disposed adjacent each other and in mesh with each other. For example, a gear of a first crankshaft 112 can directly mesh with a gear of the second crankshaft 112. In such an arrangement, rotation of one of the crankshafts 112 causes counter-rotation of the other of the crankshafts 112.

In the internal combustion engine 100 of FIG. 1, the two crankshafts 112 are positioned between the two pistons 110. The center axes (i.e., the axes of rotation) of the crankshafts 112 can be disposed between the bottoms of the cylinder bores 106. For example, the center axes of the crankshafts 112 remain below the piston 110 of the first engine assembly 101A when the piston 110 is at bottom dead center and above the piston 110 of the second engine assembly 101B when the piston 110 is at bottom dead center.

In the illustrated configuration, the two crankshafts 112 are fully housed within the housing 136. In other configurations, the two crankshafts 112 may be housed at least partially or fully within one or both of the uniblocks 102. In some configurations, the housing 136 can include crankshaft containing passages/portions (not shown) configured to allow the crankshafts 112 to rotate within.

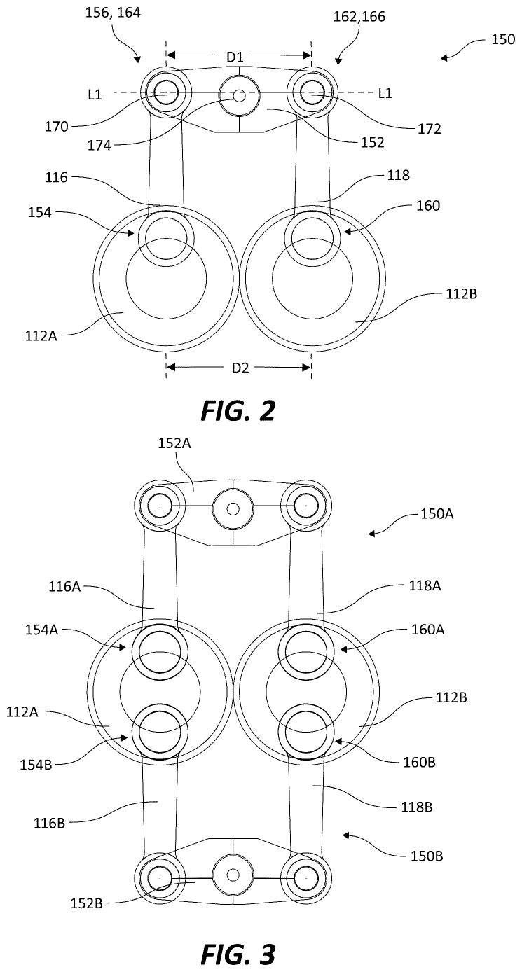

In the illustrated example of FIG. 1, each piston 110 is connected to the two crankshafts 112 via a linkage assembly 150. The linkage assembly 150 is used to convert the linear motion of the piston 110 to the rotational motion of the crankshafts 112. Example implementations of the linkage assembly 150 are described further herein with reference to at least FIGS. 2-6C.

Combustion materials (e.g., fuel and air) are delivered to the internal combustion engine 100 for combustion in at least one of the combustion chambers 104. In the illustrated configuration, each engine assembly 101 includes at least one intake valve opening 122 (“intake port”) and/or at least one fuel injector (not shown). Flow into the combustion chamber 104 through the intake valve opening 122 can be controlled by an intake valve 124. Air for the first engine assembly 101A can be received via an intake passage 126. The intake passage 126 can extend though a side surface of the uniblock 102 and may be directly adjacent to the top surface of the uniblock 102. Such a configuration provides as vertical of an entry into the combustion chamber 104 as possible.

The internal combustion engine 100 can expel exhaust products through at least one exhaust valve opening 130 (“exhaust port”). Flow out of the combustion chambers 104 through the exhaust valve openings 130 can be controlled by exhaust valves 132. The exhaust gases that pass through the exhaust valve opening 130 enter into an exhaust passage 134. For the first engine assembly 101A, the exhaust passage 134 originates at the exhaust valve opening 130 and extends upward and outward in the illustrated configuration. The exhaust passage 134 can be formed within the uniblock 102 in any suitable manner. For each engine assembly 101, one or more than one exhaust valve openings 130 can be provided. In configurations featuring multiple exhaust valve openings 130 per engine assembly 101, the exhaust passage 134 can comprise multiple runners with each runner terminating at the respective exhaust valve opening 130. Other configurations are also possible.

In the illustrated construction, a valve train 120 is positioned above the combustion chamber 104 of the engine assembly 101A. The valve train 120 in the illustrated construction is a mechanical system that controls the opening and closing of the intake valves 124 and the exhaust valves 132. The valve train 120 is mainly positioned within a chamber defined by a valve train cover 128 and a recess defined within the upper surface of the uniblock 102. Fasteners (not shown) can be used to secure the valve train cover 128 to the uniblock 102. A sealing gasket (not shown) can be positioned between the valve train cover 128 and the uniblock 102.

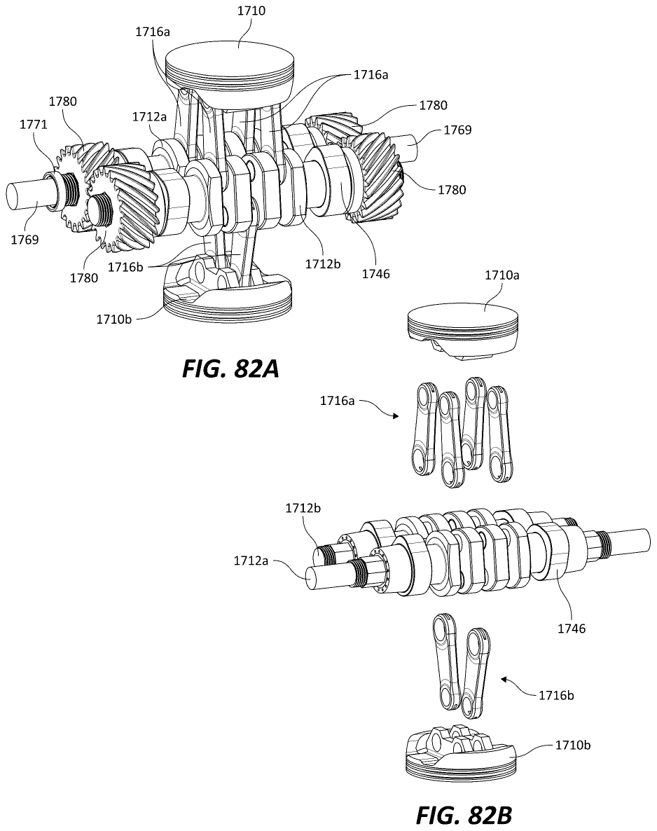

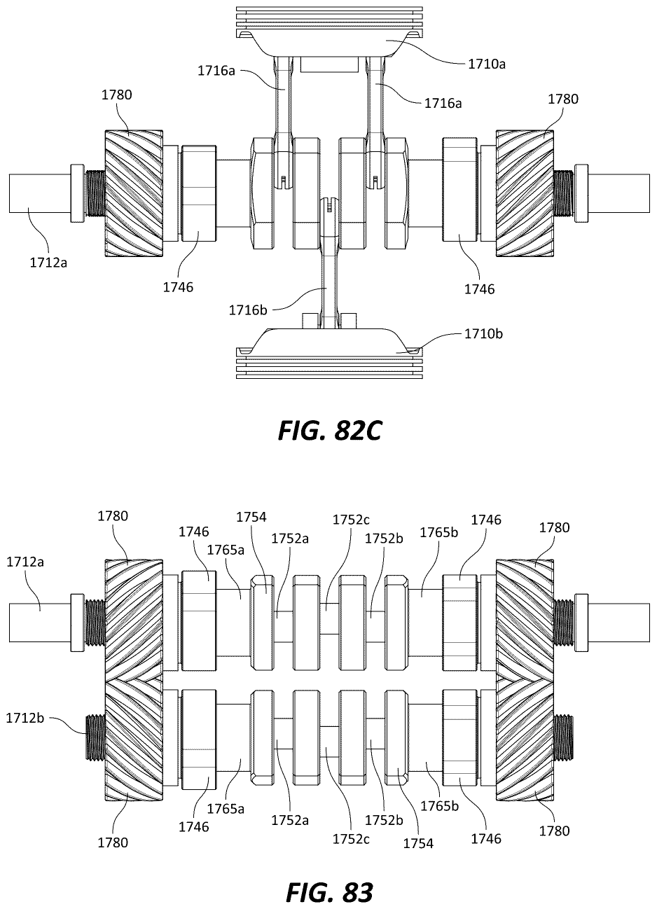

In the illustrated configuration of FIG. 1, each valve train 120 includes at least two pushrods 142 and at least two rocker arms 144. Each crankshaft 112 can drive a camshaft 146 (e.g., via a timing chain, belt, or gear system). The pushrods 142 can transmit motion from the camshafts 146 to the rocker arms 144 to control the opening and/or closing of the intake valves 124 and exhaust valves 132. In other implementations, different configurations for the valve train 120 are possible. For example, the internal combustion engine 100 may include cams on the crankshaft 112 for actuating the pushrods 142, may include one or more camshafts as part of an overhead cam system, and/or may include other valve actuating systems. Example implementations of crankshafts with cams for actuating valves are shown and described with reference to at least FIG. 82A-84B. In some configurations, the internal combustion engine 100 can utilize the valve actuating systems described in PCT Application No. US2024/054996.

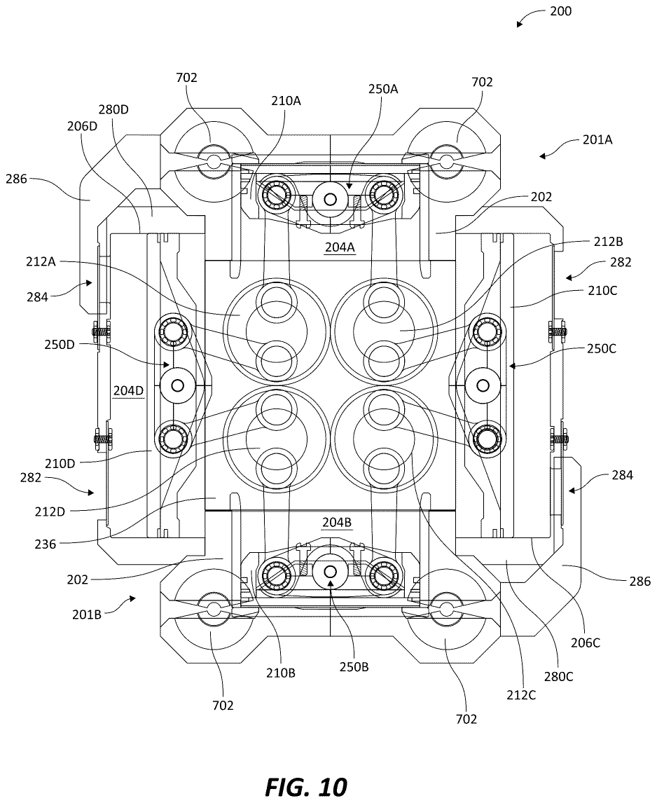

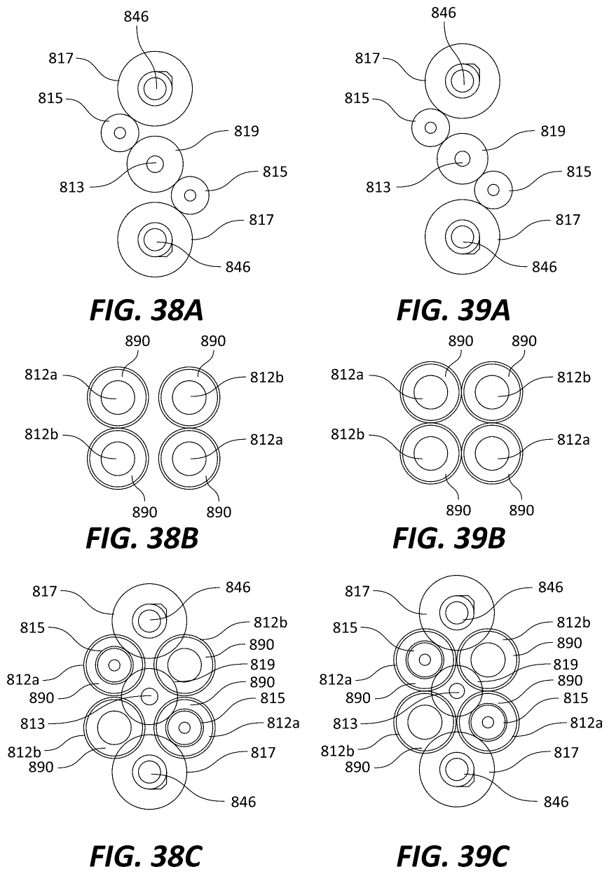

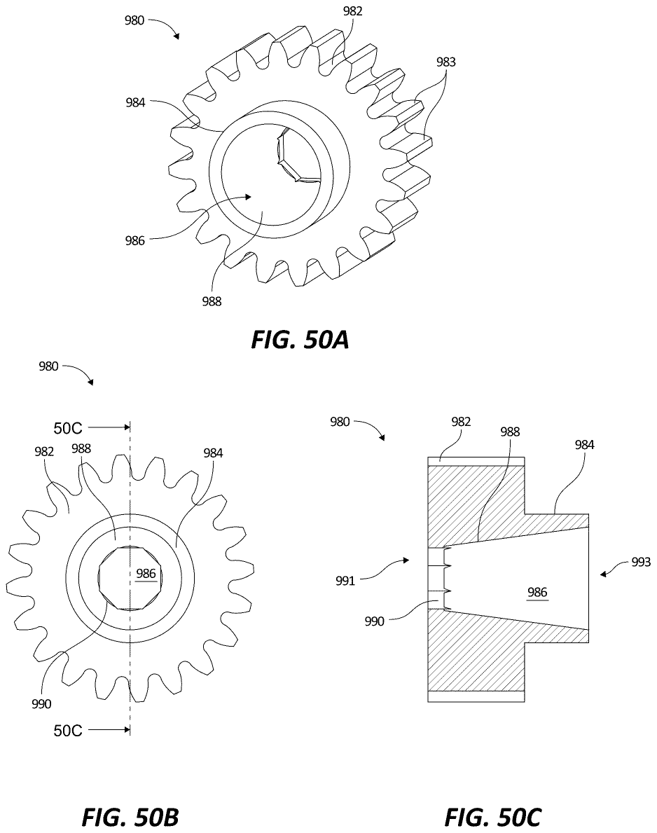

As discussed above, the illustrated internal combustion engine 100 of FIG. 1 operates with two crankshafts 112. Other internal combustion engines described herein operate with four crankshafts 112 (see e.g., internal combustion engine 200 of FIG. 10). In a two-crankshaft configuration, the two crankshafts 112 can include gears that are in mesh with each other such that each crankshaft 112 counter-rotates with the other crankshaft 112. An example implementation of a crankshaft gear is shown and described with reference to at least FIGS. 50A-50C. In the four-crankshaft configuration, each crankshaft 112 can include a gear that is in mesh with at least one other crankshaft 112, such that two of the crankshafts 112 rotate in a first direction and two of the crankshafts 112 rotate in a second direction opposite the first direction. Example configurations of gears and associated arrangements for a four-crankshaft configuration are shown and described with reference to at least FIGS. 38A-40C.

Crankshafts generally can be subjected to relatively large horizontal and/or torsional forces during operation. The pistons transmit forces to the crankpins through the connecting rods. If the crankshaft has long throws (e.g., in internal combustion engines that have long stroke lengths), the crankshaft can have large webs to help maintain the rigidity of the crankshaft. This can add significant weight to the crankshaft. To maintain balance, in some crankshafts, the webs also can include significant counterweights.

The crankshafts 112 of the internal combustion engine 100 of FIG. 1 and the other engines described herein can have shorter throws than those typically found in conventional engines, in some implementations. For example, a typical conventional crankshaft can have a throw such that the crankpin is fully or nearly fully outside of the radius of the main journal. The use of a shorter throw can reduce or eliminate the need for heavy counterweights and/or can improve rigidity of the crankshaft, which can allow for thinner webs to be used, among other advantages.

In some configurations, the use of shorter throws in the crankshafts 112 can allow the internal combustion engine 100 to have higher engine speed capabilities compared to conventional engines configured for similar output. For example, the internal combustion engine 100 can “rev faster” due at least in part to the shorter throws. High engine speed capabilities can provide certain advantages, such as increased engine power output, broader operating range, improved throttle response, and enhanced performance for certain applications, among other advantages.

In some configurations, an internal combustion engine can comprise two crankshafts 112 (see e.g., internal combustion engine 100 of FIG. 1). In some configurations, the internal combustion engine 100 can have four crankshafts (see e.g., at least the internal combustion engine 200 of FIG. 10). In some configurations, the internal combustion engine 100 can have more than four crankshafts (see e.g., at least FIGS. 22A-27). In some configurations, each piston 110 of the internal combustion engine 100 can be associated with two crankshafts 112 (e.g., the piston 110 can be coupled to two crankshafts 112). In some configurations, the strokes of each of the pistons 110 can be asymmetric or symmetric. In some configurations (e.g., inline, opposed balanced, and/or opposed compact configurations), power strokes and/or other strokes can be up to about 200 degrees per revolution, which is more degrees of revolution than in most engines. Because the end of the power stroke is defined by power pressures no longer exerting on the pistons 110 due to exhaust, intake or scavenging events becoming significant, and since these exhaust, intake or scavenging events becoming significant can be adjusted in the internal combustion engine 100, some other power strokes can be shorter, for example about 90 degrees. The increased power stroke durations per power event can give added torque, increased rotational smoothness, increased power overlap, increased turbo charging efficiency, and increased overall efficiency. A reduced power stroke duration can be used when higher compression, coming from longer compression duration, and/or longer intake, exhaust or scavenging durations are desired, though efficiency may be reduced.

As shown in FIG. 1, the two crankshafts 112 can be disposed between two pistons 110. In some configurations, both central axis of the two crankshafts 112 can be positioned between the two pistons 110. Such an arrangement can provide for an efficient use of space in the internal combustion engine 100. Such an arrangement can also provide for improved balance for the internal combustion engine 100.

FIG. 1 illustrates an example pair of crankshafts, the pair of crankshafts comprising a first crankshaft 112 and a second crankshaft 112, wherein the first crankshaft 112 is engaged with the second crankshaft 112 such that rotation of the first crankshaft causes counterrotation of the second crankshaft. FIG. 2 illustrates an additional example wherein the first and second crankshafts 112A, 112B, respectively. Additional and similar pairs of crankshafts, often referred to with reference numerals ending in 112A, 112B, are shown and described throughout this application.

FIG. 2 illustrates an isolation cross-sectional view of an embodiment of the linkage assembly 150, and a first crankshaft 112A and a second crankshaft 112B of the two crankshafts 112. Various portions of the linkage assembly 150 and associated components are shown as transparent for illustrative purposes.

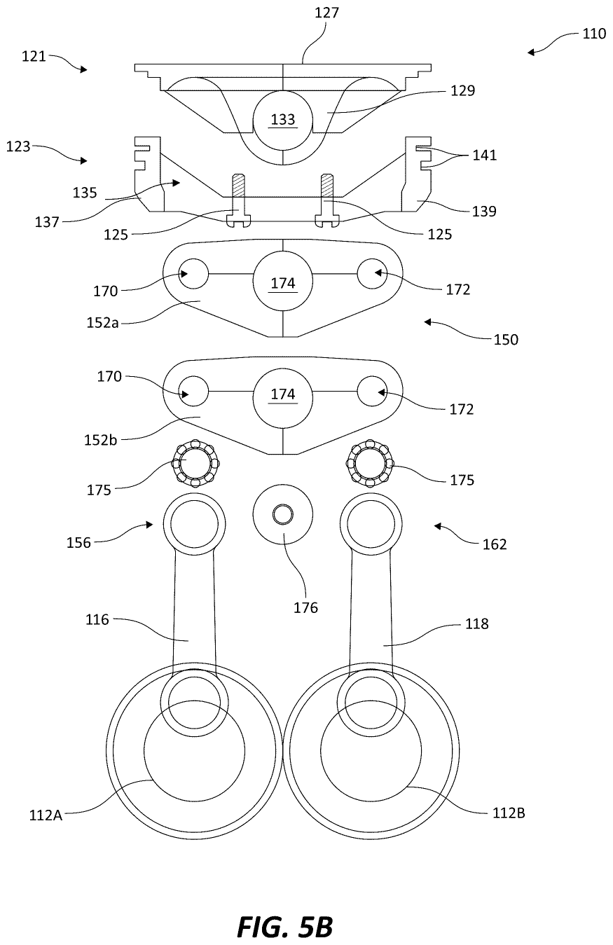

One or more linkage assemblies 150 can be used in the internal combustion engine 100 of FIG. 1. The linkage assembly 150 can be used to connect the piston 110 to the two crankshafts 112, as described further with reference to at least FIGS. 5A and 5B. The linkage assembly 150, in combination with the pair of crankshafts 112, define an assembly that constrains movement of the piston 110 to be only linear (allowing for slight variation as a result of tolerance deviations). The movement of the piston 110 is along the cylinder axis (e.g., the central axis of the cylinder bore 106). According to some configurations, the piston 110 can move only parallel (e.g., substantially only parallel) to the center line of the cylinder bore 106 with little or no side to side, rocking, or slapping forces. Constraining the motion of the piston 110 reduces side forces and stress loading on the piston 110 and on walls that define the cylinder bore 106. Such a configuration can provide significant advantages, including reduced wear of piston side walls, piston rings, and/or the cylinder/cylinder liner walls. In some cases, the arrangement can provide the advantage of reduced frictional heat and work energy losses.

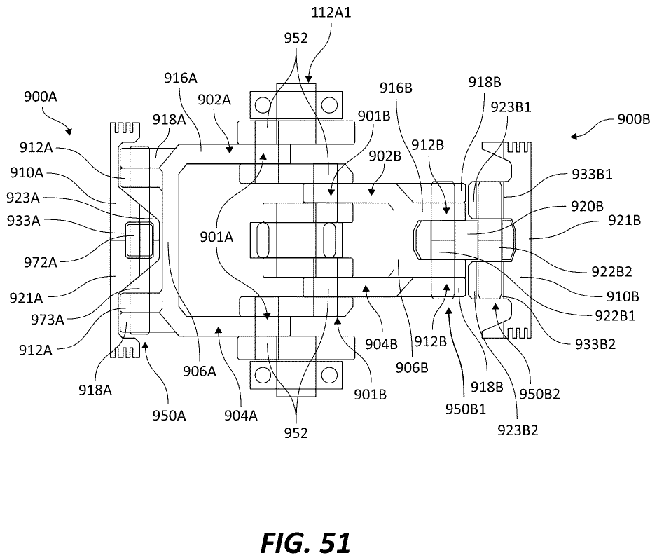

The linkage assembly 150 includes a first connecting rod 116, a second connecting rod 118, and a third connecting rod 152. The first and second connecting rods 116, 118 are used to connect the third connecting rod 152 to the two crankshafts 112 and may be referred to herein as the “crank connecting rods”. The third connecting rod 152 is used to connect the crank connecting rods 116, 118 to the piston 110 and may be referred to herein as the “piston connecting rod”. Several possible constructions for the crank connecting rods 116, 118 are described in PCT Application No. US2024/015639. Other examples of constructions for crank connecting rods are described further herein, including with reference to at least FIGS. 51-63, 66A-68D, and 86A-87C, as well as other descriptions throughout this application.

The first connecting rod 116 has a first end 154 rotatably coupled to the first crankshaft 112A. The first connecting rod 116 has a second end 156 opposite the first end 154. Similarly, the second connecting rod 118 has a first end 160 rotatably coupled to the second crankshaft 112B and a second end 162 opposite the first end 160. Rotatable coupling (e.g., between the crank connecting rods 116, 118 and the crankshafts 112) can be achieved using any conventional means, such as wrist pins. The crank connecting rods 116, 118 can be rotatably coupled to the piston connecting rod 152 at their second ends 156, 162.

The piston connecting rod 152 is configured to be coupled to both the piston 110 and the crank connecting rods 116, 118 (see e.g., FIGS. 5A and 5B). The piston connecting rod 152 can extend between a first end 164 and a second end 166. The piston connecting rod 152 can include a first coupling location 170, a second coupling location 172, and a third coupling location 174. The coupling locations 170, 172, 174 can be opening extending through the piston connecting rod 152. The piston connecting rod 152 can be rotatably coupled to the second end 156 of the first connecting rod 116 at the first coupling location 170. The piston connecting rod 152 can be rotatably coupled to the second end 162 of the second connecting rod 118 at the second coupling location 172. The piston connecting rod 152 can be rotatably coupled to the piston 110 (e.g., via a wrist pin) at the third coupling location 174. The third coupling location 174 is disposed between the first coupling location 170 and the second coupling location 172.

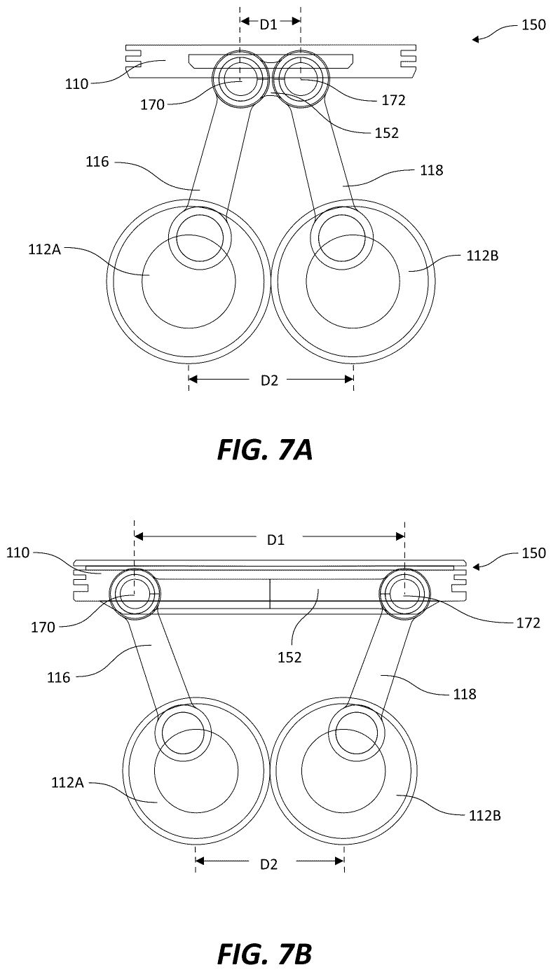

The position of the first and second coupling locations 170, 172 along the width (e.g., in a direction orthogonal to the central axis of the cylinder bore 106) of the piston connecting rod 152 can vary, depending on the configuration. In the illustrated example, the first coupling location 170 is disposed at or near the first end 164 of the piston connecting rod 152 and the second coupling location 172 is disposed at or near the second end 166 of the piston connecting rod 152. In other configurations, the distance between the first and second coupling locations 170, 172 and the third coupling location 174 can be increased or reduced, depending on if the linkage assembly 150 is arranged in a neutral, toed-out, or toed-in configuration. These configurations are described further below with reference to at least FIGS. 7A and 7B.

The position of the first and second coupling locations 170, 172 along the width (e.g., in a direction parallel to the central axis of the cylinder bore 106) of the piston connecting rod 152 can vary, depending on the configuration. The first and second coupling locations 170, 172 can be substantially aligned with the piston rings 114 (see e.g., FIG. 1). For example, a line L1-L1 bisecting both the first coupling location 170 and the second coupling location 172 can also extend between a top and a bottom ring of the piston rings 114. The line L1-L1 is also shown in FIG. 5A and described further below. Arranging the piston connecting rod 152 in this manner can provide certain advantages, as described further herein.

The third coupling location 174 can be positioned above (e.g., further from the two crankshafts 112), aligned with, or below (e.g., closer to the two crankshafts 112) the line L1-L1 bisecting first and second coupling locations 170, 172. In the illustrated configuration, the center of the third coupling location 174 is positioned slightly below the line L1-L1. In other configurations, the line L1-L1 can extend through all coupling locations 170, 172, 174 on the piston connecting rod 152. In some configurations, the line L1-L1 may not pass through the third coupling location 174.

Referring now to FIGS. 5A and 5B, an assembled isolation view and a partial exploded view of the linkage assembly 150 in isolation with an embodiment of the piston 110 and the two crankshafts 112 are shown.

As described herein, the piston connecting rod 152 is configured to transfer forces between the crank connecting rods 116, 118 and the piston 110. To facilitate the transfer of forces, the piston connecting rod 152 can be rotatably coupled to the piston 110 at one or more locations. In the illustrated example, the piston connecting rod 152 is rotatably coupled to the piston 110 at the third coupling location 174. While one example piston 110 is described in FIGS. 5A and 5B, it is recognized that the linkage assembly 150 can be used with other piston designs.

As shown in FIG. 5A, the piston connecting rod 152 can be at least partially disposed within the body of the piston 110. To facilitate assembly of the piston 110 and piston connecting rod 152, the body of the piston 110 can comprise two or more parts. For example, as shown in FIG. 5B, the piston body can include an upper portion 121 and a lower portion 123. The lower portion 123 can have an outer wall 137. The outer wall 137 is shaped to match the shape of the cylinder bore 106 that the piston 110 will be reciprocating within. For example, the outer wall 137 can be circular-shaped, oval-shaped, double-c-shaped, and/or the like. The lower portion 123 can include an opening or recess 135 located inwardly of the outer wall 137. To assemble the piston 110, the upper portion 121 can be received within the recess 135. Conventional means can be used for coupling the upper portion 121 and the lower portion 123. For example, one or more fasteners 125 can be used to couple the upper portion 121 and the lower portion 123.

The upper portion 121 of the piston 110 can include a piston top plate 127. In the illustrated configuration, the piston top plate 127 is shown as flat. In other configurations, the piston top plate 127 can comprise a recess. For example, the recess could be in the shape of a frustoconical region, a cylindrical region, and/or the like. In some configurations, the piston top plate 127 is positioned on an upwardly facing surface of the body of the piston 110. The piston top plate 127 may be a portion of the upper portion 121 or may be a separate component affixed to the piston body in any suitable manner. The piston top plate 127 can be optional. When the piston 110 is used as a combustion piston, a piston top plate 127 may be desirable to reduce heat conduction from the combustion gases into the body of the piston 110. However, when the piston 110 is used as an auxiliary piston, a piston top plate 127 may not be required, and this portion may be referred to as the piston crown 127. Auxiliary pistons are described further herein and generally refer to pistons that serve another function instead of or in addition to driving the crankshafts.

The upper portion 121 can be configured to be rotatably coupled to the piston connecting rod 152. The upper portion 121 can include a connecting portion 129. The connecting portion 129 can extend away from the piston top plate 127. The connecting portion 129 can be received within the recess 135 of the lower portion 123. The connecting portion 129 can include an opening 133. The opening 133 can be aligned with the third coupling location 174 on the piston connecting rod 152 in the assembled piston 110.

As shown in FIG. 5B, in some implementations, the piston connecting rod 152 can comprise a first rod member 152a and a second rod member 152b. The first rod member 152a can be identical to the second rod member 152b. In the assembled piston 110, the first rod member 152a can be disposed on a first side of the connecting portion 129 of the upper portion 121 and the second rod member 152b can be disposed on an opposite second side of the connecting portion 129. In this arrangement, the opening 133 of the upper portion 121 is aligned with the openings 174 of the rod members 152a, 152b. A wrist pin 176 can be received within the openings 174 and the opening 133 for rotatably coupling the rod members 152a, 152b to the upper portion 121 of the piston 110. In this configuration, the piston 110 can be configured to articulate relative to the piston connecting rod 152.

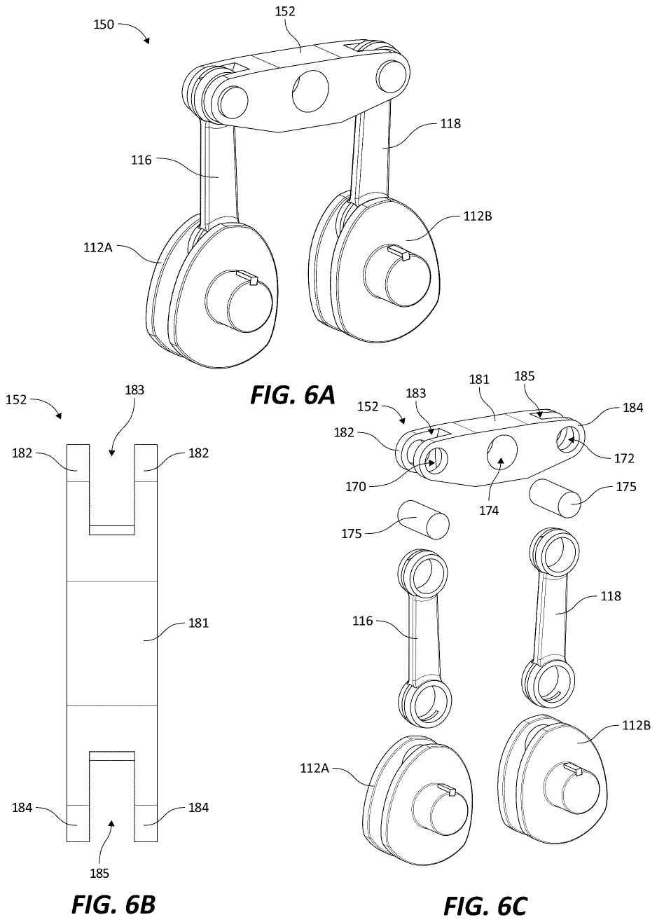

In other implementations, the piston connecting rod 152 can comprise a single rod member. Such a configuration is shown in FIGS. 6A-6C and described further below. In this example, the connecting portion 129 of the upper portion 121 may include a recess for receiving the piston connecting rod 152. To connect the piston connecting rod 152 to the piston 110, the piston connecting rod 152 may be disposed within the recess of the connecting portion 129. The wrist pin 176 can be received within the openings 174, 133 so that the piston 110 can articulate relative to the piston connecting rod 152.

As shown in FIGS. 5A and 5B, the piston connecting rod 152 is received within the recess 135 of the lower portion 123. In some configurations, the recess 135 can be sized such that there is no contact between the piston connecting rod 152 and the lower portion 123. Accordingly, the piston connecting rod 152 can be only connected to the upper portion 121 of the piston 110.

One or both of the upper portion 121 and the lower portion 123 of the piston 110 can include one or more grooves 141. For example, the grooves 141 can be formed in the outer wall 137. One or more piston rings 114 can be received within the grooves 141. The piston rings 114 can be configured to slide along the wall of the cylinder bore 106. The piston rings 114 can provide sealing of the cylinder bore 106. While two grooves 141 are shown in FIGS. 5A and 5B to receive two piston rings 114, the number of grooves 141 and piston rings 114 can be determined based upon the application and construction of the internal combustion engine including the piston 110. For example, there can be as few as one or more than five piston rings 114 per piston 110.

As shown in FIG. 5B, the rod members 152a, 152b of the piston connecting rod 152 include openings 170, 172 which define the first coupling location 170 and the second coupling location 172 respectively. Wrist pins 175 can be used to couple the second ends 156, 162 of the crank connecting rods 116, 118 to the piston connecting rod 152 at the openings 170, 172.

As shown in FIG. 5A, in the assembled piston 110, the first and second coupling locations 170, 172 can be substantially aligned with the grooves 141 that receive the piston rings 114. For example, the line L1-L1 bisecting both the first coupling location 170 and the second coupling location 172 can be substantially aligned with the piston rings 114. In the illustrated example, the first and second coupling locations 170, 172 are slightly below the lowest groove 141. In other examples, the line L1-L1 may be positioned between a lower and an upper groove of the grooves 141.

The first and second coupling locations 170, 172 of the piston connecting rod 152 are the locations where forces are transmitted between the piston connecting rod 152 and the crank connecting rods 116, 118. Because the piston connecting rod 152 is coupled to the piston 110, forces transmitted between the piston 110 and the crank connecting rods 116, 118 also occur at the first and second coupling locations 170, 172. For example, the first and second coupling locations 170, 172 are the pivot points for the piston 110. As such, the forces applied to or transmitted by the piston 110 occur substantially in line with the piston rings 114. Because the piston rings 114 engage the walls of the cylinder bore 106 as the piston 110 reciprocates, utilizing the linkage assembly 150 constrains the movement of the piston 110. For example, the piston connecting rod 152 acts like a crosshead for the piston 110. Accordingly, the linkage assembly 150 can be utilized to eliminate piston sway and to constrain the motion of the piston to move only parallel (e.g., substantially only parallel) to the center line of the cylinder bore 106 with little or no side to side, rocking, or slapping forces. Constraining the motion of the piston 110 reduces side forces and stress loading on the piston 110 and on walls that define the cylinder bore 106. Such a configuration can provide significant advantages, including reduced wear of piston side walls, piston rings, and/or the cylinder/cylinder liner walls. In some cases, the arrangement can provide the advantage of reduced frictional heat and work energy losses.

The linkage assembly 150 can be used to translate the angular motion of the two crankshafts 112 to linear motion of the piston 110 without requiring a large piston skirt to prevent piston rocking. The linkage assembly 150 can also reduce friction losses from the lash of the meshed gears of the two crankshafts 112. For example, the linkage assembly 150 can eliminate many types of lash-induced sway. Such an arrangement can provide improved performance for the piston 110 by eliminating primary and secondary forces.

In some configurations, the piston 110 can be constrained by the linkage assembly 150. For example, the combination of the piston 110 and the linkage assembly 150 can form a positive feedback loop to eliminate or balance the primary and secondary forces.

Utilizing the linkage assembly 150 in the internal combustion engine 100 can improve the efficiency of the internal combustion engine 100 by reducing unwanted vibration, pressure, and friction compared to a conventional internal combustion engine. In part because of the improved efficiency, a larger diameter piston 110 can be used in the internal combustion engine 100. Using a larger diameter piston 110 can provide certain benefits, such as allowing for a shorter stroke length, so that the piston speed can be lower. With lower piston speeds, less oil is required, so the internal combustion engine 100 can operate for longer periods without maintenance. Additionally, with lower piston speeds, the internal combustion engine 100 can rev higher, which can be desirable.

In some configurations, the piston 110 can optionally include a piston skirt 139. The piston skirt 139 is not required and the piston 110 may not include a piston skirt 139. When included, the piston skirt 139 can extend downwardly from the bottom of the lower portion 123. The piston skirt 139 can be in contact with or near the walls of the cylinder bore 106 when installed in the internal combustion engine 100 of FIG. 1. The piston skirt 139 can help to prevent or limit motion of the piston 110 in directions other than along the axis of the cylinder bore 106. For example, the piston skirt 139 can limit lateral movement of the piston 110 and rotating of the piston 110. However, the piston 110 may not include the piston skirt 139 because of several potential drawbacks. For example, contact between the piston skirt 139 and the cylinder wall can increase friction, thereby reducing efficiency. As another example, the piston skirt 139 can add weight to the piston 110, which can also decrease efficiency. According to at least some of the configurations described herein, the piston 110 may not include a piston skirt, or may include a short piston skirt. Such configurations can be possible because of engine designs that ensure little or no side to side or rocking movements of the piston 110.

Referring now to FIGS. 6A-6C, an example implementation of the linkage assembly 150 where the piston connecting rod 152 does not include multiple rod members is shown. FIG. 6A shows a perspective view of the linkage assembly 150 with portions of the two crankshafts 112 shown. FIG. 6B shows a bottom isolation view of the piston connecting rod 152, and FIG. 6C shows a partial exploded view of FIG. 6C.

As shown, when the piston connecting rod 152 is configured as a single member, the piston connecting rod 152 can include a central portion 181 and a first pair of connecting portions 182 and a second pair of connecting portions 184. The connecting portions 182, 184 can extend laterally from the central portion 181. The first pair of connecting portions 182 can be spaced apart to define a gap 183 therebetween. The second pair of connecting portions 184 can be spaced apart to define a gap 185 therebetween.

As shown in FIG. 6C, the first coupling location 170 can be openings that extend through the connecting portions 182. The crank connecting rod 116 can be positioned within the gap 183 and coupled to the piston connecting rod 152 at the first coupling location 170 via a wrist pin 175. Similarly, the second coupling location 172 can be opening that extend through the connecting portions 184 such that the crank connecting rod 118 can be positioned within the gap 185 and coupled to the piston connecting rod 152 via a wrist pin 175. The third coupling location 174 can be an opening extending through the central portion 181.

As described above, the crank connecting rods 116, 118 can be in a neutral, toed-in, or toed-out configuration. When a linkage assembly 150 is used with the crank connecting rods 116, 118, the rods can be coupled to the linkage assembly 150 in a neutral, toed-in, or toed-out configuration. With reference back to FIG. 2, in the illustrated example, the crank connecting rods 116, 118 are coupled to the linkage assembly 150 in a neutral configuration. A neutral configuration is an arrangement where the distance between the central axes of the crank connecting rods 116, 118 is substantially constant along a length of the crank connecting rods 116, 118 when the piston 110 is at top dead center and bottom dead center (e.g., as shown in FIGS. 1-3). For example, in the neutral configuration, a first distance D1 between the first end 154 of the first connecting rod 116 and the first end 160 of the second connecting rod is substantially equal to a second distance D2 between the second end 156 of the first connecting rod 116 and the second end 162 of the second connecting rod when the piston 110 is at top dead center or bottom dead center. When the linkage assembly 150 is in the neutral configuration, the first connecting rod 116 is aligned with a first vertical axis of the first crankshaft 112A and the second connecting rod 118 is aligned with a second vertical axis of the second crankshaft 112B when the piston 110 is at top dead center or bottom dead center. When the piston connecting rod 152 is utilized with the crank connecting rods 116, 118, the first distance D1 may also be defined as the distance between the first coupling location 170 and the second coupling location 172 of the piston connecting rod 152. The second distance D2 may also be defined as the distance between the central axes of the two crankshafts 112.

Arranging the crank connecting rods 116, 118 in the neutral configuration in the internal combustion engine 100 can provide certain advantages. For example, the neutral configuration allows the piston 110 to have the same crankshaft angle or angle of rotation when moving between top dead center and bottom dead center, and vice versa. Accordingly, the two crankshafts 112 rotate 180-degrees for all strokes (e.g., for each of the intake, compression, power, and exhaust strokes in a four-stroke engine and for each of the power and compression strokes in a two-stroke engine). Having the same decree of rotation for all stokes can improve the overall balance of the engine employing the crank connecting rods 116, 118 and/or the linkage assembly 150 in the neutral configuration.

The first connecting rod 116 and the second connecting rod 118 can have a same length or can have different lengths. In the illustrated configuration, the first connecting rod 116 has the same length as the second connecting rod 118. When configured in this manner, the linkage assembly 150 can be described as being a “trapezoidal linkage”, with the two crank connecting rods 116, 118 forming two opposing parallel sides of the trapezoid when the piston 110 is at top dead center and bottom dead center. In this example, the piston connecting rod 152 forms a third side of the trapezoid linkage, and the distance between the central axis of the two crankshafts 112 forms a fourth side of the trapezoid linkage.

In some configurations, the first distance D1 and the second distance D2 can be substantially equal to the lengths of the crank connecting rods 116, 118. In this configuration, the linkage assembly 150 can be in a “square linkage”, where the four sides of the trapezoid are parallel to and equal to each other when the piston 110 is at top dead center and bottom dead center.

As shown in FIG. 7A, the crank connecting rods 116, 118 can be arranged in a toed-in configuration. For ease of illustration, a schematic representation of the piston 110 and piston connecting rod 152 is shown in FIGS. 7A and 7B. The toed-in configuration occurs when the first distance D1 is less than the second distance D2. For example, when the second ends 156, 162 of the crank connecting rods 116, 118 are closer together than the first ends 154, 160 at top dead center and bottom dead center. In the toed-in configuration, the piston connecting rod 152 can have a smaller width compared to the neutral configuration, in some applications. Additionally, or alternatively, the first and second coupling locations 170, 172 may be positioned more inwardly relative to the first and second ends 164, 166 respectively of the piston connecting rod 152.

Arranging the crank connecting rods 116, 118 in the toed-in configuration can change the crank angle associated with the various strokes of an engine employing the crank connecting rods 116, 118 (e.g., the internal combustion engine 100 of FIG. 1). For a two-stroke engine, the two crankshafts 112 can rotate through more degrees of rotation for the power stroke compared to the compression stroke when the crank connecting rods 116, 118 (and the linkage assembly 150) are in the toed-in configuration. In one example, the two crankshafts 112 may rotate 200-degrees for the power stroke and 160-degrees for the compression stroke. However, the amount of degrees for each stroke will vary, depending on how toed-in the crank connecting rods 116, 118 are.

Having a larger crank angle associated with the power stroke can provide certain advantages. For example, the longer power stroke can be desirable for engine output. In another example, a larger crank angle associated with the power stroke can allow for longer intake and scavenging, which can be desirable. For example, such an arrangement can reduce choking during intake. In another example, the toe-in configuration can provide an advantage of reducing the reciprocating mass of the piston assembly because the length (and mass) of the piston connecting rod 152, when utilized, can be reduced.

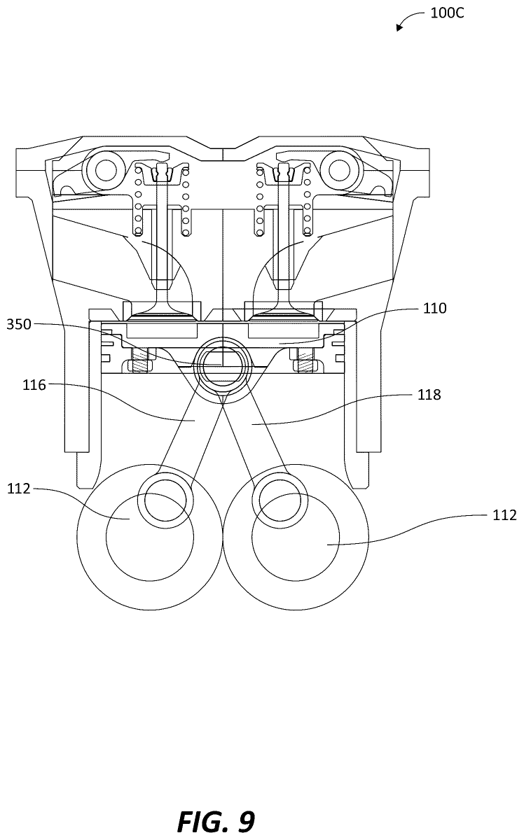

In a fully or complete toed-in configuration, the first coupling location 170 and the second coupling location 172 can be the same. For example, the second ends 156, 162 of the crank connecting rods 116, 118 can overlap and optionally share the same rotatable connection to the piston connecting rod 152 or directly to the piston 110, depending on the arrangement. This arrangement is described further with reference to at least FIG. 9. When arranged in this manner, the piston connecting rod 152 is not required, which reduces the reciprocating mass of the piston assembly and the overall mass of the internal combustion engine 100.

As shown in FIG. 7B, the crank connecting rods 116, 118 can be arranged in a toed-out configuration. The toed-out configuration occurs when the first distance D1 is greater than the second distance D2. For example, when the first ends 154, 160 of the crank connecting rods 116, 118 are closer together than the second ends 156, 162 at top dead center and bottom dead center. In the toed-out configuration, the piston connecting rod 152 can have a larger width compared to the neutral configuration, in some applications. Additionally, or alternatively, the first and second coupling locations 170, 172 may be positioned more outwardly relative to the first and second ends 164, 166 respectively of the piston connecting rod 152.

Arranging the crank connecting rods 116, 118 in the toed-out configuration can change the crank angle associated with the various strokes of an engine employing the crank connecting rods 116, 118 (e.g., the internal combustion engine 100 of FIG. 1). For a two-stroke engine, the two crankshafts 112 can rotate through more degrees of rotation for the compression stroke compared to the power stoke when the crank connecting rods 116, 118 (and the linkage assembly 150) are in the toed-out configuration. In other configurations, the toe-out configuration can result in a longer power stroke, which can provide the same advantages described above. In another example, the toed-out configuration can provide an advantage of increasing the reciprocating mass of the piston assembly because the length (and mass) of the piston connecting rod 152 can be increased. In some cases, a larger reciprocating mass can be desirable because it may reduce piston rocking due to gear lash. For example, the lash can be applied over a longer distance.

According to some configurations, one or more linkage assemblies 150 can be utilized in an engine. The one or more linkage assemblies 150 can be used in an engine described herein (e.g., the internal combustion engine 100 of FIG. 1) or any other engine to provide the associated benefits. In some configurations, multiple linkage assemblies 150 can be connected to the same pair of crankshafts. For example, FIG. 3 illustrates an isolation cross-sectional view of an embodiment of a first linkage assembly 150A and a second linkage assembly 150B connected to the first and second crankshaft 112A, 112B.

The first and second linkage assemblies 150A, 150B can be similar or identical to the linkage assembly 150 of FIG. 2. The first linkage assembly 150A can include a pair of crank connecting rods 116A, 118A and a piston connecting rod 152A. The second linkage assembly 150B can include a pair of crank connecting rods 116B, 118B and a piston connecting rod 152B. The connecting rods 116B, 118B, 152B of the second linkage assembly 150B may be referred to as the fourth connecting rod 116B, the fifth connecting rod 118B, and the sixth connecting rod 152B respectively. The connecting rods 152A, 152B can be configured in two-part form (as shown in at least FIGS. 5A and 5B) or in one-part form (as shown in at least FIGS. 6A-6C).

As shown in FIG. 3, the first and second linkage assemblies 150A, 150B can be driven by the same two crankshafts 112. The first linkage assembly 150A can be used to drive a first piston 110 and the second linkage assembly 150B can be used to drive a second piston 110, as shown in the internal combustion engine 100 of FIG. 1. The first connecting rod 116A and the fourth connecting rod 116B can be rotatably coupled to the first crankshaft 112A. The second connecting rod 118A and the fifth connecting rod 118B can be rotatably coupled to the second crankshaft 112B.

An engine utilizing multiple linkage assemblies 150 can be configured using any conventional layout, such as in an inline, “V”, “VR”, “W”, “X”, opposed, boxer, flat, radial piston, and/or the like configuration. When in a boxer configuration, the crank connecting rods 116A, 118A of the first linkage assembly 150A can be radially opposite the crank connecting rods 116B, 118B of the second linkage assembly 150B on the two crankshafts 112. For example, the first end 154A of the first connecting rod 116A can be opposite the first end 154B of the fourth connecting rod 116B on the first crankshaft 112A. Similarly, the first end 160A of the second connecting rod 118A can be opposite the first end 160B of the fifth connecting rod 118B on the second crankshaft 112B. As a result of this arrangement, the two pistons 110 can be at their respective bottom dead center and top dead center locations at the same time.

When an engine utilizing multiple linkage assemblies 150 is arranged in an opposed configuration, the crank connecting rods 116A, 118A of the first linkage assembly 150A can be aligned with the crank connecting rods 116B, 118B of the second linkage assembly 150B on the two crankshafts 112. For example, the first end 154A of the first connecting rod 116A can rotatably coupled to the first crankshaft 112A at the same location as the first end 154B of the fourth connecting rod 116B. Similarly, the first end 160A of the second connecting rod 118A can be rotatably coupled to the second crankshaft 112B at the same location as the first end 160B of the fifth connecting rod 118B. As a result of this arrangement, the piston 110 coupled to the first linkage assembly 150A is at top dead center when the piston 110 coupled to the second linkage assembly 150B is at bottom dead center. When in the opposed configuration, the crank connecting rods 116A, 118A of the first linkage assembly 150A may share crankpins with the crank connecting rods 116B, 118B of the second linkage assembly 150B for rotatably coupling to the two crankshafts 112. The internal combustion engine 100 of FIG. 1 is configured in the opposed arrangement.

According to some configurations, an engine utilizing multiple linkage assemblies 150 may configure the multiple linkage assemblies 150 different from each other. For example, the first linkage assembly 150A may be arranged in any of the neutral, toed-in, or toed-out configurations and the second linkage assembly 150B may be arranged in any of the neutral, toed-in, or toed-out configurations.

The linkage assembly 150 can be used to connect both combustion pistons and auxiliary pistons to the two crankshafts 112. “Combustion pistons” or “primary pistons”, as the terms are used herein, refer to pistons directly used in a combustion cycle to generate a power output. “Auxiliary piston”, as the term is used herein, refers to a piston that is not used directly in a combustion cycle and is instead used for alternative purpose(s). For example, an auxiliary piston can be used as a scavenging pump, supercharger, and/or other purpose, as described and/or illustrated in PCT Application No. US2025/041540, filed Aug. 11, 2025, titled “INTERNAL COMBUSTION ENGINE,” the entire contents of which are hereby incorporated by reference in their entirety. In one configuration, the first linkage assembly 150A may be used to connect a combustion piston to the two crankshafts 112 and the second linkage assembly 150B may be used to connect an auxiliary piston to the two crankshafts 112.

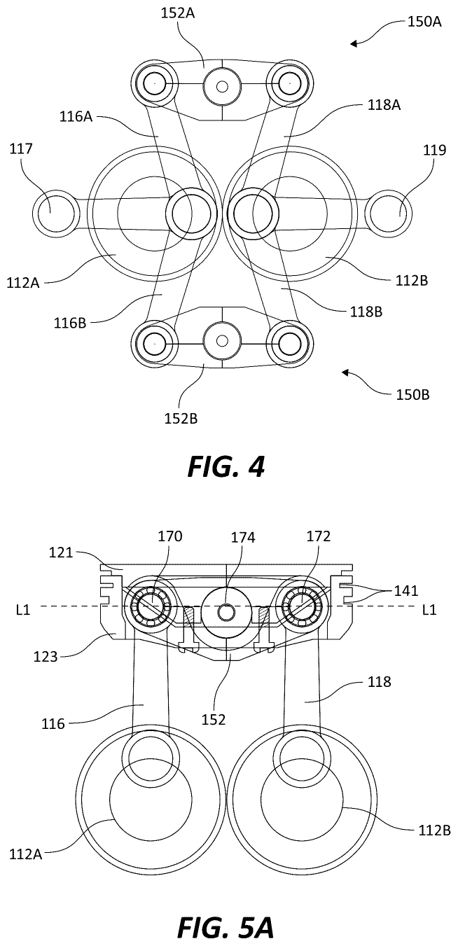

According to some configurations, an engine can include one or more pistons connected to the two crankshafts 112 by linkage assemblies 150 and one or more pistons connected to the two crankshafts 112 without a linkage assembly 150. For example, FIG. 4 illustrates an isolation cross-sectional view of an embodiment of an engine configuration including two linkage assemblies 150 connected to the first and second crankshaft 112A, 112B, and additional connecting rods. The additional connecting rods can include a seventh connecting rod 117 and/or an eighth connecting rod 119. In the illustrated example, the seventh connecting rod 117 is rotatably coupled to the first crankshaft 112A at its first end and the eighth connecting rod 119 is rotatably coupled to the second crankshaft 112B at its first end. The seventh connecting rod 117 can be coupled to a piston at its second end and the eighth connecting rod 119 can be coupled to a piston at its second end.

With continued reference to FIG. 4, either or both of the linkage assemblies 150A, 150B can be used for a combustion piston or an auxiliary piston. Similarly, either or both of the seventh and eighth connecting rods 117, 119 can be used for a combustion piston or an auxiliary piston. In one example, the linkage assemblies 150A, 150B may be coupled to combustion pistons and the seventh and eight connecting rods 117, 119 may be coupled to auxiliary pistons (e.g., similar to the configuration of internal combustion engine 200 of FIG. 10). While FIG. 4 illustrates two linkage assemblies 150A, 150B and two additional connecting rods 117, 119, it is recognized that an engine utilizing two crankshafts 112 can include any combination of one or more linkage assemblies 150A, 150B and one or more additional connecting rods 117, 119.

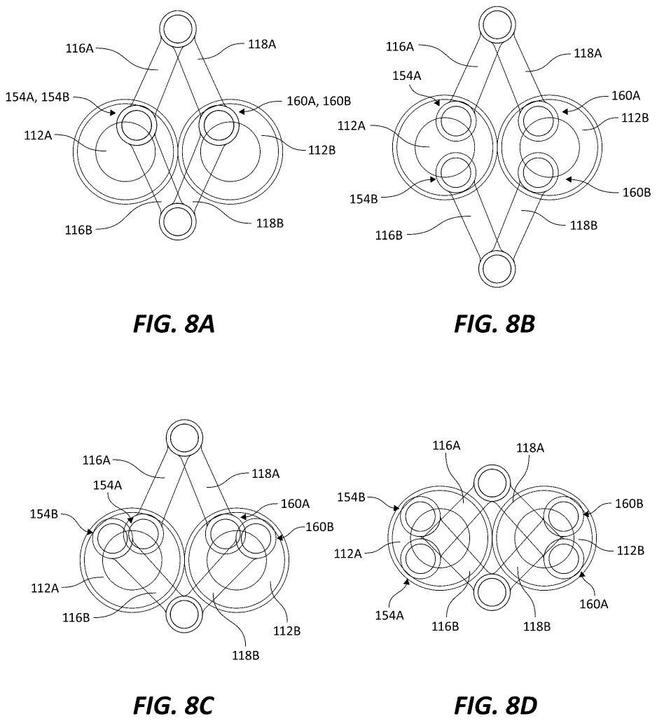

Referring now to FIGS. 8A-8D, various coupling locations for connecting rods on the two crankshafts 112 that can be used in the internal combustion engine 100 are shown. While FIGS. 8A-8D show the connecting rods in a complete toed-in configuration without piston connecting rods 152, it is recognized that the various coupling locations can be implemented in an engine utilizing a linkage assembly 150.

As shown in FIG. 8A, in some configurations, the first ends 154A, 160A of the first crank connecting rods 116A, 118A can be rotatably coupled to the crankshafts 112A, 112B at the same locations as the first ends 154B, 160B of the second crank connecting rods 116B, 118B (e.g., crankpins can be shared). This arrangement allows the pistons coupled to the crankshafts 112A, 112B to be in an opposed configuration.

As shown in FIG. 8B, in some configurations, the first ends 154A, 160A of the first crank connecting rods 116A, 118A can be rotatably coupled to the crankshafts 112A, 112B at points (e.g., crankpins) that are less than 180-degrees apart from the coupling locations of the first ends 154B, 160B of the second crank connecting rods 116B, 118B. This arrangement allows the pistons coupled to the crankshafts 112A, 112B to reach top dead center at different times from each other.

As shown in FIGS. 8C and 8D, in some configurations, the first ends 154A, 160A of the first crank connecting rods 116A, 118A can be rotatably coupled to the crankshafts 112A, 112B at points (e.g., crankpins) that are adjacent the coupling locations of the first ends 154B, 160B of the second crank connecting rods 116B, 118B. These arrangements allows the pistons coupled to the crankshafts 112A, 112B to reach top dead center at different times from each other.

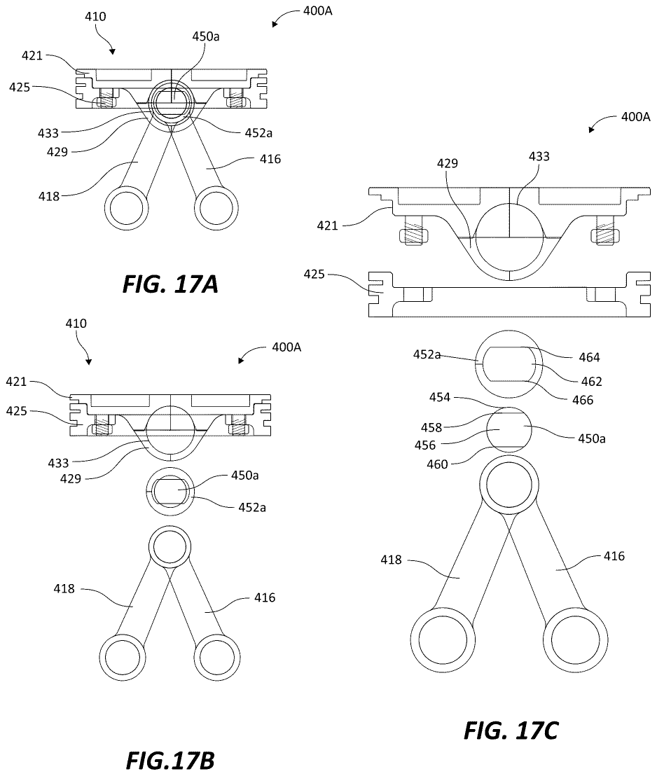

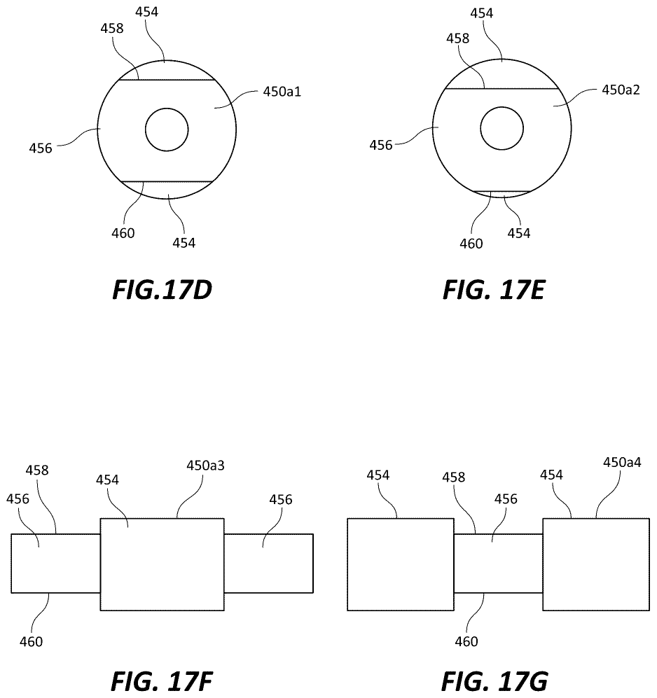

In some configurations, the linkage assembly 150 may not be utilized in an internal combustion engine having two counter-rotating crankshafts 112. For example, FIG. 9 shows an embodiment of an internal combustion engine 100C where the piston 110 is connected to the crank connecting rods 116, 118 via a wrist pin 350. The wrist pin 350 can be a laterally translating or displacing wrist pin, as described further herein with reference to at least FIGS. 17A-21B.

FIGS. 8A-8D also illustrate examples wherein the connecting rods 116A, 118A are in a fully toed-in configuration. That is, extending from the crankshafts 112A, 112B, the distal ends of the connecting rods 116A, 118A converge, or are fully toed-in, to a common point or axis. Additional examples of fully toed-in connecting rods are provided throughout the application.

With reference now to FIG. 10, an embodiment of an internal combustion engine 200 is shown. Some of the features of the internal combustion engine 200 are similar to features of the internal combustion engine 100 in at least FIG. 1. Thus, reference numerals used to designate the various features or components of the internal combustion engine 200 are identical to those used for identifying the corresponding features or components of the internal combustion engines 100 in at least FIG. 1 except that the numerical identifiers for components of the internal combustion engine 200 begin with a “2” instead of a “1”. Therefore, the structure and description for the various features of the internal combustion engine 100 and how it operates in at least FIG. 1 are understood to also apply to the corresponding features of the internal combustion engine 200, except as described below.

In some configurations, the internal combustion engine 200 of FIG. 10 can be configured to be modular, as described further herein. In one example, the four crankshafts 212 can be configured to be modular like the crankshafts 812 of FIG. 45.

The internal combustion engine 200 differs from the internal combustion engine 100 of FIG. 1 in that the internal combustion engine 200 includes four crankshafts 212. The four crankshafts 212 include a first crankshaft 212A, a second crankshaft 212B, a third crankshaft 212C, and a fourth crankshaft 212D. The first and second crankshafts 212A, 212B can be disposed adjacent each other and in mesh with each other. The first crankshaft 212A can rotate in the first direction and the second crankshaft 212B can counter-rotate in the second direction. The third and fourth crankshafts 212C, 212D can be disposed adjacent each other and in mesh with each other. The fourth crankshaft 212D can rotate in the first direction and the third crankshaft 212C can counter-rotate in the second direction. Optionally, the third crankshaft 212C can be in mesh with and counter-rotate with the second crankshaft 212B and/or the fourth crankshaft 212D can be in mesh with and counter-rotate with the first crankshaft 212A. Example gear arrangements for a four-crankshaft configuration are shown and described further with reference to at least FIGS. 38A-40C.

The four crankshafts 212 can be driven by one or more pistons 210. The first and second crankshafts 212A, 212B can be driven by a first piston 210A. The third and fourth crankshafts 212C, 212D can be driven by a second piston 210B. Optionally, the internal combustion engine 200 can include a third piston 210C and/or a fourth piston 210D, as shown in the illustrated example of FIG. 10.

The four crankshafts 212 can be at least partially housed or enclosed within a housing 236. In the illustrated example, the housing 236 is positioned between the two uniblocks 202 of the two engine assemblies 201A, 201B. The housing 236 can join the two uniblocks 202 of the engine assemblies 201A, 201B together. In this arrangement, the four crankshafts 212 can be positioned between at least the first piston 210A and the second piston 210B. When the pistons 210C, 210D are included, the four crankshafts 212 can also be disposed between the pistons 210C, 210D.

The internal combustion engine 200 can include one or more linkage assemblies 250 for rotatably coupling the one or more pistons 210 to the crankshafts 212. In the illustrated configuration, each piston 210 is coupled to a pair of crankshafts via a linkage assembly 250. The first piston 210A is rotatably coupled to the first and second crankshafts 212A, 212B via a first linkage assembly 250A. The second piston 210B is rotatably coupled to the third and fourth crankshafts 212C, 212D via a second linkage assembly 250B. The third piston 210C is rotatably coupled to the second and third crankshafts 212B, 212C via a third linkage assembly 250C. The fourth piston 210D is rotatably coupled to the first and fourth crankshafts 212A, 212D via a fourth linkage assembly 250D. In other configurations, one or more pistons 210 in the internal combustion engine 200 can be rotatably coupled to one or more of the crankshafts 212 without utilizing a linkage assembly 250. While all four linkage assemblies 250 are shown in the neutral configuration in FIG. 10, any other configuration (e.g., toed-in or toed-out) can be used for one of more of the linkage assemblies 250, when included.

Any of the pistons 210 of the internal combustion engine 200 can be configured as combustion pistons or auxiliary pistons. In the illustrated example, the first and second pistons 210A, 210B are configured as combustion pistons and the third and fourth pistons 210C, 210D are configured as auxiliary pistons. Accordingly, the third piston 210C reciprocates within an auxiliary chamber 204C. Similarly, the fourth piston 210D can reciprocate within an auxiliary chamber 204D. Auxiliary chambers may also be referred to herein as “non-combustion chambers” because combustion events generally do not occur within the auxiliary chambers.

The internal combustion engine 200 can include a first auxiliary housing 280C and/or a second auxiliary housing 280D to accommodate the third and fourth pistons 210C, 210D. The first auxiliary housing 280C encloses, envelopes, and/or surrounds both the auxiliary chamber 204C and at least a portion of the bore 206C that is associated with the auxiliary chamber 204C. The second auxiliary housing 280D encloses, envelopes, and/or surrounds both the auxiliary chamber 204D and at least a portion of the bore 206D that is associated with the auxiliary chamber 204D. The auxiliary housings 280C, 280D can be mounted to the uniblocks 202 using any conventional means (e.g., fasteners received within mount holes in the uniblocks 202).

The third and fourth pistons 210C, 210D can be configured to deliver intake air to the combustion chambers 204A and 204B. For example, the auxiliary chamber 204C can be in fluid communication with the combustion chamber 204B and the auxiliary chamber 204D can be in fluid communication with the combustion chamber 204A. In the illustrated configuration, the auxiliary housings 280C, 280D include intake ports 282 and outlet ports 284. Each outlet port 284 can deliver fluid to a respective combustion chamber 204A and 204B via an inlet feed pipe 286. Further details on auxiliary piston related configurations are described in PCT Application No. US2025/041540.

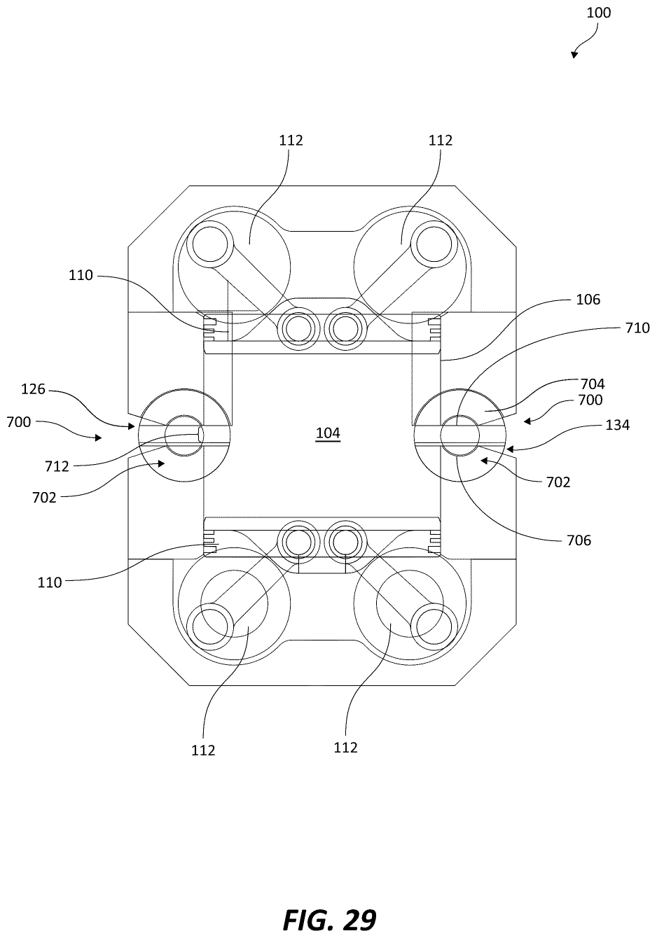

The illustrated example of the internal combustion engine 200 in FIG. 10 includes rotary valves 702. The rotary valves 702 can control the delivery of intake air and the removal of exhaust air to the combustion chambers 204A and 204B. The rotary valves 702 can be utilized instead of the valve train 120 configuration of the internal combustion engine 100 in FIG. 1. In other configurations, the internal combustion engine 200 can include one or more valve trains 120 as described with reference to at least FIG. 1. Example configurations for the rotary valves 702 and associated subassemblies 700 that can be used in the internal combustion engine 200 are described with reference to at least FIGS. 29-37.

The internal combustion engine 200 with four counter-rotating crankshafts 212 can include up to four linkage assemblies 250. The number of linkage assemblies 250 included can depend on the number of pistons 210 included in the internal combustion engine 200 and/or the desired characteristics of the internal combustion engine 200.

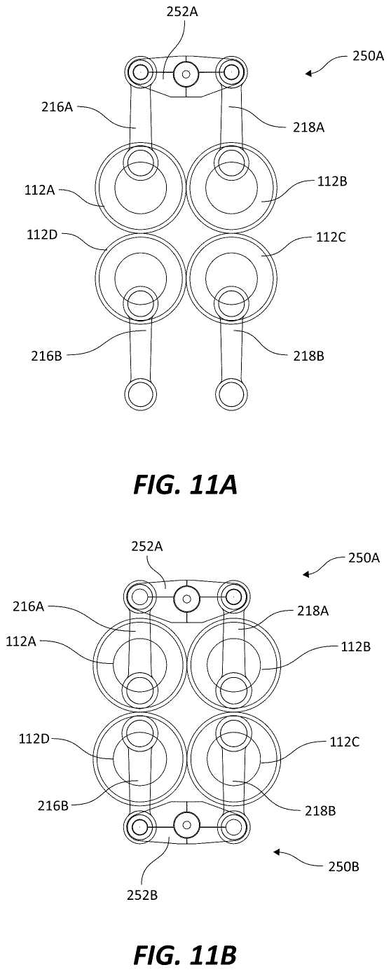

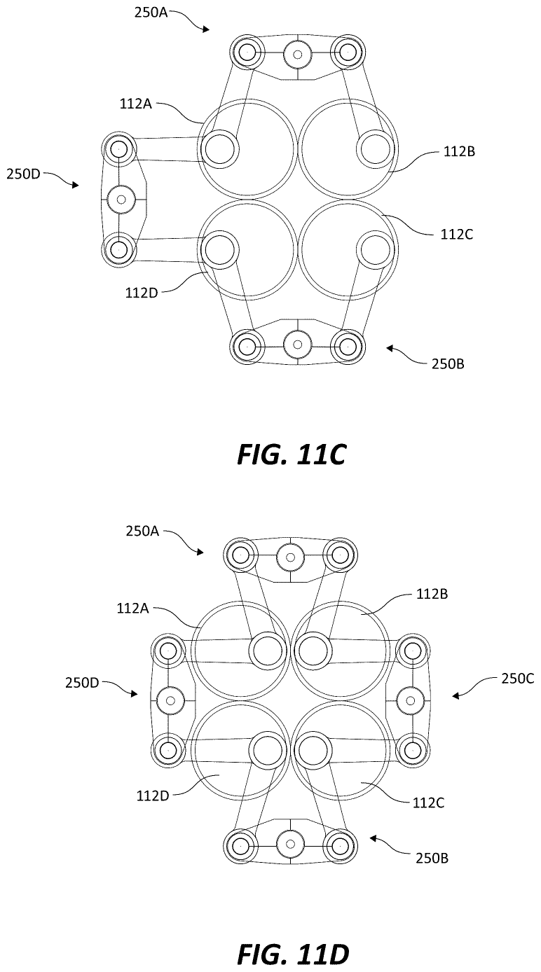

FIGS. 11A-11D illustrate isolation cross-sectional views of the crankshafts 212 of the internal combustion engine 200 and one or more linkage assemblies 250. As shown in FIG. 11A, the internal combustion engine 200 can include one linkage assembly 250A. The first linkage assembly 250A can include a first connecting rod 216A, a second connecting rod 218A, and a third connecting rod 252A. Optionally, one or more additional connecting rods can be included, such as a fourth connecting rod 216B and/or a fifth connecting rod 218B, for coupling the third and fourth crankshafts 212C, 212D to a piston, such as the second piston 210B.

As shown in FIG. 11B, the internal combustion engine 200 can include the first linkage assembly 250A and the second linkage assembly 250B. When the internal combustion engine 200 is configured in the manner of FIG. 11B, the internal combustion engine 200 may only include two pistons 210. As shown in FIGS. 11C and 11D, the internal combustion engine 200 can optionally include the third linkage assembly 250C and/or the fourth linkage assembly 250D. All of the linkage assemblies 250B, 250C, 250D can be identical to the first linkage assembly 250A.

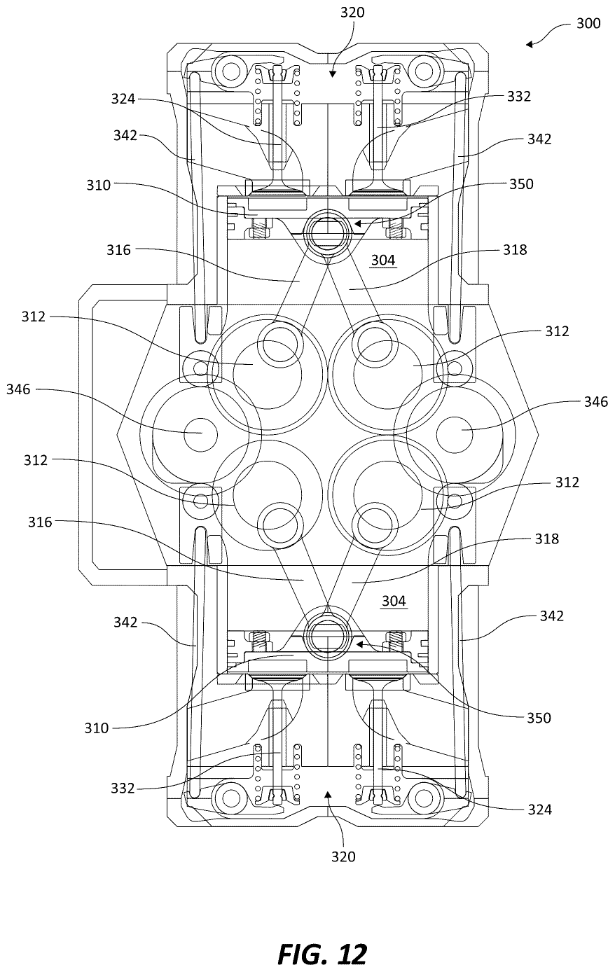

FIG. 12 illustrates an embodiment of an internal combustion engine 300. Some of the features of the internal combustion engine 300 are similar to features of the internal combustion engine 100 in at least FIG. 1 and the internal combustion engine 200 in at least FIG. 10. Thus, reference numerals used to designate the various features or components of the internal combustion engine 300 are identical to those used for identifying the corresponding features or components of the internal combustion engines 100 in at least FIG. 1 and the internal combustion engine 200 in at least FIG. 10 except that the numerical identifiers for components of the internal combustion engine 300 begin with a “3” instead of a “1” or a “2”. Therefore, the structure and description for the various features of the internal combustion engine 100 and internal combustion engine 200 and how they operate in at least FIG. 1 and FIG. 10 respectively are understood to also apply to the corresponding features of the internal combustion engine 300, except as described below. In some configurations, the internal combustion engine 300 of FIG. 12 can be configured to be modular, as described further herein. In one example, the four crankshafts 312 can be configured to be modular like the crankshafts 812 of at least FIG. 45.

The internal combustion engine 300 differs from the internal combustion engine 100 of FIG. 1 and the internal combustion engine 200 of FIG. 9 in that the internal combustion engine 300 does not include a linkage assembly with a piston connecting rod (e.g., such as the linkage assembly 150 of FIG. 1). Instead, each piston 310 of the internal combustion engine 300 can be connected to the crank connecting rods 316, 318 via a wrist pin 350. In some implementations, the wrist pin(s) 350 can be laterally translating or displacing wrist pin(s), as described further herein with reference to at least FIGS. 17A-21B.

Because wrist pins 350 are utilized, the internal combustion engine 300 is configured with the pistons 310 in a complete toed-in configuration. When arranged in the complete toed-in configuration, the crankshafts 312 can rotate through more degrees of rotation for the intake and/or power strokes, compared to the compression and/or exhaust strokes. Such an arrangement can provide certain advantages, as described above, with reference to at least FIG. 7A.

As shown in FIG. 12, each valve train 320 of the internal combustion engine 300 can optionally include pushrods 342, similar to the internal combustion engine 100 in FIG. 1. As such, the crankshafts 312 can be used to drive the camshafts 346 to control the opening and/or closing of the intake valves 324 and exhaust valves 332. In other implementations, different configurations for the valve train 320 are possible. For example, the internal combustion engine 300 may include cams on the crankshaft 312 for actuating the pushrods 342, may include one or more camshafts as part of an overhead cam system, and/or may include other valve actuating systems. In some configurations, the internal combustion engine 300 can utilize the valve actuating systems described in PCT Application No. US2024/054996. In some configurations, the internal combustion engine 300 may utilize one of more rotary valves to control the delivery of intake air and the removal of exhaust air to the combustion chambers 304.

While the internal combustion engine 300 is shown as including two combustion pistons 310, in other configurations, the internal combustion engine 300 may include one or more auxiliary pistons. In such a configuration, the auxiliary pistons may be driven by the four crankshafts 312. In alternative configurations, the internal combustion engine 300 may only include a single combustion piston 310.

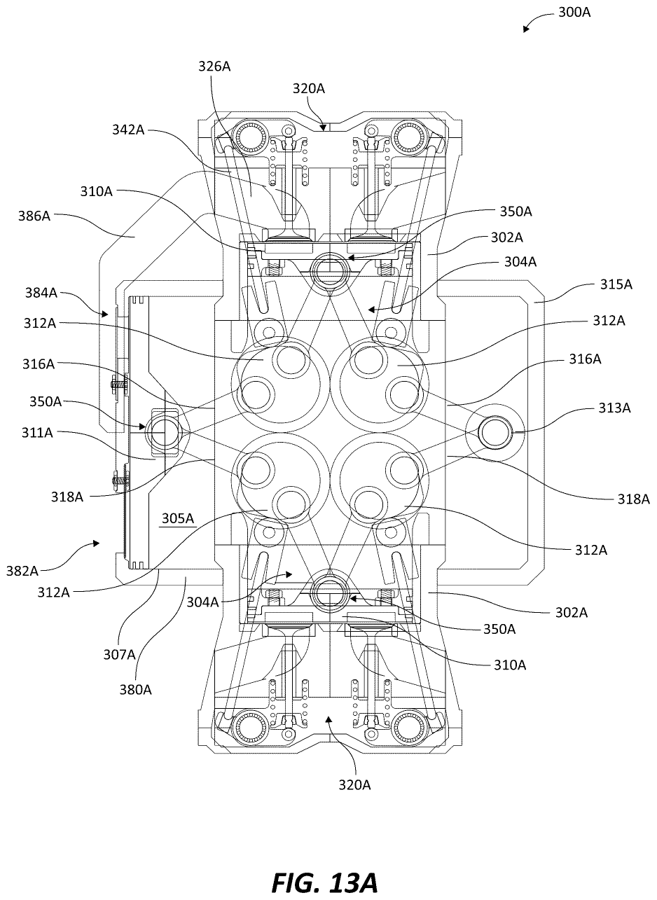

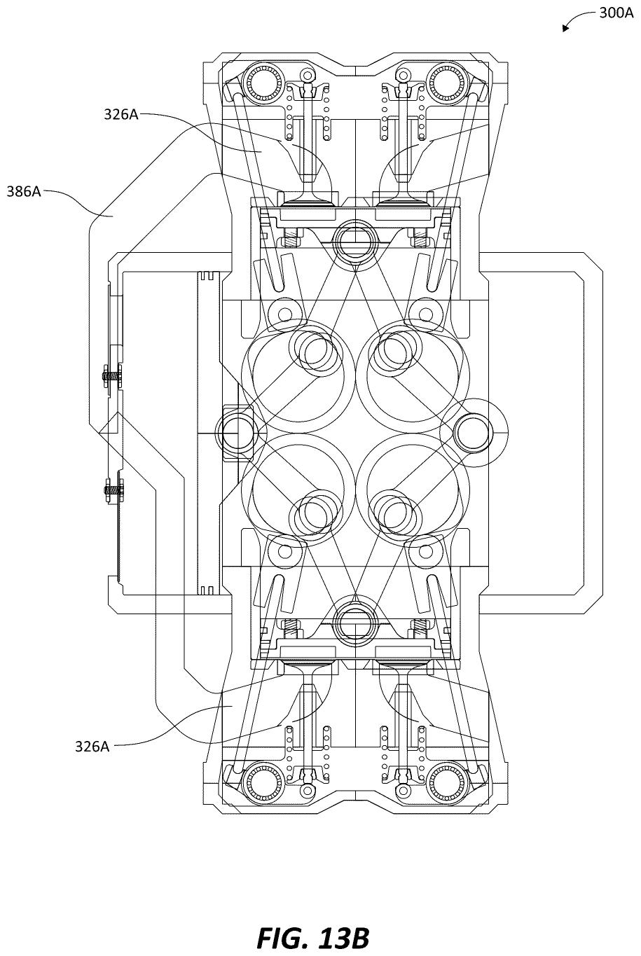

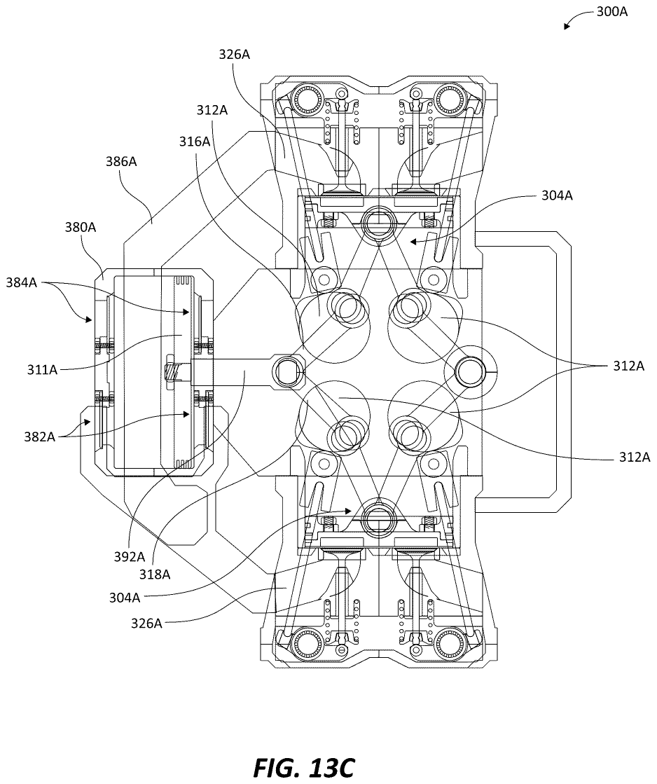

FIGS. 13A-13C illustrate embodiments of an internal combustion engine 300A. Some of the features of the internal combustion engine 300A are similar to features of the internal combustion engine 100 in at least FIG. 1, the internal combustion engine 200 in at least FIG. 10, and the internal combustion engine 300 in at least FIG. 12. Thus, reference numerals used to designate the various features or components of the internal combustion engine 300A are identical to those used for identifying the corresponding features or components of the internal combustion engines 100 in at least FIG. 1, the internal combustion engine 200 in at least FIG. 10, and the internal combustion engine 300 in at least FIG. 12, except that the numerical identifiers for components of the internal combustion engine 300A begin with a “3” instead of a “1” or a “2”, and end with an “A”. Therefore, the structure and description for the various features of the internal combustion engines 100, 200, and 300 and how they operate in at least FIGS. 1, 10, and 12 are understood to also apply to the corresponding features of the internal combustion engine 300A, except as described below. In some configurations, the internal combustion engine 300A of FIGS. 13A-13C can be configured to be modular, as described further herein. In one example, the four crankshafts 312A can be configured to be modular like the crankshafts 812 of at least FIG. 45.

The internal combustion engine 300A differs from the internal combustion engine 300 of FIG. 12 in that the internal combustion engine 300A includes an auxiliary piston 311A. The auxiliary piston 311A can be similar to the pistons 210C, 210D of the internal combustion engine 200 of FIG. 10.

The internal combustion engine 300A can include an auxiliary housing 380A to accommodate the auxiliary piston 311A. The auxiliary housing 380A encloses, envelopes, and/or surrounds both the auxiliary chamber 305A and at least a portion of the bore 307A that is associated with the auxiliary chamber 305A. The auxiliary housing 380A can be mounted to the uniblocks 302A using any conventional means (e.g., fasteners received within mount holes in the uniblocks 302A).

The auxiliary piston 311A can be configured to deliver intake air to one or more of the combustion chambers 304A of the internal combustion engine 300. For example, the auxiliary chamber 305A can be in fluid communication with one or both of the combustion chambers 304A. In the configuration of FIG. 13A, the auxiliary housing 380A includes a single intake port 382A and a single outlet port 384A. The outlet port 384A can deliver fluid to one or both of the combustion chambers 304A via the inlet feed pipe 386A. In the example of FIG. 13A, the inlet feed pipe 386A only directs fluid to the combustion chamber 304A near the top of the page via the intake passage 326A.

In other examples, the internal combustion engine 300 may include multiple inlet feed pipes or the inlet feed pipe 386A may be split so that fluid from the auxiliary chamber 305A can be directed to both combustion chambers 304A. For example, the internal combustion engine 300A of FIG. 13B includes an inlet feed pipe 386A configured to deliver fluid to both combustion chambers 304A via the intake passages 326A.

With reference to FIG. 13C, in some configurations, the internal combustion engine 300A can include one or more double-acting pistons. For example, the auxiliary piston 311A can be configured as a double-acting piston. In such a configuration, the auxiliary housing 380A can include multiple intake ports 382A and multiple outlet ports 384A. At least one intake port 382A and at least one outlet port 384A can be disposed on either side of the auxiliary piston 311A in the auxiliary housing 380A. As such, the auxiliary piston 311A can draw in fluid via one of the intake ports 382A and deliver fluid to the inlet feed pipe 386A via one of the outlet ports 384A on both the upstroke and the downstroke. For example, the auxiliary piston 311A can utilize pressure on both sides of the auxiliary piston 311A.

In the configuration of FIG. 13C, the internal combustion engine 300A can include a piston shaft 392A for the auxiliary piston 311A. The piston shaft 392A can be coupled on one end to the auxiliary piston 311A. The piston shaft 392A can be coupled on an opposite end to one or more connecting rods. For example, the piston shaft 392A can be coupled to a pair crank connecting rods 316A, 318A. As such, every complete revolution of the crankshafts 312A causes the auxiliary piston 311A to complete an upstroke and a downstroke so that intake air is delivered to the combustion chambers 304A twice per crankshaft revolution. Accordingly, the configuration of FIG. 13C including a double-acting auxiliary piston 311A may be ideal for a two-stroke engine.

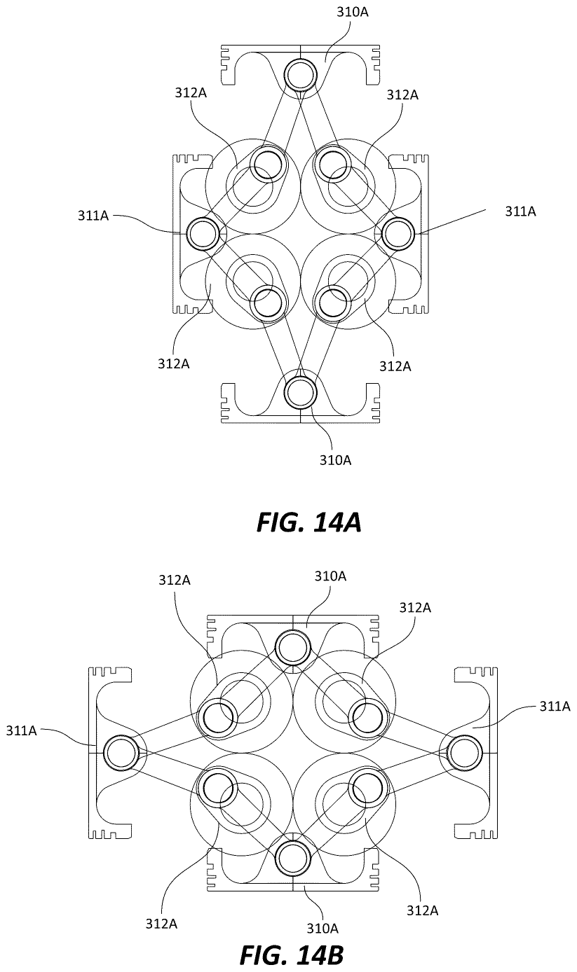

According to some configurations, the internal combustion engine 300A may include multiple auxiliary pistons 311A and associated components, similar to the arrangement of the internal combustion engine 200 in FIG. 10. In such a configuration, each auxiliary chamber 305A may be in fluid communication with one of the combustion chambers 304A. For example, FIGS. 14A and 14B illustrate an example of two auxiliary pistons 311A and two combustion pistons 310A that can be utilized in the internal combustion engine 300A. FIG. 14A shows the combustion pistons 310A at top dead center and FIG. 14B shows the combustion pistons 310A at bottom dead center. While the pistons 310A, 311A are shown in the boxer configuration in FIGS. 14A and 14B, other configurations are also possible.

Referring back to FIG. 13A, when only one auxiliary piston 311A is included in the internal combustion engine 300, the internal combustion engine 300 can include a counterweight 313A. The counterweight 313A is used to counterbalance the auxiliary piston 311A. Accordingly, the counterweight 313A is disposed on an opposite side of the internal combustion engine 300 than the auxiliary piston 311A. The counterweight 313A can be the same weight as the auxiliary piston 311A.

The internal combustion engine 300 can include a counterweight housing 315A for the counterweight 313A. The counterweight housing 315A can be mounted to the uniblocks 302A using any conventional means (e.g., fasteners received within mount holes in the uniblocks 302). In some implementations, the counterweight housing 315A can store oil for the internal combustion engine 300. For example, as the crankshafts 312 rotate and the counterweight 313A reciprocates, the counterweight 313A can dip into the oil store to deliver oil to the crankshafts 312A. For example, the counterweight 313A can splash or otherwise convey oil to the crankshafts 312A.

Like the pistons 310A, the auxiliary piston 311A and the counterweight 313A can be connected to the crankshafts 312 via crank connecting rods 316A, 318B. In the illustrated example, the auxiliary piston 311A is connected to the crank connecting rods 316A, 318B via a wrist pin 350A. As such, the auxiliary piston 311A is in a complete toed-in configuration. In other implementations, one or more linkage assemblies (e.g., linkage assemblies 150 of FIG. 2) can be used in the internal combustion engine 300A for either the pistons 310A, the auxiliary piston(s) 311A, or both.

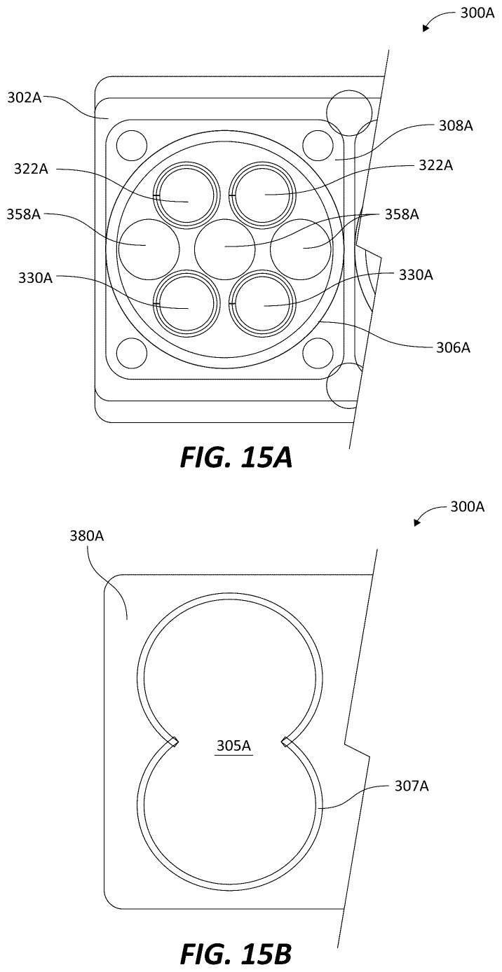

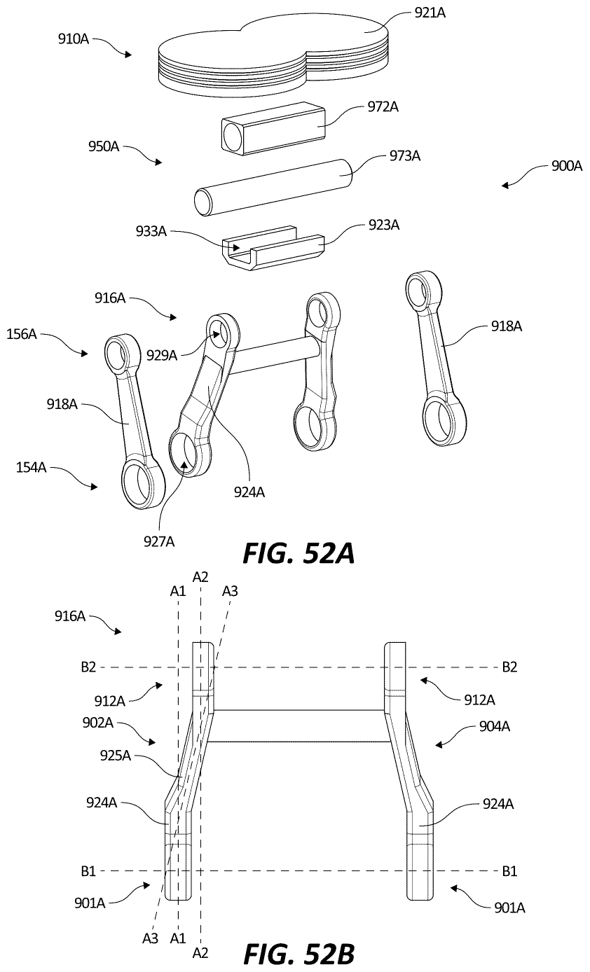

FIG. 15A shows an example top view of the internal combustion engine 300A with the valve train cover and various components of the valve train 320A removed. In the illustrated example, the internal combustion engine 300A includes a cylindrically shaped cylinder bore 306A. In other examples, the bore 306A can be a different shape, such as oval-shaped or double-c shaped. FIG. 15B shows an example of a double-c shaped bore that can be used for the bore 306A and/or the auxiliary bore 307A and FIG. 52A shows an example of a double-c shaped piston 910A.

As shown in FIG. 15A, the internal combustion engine 300A can include multiple intake valve opening 322A and/or multiple exhaust valve openings 330A for each uniblock 302A. The valve openings 322A, 330A can extend through the cylinder top plate 308A, when included in the internal combustion engine 300A. While two intake valve openings 322A and two exhaust valve openings 330A are depicted in FIG. 15A, the number of intake valve openings 322A and exhaust valve openings 330A can vary, and the number of intake valve openings 322A is not necessarily equal to the number of exhaust valve openings 330A.

Having multiple intake and exhaust valve openings 322A, 330A can provide certain advantages. For example, the internal combustion engine 300A can generally receive more intake air and expel more exhaust when there are multiple intake and exhaust valve openings 322A, 330A. Additionally, the timing of the corresponding valves can be varied between the multiple intake valve opening 322A and/or the multiple exhaust valve openings 330A.

The internal combustion engine 300A can include a plurality of ports 358A. The ports 358A can extend through the cylinder top plate 308A, when included in the internal combustion engine 300A. The ports 358A can be disposed between the intake valve openings 322A and the exhaust valve openings 330A. The ports 358A can receive one or more fuel injectors, spark plugs, and/or the like. The uniblock 302A enables greater freedom in the placement of the ports 358A, for example, when compared to conventional engines. Because of the geometry of the uniblock 302A, one or more of the fuel injectors can be positioned in any desired location around the combustion chamber 304A.

In some configurations, multiple fuel injectors, multiple spark plugs, or other components can be provided in the internal combustion engine 300A at the ports 358A. For example, in some configurations, the internal combustion engine 300A can be designed to operate using a variety of fuels. In some configurations, the internal combustion engine 300A that can be configured to run on any combination of gasoline, fuel oil, diesel, natural gas, biofuel, ethanol, hydrogen, or other suitable fuel type. In some configurations of the internal combustion engine 300A, separate fuel injectors can be provided for different fuels in the ports 358A. In some configurations of the internal combustion engine 300, a first fuel injector can be disposed in one port 358A to provide a first fuel type (e.g., natural gas) and a second fuel injector can be disposed in another port 358A to provide a second fuel type (e.g., ethanol).

Referring now to FIG. 15B, an isolation view of an example auxiliary chamber 305A and a portion of an example auxiliary housing 380A is shown. The auxiliary bore 307A can have the shape of the perimeter of two overlapping circles when viewed from above. In the configuration illustrated in FIG. 15B, the two overlapping circles are shown to have the same radii. In other configurations, this geometry of two overlapping circles may use two circles having different radii. The auxiliary bore 307A can have the shape of two cylinders that are joined along chord lines that are at some distances from the centers of the two cylinders. In some configurations, the chord lines can be an equal distance from the centers of the two cylinders. This shape may be referred to herein as a “double-c”, “overlapping-circle”, “peanut”, “figure-of-8”, and/or “hourglass”. Depending on where the two cylinders intersect, the auxiliary bore 307A may have the shape of a vesica piscis. However, it is not required that the two cylinders intersect such that the center of each cylinder lies on the perimeter of the other. In some configurations, the diameter of the two cylinders forming the double-c shaped auxiliary bore 307A may be the same, less than, or greater than the diameter of the cylindrically shaped cylinder bore 306A.

When the auxiliary bore 307A is configured to be double-c shaped, the auxiliary piston 311A can have a corresponding double-c shape. Further details on double-c shaped piston and bore configurations are described in PCT Application No. US2025/041540. As example double-c shaped piston 910A is shown in FIG. 52A. Generally, double-c shaped pistons have a cross-sectional that has a perimeter of two overlapping circles, similar to the double-c shaped bore described above.

While the description of FIGS. 15A and 15B references the internal combustion engine 300A, it is understood that the same configurations can be used in any of the internal combustion engines described herein. Further, any of the internal combustion engines described herein can utilize any combination of double-c shaped pistons and bores and cylindrically shaped pistons and bores. In the example of the internal combustion engine 300A, the bore(s) 306A and the bore 307A can all be cylindrically shaped, can all be double-c shaped, or can be a combination of cylindrical and double-c shapes.

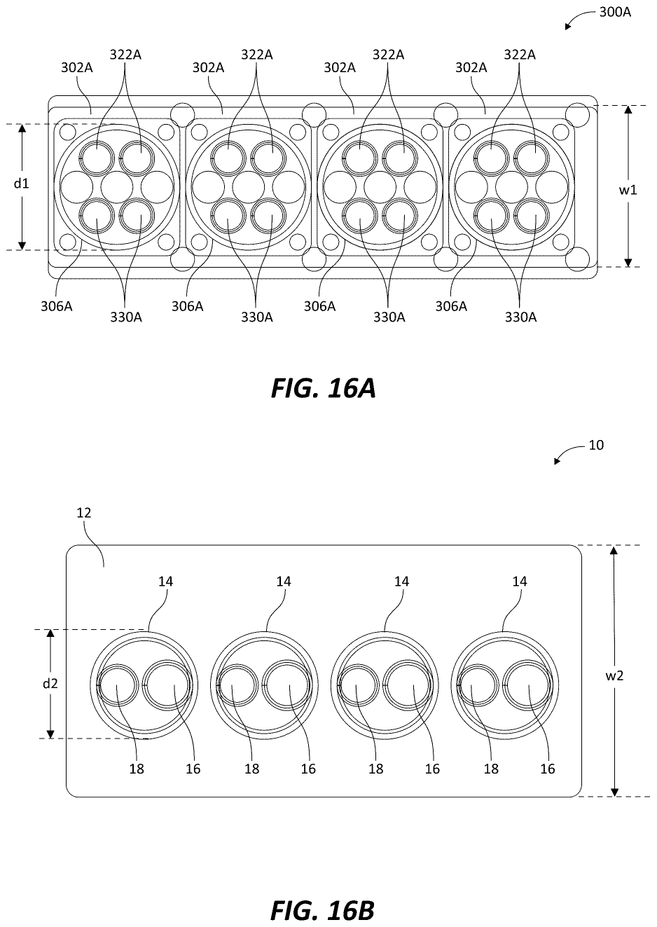

Referring now to FIG. 16A, the internal combustion engine 300A can include any number of side-by-side uniblocks 302A. For example, in the configuration of FIG. 16A, the internal combustion engine 300A includes four side-by-side uniblocks 302A. As described herein, the modular nature afforded by the uniblock design facilitates engines of a multitude of constructions. For example, any of the internal combustion engines can be configured to include two or more side-by side uniblocks.

FIG. 16B shows an example of a conventional four piston internal combustion engine 10. The conventional engine 10 has a block 12, cylinder bores 14, intake valve openings 16 and exhaust valve openings 18. As shown in FIGS. 16A and 16B, the internal combustion engines described herein (e.g., the internal combustion engine 300A), can provide a more efficient use of block space compared to the conventional engine 10. For example, the ratio of bore diameter d1 to block diameter w1 for the internal combustion engine 300A is larger than the ratio of bore diameter d2 to the block diameter w2 for the conventional engine 10. Accordingly, the internal combustion engine 300A can lighter and smaller than the conventional engine 10 while producing a similar or greater output.

Wrist pins, also referred to as piston pins or piston wrist pins, are used to couple a piston to one or more connecting rods. The connecting rods are in turn coupled to one or more crankshafts. In internal combustion engines, forces exerted on the piston (e.g., from combustion) and corresponding piston motion are transferred to the crankshaft(s) through the wrist pin and connecting rod(s). In general, the wrist pin includes at least a cylindrical portion that couples the piston to the connecting rod, with the cylindrical portion providing a bearing surface for a portion of the connecting rod. Further, the connecting rod often allows the piston to pivot and move relative to the connecting rod as the piston moves up and down in the cylinder bore during an engine's operation. This movement can be useful in converting the reciprocating motion of the piston into rotational motion of the crankshaft.

The wrist pin extends through a wrist pin boss, also referred to as a gudgeon pin boss, that is formed on or otherwise attached to the piston. The wrist pin boss can be configured as a single- or multi-part structure configured to receive the wrist pin. The wrist pin boss is configured to withstand the forces and stresses generated during engine operation.

As discussed generally herein, in some embodiments, a piston can be coupled to two different connecting rods, with each connecting rod further connected to a separate, counter-rotating crankshaft. In some embodiments, a piston can be coupled to three different connecting rods, with two connecting rods being further connected to one crankshaft and one connecting rods being further connected to a separate, counter-rotating second crankshaft. In some embodiments, a piston can be coupled to four different connecting rods, with two connecting rods being further connected to one crankshaft and two connecting rods being further connected to a separate, counter-rotating second crankshaft. In such configurations, each connecting rod has one end that is coupled to its associated crankshaft and another end that is coupled to the piston by a wrist pin. In such configurations, the wrist pin can couple one, two, three, four, or potentially more different connecting rods to the piston. For example, the wrist pin can extend through an end of each of the two connecting rods as well as through the wrist pin boss. In another example, the wrist pin can extend through an end of each of the three or four connecting rods as well as through the wrist pin boss.

When a piston is coupled to two or more connecting rods, it can be advantageous to configure the wrist pin and/or piston to allow the wrist pin to move or translate (e.g., linearly) relative to the piston. In some embodiments, such a wrist pin can be referred to as a translating wrist pin. For example, it can be advantageous to configure the wrist pin and/or piston to allow the wrist pin to move laterally or linearly in a direction that is perpendicular to the longitudinal axis of the wrist pin and generally parallel to the piston crown or upper surface of the piston or the axis along which the piston reciprocates.

Allowing for such movement of the wrist pin relative to the piston can accommodate lash between the counter-rotating crankshafts coupled to the piston via the wrist pin and connecting rods and/or other imperfect tolerances in the system. Allowing for such movement of the wrist pin relative to the piston can facilitate smooth movement of the piston within the bore and reduce binding and/or scraping of the piston with the bore in which the piston moves. This can increase engine performance and reduce friction, heat, and other inefficiencies. In some embodiments, the wrist pin and/or piston are configured such that the wrist pin can move or translate a linear or distance of about or at least 0.25 mm, 0.5 mm, 0.75 mm, 1.0 mm, 1.25 mm, 1.5 mm, 1.75 mm, or 2.0 mm relative to the piston, although other distances both larger and smaller are also possible.

FIGS. 17A-17G illustrate embodiments of a translating wrist pin and piston assembly 400A. FIG. 17A shows the translating wrist pin and piston assembly 400A in an assembled configuration, while FIGS. 17B and 17C illustrate various exploded views thereof. FIGS. 17D-17G illustrate various different embodiments of translating wrist pins 450a that can be used in the translating wrist pin and piston assembly 400A.

With reference to FIGS. 17A-17C, the translating wrist pin and piston assembly 400A includes a piston 410, a translating wrist pin 450a, an insert 452a, a first connecting rod 416, and a second connecting rod 418. Although FIGS. 17A-17B, the translating wrist pin assembly 400A can also be used to connect three, four, or more connecting rods to the piston 410. In the illustrated embodiment, the translating wrist pin 450a is received within the insert 452a, which is received within an opening 433 on a connecting portion 429 of the piston 410. The translating wrist pin 450a couples an end of each of the first connecting rod 416 and the second connecting rod 418 to the piston 410.

In the illustrated embodiment, the piston 410 comprises an upper portion 421 and a lower portion 423. The upper portion 421 and the lower portion 423 can be coupled together with fasteners (e.g., bolts) as illustrated or by other fastening methods of mechanisms. In other embodiments, the piston 410 may comprise a single part or more than two portions (e.g., three or more portions) that are assembled together to form the piston.

In the illustrated embodiment, the upper portion 421 of the piston 410 comprises a connecting portion 429 that extends downward (relative to the orientation shown in the figures) from a main body of the piston 410. The connecting portion 429 can comprise a boss that is configured to receive the translating wrist pin 450a and the insert 452a. For example, in the illustrated embodiment, the connecting portion 429 comprises an opening 433 extending therethrough. The opening 433 is configured to receive the translating wrist pin 450a and the insert 452a.

In the example of FIGS. 17A-17C, the connecting portion 429 comprises a continuous, single structure with the opening 433 formed therethrough. In such embodiments, the translating wrist pin 450a and insert 452a can be slid into the opening 433 during assembly. In other embodiments, the connecting portion 429 may comprise two separate parts or members that are configured to be coupled together to form the opening 433. In such embodiments, the two separate parts or members can be assembled around the translating wrist pin 450a and insert 452a.

The opening 433 can be configured with a shape that corresponds to an outer shape of the insert 452a. In the illustrated embodiment, the opening 433 comprises a cylindrical or circular opening and the outer shape of the insert 452a is cylindrical or circular. In this manner, the insert 452a can be closely received within the opening 433 of the connecting portion 429 of the piston 410. In some embodiments, the opening 433 and insert 452a are configured such that the insert 452a can rotate within the opening 433. For example, an inner surface or wall of the opening 433 can provide a bearing surface and the outer surface or wall of the insert 452a can provide a bearing surface. In some embodiments, the insert 452a can be friction fit, mechanically or adhesively fixed, welded, or otherwise secured within the opening 433 such that the insert 452 does not rotate with respect to the opening 433.

As best shown in FIG. 17C, the insert 452A can comprise a slot 462 formed therethrough. The slot 462 can include at least an upper bearing surface 464 and a lower bearing surface 466. The upper bearing surface 464 can comprise a flat surface. The lower bearing surface 466 can comprise a flat surface. In the illustrated embodiment, lateral sides of the slot 462 are rounded. This need not be the case in all embodiments.

As will be described in more detail below, the slot 462 is configured to receive a flat portion 456 of the translating wrist pin 450a. The lateral width of the slot 462 is wider than the lateral width of the flat portion 456 of the translating wrist pin 450a such that the translating wrist pin 450a can move laterally along the width of the slot 462. This allows the translating wrist pin 450a to move (e.g., laterally translate or displace) relative to the piston 410. Such movement can help to accommodate lash between the counter-rotating crankshafts coupled to the piston 410 via the wrist pin 450a and connecting rods 416, 418 and/or other imperfect tolerances in the system. Allowing for such linear movement of the wrist pin 450a relative to the piston 410 can facilitate smooth movement of the piston 410 within the bore and reduce binding and/or scraping of the piston 410 with the bore in which the piston 410 moves. This can increase engine performance and reduce friction, heat, and other inefficiencies. To provide for this lateral translation, in some embodiments, the lateral width of the slot 462 is greater than the lateral width of the portion of the wrist pin 450a that is received within the slot 462 (e.g., the flat portion 456) by a distance of at least 0.25 mm, 0.5 mm, 0.75 mm, 1.0 mm, 1.25 mm, 1.5 mm, 1.75 mm, 2.0 mm, or more, although other distances both larger and smaller are possible.

FIGS. 17D-17E illustrate various embodiments of translating wrist pins 450a that can be used with the translating wrist pin and piston assembly 400a of FIGS. 17A-17C. As shown, for each embodiment, the translating wrist pin 450a includes one or more cylindrical portions 454 and one or more flat portions 456. The cylindrical portions 454 can be fully cylindrical. The flat portions 456 can include one or more flat faces. As noted previously, the flat portion(s) 456 are configured to be received within the slot 462 of the insert 452a. The flat portion(s) 456 can comprise a lateral width that is less than a lateral width of the slot 462 as described previously such that the wrist pin 450a can translate or laterally displace within the slot 462. Each flat portion 456 can include an upper bearing surface 458 and a lower bearing surface 460. The upper bearing surface 458 can be a flat surface. The lower bearing surface 460 can be a flat surface.

When the translating wrist pin 450a is received within the slot 462 of the insert 452a, the upper bearing surface 458 is configured to contact and slide along the lower bearing surface 466 of the slot 462. Similarly, when the translating wrist pin 450a is received within the slot 462 of the insert 452a, the lower bearing surface 460 is configured to contact and slide along the upper bearing surface 464 of the slot 462. Each of these surfaces can comprise a surface material or finish that is configured to facilitate sliding. Further, each of these surfaces can comprise a surface material or finish that is configured to reduce wear and/or avoid, limit, or dissipate heat.

The cylindrical portion 454 comprises an outer surface that is configured to extend through openings formed on one end of each of the connecting rods 416, 418. The outer surface of the cylindrical portion 454 therefore provides a bearing surface that interacts with a corresponding bearing surface on an inner surface of the openings on the ends of the connecting rods 416, 418. The cylindrical portion 454 of the translating wrist pin 450a provides a pivoting or rotational coupling between the translating wrist pin 450a and the connecting rods 416, 418. That is, the connecting rods 416, 418 can pivot or rotate about the translating wrist pin 450a. The outer surface of the cylindrical portion 454 can comprise surface material or finish that is configured to facilitate sliding or pivoting relative to the inner surface of the opening of the end of the connecting rods. Further, each of these surfaces can comprise a surface material or finish that is configured to reduce wear and/or avoid, limit, or dissipate heat. The diameter of the cylindrical portion 454 can be less than the diameter of the opening 433.

FIG. 17D illustrates an embodiment of the translating wrist pin 450al wherein the upper bearing surface 458 and the lower bearing surface 460 are provided with a similar configuration. For example, as illustrated in FIG. 17D, the upper bearing surface 458 and the lower bearing surface 460 are of equal lateral width and are formed as chords taken at equal distances from the center of the translating wrist pin 450al. The upper bearing surface 458 and the lower bearing surface 460 do not, however, need to always have similar configurations.

For example, FIG. 17E illustrates an example of a translating wrist pin 450a2 where the upper bearing surface 458 is configured with a greater lateral width than the lower bearing surface 460. Also, in FIG. 17E, the upper bearing surface 458 is formed as a chord positioned at a shorter distance from the center of the translating wrist pin 450a2 than the chord that forms the lower bearing surface 460. When the translating wrist pin and piston assembly 400A is used in a portion of an engine associated with combustion, the wrist pin 450a may experience the greatest forces during a combustion stroke. During the combustion stroke, the piston 410 applies a downward force on the wrist pin 450a (relative to the orientations shown in these figures). As such, providing the configuration of the wrist pin 450a2 of FIG. 17E may be advantageous as it includes a larger upper bearing surface 458 to help accommodate the larger forces experienced during a power stroke.

FIGS. 17F and 17E illustrate that the translating wrist pin 450a can include different arrangements of the flat portion(s) 456 and the cylindrical portion(s) 454. For example, in FIG. 17F, the translating wrist pin 450a3 includes two flat portions 456 positioned on opposite ends of the cylindrical portion 454. For such a configuration, the translating wrist pin 450a3 would be used with two inserts 452a, one insert 452a receiving each flat portion 456. FIG. 17G illustrates an alternative embodiment where the translating wrist pin 450a4 comprises a centrally positioned flat portion 456 with cylindrical portions 454 positioned on each end. Such an embodiment could be used with a single insert 452a which received the flat portion 456. Either one or both of the translating wrist pin 450a4 or the insert 452a could comprise two parts that could be selectively coupled to facilitate installation of the wrist pin 450a4 within the slot 462 of the insert 452a. As noted previously, the cylindrical portion(s) 454 engage with the ends of the connecting rods 416, 418. Other arrangements and numbers of flat portions 456 and cylindrical portions 454 are possible.

Although FIGS. 17A-17C have illustrated the translating wrist pin and piston assembly 400A as including an insert 452a that is separate from the piston 410, in some embodiments, the insert 452 can be omitted, and the opening 433 of the connecting portion 429 of the piston can be configured to provide the functionality of the insert 452a. For example, the opening 433 in the piston 410 can be provided with the slot 462 for receiving the flat portion(s) of the translating wrist pin 450a.

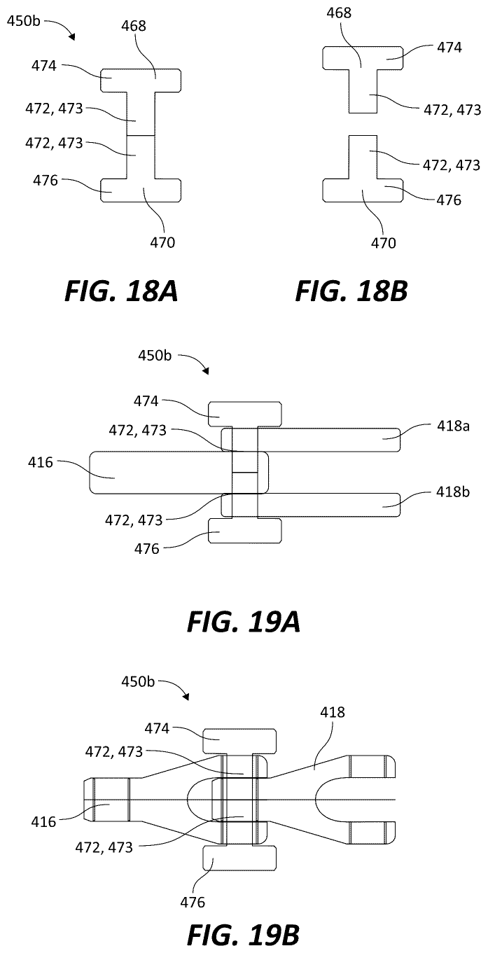

FIGS. 18A and 18B illustrate another embodiment of a translating wrist pin 450b. FIG. 18A illustrates the translating wrist pin 450b in an assembled configuration and FIG. 18B illustrates the translating wrist pin 450b in an exploded configuration. As with the translating wrist pin 450a described above, the translating wrist pin 450b is configured to couple one or more connecting rods to a piston in a manner that allows the translating wrist pin 450b to translate, displace, or move, relative to the piston so as to accommodate for lash between meshed connecting rods or other imperfect tolerances in the system.

With reference to FIGS. 18A and 18B, the translating wrist pin 450b can comprise a first component 468 and a second component 470. The first component 468 and the second component 470 can be configured to couple together, for example, using a mechanical fastener or bolt that is inserted longitudinally through one of the components to engage with the other of the components. Other methods or mechanisms for securing the first component 468 to the second component 470 are also possible. For example, in some embodiments, the first component 468 includes a threaded protrusion and the second component 470 includes a threaded recess configured to receive and threadedly engage the threaded protrusion.

As shown in FIGS. 18A and 18B, the translating wrist pin 450b is configured such that it has an H- or I-shape That is, the translating wrist pin 450b includes a wrist pin portion 472 that extends along one axis and two rails 474, 476 on the ends of the wrist pin portion 472 that extend perpendicularly to the wrist pin portion 472 and parallel to each other. The translating wrist pin 450b comprises a wrist pin portion 472 which can be configured as a shaft 473. The shaft 473 can be cylindrical. The wrist pin portion 472 is configured to, during use, extend through ends of connecting rods coupled thereto (see, for example, FIGS. 19A and 19B, described below). For example, the wrist pin portion 472 (e.g., the shaft 473) comprises an outer surface that is configured to extend through openings formed on one end of each of the connecting rods. The outer surface of the wrist pin portion 472 therefore provides a bearing surface that interacts with a corresponding bearing surface on an inner surface of the openings on the ends of the connecting rods. The wrist pin portion 472 of the translating wrist pin 450b provides a pivoting or rotational coupling between the translating wrist pin 450b and the connecting rods. That is, the connecting rods can pivot or rotate about the translating wrist pin 450b. The outer surface of the wrist pin portion 472 can comprise surface material or finish that is configured to facilitate sliding or pivoting relative to the inner surface of the opening of the end of the connecting rods. Further, each of these surfaces can comprise a surface material or finish that is configured to reduce wear and/or avoid, limit, or dissipate heat. The diameter of the wrist pin portion 472 can be less than the diameter of the opening 433 on the piston 410.

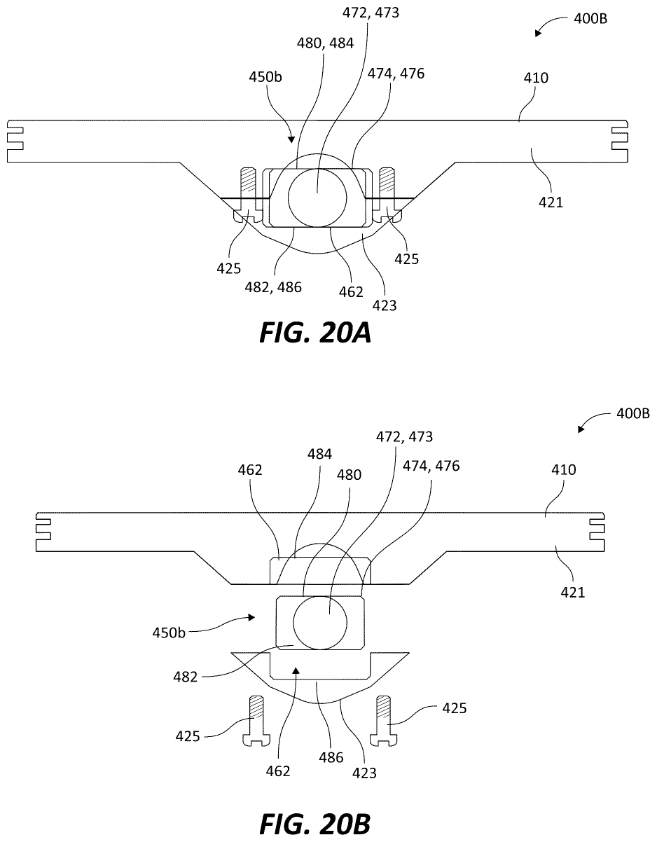

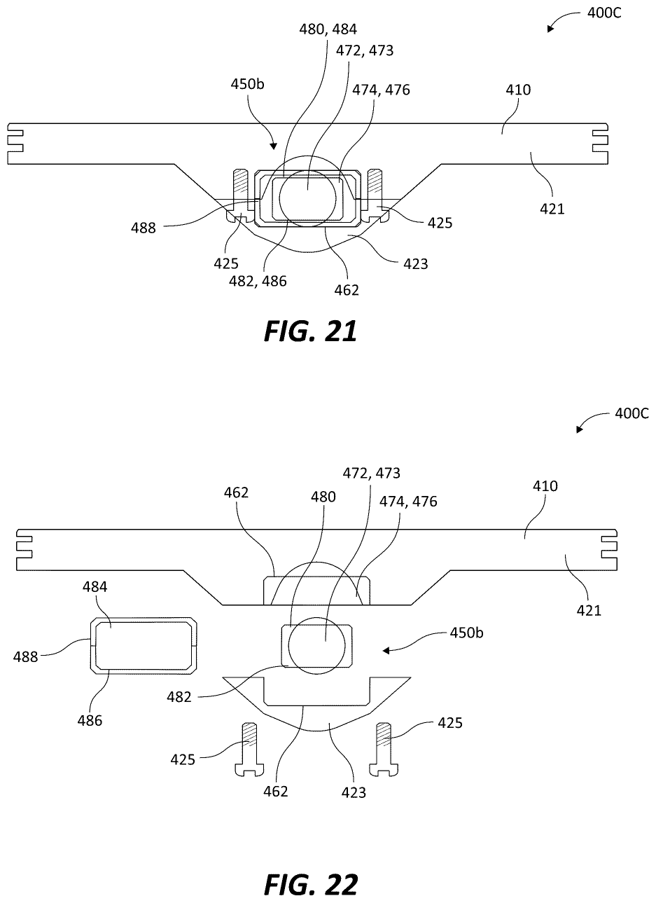

As shown for the illustrated embodiment, the translating wrist pin 450b can also include a first rail 474 and second rail 476. The first rail 474 can be positioned on one end of the wrist pin portion 472 and the second rail 476 can be positioned on an opposite end of the wrist pin portion 472. The first rail 474 and the second rail 476 can each extend parallel to each other and orthogonally to a longitudinal direction of the wrist pin portion 472. As will be described below with reference to FIGS. 20A-21B, the first and second rails 476, 478 are, during use, received within a slot 462 associated with the piston. The first and second rails 476, 478 are configured to laterally displace or translate within the slot 462 and piston 410. The first and second rails 476, 478 can comprise upper bearing surface 480 and a lower bearing surface 482 (as best seen in FIGS. 20A-21B). The upper bearing surface 480 can be a flat surface. The lower bearing surface 482 can be a flat surface. In some embodiments, the first and second rails 476, 478 can be configured as rectangular prism, although other shapes are possible.

FIGS. 19A and 19B illustrate various connecting rod configurations that can be used with translating wrist pins 450. In the illustrated embodiments of FIGS. 19A and 19B, the connecting rods are shown with a translating wrist pin 450b as shown in FIGS. 18A and 18B. However, it should be noted that the translating wrist pins 450a of FIGS. 17A-17G can be used with similar connecting rod configurations. As noted previously, the translating wrist pins 450b can be used to couple one or more connecting rods 416, 418 to the piston 410. Each connecting rod 416, 418 can also be connected to a crankshaft. In FIG. 19A, the translating wrist pin 450b is connected to a first connecting rod 416 and a second connecting rod 418. The second connecting rod 418 comprises a first member 418a and a second member 418b. In some embodiments, for example, as illustrated, the first and second members 418a, 418b of the second connecting rod 418 can have a combined mass that is equal to the mass of the first connecting rod 416 so that the engine remains balanced. In some embodiments, the first and second members 418a, 418b can be considered two connecting rods (e.g., each member can be a connecting rod) such that, FIG. 19A illustrates three connecting rods.

In the embodiment illustrated in FIG. 19B, wishbone-shaped or forked-shaped connecting rods 416, 418 are used. Each wishbone-shaped connecting rod 416, 418 includes a forked end and a non-forked end. For the first connecting rod 416, the forked end is coupled to the translating wrist pin 450b. The forked end would then be coupled to a crankshaft. For the second connecting rod 418, the non-forked end is coupled to the translating wrist pin 450b. The non-forked end of the second connecting rod 418 is received between the forked end of the first connecting rod 416. In some implementations of the illustrated embodiment of FIG. 19B, each connecting rod has the same shape and mass, and while oriented differently, still provide good balance for the engine. Advantageously, the connecting rod arrangements of FIGS. 19A and 19B allow connecting rods to be chained together end to end.

FIGS. 20A and 20B illustrate another embodiment of a translating wrist pin and piston assembly 400B. FIG. 20A shows the translating wrist pin and piston assembly 400B in an assembled configuration, while FIG. 20B illustrates an exploded view thereof. The translating wrist pin and piston assembly 400B can be configured to include a translating wrist pin 450b as described with respect to FIGS. 18A and 18B or other wrist pin configurations. The translating wrist pin and piston assembly 400B can be configured to include connecting rod configurations as described with respect to FIGS. 19A and 19B, as well as other connecting rod configurations.

In the illustrated embodiment, the wrist pin 450b is received within a slot 462 formed in or by the piston 410. In particular, the first and second rails 474, 476 are received within the slot 462. The wrist pin portion 472 and shaft 473 thereof extend between the first and second rails 474, 476 through ends in the connecting rods, thereby coupling the connecting rods to the piston 410.

In the illustrated embodiment, the piston 410 comprises an upper portion 421 and a lower portion 423. The upper portion 421 and the lower portion 423 can be coupled together with fasteners 425 (e.g., bolts) as illustrated or by other fastening methods of mechanisms. In other embodiments, the piston 410 may comprise a single part or more than two portions (e.g., three or more portions) that are assembled together to form the piston. In the illustrated embodiment, the slot 462 (or two slots 462) is formed between the upper portion 421 and the lower portion 423 of the piston. As illustrated, the slot(s) 462 can comprise a rectangular slot. In general, the slot(s) 462 can comprise a shape that corresponds to the shape of a rail 474, 476 of the translating wrist pin 450b. For example, two slots 462 can be disposed in or on the piston 410 to receive the two rails 474, 476, of the translating wrist pin 450b.

The slot(s) 462 can include at least an upper bearing surface 484 and a lower bearing surface 486 (see FIG. 20B). The upper bearing surface 484 can comprise a flat surface. The lower bearing surface 486 can comprise a flat surface. In the illustrated embodiment, lateral sides of the slot 462 are flat. This need not be the case in all embodiments. As will be described in more detail below, the slot 462 is configured to receive a rail (e.g., first rail 474 or second rail 476) of the translating wrist pin 450b. The upper bearing surface 484 of the slot 462 can be configured to contact and slidingly engage with an upper bearing surface 480 of the rail 474, 476 of the translating wrist pin 450b. The lower bearing surface 486 of the slot 462 can be configured to contact and slidingly engage with a lower bearing surface 482 of the rail 474, 476 of the translating wrist pin 450b. Each of these surfaces (e.g., of the rail 474, 476 and/or the slot 462) can comprise a surface material or finish that is configured to facilitate sliding. Further, each of these surfaces can comprise a surface material or finish that is configured to reduce wear and/or avoid, limit, or dissipate heat.

The lateral width of the slot 462 is wider than the lateral width of the rail of the translating wrist pin 450b such that the translating wrist pin 450ba can move laterally along the width of the slot 462. This allows the translating wrist pin 450b to move (e.g., laterally translate or displace) relative to the piston 410. Such movement can help to accommodate lash between the counter-rotating crankshafts coupled to the piston 410 via the wrist pin 450a and connecting rods 416, 418 and/or other imperfect tolerances in the system. Allowing for such linear movement of the wrist pin 450b relative to the piston 410 can facilitate smooth movement of the piston 410 within the bore and reduce binding and/or scraping of the piston 410 with the bore in which the piston 410 moves. This can increase engine performance and reduce friction, heat, and other inefficiencies. To provide for this lateral translation, in some embodiments, the lateral width of the slot 462 is greater than the lateral width of the portion of the wrist pin 450b that is received within the slot 462 (e.g., the rails) by a distance of at least 0.25 mm, 0.5 mm, 0.75 mm, 1.0 mm, 1.25 mm, 1.5 mm, 1.75 mm, 2.0 mm, or more, although other distances are possible.

FIGS. 21 and 22 illustrate another embodiment of a translating wrist pin and piston assembly 400C. The embodiment of FIGS. 21 and 22 is in some respects similar to that of FIGS. 20A and 20B, although the embodiment of FIGS. 21 and 22 further includes an insert 488 which is received within the slot 462. FIG. 21 shows the translating wrist pin and piston assembly 400C in an assembled configuration, while FIG. 22 illustrates an exploded view thereof. The translating wrist pin and piston assembly 400C can be configured to include a translating wrist pin 450b as described with respect to FIGS. 18A and 18B or other wrist pin configurations. The translating wrist pin and piston assembly 400C can be configured to include connecting rod configurations as described with respect to FIGS. 19A and 19B, as well as other connecting rod configurations.

In the illustrated embodiment, the wrist pin 450b is received within an insert(s) 488 that is received within the slot(s) 462 formed in, on, or by the piston 410. In particular, the first and second rails 474, 476 are received within the insert(s) 488. The wrist pin portion 472 and shaft 473 thereof extend between the first and second rails 474, 476 through ends in the connecting rods, thereby coupling the connecting rods to the piston 410.

In the illustrated embodiment, the piston 410 comprises an upper portion 421 and a lower portion 423. The upper portion 421 and the lower portion 423 can be coupled together with fasteners 425 (e.g., bolts) as illustrated or by other fastening methods of mechanisms. In other embodiments, the piston 410 may comprise a single part or more than two portions (e.g., three or more portions) that are assembled together to form the piston. In the illustrated embodiment, the slot 462 is formed between the upper portion 421 and the lower portion 423 of the piston. As illustrated, the slot 462 can comprise a rectangular slot. In general, the slot 462 can comprise a shape that corresponds to the shape of the insert 488, such that the insert 488 is closely received within the slot 462.

The insert(s) 488 can include at least an upper bearing surface 484 and a lower bearing surface 486 (see FIG. 22). The upper bearing surface 484 can comprise a flat surface. The lower bearing surface 486 can comprise a flat surface. In the illustrated embodiment, lateral sides of the insert(s) 488 are flat. This need not be the case in all embodiments. As will be described in more detail below, the insert(s) 488 is configured to receive a rail (e.g., first rail 474 or second rail 476) of the translating wrist pin 450b. The upper bearing surface 484 of the insert(s) 488 can be configured to contact and slidingly engage with an upper bearing surface 480 of the rail 474, 476 of the translating wrist pin 450b. The lower bearing surface 486 of the insert(s) 488 can be configured to contact and slidingly engage with a lower bearing surface 482 of the rail 474, 476 of the translating wrist pin 450b. Each of these surfaces (e.g., of the rail 474, 476 and/or the insert 488) can comprise a surface material or finish that is configured to facilitate sliding. Further, each of these surfaces can comprise a surface material or finish that is configured to reduce wear and/or avoid, limit, or dissipate heat.

The lateral width of the insert(s) 488 is wider than the lateral width of the rail of the translating wrist pin 450b such that the translating wrist pin 450ba can move laterally along the width of the insert(s) 488. This allows the translating wrist pin 450b to move (e.g., laterally translate or displace) relative to the piston 410. Such movement can help to accommodate lash between the counter-rotating crankshafts coupled to the piston 410 via the wrist pin 450a and connecting rods 416, 418 and/or other imperfect tolerances in the system. Allowing for such linear movement of the wrist pin 450b relative to the piston 410 can facilitate smooth movement of the piston 410 within the bore and reduce binding and/or scraping of the piston 410 with the bore in which the piston 410 moves. This can increase engine performance and reduce friction, heat, and other inefficiencies. To provide for this lateral translation, in some embodiments, the lateral width of the insert(s) 488 (in particularly the lateral interior width) is greater than the lateral width of the portion of the wrist pin 450b that is received within the slot 462 (e.g., the rails) by a distance of at least 0.25 mm, 0.5 mm, 0.75 mm, 1.0 mm, 1.25 mm, 1.5 mm, 1.75 mm, 2.0 mm, or more, or other distances both greater and smaller than those listed.

The translating wrist pins 450 and piston coupling configurations described in this section can be implemented in any engine configuration described herein and may be particularly advantageous in instances where two or more connecting rods are connecting to a piston by a wrist pin. Especially where the two or more connecting rods are connected to two counterrotating and meshed crankshafts as described throughout this application. As noted previously, these configuration can help accommodate lash between the counterrotating crankshafts and/or between other components in this system and reduce binding and/or scraping of the piston with the bore in which the piston moves.

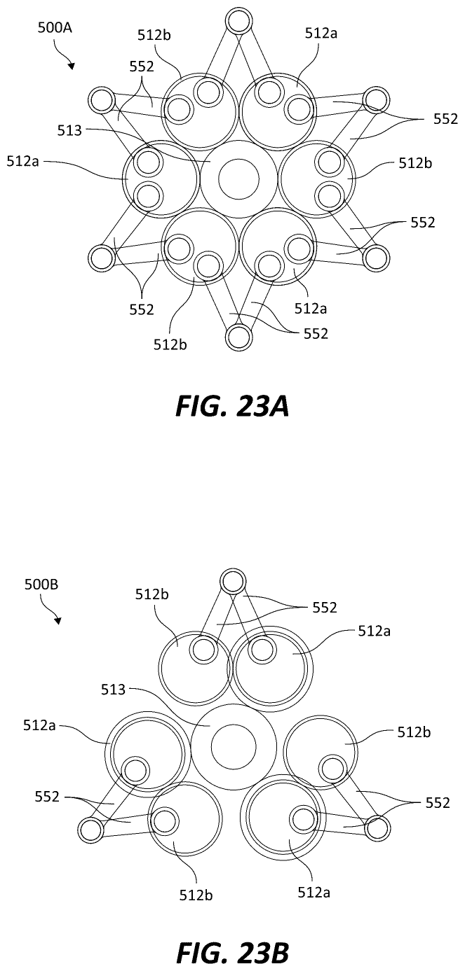

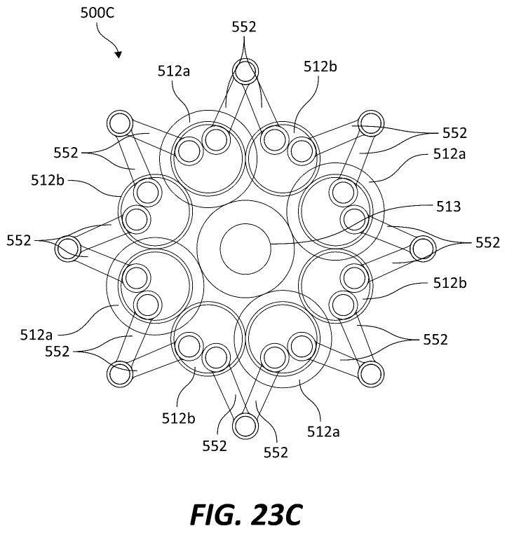

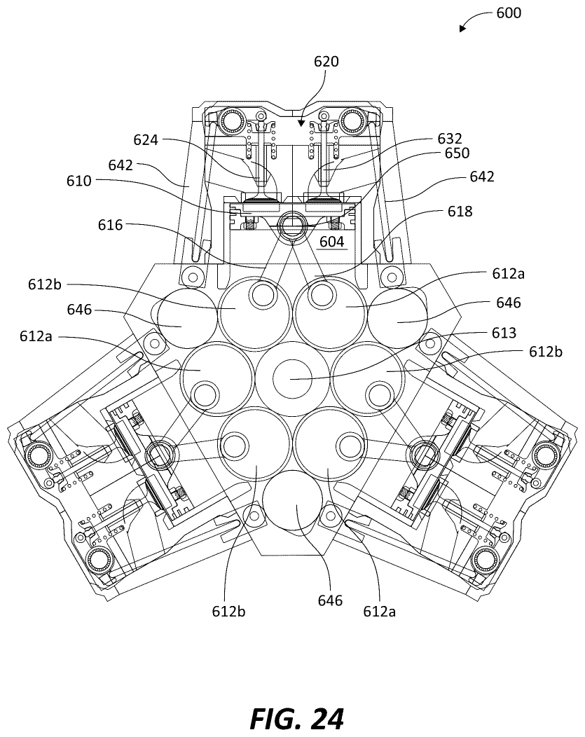

With reference now to FIGS. 23A-28, radial configurations that include three or more pairs of counterrotating crankshafts will now be described. FIGS. 23A-23C illustrate schematically various radial configurations and arrangements for crankshafts and will be used to describe general principals with the understanding that additional embodiments and arrangements are possible. FIGS. 24 through 28 illustrate embodiments of internal combustion engines which include radial configurations with three or more pairs of counterrotating crankshafts. Again, the illustrated embodiments are provided by way of example and illustration, and other embodiments within the scope of this application are possible.

FIGS. 23A-23C each illustrate crankshaft configurations including at least two pairs of crankshafts (each pair of crankshafts comprising a first crankshaft 512A and a second crankshaft 512B), wherein, in each pair of crankshafts, the first crankshaft is engaged with the second crankshaft such that rotation of the first crankshaft causes counterrotation of the second crankshaft. FIGS. 23A and 23B each illustrate three pairs of crankshafts, while FIG. 23C shows four pairs of crankshafts. Each pair of crankshaft is coupled by a plurality of connecting rods 552 to a piston (pistons are not included in FIGS. 23A-23C, but see, e.g., pistons 610, 611 of FIGS. 24-27).

FIG. 23A illustrates an embodiment of a radial crankshaft configuration 500A that includes six crankshafts 512 arranged in pairs. Each pair of crankshafts 512 comprises a first crankshaft 512a and a second crankshaft 512b. In the illustrated configuration 500A, each crankshaft 512a, 512b is coupled to two connecting rods 552. Although not illustrated, each of the two connecting rods 552 coupled to one of the crankshafts 512a, 512b can be coupled to a piston (e.g., any type of piston). Accordingly, in the illustrated embodiment, each crankshaft 512a, 512b can be coupled to two separate pistons. In some embodiments, crankshafts 512a, 512b need not be coupled to pistons and can be coupled to other features, such as a counterweight, as shown, for example, in FIG. 13C and elsewhere in this application. In some embodiments, each crankshaft 512 can include only a single connecting rod 552 and be coupled to only a single piston (e.g., similar to the configuration of FIG. 23B).

For each pair of crankshafts, the first crankshaft 512a can rotate in a first direction and the second crankshaft 512b can rotate in a second direction, with the second direction being opposite the first direction. The two crankshafts 512a, 512b can be disposed adjacent each other and in mesh with each other. For example, a gear of a first crankshaft 512a can directly mesh with a gear of the second crankshaft 512b. In such an arrangement, rotation of one of the crankshafts 512a causes counter-rotation of the other of the crankshafts 512b, and vice versa.

In the illustrated configuration 500A of FIG. 23A, each first crankshaft 512a is in mesh with each of the second crankshafts 512b positioned on opposite sides of the first crankshaft 512a. Similarly, each second crankshaft 512b is in mesh with each of the first crankshafts 512a positioned on opposite sides of the second crankshaft 512b. Thus, for this configuration, each first crankshaft 512a forms a pair with each of the two second crankshafts 512b with which it is in mesh, and similarly, each second crankshaft 512b forms a pair with each of the two first crankshafts 512a with which it is in mesh. For the illustrated configuration 500A of FIG. 23A, the six crankshafts 512a are in mesh with each other such that they form a continuous chain, with each crankshaft 512a, 512b counterrotating with those directly in mesh with it. Rotation of any of the crankshafts 512a, 512b is transmitted to each of the other crankshafts with adjacent crankshafts counterrotating.

Further, as shown in FIG. 23A, in the illustrated embodiment, one crankshaft of each pair, for example, each of the first crankshafts 512a is also in mesh with an output or timing shaft 513. For example, a gear on each of the first crankshafts 512a can be in mesh with a gear on the output shaft 513. Rotation of any of the first crankshafts 512a thereby causes rotation of the output or timing shaft 513 (as well as rotation of each of the other first crankshafts 512a and second crankshafts 512b). Notably, because each crankshaft 512 in a pair of crankshafts 512a, 512b counterrotates, only one of the crankshafts of a pair can be directly in mesh with the output or timing shaft 513. In FIG. 22A, the timing or output shaft 513 need not be necessary for timing as each of the crankshafts are all directly or indirectly in mesh with each other, providing timing functionality. The output shaft 513 can be used as a centralized power take off to facilitate distribution of forces and balance. Notably, however, any of the crankshafts 512 can also be used as a power take off. Accordingly, in some embodiments, the output or timing shaft 513 can be omitted.

In some embodiments, for example, as illustrated in the configuration 500A of FIG. 23A, the output or timing shaft 513 can be positioned centrally, with the first and second crankshafts 512a, 512b arranged radially around the output or timing shaft 513. In the illustrated embodiment, six crankshafts 512 are included, with each crankshaft positioned at a 60-degree spacing about the central axis of the output or timing shaft 513.

While FIG. 23A illustrates six crankshafts 512, other even numbers of crankshafts can be used. For example, similar embodiments, with eight, ten, twelve, or more crankshafts radially arranged around a central axis can be provided. FIG. 23A illustrates an example where for each pair of crankshafts, the first crankshaft is engaged with a second crankshaft of an adjacent pair of crankshafts such that rotation of the first crankshaft causes counter rotation of the second crankshaft of the adjacent pair of crankshafts.

FIG. 23B illustrates another embodiment of a radial crankshaft configuration 500B that includes six crankshafts 512 arranged in pairs. Each pair of crankshafts 512 comprises a first crankshaft 512a and a second crankshaft 512b. In the illustrated configuration 500A, each crankshaft 512A is coupled to one connecting rod 552. Although not illustrated, each connecting rod 552 coupled to one of the crankshafts 512 can be coupled to a piston. In this configuration, each pair of crankshafts 512 is associated with motion of one piston. In some embodiments, crankshafts 512 need not be coupled to pistons and can be coupled to other features, such as a counterweight, as shown, for example, in FIG. 13C and elsewhere in this application.

For each pair of crankshafts, the first crankshaft 512a can rotate in a first direction and the second crankshaft 512b can rotate in a second direction, with the second direction being opposite the first direction. The two crankshafts 512a, 512b can be disposed adjacent each other and in mesh with each other. For example, a gear of a first crankshaft 512a can directly mesh with a gear of the second crankshaft 512b. In such an arrangement, rotation of one of the crankshafts 512a causes counter-rotation of the other of the crankshafts 512b, and vice versa.

Unlike the configuration 500A of FIG. 23A, for the configuration 500B of FIG. 23B, each crankshaft 512 is only directly engaged with one other crankshaft. For example, each first crankshaft 512a is only directly engaged with one second crankshaft 512b. Accordingly, clear pairs of first and second crankshafts 512b are provided. In the illustrated embodiment of FIG. 23B, three pairs of first and second crankshafts 512a, 512b are shown. Comparing FIG. 23A with 23B, one can see that in the configuration of FIG. 23B, space exists between each pair of crankshafts 512a, 512b.

As shown in FIG. 23B, in the illustrated embodiment, one crankshaft of each pair, for example, each of the first crankshafts 512a is also in mesh with an output or timing shaft 513. For example, a gear on each of the first crankshafts 512a can be in mesh with a gear on the output shaft 513. Rotation of any of the first crankshafts 512a thereby causes rotation of the output or timing shaft 513 (as well as rotation of each of the other first crankshafts 512a and second crankshafts 512b). Because the pairs of crankshafts are not engaged directly with each other, the timing or output shaft 513 provides timing functionality, causing the crankshafts to rotate at the same rate. Notably, because each crankshaft 512 in a pair of crankshafts 512a, 512b counterrotates, only one of the crankshafts can be directly in mesh with the output or timing shaft 513. The output shaft 513 can be used as a centralized power take off to facilitate distribution of forces and balance. Notably, however, any of the crankshafts 512 can also be used as a power take off.

In some embodiments, for example, as illustrated in the configuration 500B of FIG. 23B, the output or timing shaft 513 can be positioned centrally, with the pairs of crankshafts 512 arranged radially around the output or timing shaft 513. In the illustrated embodiment, three distinct pairs of crankshafts 512 are included, with each pair of crankshafts positioned at a 120-degree spacing about the central axis of the output or timing shaft 513.

While FIG. 23B illustrates three pairs of crankshafts 512, other numbers of crankshafts can be used. For example, similar embodiments, with four, five, six, or more pairs of crankshafts radially arranged around a central axis can be provided. FIG. 23B illustrates an example, including a timing gear, and wherein, for each pair of crankshafts, the first crankshaft is engaged with the timing gear such that rotation of the first crankshaft causes rotation of the timing gear.

FIG. 23C illustrates another example configuration of radial crankshaft configuration 500C that includes eight crankshafts 512 arranged in pairs. The configuration 500C of FIG. 23C is similar to the configuration 500A of FIG. 23A in that each crankshaft 512 is directly in mesh with each of the two crankshafts immediately adjacent to it. However, in FIG. 23C, the configuration 500C includes eight crankshafts (instead of six as in FIG. 23A). This embodiment is included to illustrate how greater numbers of crankshafts can be arranged. The configuration 500C of FIG. 23C could further be modified to arrange the crankshafts 512 in distinct pairs that are separated from each other similar to the configuration 500B of FIG. 23B.

FIGS. 24-28 illustrate example internal combustion engines 600 including a radial configuration of crankshafts and pistons. In these illustrated embodiments, each internal combustion engine includes six crankshafts and three primary pistons, with some embodiments further including three auxiliary pistons. These embodiments are provided by way of example and can be extrapolated for other embodiments with greater numbers of crankshafts and pistons. In general, such embodiments can include an even number of crankshafts with half that number of pistons. In some embodiments, half the number of crankshafts of auxiliary pistons can also be provided. In some embodiments, the number of primary pistons can be equal to the number of crankshafts.

FIG. 24 illustrates an embodiment of an internal combustion engine 600. Some of the features of the internal combustion engine 600 are similar to features of the internal combustion engine 300 in FIG. 12. Thus, reference numerals used to designate the various features or components of the internal combustion engine 600 can be similar or identical to those used for identifying the corresponding features or components of the internal combustion engine 300 except that the numerical identifiers for components of the internal combustion engine 600 begin with a “6” instead of a “3.” Therefore, the structure and description for some of the various features of the internal combustion engine 300 are understood to also apply to the corresponding features of the internal combustion engine 600, except as described below. In FIG. 24 pistons and crankshafts are shown at top dead center. In some configurations, the internal combustion engine 600 of FIG. 24 can be configured to be modular, as described further herein. In some embodiments, the crankshafts 612 can be configured to be modular like the crankshafts 812 of FIG. 45.

The internal combustion engine 600 differs from the internal combustion engine 300 of FIG. 12 in that the internal combustion engine 300 includes six crankshafts 612 instead of four. The six crankshafts 612 are arranged radially around a central timing or output shaft 613 in a manner similar to the configuration 500A of FIG. 23A, except that each crankshaft 612 is coupled to only one connecting rod 616 or connecting rod 618 (instead of two connecting rods as in the configuration 500A of FIG. 23A). As such, and as illustrated in FIG. 24, the internal combustion engine 600 includes three pistons 610 arranged radially with a spacing of 120 degrees therebetween. The internal combustion engine 600 is well balanced with respect to primary and secondary forces, due largely to its radially symmetric design.

Each piston 610 of the internal combustion engine 600 can be connected to the connecting rods 616, 618 via a wrist pin 650. The wrist pin 650 can be a laterally translating or displacing wrist pin, as described further herein with reference to at least FIGS. 17A-20B. Because wrist pins 650 are utilized, the internal combustion engine 600 is configured with the pistons 610 in a complete toed-in configuration. When arranged in the complete toed-in configuration, the crankshafts 312 can rotate through more degrees of rotation for the intake and/or power strokes, compared to the compression and/or exhaust strokes. Such an arrangement can provide certain advantages, as described above, with reference to at least FIG. 7A. Similarly, the wrist pins 650 allow linear movement of the wrist pin relative to the piston can facilitate smooth movement of the piston within the bore and reduce binding and/or scraping of the piston with the bore in which the piston moves. This can increase engine performance and reduce friction, heat, and other inefficiencies.

As shown in FIG. 24, each valve train 620 of the internal combustion engine 600 can optionally include pushrods 642, similar to the internal combustion engine 300 in FIG. 12. In some embodiments, the crankshafts 612 can be used to drive camshafts 646 to control the opening and/or closing of the intake valves 624 and exhaust valves 632. For example, a gear of a crankshaft 612 can be in mesh with a gear of the camshaft 646 such that rotation of the crankshaft 612 causes rotation of the camshaft 646. In other implementations, different configurations for the valve train 620 are possible. For example, the internal combustion engine 600 may include cams on the crankshaft 612 for actuating the pushrods 642, may include one or more camshafts as part of an overhead cam system, and/or may include other valve actuating systems. In some configurations, the internal combustion engine 600 can utilize the valve actuating systems described in PCT Application No. US2024/054996. In some configurations, the internal combustion engine 600 may utilize one of more rotary valves to control the delivery of intake air and the removal of exhaust air to the combustion chambers 604.

While the internal combustion engine 600 is shown as including three combustion pistons 610, in other configurations, the internal combustion engine 600 may include one or more auxiliary pistons, for example as described below. In such a configuration, the auxiliary pistons may be driven by the six crankshafts 612. In alternative configurations, the internal combustion engine 600 may include only a single combustion piston 610.

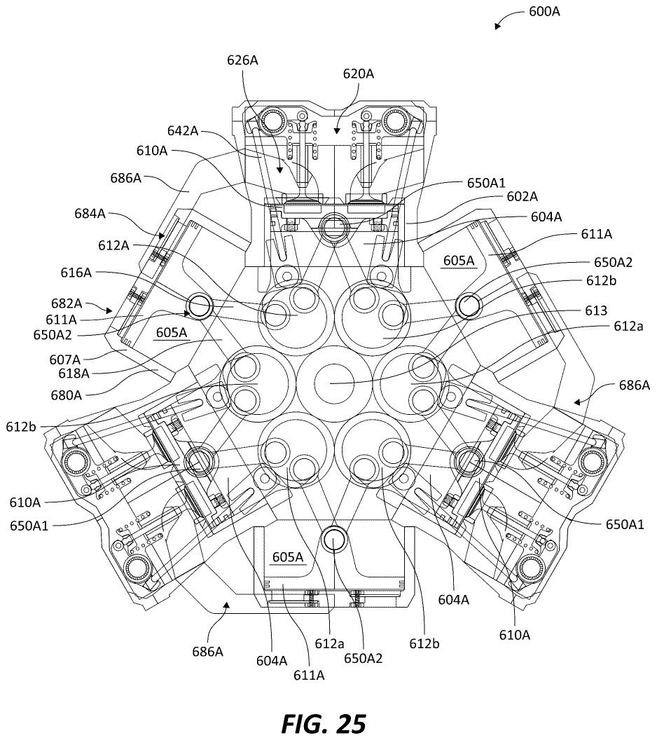

FIGS. 25-28 illustrate embodiments of an internal combustion engines 600A, 600B, 600C respectfully. Some of the features of the internal combustion engines 600A, 600B, 600C are similar to features of the internal combustion engine 300 in at least FIG. 12 and the internal combustion engine 600 in FIG. 23. Thus, reference numerals used to designate the various features or components of the internal combustion engines 600A, 600B, 600C are identical to those used for identifying the corresponding features or components of the internal combustion engine 300 in at least FIG. 12 and the internal combustion engine 600 in FIG. 23, except that the numerical identifiers for components of the internal combustion engine 600A begin with a “6” instead of a “3” and end with an “A,”, “B,” or “C.” Therefore, the structure and description for the various features of the internal combustion engines 300 and 600 and how they operate in at least FIGS. 12 and 24 are understood to also apply to the corresponding features of the internal combustion engine 600A, except as described below. In FIGS. 25-28 pistons and crankshafts are shown at top dead center. In some configurations, the internal combustion engine 600A, 600B, 600C of FIGS. 25-28 can be configured to be modular, as described further herein. In one example, the crankshafts 612A can be configured to be modular like the crankshafts 812 of FIG. 45.

The internal combustion engine 600A of FIG. 25 differs from the internal combustion engine 600 of FIG. 24 in that the internal combustion engine 600A includes three auxiliary pistons 611A. The auxiliary pistons 611A can be similar, in some respects, to the pistons 210C, 210D of the internal combustion engine 200 of FIG. 10. In the illustrated embodiment of FIG. 25, the auxiliary pistons 611A are arranged radially and between the pistons 610A. Accordingly, the auxiliary pistons 611A are arranged with 120-degree spacing or the pistons 610A and the auxiliary pistons are radially arranged with 60-degree spacing. The internal combustion engine 600A is well balanced with respect to primary and secondary forces, due largely to its radially symmetric design.

The internal combustion engine 600A can include auxiliary housings 680A to accommodate the auxiliary piston 611A. Each auxiliary housing 680A encloses, envelopes, and/or surrounds both the auxiliary chamber 605A and at least a portion of the bore 607A that is associated with the auxiliary chamber 605A. Each auxiliary housing 680A can be mounted to the uniblocks 602A using any conventional means (e.g., fasteners received within mount holes in the uniblocks 602A).

Each auxiliary piston 611A can be configured to deliver intake air to one or more of the combustion chambers 604A of the internal combustion engine 600A. For example, each auxiliary chamber 605A can be in fluid communication with one or both of the combustion chambers 604A immediately adjacent to it. In the configuration of FIG. 24, the auxiliary housing 680A includes a single intake port 682A and a single outlet port 684A. The outlet port 684A can deliver fluid to one or both of the combustion chambers 604A adjacent to the auxiliary piston 611A via the inlet feed pipe 686A. In the example of FIG. 23, each inlet feed pipe 686A only directs fluid to one adjacent combustion chamber 604A via the intake passage 626A. In other examples, the internal combustion engine 600A may include multiple inlet feed pipes or the inlet feed pipe 686A may be split so that fluid from an auxiliary chamber 305A can be directed to both immediately adjacent (or other) combustion chambers 604A. For example, the internal combustion engine 600A of FIG. 24 could include an inlet feed pipe 686A configured to deliver fluid to both adjacent combustion chambers 604A via the intake passages 626A.

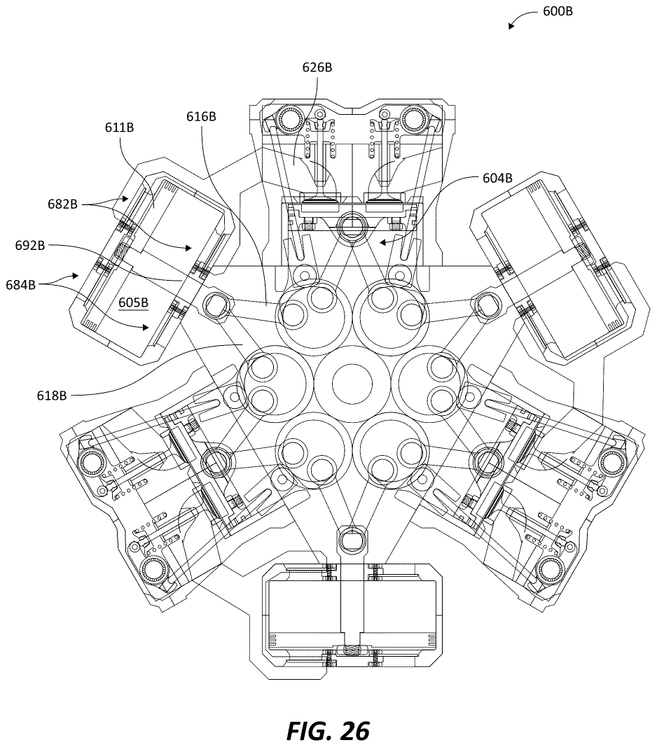

With reference to FIGS. 26-28, in some configurations, the internal combustion engine 600B, 600C can include one or more double-acting pistons. For example, an auxiliary piston 611B, 611C can be configured as a double-acting piston. In such a configuration, the auxiliary housing 680B, 680C can include multiple intake ports 682B, 682C and multiple outlet ports 684B, 684C. At least one intake port 682B, 682C and at least one outlet port 684B, 684C can be disposed on either side of the auxiliary piston 611B, 611C in the auxiliary housing 680B, 680C. As such, the auxiliary piston 611B, 611C can draw in fluid via one of the intake ports 682B, 682C and deliver fluid to the inlet feed pipe 686B, 686C via one of the outlet ports 684B, 684C on both the upstroke and the downstroke. For example, the auxiliary piston 611B, 611C can utilize pressure on both sides of the auxiliary piston 611B, 611C.

In the configuration of FIG. 26-28, the internal combustion engines 600B, 600C, 600D can include a piston shaft 692B, 692C, 692D for each auxiliary piston 611A, 611B, 611C. The piston shaft 692B, 692C, 692D can be coupled on one end to the auxiliary piston 611B, 611C, 611D. The piston shaft 692B, 692C, 692C can be coupled on an opposite end to one or more connecting rods. For example, the piston shaft 692A can be coupled to a pair crank connecting rods 616A, 618A. As such, every complete revolution of the crankshafts 612B, 612C, 612C causes the auxiliary piston 611B, 611C, 611D to complete an upstroke and a downstroke so that intake air is delivered to the combustion chambers 604B, 604C, 604D twice per crankshaft revolution. Accordingly, the configuration of FIG. 26-28 including a double-acting auxiliary piston 611B, 611C, 611D may be ideal for a two-stroke engine.

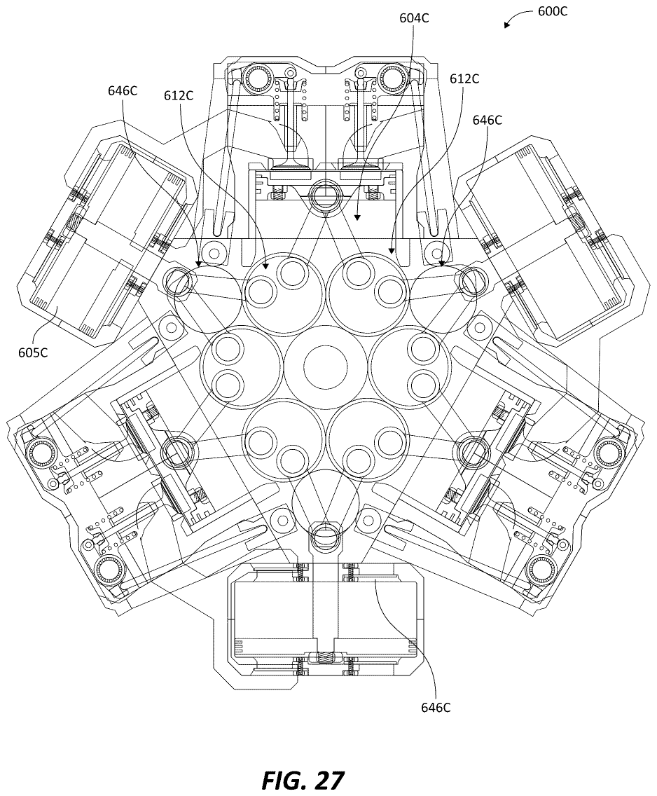

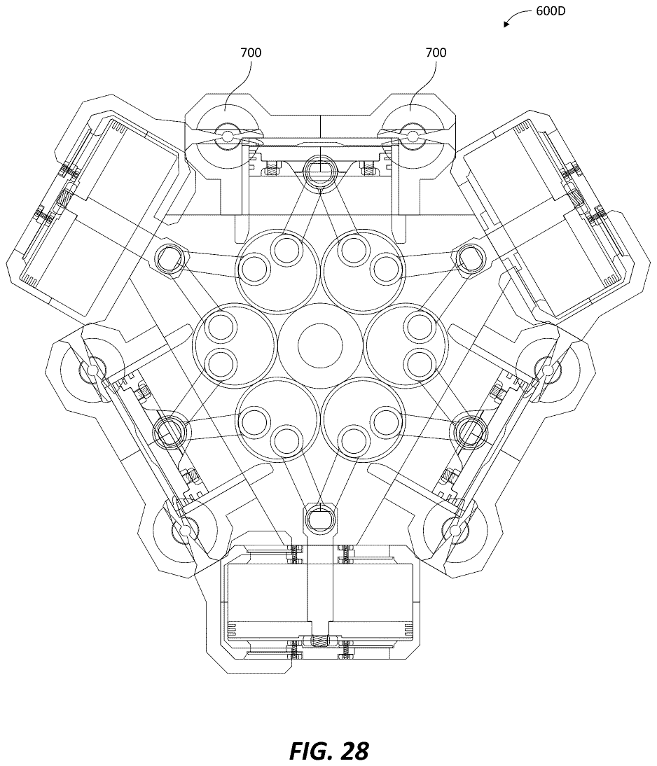

In the internal combustion engine 600C of FIG. 27, separate camshafts 646C are driven by the crankshafts to control valve timing associated with the combustion chambers 604C. The camshafts 646C can be geared to the crankshafts 612C such that for each two rotations of the crankshaft 612C, the camshaft 646C rotates once. This arrangement can cause the valves to open with only every second revolution of the crankshaft 612C and may be ideal for a four-stroke engine. In FIG. 28, the internal combustion engine 600C is illustrated with rotary valves subassemblies 700, which are described below, with reference to FIGS. 29-37.

With reference now to FIGS. 29-37, various embodiments of rotary valve subassemblies 700 that can be used with the internal combustion engines (such as the internal combustion engine 100, for example) will be described. The rotary valve subassemblies 700 can be positioned to control flow through the intake passage 126 and the exhaust passage 134. The rotary valve subassemblies 700 preferably are positioned such that deadspace can be reduced or eliminated between the rotary valve subassemblies 700 and the respective combustion chamber 104.

The rotary valve subassemblies 700 employ one or more rotary valves 702. In some configurations, the rotary valves 702 can be replaced with poppet valves or other suitable valves. The rotary or poppet valve configurations are particularly suitable for when the rotary valve subassemblies 700 are being used with either an internal combustion engine or a compressor or pump configuration. In some configurations, the rotary valves 702 can be replaced by check valves, ball valves, or other suitable valves that are configured to control flow direction. These configurations are particularly suitable for when the valve subassembly is being used in a compressor or pump configuration rather than an internal combustion engine configuration.

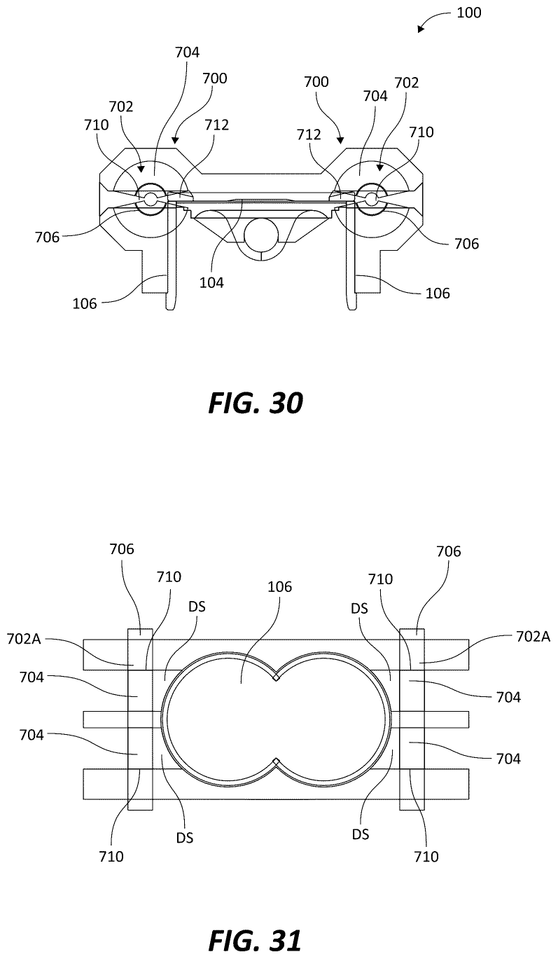

Turning to FIGS. 29 and 30, the rotary valves 702 can be mounted adjacent to one or more cylinder bores 106. In the illustrated configurations, the rotary valves 702 can be mounted such that two or more rotary valves 702 are diametrically opposed to each other with the cylinder bore 106 being positioned therebetween. Other relative placements are possible. The illustrated configuration bilateral configuration, however, simplifies movements of the valves in manners that will be described below. In addition, the illustrated bilaterial configuration can improve crossflow. In FIG. 29, the rotary valves 702 are positioned at approximately the midpoint of a cylinder bore. In FIG. 30, the rotary valves 702 are positioned at a top end (e.g., a TDC end) of a cylinder bore. This position can be advantageous as it permits additional space above the cylinder bore when compared with traditionally positioned poppet valves, for example.

In the configurations illustrated in FIGS. 31-35, two of the rotary valves 702 are positioned on one side of the cylinder bore 106 and two of the rotary valves 702 are positioned diametrically opposed on the opposite side of the cylinder bore 106. In some configurations, a central axis extends through the intake passage 126 and the exhaust passage 134 such that the rotary valves are positioned generally at the same axial position along the cylinder bore 106. In some configurations, the rotary valves 702 positioned along the intake passage 126 may be positioned higher or lower than the rotary valves 702 positioned along the exhaust passage 134. However, any opening from the rotary valves 702 into the cylinder bore 106 preferably is out of the sweep of the piston 110 within the cylinder bore 106.

In some configurations, the rotary valves 702 can be positioned along the side wall that defines the cylinder bore 106. The rotary valves 702 can be positioned anywhere along the side wall; however, to remain clear of the movement path of any piston rings (not shown) mounted to the piston 110, the rotary valves 702 can be positioned at the upper/lowermost ends of the cylinder bore 106 when the combustion chamber 104 is positioned at the top/bottom of the cylinder bore 106 (see FIG. 30) and/or the rotary valves 702 can be positioned at the center portion of the cylinder bore 106 when the combustion chamber 104 is positioned at the axial center of the cylinder bore 106 (see FIG. 29). Either position results in the rotary valves 702 being positioned along a portion of the wall that defines the cylinder bore 106 that will not interfere with sealing of the piston rings of the piston 110 with the wall that defines the cylinder bore 106. Moreover, the positioning of the rotary valves 702 results in a cross flow of gases within the combustion chamber 104. In some configurations, it is preferred that the rotary valves 702 are not positioned along the top surface that defines the top or bottom of the combustion chamber within the cylinder bore but that the rotary valves are positioned along the rim define at the end of the side wall that defines the cylinder bore 106 or in the central portion of the side wall that defines the cylinder bore 106. Fuel injectors and spark plugs and any other components that are desired to be in or adjacent to the combustion chamber can be positioned to extend in a different plane relative to the intake passage 126 and the exhaust passage 134 when the combustion chamber is positioned in the middle of the cylinder bore 106.

Each of the rotary valves 702 can comprise a valve body 704 and a valve shaft 706. In some configurations, one of the valve shafts 706 can support two or more valve bodies 704. In some configurations, each valve shaft 706 supports only one valve body 704. The valve bodies 704 will be explained in further detail below. The valve shaft 706 is used to rotate the valve body 704. As such, the valve shafts can be supported by suitable bearings or the like.

In the configuration illustrated in FIG. 29, the internal combustion engine 100 comprises four crankshafts 112. The four crankshafts 112 are connected to two opposed pistons 110. In FIG. 29, the two opposed pistons 110 are shown in top dead center and bottom dead center—as such, there are only two opposed pistons 110 that are illustrated. As described elsewhere in this document, the crankshafts 112 can be coupled for rotation in any suitable manner. In some configurations, the crankshafts 112 project beyond a first end of the internal combustion engine 100. The projecting portions of the four crankshafts 112 can be connected together using gears, chains, or any other suitable configuration. In this manner, rotation of the four crankshafts can be coordinated. In some configurations, at least one of the crankshafts 112 can project beyond a second end of the internal combustion engine 100. This projecting portion of the at least one crankshaft 112 can be coupled to the valve shafts 706 through gears, chains, or any other suitable configuration. Advantageously, in the configuration illustrated in FIG. 29, the four crankshafts 112 and the two valve shafts 706 are parallel with each other. In some configurations, the internal combustion engine 100 of FIG. 29 can be configured to be modular, as described further herein. In one example, the crankshafts 112 can be configured to be modular like the crankshafts 812 of FIG. 45.

In a two-stroke configuration of the internal combustion engine 100, the crankshaft 112 and the valve shaft 706 can be coupled such that the valve bodies 704 are driven at half of the rotational speed of the crankshafts 112. This is because the valve body 704 has a through passage 710 and, because this through passage 710 extends straight through the valve body 704 and has no flow direction restricting elements, the through passage 710 allows flow every 180 degrees of rotation. In some configurations, the passage 710 may not extend straight through the valve body 704 or the passage 710 may incorporate a flow direction limiting assembly. In such configurations, the timing of the rotation of the valve body 704 can be adjusted accordingly. In a four-stroke configuration of the internal combustion engine 100, the crankshaft 112 and the valve shaft 706 can be coupled such that the valve bodies 704 are driven at one quarter of the speed of the crankshafts 112. In some configurations, the rotary valves 702 are configured such that the rotary valves 702 allow air into the combustion chamber 104 and/or out of the combustion chamber 104 for one quarter of the engine cycle.

Each of the rotary valves 702 controls flow into and/or out of the cylinder bore 106. In the illustrated configuration, the wall that defines the cylinder bore 106 can include one or more opening 712 through which gases pass under the control of the rotary valve 702. In some configurations, the opening 712 can appear as slit 712 that extends around a portion of the circumference of the cylinder bore 106. The slit 712 can be narrow in the axial direction of the cylinder bore 106 and the slit 712 can be broad in the circumferential direction of the cylinder bore 106. Having a narrow slit 712 can be advantageous when seeking to provide a high compression ratio to the internal combustion engine 100. Moreover, having a narrow slit 712 in the axial direction of the cylinder bore 106 maximizes the axial length of the cylinder bore 106 through which the pistons 110 can sweep without contacting the slit 712. Because the piston 110 does not need a skirt to open and close any ports, the piston 110 can have a short or squat appearance without any skirt, if desired. Thus, the narrow slit in the axial direction can help produce a compact engine construction. The passage on the side of the valve body 704 that is away from the cylinder bore 106 can have any suitable construction. In some configurations, the passage on the other side of the valve body 704 from the cylinder bore 106 is constructed such that the opening does not restrict flow through the respective slit 712.

With reference now to FIGS. 31-35, at least five different constructions of the rotary valves 702 will be described. As mentioned above, the rotary valves 702 generally comprise the valve body 704 and the valve shaft 706. In some configurations, two or more valve bodies 704 are carried by a single valve shaft 706. In some configurations, a single valve body 704 is carried by a single valve shaft 706. In some such configurations, two or more valve shafts 706 can be rotationally connected. In some configurations, the valve shafts 706 can be joined for rotation. For example, the valve shafts 706 can be connected using a splined connection such that the two valve shafts 706 can have axial movement but generally be secured together for rotational movement. In some configurations, the valve shafts 706 could comprise a portion having splines, a square or other shape, or a keyed connection such that axial movement can be possible between the two valve bodies 704 but relative rotational movement is limited or eliminated. In some configurations, a single shaft can extended between two valve bodies 704 such that the valve bodies 704 themselves can move axially relative to the valve shaft 706 rather than having two valve shafts 706 that can move axially relative to each other. While not illustrated, the valve shafts 706 and/or the valve bodies 704 can be supported by one or more bearings.

As illustrated in FIGS. 31-35, the pistons and the illustrated cylinder bores 106 can comprise a double-C shaped configuration. In some configurations, however, the pistons and the cylinder bores can be large diameter circular bores or any other suitable configuration.

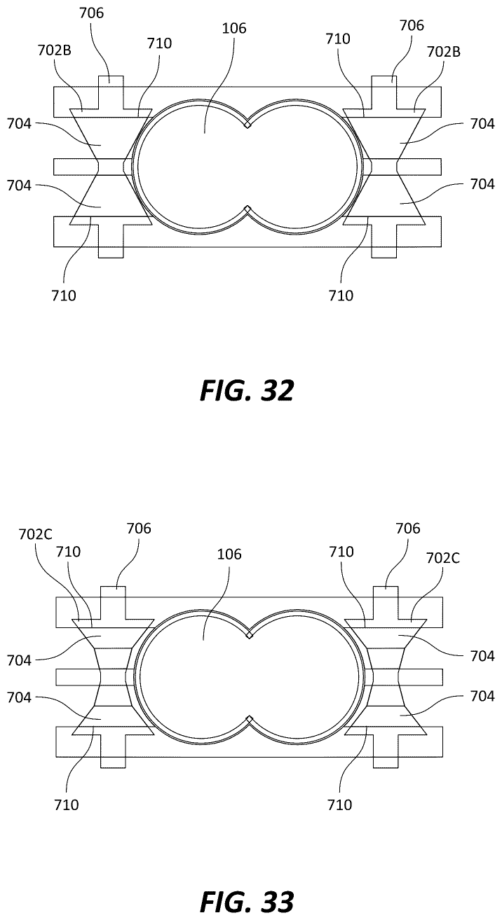

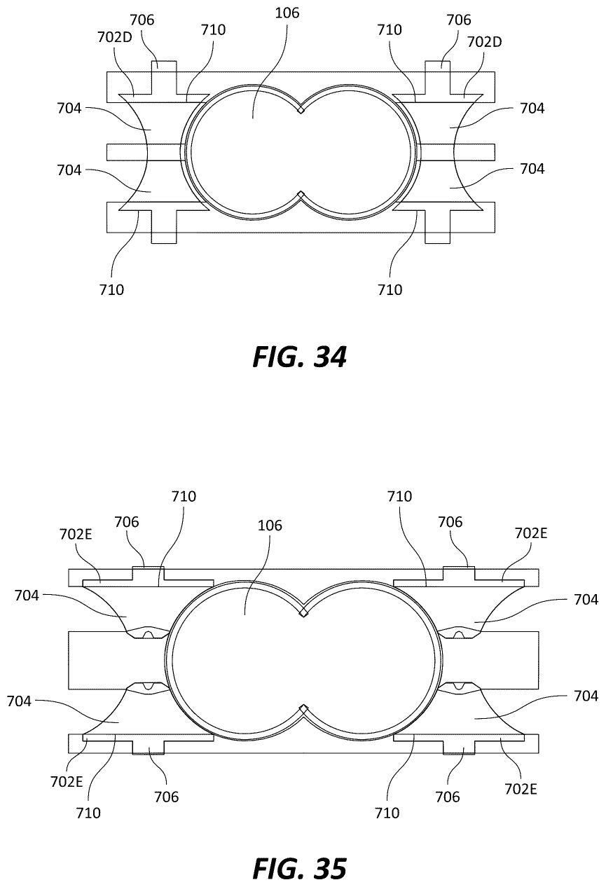

FIG. 31 illustrates a set of cylindrical rotary valves 702. As illustrated, the cylindrical rotary valves 702 being positioned alongside of a cylindrical or double-C shaped cylinder bore 106 results in a significant deadspace DS between each of the valve bodies 704 and the cylinder bore 106. Accordingly, to reduce the deadspace DS, the valve bodies 704 can have a conical shape (see FIG. 32), a multi-faceted conical shape (see FIG. 33), an hourglass shape (see FIG. 34) or a split tailored shape (see FIG. 35). Each of the shapes further reduces the amount of deadspace between the valve body 704 and the cylinder bore 106. The multi-faceted conical shape can comprise two or more portions with differing slopes to somewhat approximate the curve of the wall of the cylinder bore 106.

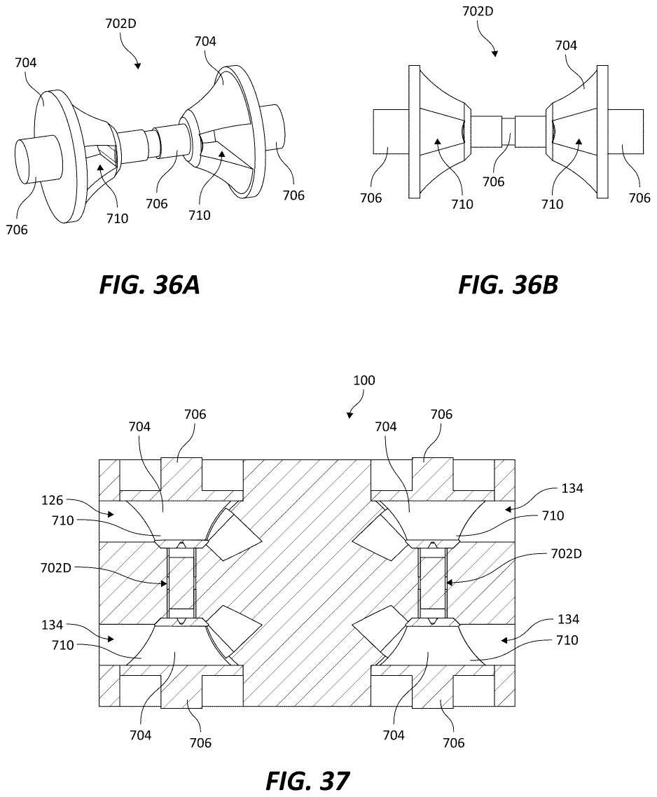

FIGS. 36A and 36B illustrate additional views of a rotary valve 702 wherein the valve bodies 704 comprise an hour glass shape. As shown, the valve bodies 704 are mounted on valve shaft 706 and include an opening or passage 710 formed therethrough to permit airflow therefrom. As shown in FIGS. 36A and 36B, the hourglass shape of the valve bodies can include a curved surface. Use of a curved surface and hourglass shape can facilitate manufacturing and/or improve tolerances because the valve body 704 can be lapped in to the cylinder bore or housing producing substantially corresponding surfaces as shown in FIG. 37.

As discussed above, two rotary valve bodies 704 can be formed as a single component on a single shaft 706 or two rotary valve bodies 704 can be formed as two separate components with each having a separate shaft 706. In some configurations, particularly when separate shafts are provided, the valve body 704 can be lapped in position such that the fit between the profile of the valve body 704 and the wall that defines the cylinder bore (in particular, the slit or opening 712 in the wall) can be customized for a better fit. Such a lapped shape can help to reduce leakage in the region between the valve body 704 and the opening 712. Other components, such as seals and the like, can also be used to reduce leakage out of the cylinder bore 106 into the intake passage 126 and the exhaust passage 134 through the rotary valve subassemblies 700.

Standard cylindrical rotary valves that rotate in standard cylindrical housings have geometry such that when the cylindrical valve expands radially, such as may happen with valve heating, this may decrease the valve to housing clearances and may even cause friction or wear. In addition, standard cylindrical rotary valves in cylindrical housings have geometry such that, if the cylindrical valve shrinks radially, as may happen with valve cooling, then the valve to housing clearances may increase. Both of these possible increases or decreases in valve-to-housing clearances cannot in standard cylindrical valves in cylindrical housings be addressed by using axial movements of the valves with respect to the housing. In contrast, the illustrated valve shapes, which may have a larger diameter at one end and a smaller diameter at the other end, and which rotate in complementary housings, have geometry that allows for small axial movement of the valve(s) in the valve housing(s). The small axial movement causes a decrease or increase in valve clearances dimensions. This small axial movement may be passive or active. In some configurations having active movement, the movement may be actuated using mechanical linkages, electromagnetic forces, or hydraulic fluid pressure changes. These small axial translations of the valve(s) relative to the housings(s) may increase or decrease valve to valve body clearances.

Where the valve bodies 704 are capable of axial movement relative to each other, the rotary valves 702 can better accommodate thermal expansion. In other words, as different elements change temperature, the valve bodies 704 can be adjusted to maintain a desired gap or positioning relative to the respective openings 712. Such an adjustment can help to maintain a desired clearance such that a desired level of sealing can be achieved between the valve bodies 704 and the respective openings 712. In some such configurations, the axial position of the valve bodies 704 can be adjusted either independently of each other or together with each other. In some configurations, oil pressure on each axial end of the valve bodies 704 or on the valve shaft 706 can be adjusted to cause slight axial movement in either direction. In some configurations, a forked member can be used to allow rotational movement of the valve bodies 704 while facilitating control of an axial position of the valve body 704. Other configurations also can be used.

FIGS. 38A-40 schematically illustrate configurations of crankshafts 812, camshafts 846, and output shafts 813. FIGS. 38A-38C all relate to an embodiment where four crankshafts 812 (shown in FIGS. 38B and 38C) are arranged in two distinct pairs, with the pairs being separated from each other and each pair including a timing gear 815 that couples the pair to the output shaft 813. FIGS. 39A-39C all relate to a similar embodiment, except that each of the four crankshafts 812 is directly engaged or in mesh with two adjacent crankshafts 812, such that the four crankshafts form a continuous chain. FIGS. 38A and 38B show camshafts 846, timing gears 815, and an output shaft 813 that can be used with the crankshaft 812 arrangements shown in FIGS. 38B and 39B. FIGS. 38C and 39C show an assembled configuration of the camshafts 846, timing gears 815, and an output shaft 813 of FIGS. 38A and 39A together with the crankshaft configurations of FIGS. 38B and 39B. FIG. 30 shows a perspective view that can be similar to the arrangements shown in FIGS. 38A-39B.

With reference first to FIG. 38A, an arrangement of camshafts 846, timing gears 815, and an output shaft 813 is illustrated. As shown in the illustrated embodiment, the camshafts 846 are each engaged (e.g., in mesh with) with a corresponding timing gear 815. Each timing gear 815 is then engaged (e.g., in mesh with) the output shaft 813. While this description indicates that these components can be engaged with each other via meshed gears. Other coupling mechanisms are possible. For example, the gears can be replaced with pulleys and belts. As shown in FIG. 38A, engagement of the camshafts 846, timing gears 815, and the output shaft 813 can all occur within a single plane. However, this need not be the case in all embodiments.

FIG. 38A also illustrates that the camshaft 846 can be engaged with the timing gear 815 via a gear 817 mounted on and rotationally fixed with respect to the camshaft 846. The timing gear 815 can be mounted on one of the crankshafts 812 such that the timing gear 815 and crankshafts 812 rotate together at the same speed. A gear ratio between the timing gear 815 and the gear 817 of the crankshaft 812 can be selected to relate the rotational speed of the camshaft 846 and the crankshafts 812. For example, in the illustrated embodiment, the gear 817 of the camshaft 846 is twice as large as the timing gear 815 such that it requires two revolutions of the crankshafts 812 and timing gear 815 to cause one rotation of the camshaft 846. This can be useful for providing valve timing associated with the camshaft 846.

FIG. 38A also illustrates that the output shaft 813 can include a gear 819 mounted thereon and rotationally fixed thereto. The gear 819 can be engaged with (e.g., in mesh with) the timing gear 815. A gear ratio between the timing gear 815 and the gear 819 of the output shaft 813 can be selected to relate the rotational speed and/or torque of the output shaft 813 and the crankshafts 812.

FIG. 38B shows an arrangement of crankshafts 812. As noted above, in the illustrated configurations, the crankshaft 812 are arranged in two distinct pairs, with the pairs being separated from each other. That is, each pair of crankshafts 812 includes a first crankshaft 812a and a second crankshaft 812b. The first crankshaft 812a is engaged (e.g., in mesh with) the second crankshaft 812b such that they rotate together, albeit in opposite directions. In the embodiment of FIG. 38B, the two pairs of crankshafts are separated from each other (e.g., not directly engaged with each other). While this description indicates that these components can be engaged with each other via meshed gears. Other coupling mechanisms are possible. For example, the gears can be replaced with pulleys and belts.

FIG. 38C shows an assembled configuration of the camshafts 846, timing gears 815, and an output shaft 813 of FIG. 38A together with the crankshaft configurations of FIG. 38B. As shown in this figure, the timing gears 815 are each coupled to (e.g., mounted on and rotationally fixed with respect to) the first crankshafts 812a, such that the timing gears 815 and first crankshafts 812a rotate together. FIG. 38C also illustrates that the camshafts 846, timing gears 815, and output shaft 813 are all engaged with each other in a common plane, while the crankshafts 812 are engaged with each other in a different plane.

FIGS. 39A-39C show an arrangement similar to that of FIGS. 38A-38C except that, as shown in FIGS. 39B and 39C, the four crankshafts 812 are engaged with each other. That is the pairs of crankshafts 812 are engaged with each other.

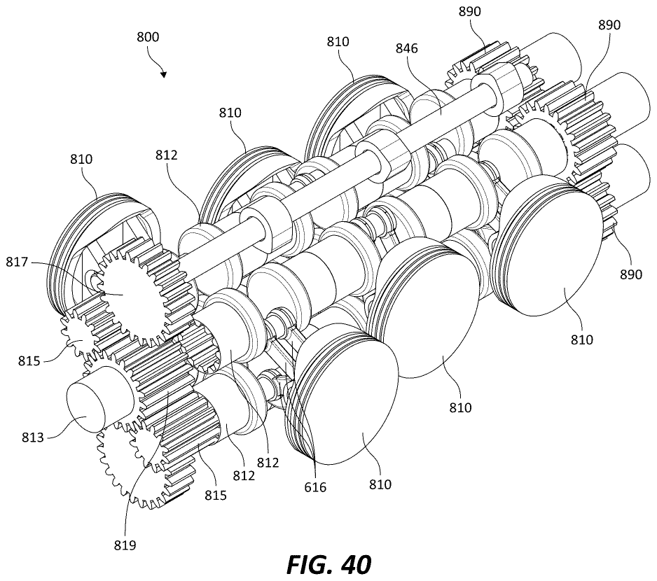

In FIG. 40A, the pistons 810 are illustrated as circular-shaped pistons. In other embodiments, other shapes of pistons can be used. Circular-shaped pistons generally have an outer wall that is cylindrical along at least a portion of its length and/or a cross-section that is circular.

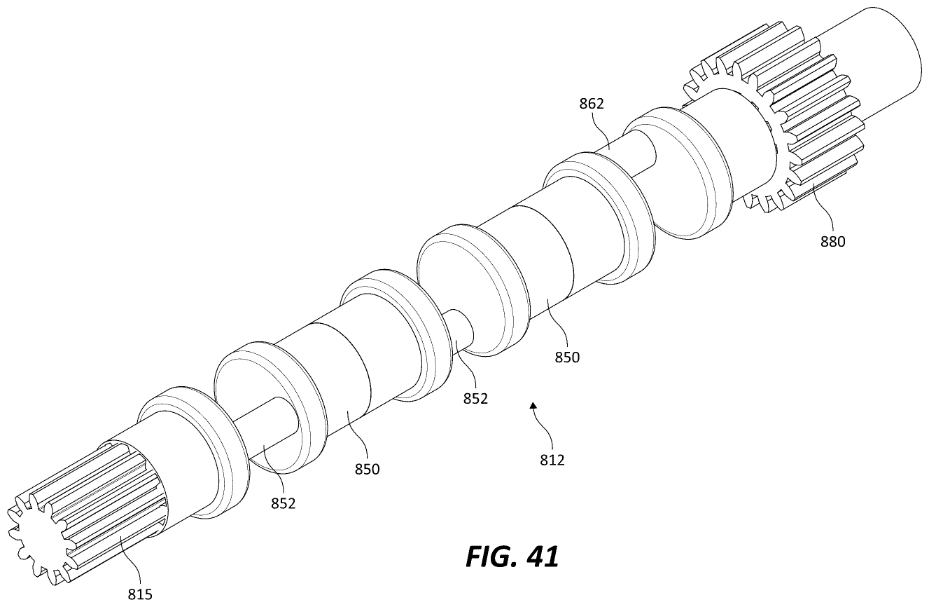

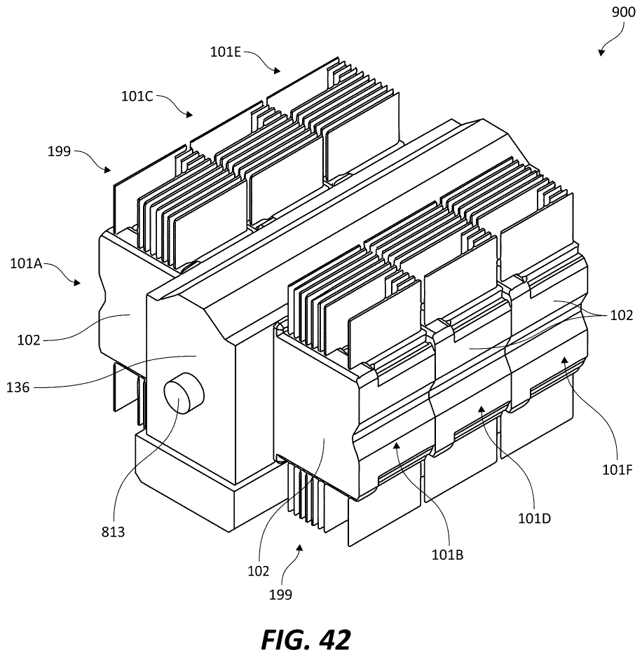

FIGS. 42-45 show various engine assemblies and sub-assemblies. With reference first to FIG. 42, an embodiment of an internal combustion engine 900 is shown. As described herein, the modular nature afforded by the uniblock design facilitates engines of a multitude of constructions. The internal combustion engine 900 has a modular construction including six engine assemblies 101A-101F (collectively referred to as the “engine assemblies 101”). Each of the engine assemblies 101 includes a separate uniblock 102. The uniblocks 102 are coupled to the housing 136 to form the internal combustion engine 900. The housing 136 is centrally located between pairs of engine assemblies 101. For example, the first engine assembly 101A is disposed on a first side of the housing 136 and the second engine assembly 101B is disposed on an opposite second side of the housing 136 (see e.g., a similar arrangement in the internal combustion engine 100 of FIG. 1).

While six engine assemblies 101 are shown in FIG. 42, it is recognized that the internal combustion engine 900 can include any number of engines assemblies 101. Generally, each engine assembly 101 provides at least one combustion cylinder for the internal combustion engine 900. Accordingly, the number of engines assemblies 101 included in the internal combustion engine 900 can be selected for the desired output of the internal combustion engine 900. Any of the internal combustion engines described herein can be modularly configured in a similar manner as the internal combustion engine 900.

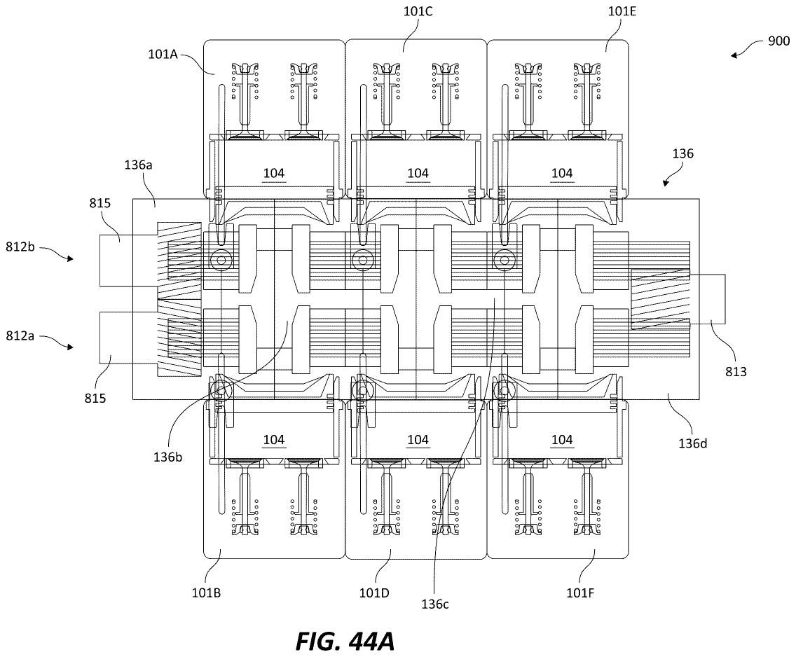

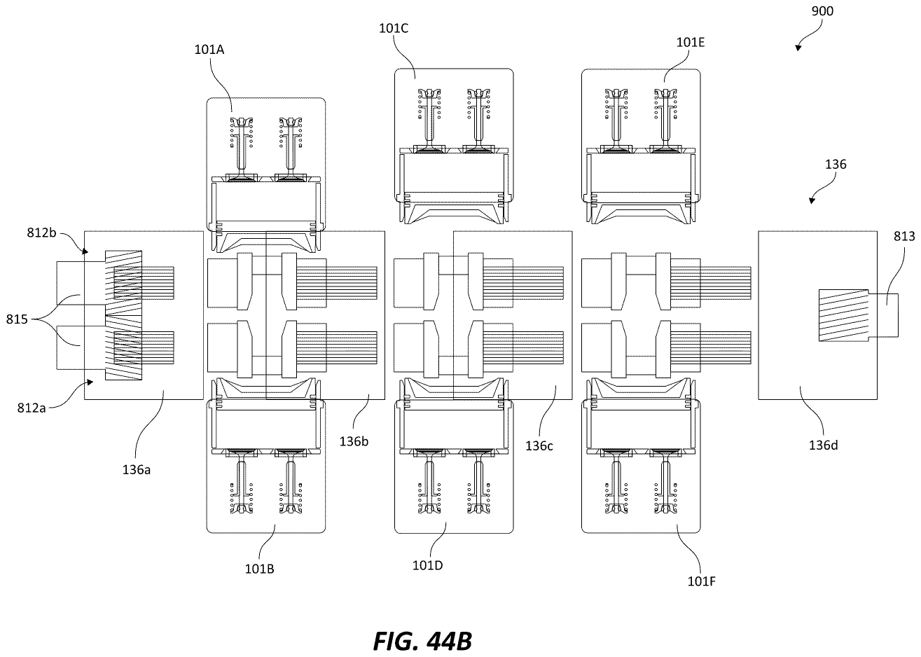

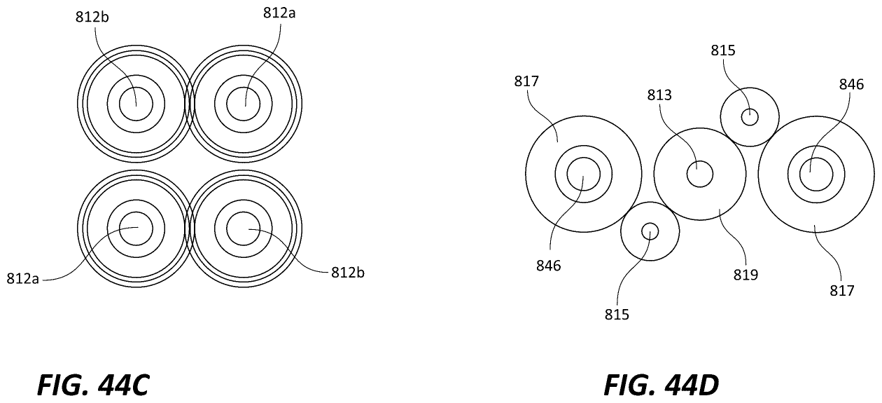

In some configurations, the internal combustion engine 900 can be configured to have a variable number of engine assemblies 101. For example, the number of engine assemblies 101 in the internal combustion engine 900 can be changed, depending on the desired performance or use of the internal combustion engine 900. To facilitate the variability, the housing 136 can be segmented into sub-housing sections, and additional housing sections can be added when desired. For example, as shown in FIGS. 44A and 44B, the housing 136 can comprise four sub-housing sections 136a-136d. If additional engine assemblies 101 are desired, additional sub-housing sections can be coupled to the existing sub-housing sections 136d-136d and further engine assemblies 101 can be added to the internal combustion engine 900. Similarly, if a smaller engine is desired, one or more of the sub-housing sections 136a-136d and associated engine assemblies 101 can be removed from the internal combustion engine 900. The crankshafts 812 in the internal combustion engine 900 can also be modular in some configurations, as described further with reference to FIG. 45.

Having a modular internal combustion engine 900 can provide a number of advantages. In one example, having removable subcomponents, such as the engine assemblies 101, can allow for damaged or worn components to be easily replaced as required. If a portion of an engine assembly 101 is damaged, the entire engine assembly 101 can be removed and replaced with a new engine assembly 101. This arrangement can facilitate quick repairs, which is desirable in some use cases. In another example, the modular internal combustion engine 900 can allow for a variable number of engine assemblies 101 to be included in the internal combustion engine 900, as described above. In yet another example, the modular internal combustion engine 900 can allow for engine assemblies 101 with different characteristics to be utilized in the internal combustion engine 900. For example, engine assemblies 101 with different sized pistons (e.g., variable stroke volume) can be utilized in the internal combustion engine 900 when desired.

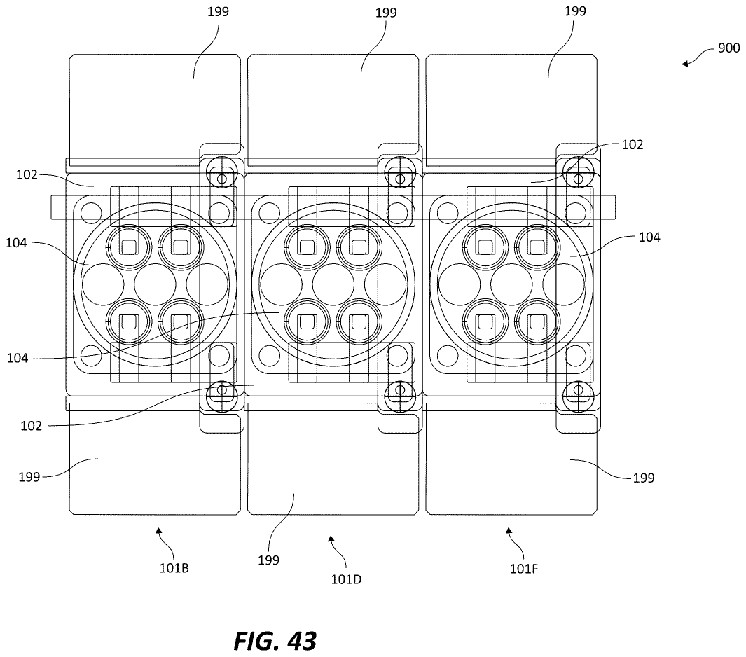

FIG. 43 shows an example side view of the internal combustion engine 900, with some components removed or shown as transparent for illustrative purposes. As shown in FIGS. 42 and 43, the internal combustion engine 900 can include one or more cooling components 199. In the illustrated example, the cooling components 199 comprise a plurality of fins 199. In other examples, the cooling components 199 can be cooling tubes, cooling plates, and/or the like. In the illustrated example, each engine assembly 101 includes a plurality of fins 199. The fins 199 can be disposed on one or both sides of the uniblocks 102 (e.g., the top and bottom in the orientation of FIG. 42). The fins 199 can be exposed to the environment outside of the internal combustion engine 900, allowing for air-cooling of the internal combustion engine 900 via the fins 199. The fins 199 can be used to prevent or at least reduce the likelihood of excess heat buildup in the combustion chambers 104 of the engine assemblies 101. The excess heat could otherwise result in damage to engine components or cause premature lubricant degradation. Additionally, regulating the temperature of the combustion chambers 104 can enable the use of lower cost lubricants (e.g., avoid the use of more expensive lubricants suitable for use at temperatures higher than those typically encountered in an internal combustion engine). Any of the engines described herein can utilize cooling components like the fins 199.

FIG. 44A shows a top partial-section view of the internal combustion engine 900 and FIG. 44B shows a partial-exploded-section view of the internal combustion engine 900, with certain components not shown or shown as transparent for illustrative purposes. Two crankshafts 812a and 812b are visible in FIGS. 44A and 44B, although in some embodiments, two similar crankshafts can be arranged below (e.g. into the page relative to the illustrated orientation) the two visible crankshaft such that the internal combustion engine 900 includes four crankshafts for examples, as described herein with reference to various four crankshaft configurations. As shown in FIG. 44B, various components of the internal combustion engine 900 can be configured to be removable from the internal combustion engine 900. For example, the housing 136 can comprise four sub-housing sections 136a-136d in the current configuration. In other configurations, the housing 136 can comprise more or less than four sub-housing sections. Similarly, the internal combustion engine 900 can include six removable engine assemblies 101 in the current configuration. In other configurations, the internal combustion engine 900 can include more or less engine assemblies 101.

When the internal combustion engine 900 is configured to be modular, various coupling mechanisms can be used between the subcomponents. For example, fasteners, alignment pins, and/or the like can be used to couple the subcomponents together. In some cases, seals may be used between different subcomponents of the internal combustion engine 900. For example, one or more seals may be disposed between the sub-housing sections 136a-136d. Advantageously, connections between adjacent modules are “low-pressure” (e.g., not exposed to forces associated with compression/combustion).

FIG. 44C shows a side view of the crankshafts 812 of the internal combustion engine 900 and FIG. 44D shows a side view of the camshaft 846 and output shaft 813 arrangement of the internal combustion engine 900. The internal combustion engine 900 can include either of the crankshaft configurations described with reference to at least FIGS. 38A-40C. In the illustrated configuration, the internal combustion engine 900 includes the same camshaft 846 and output shaft 813 arrangement as described with reference to FIGS. 38A-39C.

Referring now to FIG. 45, the internal combustion engine 900 can include modular crankshafts 812. FIG. 45 shows an exploded view of the first crankshaft 812a and the second crankshaft 812b. Each crankshaft 812 can include one or more shafts 856, one or more first crank portions 860, and one or more second crank portions 862. The first and second crank portions 860, 862 can form the main portions of the crankshaft (e.g., the main journals, webs, and crankpins). The shafts 856 can be used to couple the first and second crank portions 860, 862 together and/or to provide structural support and rigidity to the crankshafts 812.

In the illustrated configuration, the first crank portions 860 of the crankshafts 812 include a main journal 850 and a web 854. In the illustrated configuration, the second crank portions 862 of the crankshafts 812 include a main journal 850, a web 854, and a crankpin 852. The shafts 856 can be used to couple the first crank portions 860 to the second crank portions 862. For example, the main journals 850 can be configured to receive the shafts 856 via openings extending through the main journals 850 along the axis of the crankshafts. The shafts 856 can include splines and the openings in the main journals 850 can include spline guides. As such, the first and second crank portions 860, 862 are rotationally coupled together via the shafts 856.

As shown in FIG. 44A, when the crankshafts 812 are assembled, the crankpin 852 of the second crank portion 862 can abut the web 854 of the first crank portion 860. In some configurations, the webs 854 of the first crank portion 860 can include an opening for at least partially receiving the crankpins 852 of the second crank portions 862.

The number first and second crank portions 860, 862 in the crankshafts 812 can be varied, depending on the number of engine assemblies 101 (and associated pistons) included in the internal combustion engine 900. In the example configuration of FIG. 45, two pairs of first and second crank portions 860, 862 are shown, such that the crankshafts 812 could be used in an engine with four engine assemblies 101. An additional pair of first and second crank portions 860, 862 is used in the internal combustion engine 900 shown in FIG. 42.

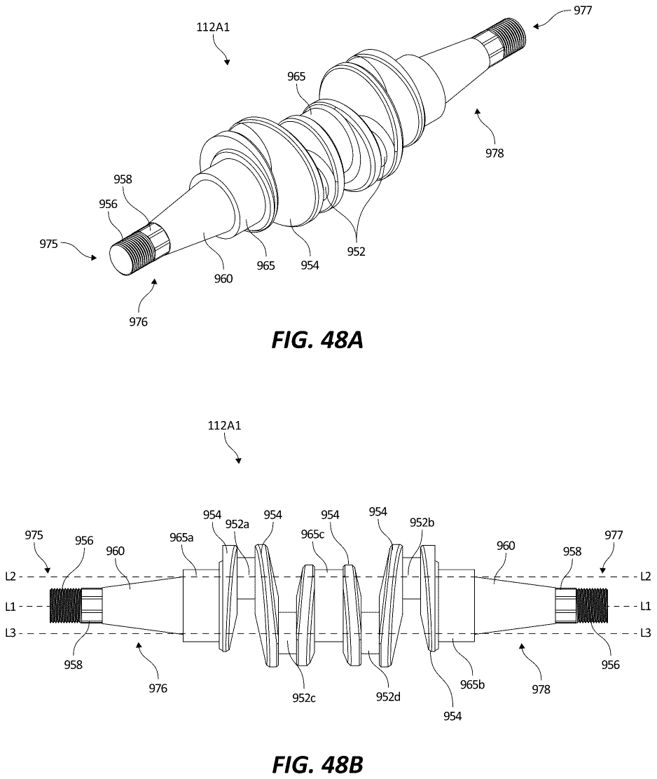

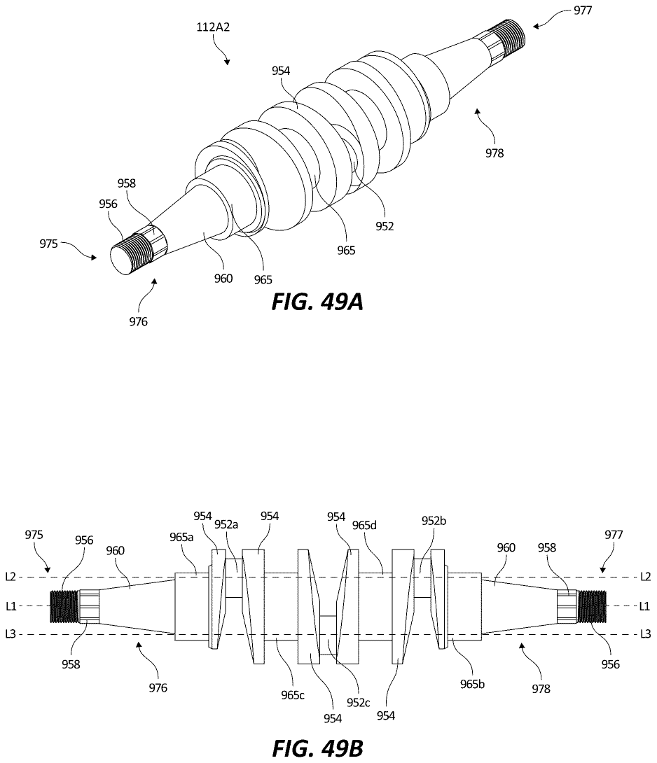

While a modular internal combustion engine 900 can provide certain advantages, examples of which are detailed above, the internal combustion engine 900 does not need to be modular. For example, in some configurations, the internal combustion engine 900 may not include any sub-housing sections. In another example, in some configurations, the internal combustion engine 900 may not include modular crankshafts 812 and may instead include solid single component crankshafts 812. Any of the crankshafts described herein (e.g., including the crankshaft 112A1, 112A2 of FIGS. 48A-49B) can have a modular construction, similar to the crankshafts 812, in some implementations.

Crankshafts are the primary rotating component in an internal combustion engine and are configured to convert the reciprocating motion of the piston(s) into rotary motion. The crankshafts include main journals which rotate within main bearings. The main journal and bearings are typically positioned at the ends of the crankshaft and between pairs of pistons. In a flat-plane crankshaft, the crank throws are 180-degrees apart from each other, such that pistons on paired journals are opposite each other. Accordingly, each piston pair includes pistons configured to reciprocate within their respective bores on opposite side of the crankshaft.

The crankshafts are connected to the piston(s) by connecting rods. Generally, internal combustion engines include a single crankshaft, with one connecting rod extending between each piston and the crankshaft. The piston is connected to the small end of the connecting rod by a wrist pin and the crankshaft is connected to the big end of the connecting rod by a crankpin of the crankshaft. The connecting rods are generally linear connections and can be aligned with the central axis of the bore the piston is reciprocating in when the piston is at top dead center and bottom dead center. The connecting rod can be connected to the wrist pin at the center of the piston, with the small end traveling along the central axis of the bore as the piston reciprocates.

Depending on the configuration, pistons reciprocating on opposite sides of the crankshaft can share a crankpin or can be coupled to adjacent crankpins that are separated by a web of the crankshaft. For example, pistons on opposite sides of the crankshaft in a 180-degree V configuration share a crankpin, with their respective connecting rods being coupled to the crankpin side-by-side. Because of this arrangement, the central axes of the bores are not perfectly aligned with each other, and some degree of offset is required. Additionally, the pistons cannot be opposed to each other because they share a crankpin. In another example, pistons on opposite sides of the crankshaft in a boxer configuration are each connected to a separate crankpin separated by a web. Because of this arrangement, the pistons can be opposed to each other, but the central axes of their respective bores cannot be aligned with each other. Having misaligned or offset paired bores introduces bending loads, torsional vibrations, and secondary forces on the crankshaft. To account for these issues, flat-plane crankshafts can be stiff and heavy, increasing the overall size and weight of the engine, which may not be desirable.

As described herein, the internal combustions engines of this disclosure can include two counter-rotating crankshafts, four counter-rotating crankshafts, or more the four counter-rotating crankshafts. Because of this arrangement, each piston can be connected to two crankshafts by at least two connecting rods (e.g., at least one connecting rod connected to one counter-rotating crankshaft and at least one connecting rod connected to the other counter-rotating crankshaft). These crankshaft configurations provide numerous advantages, as described herein. Additional advantages can be realized when the crankshafts are configured to allow at least one piston in a pair of opposite pistons to be connected to at least one of the crankshafts at more than one location. For example, a piston can be coupled to one crankshaft at multiple locations using multiple connecting rods or by configuring the connecting rod to allow for multiple connection points to one or more crankpins of the crankshaft.

One advantage of this configuration is that the central axes of opposing bores can be perfectly aligned. For example, opposing bores can share a central axis. This is because the opposite pistons do not need to share the same crankpins, or if the same crankpins are shared, the multiple connecting rods can allow for different piston connections without introducing offset. Having opposing bores with a shared central axis prevents or reduces the bending loads, torsional vibrations, and secondary forces on the crankshaft described above. As a result, the crankshafts can be smaller and lighter, resulting in a more efficient, smaller, and/or lighter internal combustion engine. Additionally, opposite pistons can be completely opposed to each other, resulting in a more balanced configuration.

Another advantage of this configuration is that the additional crankpins can allow the connecting rods for a pair of pistons to be distributed along the length of the crankshaft, which can reduce pistons rocking.

Another advantage of this configuration is that the crankshafts can include additional main journals and main bearings that are positioned in line with the reciprocating pistons. In some configurations, the crankshafts can be configured to have one or more than one main journal and bearing positioned between crankpins (and between the reciprocating pistons). These central main journals and bearings can allow for a stiffer crankshaft, which can be desirable. Additionally, the central main journals and bearings can improve the support for the crankshaft because the crankshaft is supported by the block of the engine at additional locations along its length. This arrangement can allow for forces to be pressed on either side of the central main bearing(s).

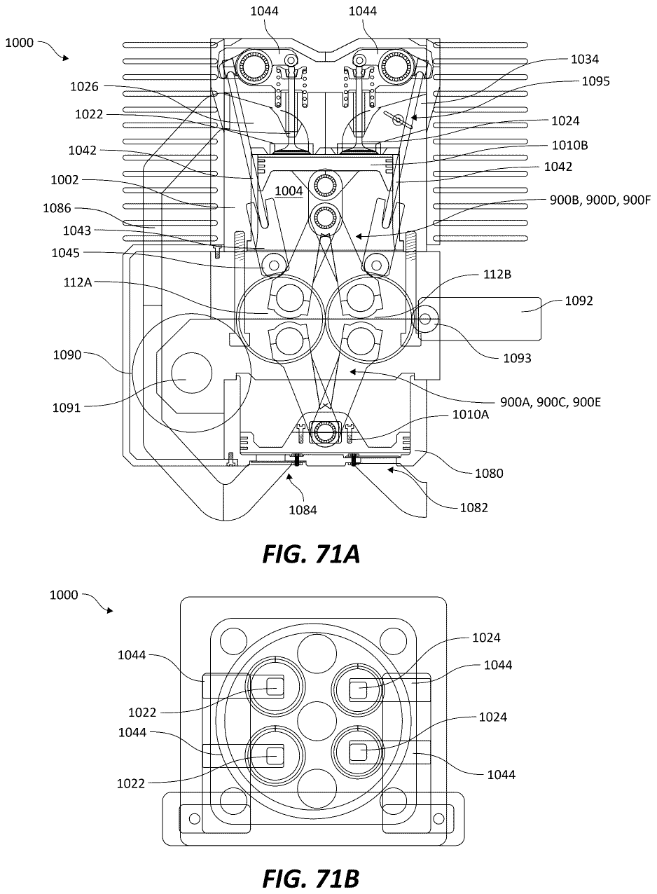

In some configurations, the additional crankpins and/or additional main journal(s) and bearing(s) can change the relative positions of the webs of the crankshafts. For example, the outer webs of the crankshafts can be out-of-plane of the reciprocating pistons. Because of this arrangement, the webs of the crankshafts can be utilized for other purposes, such as lifting push rods for valve operation, controlling fuel injectors, and/or the like. For example, the webs can function as cam lobes, can include cam lobes, or the crankshafts can include or be configured to receive removable cam lobes for operating pushrods. When utilized in this manner, additional camshafts for valves and/or secondary fuel injector shafts for the engine may not be required, reducing the total number of shafts in the engine. Having fewer shafts can decrease the weight, size, and/or complexity (e.g., part count) of the engine, which can be desirable. These configurations are described further herein with reference to at least FIGS. 71A-73.

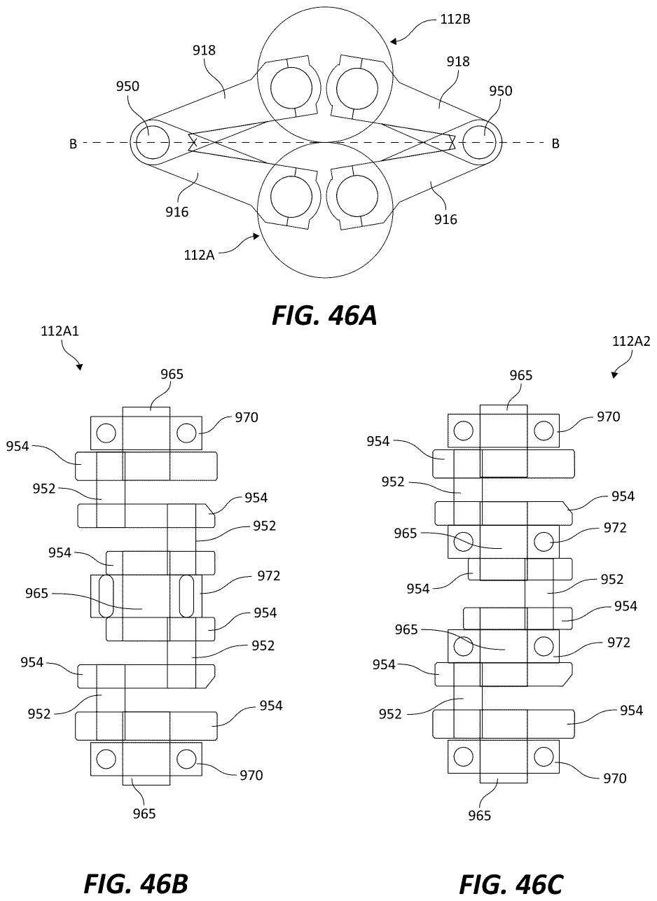

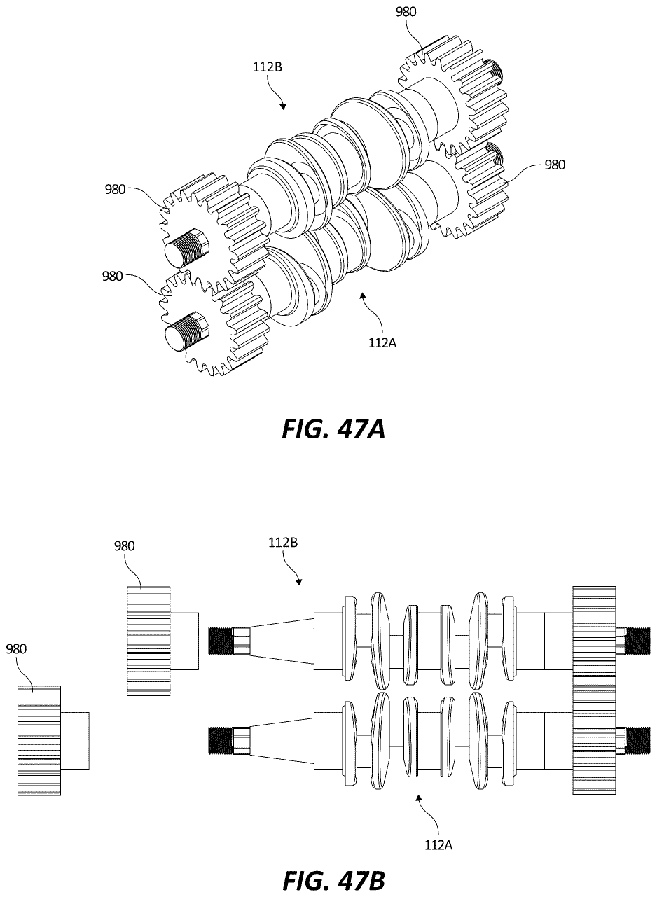

Referring now to FIGS. 46A-49B, embodiments of crankshafts that can be incorporated into any of the internal engines described herein are shown. FIG. 46A illustrates a side schematic view of a pair of counter rotating crankshafts and associate connecting rods and FIGS. 46B and 46C illustrate schematic top section views of embodiments of the crankshafts. FIGS. 47A and 47B show an example implementation of a pair of crankshafts corresponding to the arrangement of FIG. 46A, FIGS. 48A and 48B show isolation views of an example implementation of the crankshaft of FIG. 46B, and FIGS. 49A and 49B show isolation views of an example implementation of the crankshaft of FIG. 46C.

As shown in FIGS. 46A, 47A, and 47B, a first crankshaft 112A and a second crankshaft 112B can be in mesh with each other and configured to counter-rotate relative to each other. As shown in FIGS. 47A and 47B, the crankshafts 112A, 112B can be in mesh using gears 980. For example, each crankshaft 112A, 112B can include at least one gear 980. An example implementation of a gear 980 is described further with reference to at least FIGS. 50A-5C.

As shown in FIG. 46A, at least two first connecting rods 916 can be coupled to the first crankshaft 112A and at least two second connecting rods 918 can be coupled to the second crankshaft 112B when the crankshafts 112 are configured to be coupled to two opposed pistons. On each side of the crankshafts 112, the first connecting rods 916 and the second connecting rods 918 can be coupled to a wrist pin 950. The wrist pins 950 can be coupled to pistons (not shown) and/or counterweights (not shown). Throughout this disclosure, reference to opposing piston pairs or opposite pistons includes configurations where a piston is opposite a counterweight.

In the illustrated example, the wrist pins 950 are both aligned with and are configured to travel along a path defined by a central axis B-B. The central axis B-B can be the central axis of a pair of opposing bores in an engine. Accordingly, when the wrist pins 950 are coupled to pistons, the pistons can be completely opposed to each other.

FIG. 46B shows a schematic cross-sectional view of an embodiment of a crankshaft 112A1. When incorporated into an engine, two crankshafts 112A1 can be utilized in the configuration of FIG. 46A. For example, both the first crankshaft 112A and the second crankshaft 112B can be configured as the crankshaft 112A1.

The crankshaft 112A1 can include a plurality of main journals 965, main bearings 970, webs 954, and crankpins 952. The crankshaft 112A1 also includes a central main bearing 972. In the illustrated example, the crankshaft 112A1 is configured for two opposed pistons. In other embodiments, the crankshaft 112A1 can include additional main journals 965, main bearings 970, 972, webs 954, and crankpins 952 and can be configured to be coupled to additional piston pairs. For example, the crankshaft 112A1 can be sized for additional pistons.

The crankshaft 112A1 can be rotationally supported at the main journals 965 by the corresponding main bearings 970, 972. Each main journal 965 can be received within a main bearing 970, 972, with the main bearings 970, 972 being mounted in the block of an associated engine. The central main bearing 972 can differ from the other main bearings 970 in that the central main bearing 972 is configured to be positioned in line with the reciprocating pistons in the assembled engine. For example, one or more connecting rods can be positioned on either side of the central main bearing 972. In some embodiments, the central main bearing 972 can be larger (e.g., have a greater thickness) than the other main bearings 970.

The webs 954 can be positioned between and supported by the main journals 965. Some of the webs 954 can be directly coupled to a main journal 965, while other webs 954 can be positioned between adjacent webs 954 that are directly coupled to a main journal 965. The crankpins 952 can extend between adjacent webs 954 (e.g., a pair of adjacent webs). In the illustrated example of FIG. 46B, each crankpin 952 is positioned adjacent at least one main journal 965. Accordingly, each crankpin 952 can be positioned adjacent a portion of the crankshaft 112A1 directly supported by the block of the engine. Such a configuration can reduce the bending load on the crankpin 952.

In some embodiments, the crankshaft 112A1 can be configured for use with piston pairs where each piston is coupled to the crankshaft 112A1 at two locations. For example, the crankshaft 112A1 can include four crankpins 952, with two crankpins 952 being utilized for each piston. In some embodiments, two connecting rods can be coupled to each piston and each crankshaft 112A1. In other embodiments, one connecting rod with multiple crank-coupling points can be coupled to each piston and each crankshaft 112A1. Example embodiments of connecting rod and piston assemblies that can be used with the crankshaft 112A1 are shown in at least FIGS. 51, 54, 61, and 62.

Referring now to FIGS. 48A and 48B, a perspective view and a side view of an example implementation of the crankshaft 112A1 of FIG. 46B are shown in isolation. In the example of FIGS. 48A and 48B, the crankshaft 112A1 is configured for use with two opposed pistons. In other implementations, the construction of the crankshaft 112A1 can be extended to facilitate additional pairs of pistons.

The crankshaft 112A1 extends along a longitudinal axis L1-L1 that defines an axis of rotation of the crankshaft 112A1. The crankshaft 112A1 includes a plurality of main bearing journals 965 (“MBJs”) positioned along the longitudinal axis L1-L1. The crankshaft 112A1 further includes a plurality of crankpins 952 and a plurality of crank webs 954 (“webs”). In the illustrated configuration, each crankpin 952 extends between a pair of webs 954.

The crankshaft 112A1 can include a first shaft portion 976 that extends to and defines a first end 975 of the crankshaft 112A1 and a second shaft portion 978 that extends to and defines a second end 977 of the crankshaft 112A1.

In the illustrated example, the first shaft portion 976 includes a tapered portion 960 that extends along a length and has a varying diameter along its length. For example, the tapered portion 960 has a minimum diameter at the end closest to the first end 975. The diameter of the tapered portion 960 can increase moving away from the first end 975 and towards the second end 977. The tapered portion 960 can engage a portion of a gear (e.g., the gear 980 of FIGS. 50A-50C), in some examples, as described further herein.

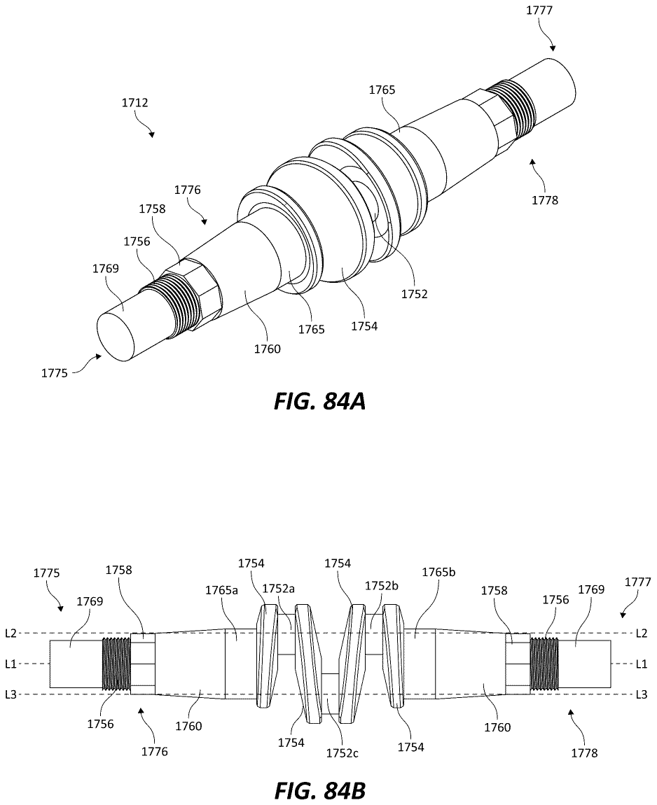

In some implementations, the tapered portion 960 can extend from or abut a first outer MBJ 965a. In other implementations, a non-tapered portion of the first shaft portion 976 may be positioned between the tapered portion 960 and the first outer MBJ 965a. In some implementations, a portion of the first shaft portion 976 may comprise or may be configured to support a cam lobe between the end 975 and the first outer MBJ 965a, similar to the crankshaft 1712 of FIGS. 84A and 84B. In such cases, the cam lobe may be used to actuate valves of an associated engine (e.g., via a pushrod).

In the illustrated example, the first shaft portion 976 further includes a registration portion 958 positioned between the tapered portion 960 and the first end 975. The registration portion 958 has a polygonal cross-section, in the illustrated example. The registration portion 958 may also interface with a portion of the gear 980. For example, the registration portion 958 can allow the rotational position of the crankshaft 112A1 to be changed relative to the gear 980 and any other crankshafts the crankshaft 112A1 is used in conjunction with.

The number of sides included in the registration portion 958 defines the number of rotational positions of the crankshaft 112A1 relative to the gear 980. For example, when the registration portion 958 has a hexagonal cross-section, the crankshaft 112A1 has six rotational positions relative to the gear 980. In another example, when the registration portion 958 has an octagonal cross-section, the crankshaft 112A1 has eight rotational positions relative to the gear 980. In other configurations, the registration portion 958 can have any other number of sides to define any number of rotational positions.

The first shaft portion 976 may include a threaded portion 956. The threaded portion 956 can be used to secure another component to the crankshaft 112A1, such as the gear 980 using a threaded collar, for example. The threaded portion 956 can extend from the registration portion 958. In other configurations, different coupling mechanisms known in the art can be used to secure the gear 980 to the crankshaft 112A1.

In the illustrated example, the second shaft portion 978 is configured in the same manner as the first shaft portion 976. For example, the second shaft portion 978 can be configured to support and engage another gear 980, as shown in FIGS. 47A and 47B. In other configurations, the second shaft portion 978 may be configured differently than the first shaft portion 976 and/or may not be configured to support a gear. For example, the second shaft portion 978 may be an output shaft of a system including the crankshaft 112A1.

As shown in FIG. 48B, the crankshaft 112A1 can include a first outer MBJ 965a and a second outer MBJ 965b. The first shaft portion 976 extends from the first outer MBJ 965a and the second shaft portion 978 extends from the second shaft portion 978 in the illustrated example. Each outer MBJs 965a, 965b can receive main bearings that can being mounted in the block of an associated engine, for example.

A central MBJ 965c can be positioned between the outer MBJs 965a, 965b. In the illustrated example, the central MBJ 965c is the only main journal between the outer MBJs 965a, 965b. In other configurations where the crankshaft 112A1 is configured to be coupled to multiple pairs of pistons, additional central MBJs 965c can be included.

As described with reference to FIG. 46B, the crankshaft 112A1 includes four crankpins 952, in the illustrated example. A first crankpin 952a and a second crankpin 952b can be aligned along a longitudinal axis L2. A third crankpin 952c and a fourth crankpin 952d can be aligned along a longitudinal axis L3. Each of the longitudinal axes L1, L2, L3 can be parallel to each other.

The third and fourth crankpins 952c, 952d can be positioned between the first and second crankpins 952a, 952b. This arrangement can allow the first and second crankpins 952a, 952b to couple a first piston to the crankshaft 112A1 and the third and fourth crankpins 952c, 952d to couple a second piston to the crankshaft 112A1, as described further herein. In some configurations, the longitudinal axis L2 and the longitudinal axis L3 can be 180-degrees rotationally offset from each other about the rotational axis L1 of the crankshaft 112A1. This arrangement can allow the first piston and second piston to be in an opposed configuration.

FIG. 46C shows an embodiment of a crankshaft 112A2. When incorporated into an engine, two crankshafts 112A2 can be utilized in the configuration of FIG. 46A. For example, both the first crankshaft 112A and the second crankshaft 112B can be configured as the crankshaft 112A2.

The crankshaft 112A2 can be configured in a similar manner as the crankshaft 112A1 and can include a plurality of main journals 965, main bearings 970, webs 954, and crankpins 952. The crankshaft 112A2 can differ from the crankshaft 112A1 in that that the crankshaft 112A2 can include at least two central main bearings 972. In the illustrated example, the crankshaft 112A2 is configured for two opposed pistons. In other embodiments, the crankshaft 112A2 can include additional main journals 965, main bearings 970, 972, webs 954, and crankpins 952 and can be configured to be coupled to additional piston pairs.

The crankshaft 112A2 can also differ from the crankshaft 112A1 in the arrangement of the webs 954 and crankpins 952, in part due to the additional central main bearings 972. For example, each web 954 can be positioned between and directly coupled adjacent main journals 965. Accordingly, each crankpin 952 can be positioned between two adjacent main journals 965. Such a configuration can provide improved support for the crankpins 952, because each crankpin 952 extends between a main bearing 970 and a central main bearing 972, which are the portions of the crankshaft 112A2 directly supported by the block of the engine.

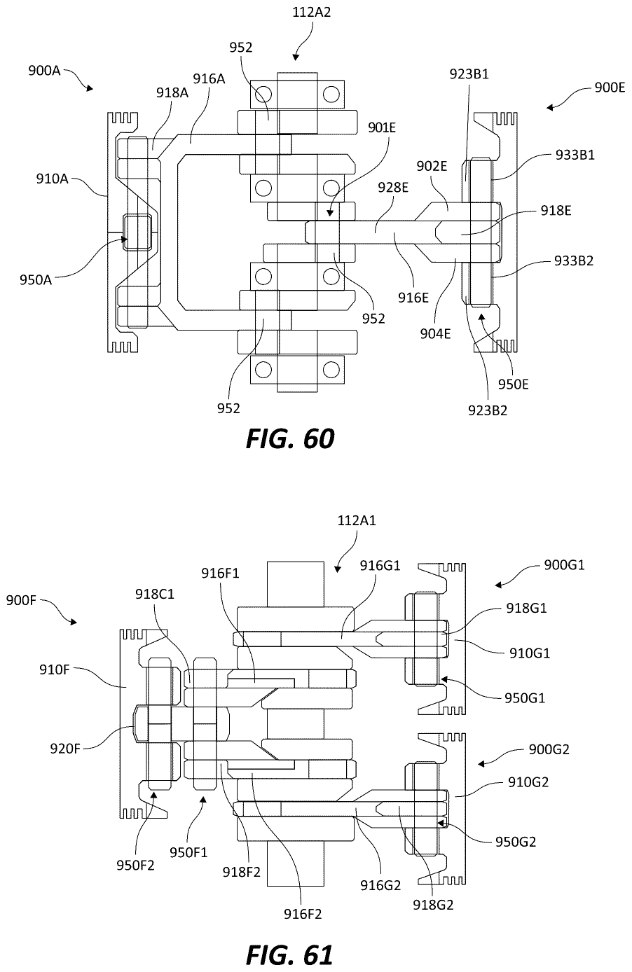

In the illustrated example, the crankshaft 112A2 includes three crankpins 952, with one crankpin 952 being centrally located along the length of the crankshaft 112A2. In some embodiments, the crankshaft 112A2 can be configured for use with piston pairs where at least one piston is coupled to the crankshaft 112A2 at two locations and the other piston is coupled to the crankshaft 112A2 at one location. For example, two crankpins 952 can be utilized for one piston, and the central crankpin 952 can be utilized for the opposite piston. Example embodiments of connecting rod and piston assemblies that can be used with the crankshaft 112A2 are shown in FIGS. 60 and 63.

In some embodiments, the outermost webs 954 (e.g., the web 954 closest to the bottom of the page and the web 954 closest to the top of the page) of the crankshafts 112A1, 112A2 can be utilized for other purposes, such as lifting push rods for valve operation, fuel injectors, and/or the like. For example, these webs 954 can function as cam lobes, can include cam lobes, or can be configured to receive removable cam lobes for operating pushrods.

In some embodiments, the webs 954 configured to drive push rods and/or fuel injectors can be configured to receive a cam lobe shaft. For example, these webs 954 can be shaped as a shaft, and another shaft with a cam lobe can be positioned on top off or adjacent those webs 954. In some embodiments, these webs 954 can function as a key and slot pair with the cam lobe shaft. For example, one or both of the webs 954 and the cam lobe shaft can include opening/slots that can be aligned and keyed together. This arrangement can allow for the positions of the lobe portion to be changed relative to the crankshaft for changing valve timing and/or duration. In some embodiments, the number of slots can vary between the webs 954 and the cam lobe shaft, to increase the number of combinations possible. For example, the webs 954 may include 20 slots and the cam lobe shaft may include 19 slots, or vice versa, allowing for 380 different positions, approximately 1-degree off from each other.

FIGS. 48A-48B illustrate, for example, a crankshaft 112A1 comprising a first main bearing journal, a second main bearing journal, and a third main bearing journal, a pair of crankpins positioned between the first main bearing journal and the second main bearing journal, and a pair of crankpins positioned between the second main bearing journal and the third main bearing journal, optionally wherein for each pair of crankpins a first crankpin is rotationally offset from the a second crankpin about a longitudinal axis of the crankshaft by a crankpin offset, optionally wherein the crankpin offset is 0 degrees, optionally wherein the crankpin offset is 60 degrees, optionally wherein the crankpin offset is 90 degrees, optionally wherein the crankpin offset is 120 degrees, optionally wherein the crankpin offset is 180 degrees. Other crankpin offsets are also possible.

Referring now to FIGS. 49A and 49B, a perspective view and a side view of an example implementation of the crankshaft 112A2 of FIG. 46C are shown in isolation. In the example of FIGS. 49A and 49B, the crankshaft 112A2 is configured for use with two opposed pistons. In other implementations, the construction of the crankshaft 112A2 can be extended to facilitate additional pairs of pistons.

Like the crankshaft 112A1 of FIGS. 48A and 48B, the crankshaft 112A2 extends along a longitudinal axis L1-L1 that defines an axis of rotation of the crankshaft 112A2. The crankshaft 112A2 also includes a plurality of MBJs 965 positioned along the longitudinal axis L1, a plurality of crankpins 952, and a plurality of webs 954. The first shaft portion 976 and the second shaft portion 978 of the crankshaft 112A2 can be configured in a similar manner as the shaft portions 976, 978 of the crankshaft 112A1, in some examples.

In the illustrated configuration, the crankshaft 112A2 differs from the crankshaft 112A1 of FIGS. 48A and 48B in that the crankshaft 112A2 includes two central MBJs 965c, and 965d and three crankpins 952 between the outer MBJs 965a, 965b. When configured for use with two pistons, the central MBJs 965c, and 965d and three crankpins 952 can be the only bearing journals and only crankpins between the outer MBJs 965a, 965b.

As shown in FIG. 49B, the first and second crankpins 952a, 952b extend along and can be aligned along the longitudinal axis L2 and the third crankpin 952c extends along the longitudinal axis L3. The longitudinal axis L2 can be 180-degrees offset form the longitudinal axis L3 about the rotational axis L1 of the crankshaft 112A2. Accordingly, one piston coupled to the crankshaft 112A2 can be coupled to the first and second cranks pins 952a, 952b while another opposed piston can be coupled to the crankshaft 112A2 by the third crankpin 952c. In the illustrated example, the third crankpin 952c is positioned between the first and second crankpins 952a, 952b.

FIGS. 49A-49B illustrate, for example, a crankshaft 112A2 that includes a first main bearing journal, a second main bearing journal, a third main bearing journal, and a fourth main bearing journal, a first crankpin positioned between the first main bearing journal and the second main bearing journal, a second crankpin positioned between the second third main bearing journal and the third fourth main bearing journal, and a third crankpin positioned between the third second main bearing journal and the fourth third main bearing journal, optionally wherein the first crankpin and the second third crankpin are aligned along a common axis and the second third crankpin is rotationally offset from the first and third second crankpins about a longitudinal axis of the crankshaft by a crankpin offset, optionally wherein the crankpin offset is 0 degrees, optionally wherein the crankpin offset is 60 degrees, optionally wherein the crankpin offset is 90 degrees, optionally wherein the crankpin offset is 120 degrees, optionally wherein the crankpin offset is 180 degrees. Other crankpin offsets are also possible.

Referring now to FIGS. 50A-50C, a perspective view, a side view, and a cross-sectional view of an embodiment of a crank gear 980 are shown. The gear 980 can be used with any of the crankshafts described herein to facilitate pairing and counterrotation of at least two crankshafts. For example, as shown in FIGS. 47A and 47B, a pair of gears 980 can be in mesh with each other to allow the crankshafts 112A, 112B to counter rotate with each other. For ease of description, the gear 980 is described for use particularly with reference to the crankshaft 112A1 of at least FIGS. 48A and 48B.

In the illustrated example, the gear 980 includes a gear body 982. The gear body 982 includes a plurality of teeth 983 extending circumferentially around the gear body 982. A bore 986 extends through the gear 980 from a first opening 991 on first side of the gear 980 to a second opening 993 on an opposite side of the gear 980. The gear 980 can be mounted on a crankshaft (e.g., the crankshaft 112A1) by inserting a shaft portion (e.g., the first shaft portion 976) of the crankshaft through the bore 986. In some configurations, a threaded collar can be used to secure the gear 980 to the crankshaft 112A1. In the illustrated example, the gear 980 includes a tubular hub 984 extending from the gear body 982. In other configurations, the tubular hub 984 may not be included.

In the illustrated example, the bore 986 has tapered side walls 988. The tapered side walls 988 allow the gear 980 to interface with the tapered shaft of a crankshaft the gear 980 is coupled to, such as the tapered portion 960 of the crankshaft 112A1. Utilizing a tapered bore 986 can provide a benefit of creating a wedging effect that produces a tight friction fit with the crankshaft 112A1. This configuration allows the gear 980 to transmit high torque reliably without slipping, distributes load evenly along the contact surface to reduce stress and wear, and/or ensures precise axial alignment. Additionally, the tapered bore 986 makes assembly and removal easier, as the gear 980 can be slid onto the crankshaft 112A1 and secured with minimal force, and later removed without damaging the gear 980 or crankshaft 112A1.

At least a portion of the bore 986 can be configured as a registration opening 990. The registration opening 990 can have a cross-sectional shape that corresponds to the cross-section shape of a registration portion of a crankshaft (e.g., the registration portion 958 of the crankshaft 112A1). For example, the registration opening 990 can have a polygonal cross-sectional shape. This configuration can allow the gear 980 to be coupled to the crankshaft 112A1 with the crankshaft 112A1 in a variety of rotational positions, as explained above.

As shown in FIGS. 47A and 47B, one or more gears 980 can be secured to one or more crankshafts 112 with a portion of the crankshafts 112 extending through the bore(s) 986. When both crankshafts 112A, 112B include a gear 980, the teeth 983 of each gear 980 can be in mesh. This arrangement allows the crankshafts 112A, 112B to counter rotate with each other.

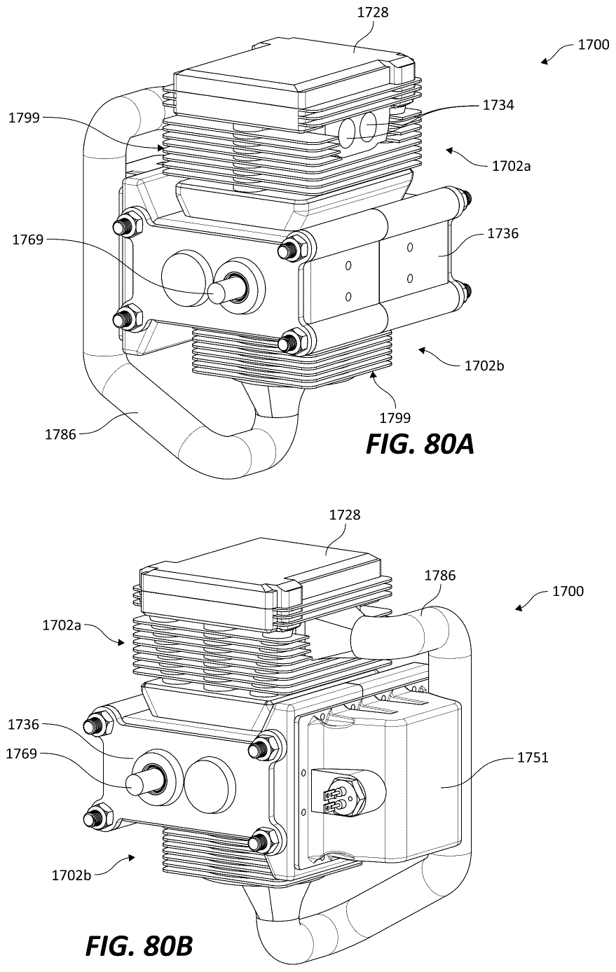

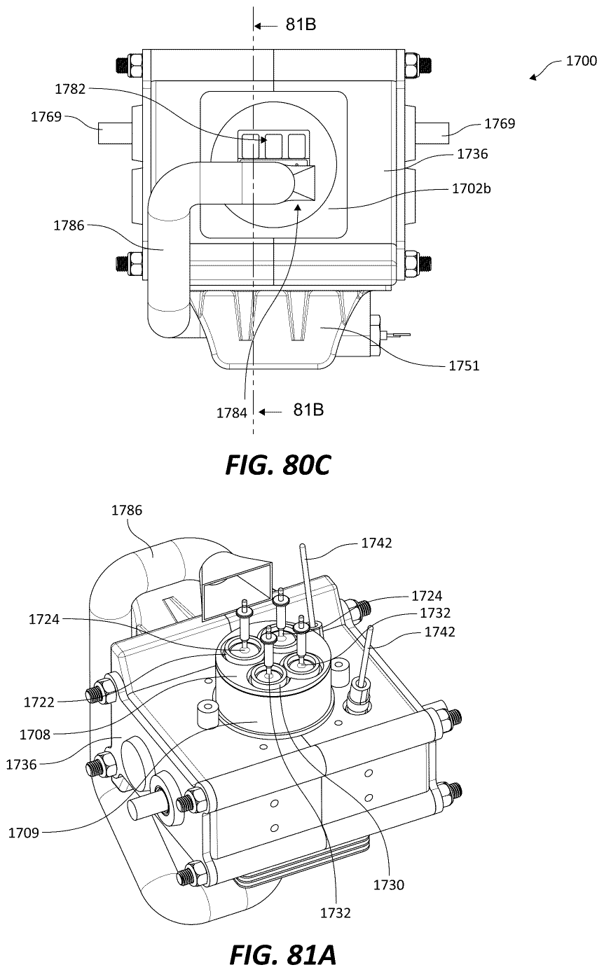

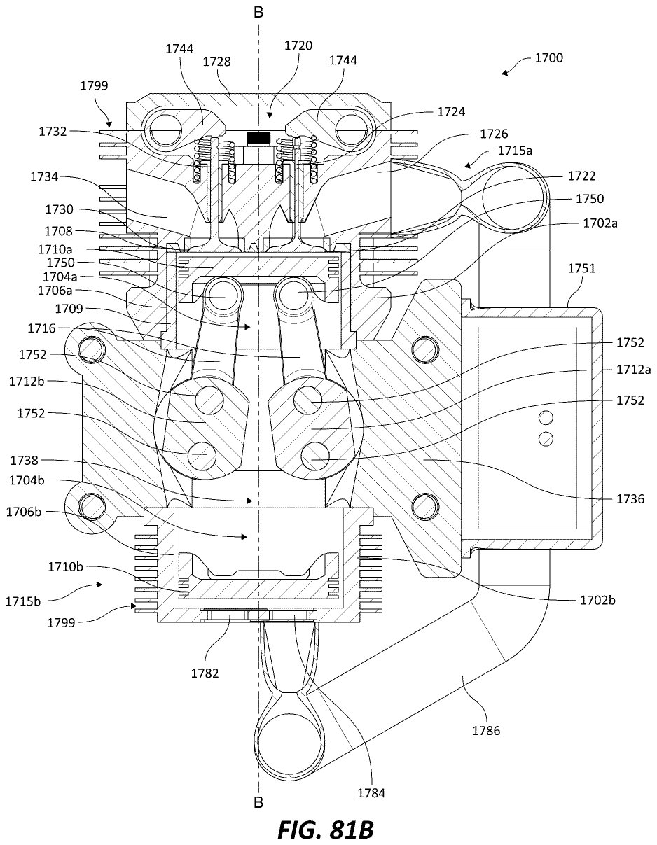

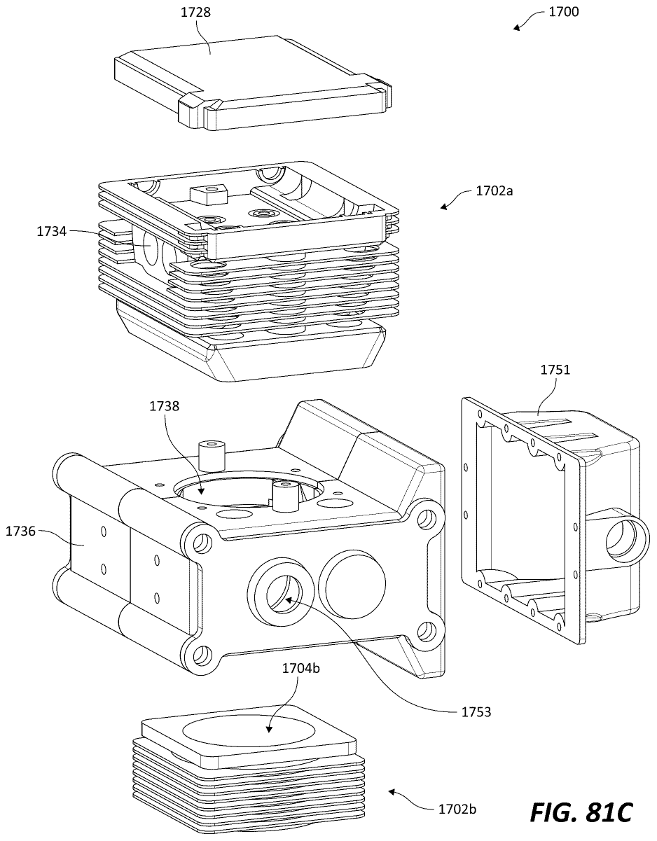

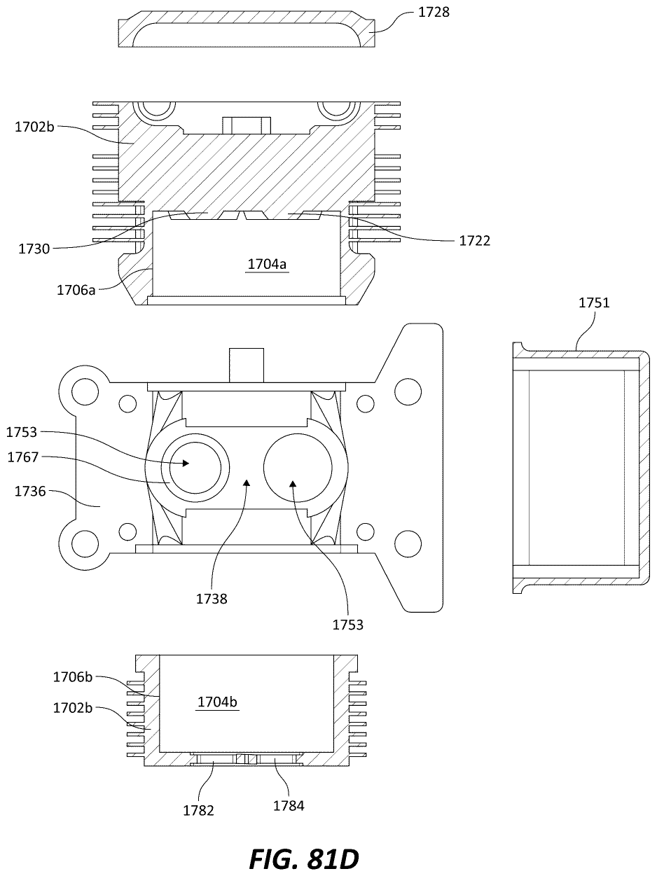

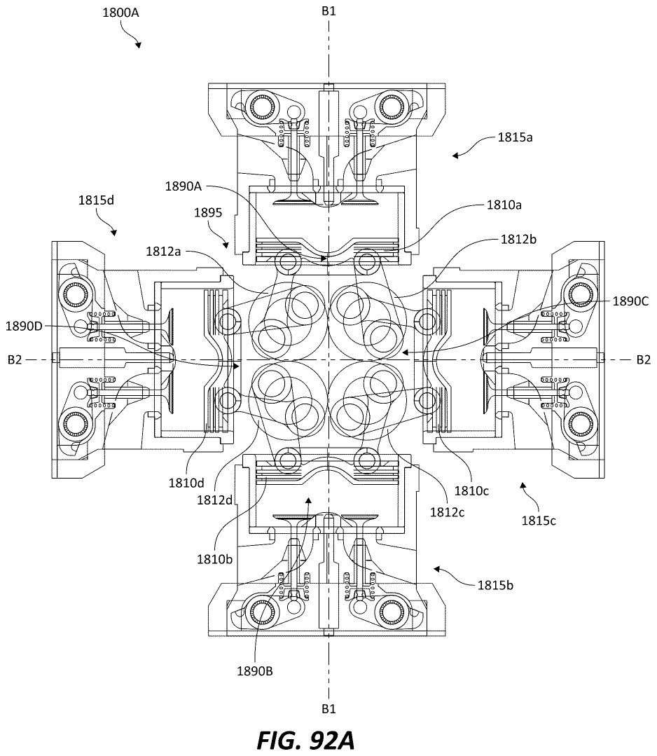

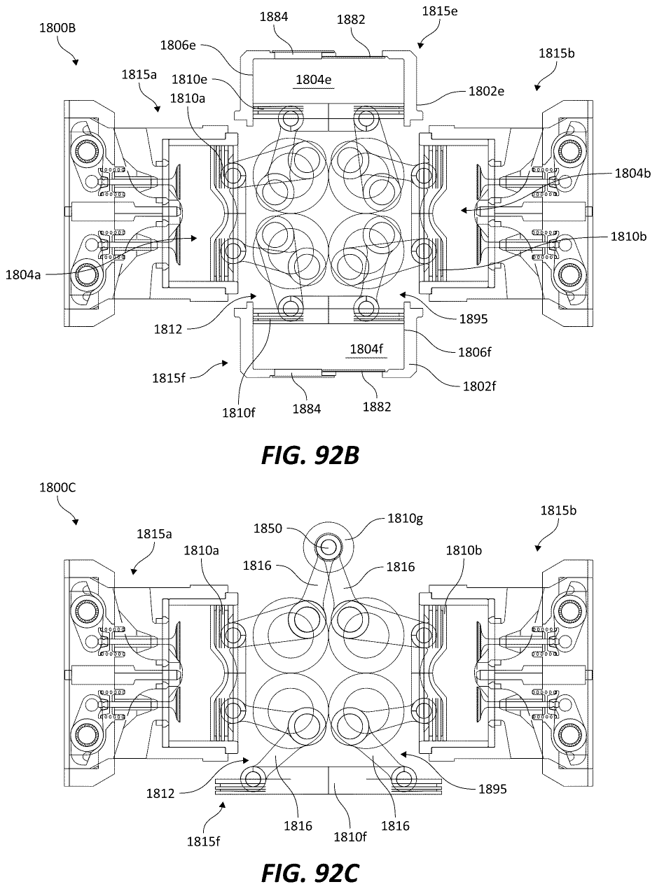

Referring now to FIGS. 51-63, various embodiments of connecting rod and piston assemblies that can be incorporated into any of the internal combustion engines described herein are shown. While the embodiments of FIGS. 51-63 are primarily described with reference to two-crankshaft configurations (e.g., the engine 100 of FIG. 1, the engine 1700 of FIGS. 80A-81D, etc.), it is recognized that the same or similar connecting rod and piston assemblies can be used in a four-crankshaft configuration (e.g., the engine 300 of FIG. 12, the engines of FIGS. 92A-92C, etc.), in a six-crankshaft configuration (e.g., the internal combustion engines of at least FIGS. 24-28), and/or any other engine with any number of crankshafts. As described further herein, some of the connecting rod and piston assemblies of FIGS. 51-63 incorporate translating wrist pins. Any of the connecting rod and piston assemblies of FIGS. 51-63 can incorporate the translating wrist pins and/or associated components described with reference to at least FIGS. 17A-20B.

In FIGS. 51, 54, and 60-63, the connecting rod and piston assemblies are shown on opposite sides and connected to the same crankshaft. The crankshaft can be one crankshaft in a pair of crankshafts 112 (as shown in FIG. 46A), can be one crankshaft in a four-crankshaft configuration, can be one crankshaft in a single crankshaft configuration, can be one crankshaft in an engine configured for more than four-crankshafts, and/or the like. In a four-crankshaft arrangement, the connecting rod and piston assemblies on opposite sides of the illustrated crankshaft in FIGS. 51-63 would generally be connected to different crankshafts. In FIGS. 41-63, the connecting rod and piston assemblies are shown connected to one of the embodiments of the crankshafts 112A1, 112A2. However, any of the connecting rod and piston assemblies can be used with either of the crankshafts 112A1, 112A2.

The connecting rod and piston assemblies on opposite sides of the crankshaft can be configured to have the same reciprocating mass. For example, the crankshaft can be connected to reciprocating assemblies on opposite sides that are balanced with each other. Having balanced reciprocating assemblies provides benefits, including improved engine smoothness, longevity, and performance.

In any of the configurations of FIGS. 51-63, the pistons on opposite sides of the crankshaft can both be combustion pistons, can both be auxiliary pistons, or one or more can be configured as a combustion piston(s) while the other one or more are configured as an auxiliary piston(s). Further, in any of the configurations of FIGS. 51-63, the pistons can be circular-shaped, oval-shaped, double-c-shaped, and/or the like. Oval-shaped pistons generally have an outer wall that is oval-shaped along at least a portion of the wall. For example, oval-shaped pistons can have an oval-shaped cross section.

With reference first to FIG. 51, an embodiment of a connecting rod and piston assembly 900A and an embodiment of a connecting rod and piston assembly 900B are shown schematically. The assemblies 900A, 900B are shown as connected to the same crankshaft 112A1. The connecting rod and piston assembly 900A can include a first piston 910A. The connecting rod and piston assembly 900B can include a second piston 910B. In the illustrated example, the first piston 910A is configured as an auxiliary piston and the second piston 910B is configured as a combustion piston.

The connecting rod and piston assembly 900A can include the first piston 910A, a first connecting rod 916A, one or more second connecting rod(s) 918A, and a wrist pin 950A. The first connecting rod 916A can be configured to connect the first piston 910A to the crankshaft 112A1, which can be the first crankshaft 112A of FIG. 46A. The second connecting rod(s) 918A can be configured to connect the first piston 910A to another crankshaft 112A1, which can be the second crankshaft 112B of FIG. 46A. The wrist pin 950A can be used to couple the connecting rods 916A, 918A to the first piston 910A. An example implementation of the piston 910A, and the connecting rods 916A, 918A is shown in an exploded view of FIG. 52A. An implementation of the connecting rod 916A is shown in FIG. 52B and described further below.

In the illustrated embodiment, the piston 910A comprises an upper portion 921A and a lower portion 923A. The upper portion 921A and the lower portion 923A can be coupled together with fasteners (e.g., bolts) or by other fastening methods of mechanisms. In other embodiments, the piston 910A may comprise a single part or more than two portions (e.g., three or more portions) that are assembled together to form the piston 910A.

In the illustrated embodiment, the piston 910A has an opening 933A. The opening 933A can be configured to receive the wrist pin 950A. The opening 933A can be formed in one or both of the upper portion 921A and the lower portion 923A. As shown in FIG. 52A, the opening 933A can be at least partially defined by the lower portion 923A, in some examples.

In some embodiments, the opening 933A can be machined into the bottom of the upper portion 921A. In such embodiments, the lower portion 923A can be a cap portion coupled to the bottom of the upper portion 921A. In some embodiments, the opening 933A may be circular shaped, for easier machining. In other embodiments, the opening 933A can be rectangularly shaped or can have any other suitable shape.

In the illustrated example, the wrist pin 950A is configured as a translating wrist pin. In some embodiments, the wrist pin 950A can be configured to interface with an insert received within the opening 933A, like the insert 452a of the piston assembly 400A of FIGS. 17A-17C.

In the illustrated embodiment, the upper portion 921A and the lower portion 923A can be coupled together to form the opening 933A. For example, the upper portion 921A and the lower portion 923A can be assembled around the wrist pin 950A. In other embodiments, the piston 910A can form a continuous structure with the opening 933A formed therethrough. In such embodiments, the wrist pin 950A can be slid into the opening 933A during assembly.

The wrist pin 950A can comprise a translating portion 972A and a shaft portion 973A. The translating portion 972A can be coupled to the shaft 973A. In some embodiments, the translating portion 972A and the shaft 973A can be integrally formed. In some embodiments, the shaft 973A can extend through the translating portion 972A. The translating portion 972A can be located at or near the longitudinal center of the shaft 973A. The translating portion 972A can be received within the opening 933A. The shaft 973A can be configured to be rotatably coupled to the connecting rods 916A, 918A.

The translating portion 972A can be any suitable shape. In the illustrated example, the translating portion 972A has a rectangular cross-section in the view of FIG. 51. The opening 933A can have a shape that corresponds to an outer shape of the translating portion 972A of the wrist pin 950A, or the insert when included. In the illustrated embodiment, the opening 933A comprises a rectangular opening. In this manner, the translating portion 972A can be closely received within the opening 933A of the piston 910A. As such, the translating portion 972A can be configured to allow for translation of the first piston 910A relative to the connecting rods 916A, 918A in at least one direction. For example, translation can occur in directions perpendicular to the central axis of the bore the piston 910A is received in.

In some embodiments, the opening 933A can be configured to include one or more bearing surfaces. For example, the opening 933A may include an upper bearing surface and/or a lower bearing surface. The bearing surfaces can be flat surfaces that can interface with flat surfaces of the translating portion 972A.

The lateral width of the opening 933A can be wider than the lateral width of the translating portion 972A of the wrist pin 950A, in some cases, such that the wrist pin 950A can move laterally along the width of the opening 933A. This arrangement allows the wrist pin 950A to move (e.g., laterally translate or displace) relative to the piston 910A. Such movement can help to accommodate lash between the counter-rotating crankshafts coupled to the piston 910A via the wrist pin 950A and connecting rods 916A, 918A, and/or to accommodate other imperfect tolerances in the system. Allowing for such linear movement of the wrist pin 950A relative to the piston 910A can facilitate smooth movement of the piston 910A within the bore and reduce binding and/or scraping of the piston 910A with the bore in which the piston 910A moves. For example, linear movement can increase engine performance and reduce friction, heat, and other inefficiencies. To provide for this lateral translation, in some embodiments, the lateral width of the opening 933A is greater than the lateral width of the translating portion 972A of the wrist pin 950A by a distance of at least 0.25 mm, 0.5 mm, 0.75 mm, 1.0 mm, 1.25 mm, 1.5 mm, 1.75 mm, 2.0 mm, or more.

The shaft 973A of the wrist pin 950A can be cylindrical. The shaft 973A can include an outer surface that is configured to extend through openings formed at ends each of the connecting rods 916A, 918A (e.g., pin bores). The outer surface of the shaft 973A can provide a bearing surface that interacts with a corresponding bearing surface of the connecting rods 916A, 918A (e.g., the pin bore itself or a bushing/bearing received therein). The shaft 973A provides a pivoting or rotational coupling between the wrist pin 950A and the connecting rods 916A, 918A. That is, the connecting rods 916A, 918A can pivot or rotate about the wrist pin 950A. The diameter of the shaft 973A can be less than the diameter or height of the opening 933A.

Although FIG. 51 illustrates the piston assembly 900A as not including an insert that is separate from the piston 910A, in some embodiments, the piston 910A can include an insert configured to provide the functionality of the opening 933A. For example, the opening 933A in the piston 910A can house an insert for receiving the translating portion 972A of the wrist pin 950A.

As shown in FIG. 51, the connecting rod 916A can be configured to connect to the crankshaft 112A1 at two locations. Accordingly, the connecting rod 916A can be configured as a dual-arm connecting rod. As shown in FIGS. 52A and 52B, the connecting rod 916A can include a first arm portion 902A and a second arm portion 904A. Each arm portion 902A, 904A includes a body 924A extending between a first end 901A and a second end 912A. For example, the arm portions 902A, 904A can be constructed in a similar manner as each other. For ease of reference, the features of the first arm portions 902A, 904A are described with particular reference to the first arm portion 902A. The first ends 901A allow the connecting rod 916A to be coupled to a crankshaft and may be referred to herein as the “big ends”. The second ends 912A allow the connecting rod 916A to be coupled to a piston and may be referred to herein as the “small ends”.

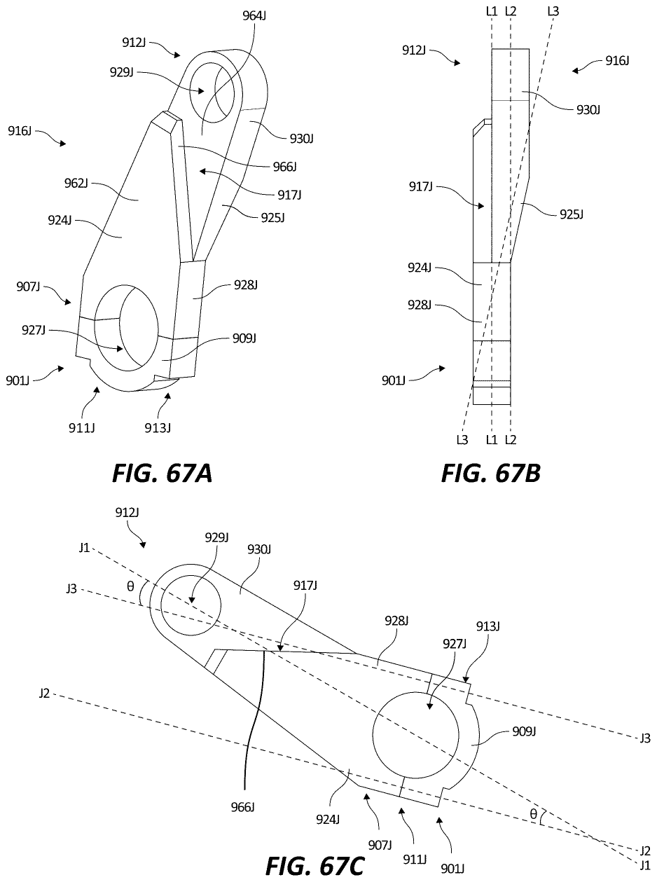

The ends of any connecting rod described herein that connect to a crankshaft (“the big ends”) can include a removable end cap (see e.g., the end cap 909J of the connecting rod 916J of FIGS. 67A-67C) to facilitate the connection. The end cap, when included, can at least partially define the big end of the associated connecting rod. The body of the associated connecting rod may extend to an end where it is coupled to the end cap. Together, the end of the connecting rod body and the end cap can define the big end.

The arm portions 902A, 904A can be joined together via a connecting or central portion 906A of the connecting rod 916A. The connecting portion 906A can extend between the first arm portion 902A and the second arm portion 904A. In the illustrated example, the connecting portion 906A extends in substantially the same direction as a longitudinal axis of the crankshaft 112A1. Accordingly, the connecting rod 916A can be stirrup- or c-shaped. The connecting portion 906A can connect the body 924A of the first arm portion 902A to the body 924A of the second arm portion 904A. The connecting portion 906A can maintain a set position of the first arm portion 902A relative to the second arm portion 904A.

Each of the arm portions 902A, 904A can include openings for coupling the connecting rod 916A to a piston (e.g., the piston 910A) and to a crankshaft (e.g., the crankshaft 112A1). For example, a crankshaft bore 927A extends through the first end 901A and a pin bore 929A extends through the second end 912A. The crankshaft bores 927A of each arm portion 902A, 904A can receive separate crankpins 952 of the crankshaft 112A1. The crankpins 952 coupled to the connecting rod 916A can be spaced apart along the length of the crankshaft 112A1. For example, when used with the crankshaft 112A1 of FIGS. 48A and 48B, the crankshaft bore 927A of the first arm portion 902A can receive the first crankpin 952a and the crankshaft bore 927A of the second arm portion 904A can receive the second crankpin 952b.

Because the connecting rod 916A includes two arm portions 902A, 904B, the connecting rod 916A can be configured to be coupled to the wrist pin 950A at two locations. For example, the connecting rod 916A can receive a portion of the wrist pin 950A in the pin bore 929A of the first arm portion 902A and another portion of the wrist pin 950A in the pin bore 929A of the second arm portion.

The crankshaft bores 927A and the pin bores 929A of the arm portions 902A, 904A can be axially aligned with each other. For example, a first bore axis B1 can extend through both crankshaft bores 927A and a second bore axis B2 can extend through both pin bores 929A. The connecting portion 906A can maintain the alignment by preventing relative movement between the first arm portion 902A and the second arm portion 904A.

As shown in FIG. 52B, the second ends 912A of the arm portion 902A, 904A can be spaced apart from each other relative to the longitudinal axis of the crankshaft 112A1 with a space therebetween. A portion of the piston 910A, such as the lower portion 923A, can be at least partially disposed within the space between the second ends 912A.

In the illustrated example, the body 924A includes an angled segment 925A between the first end 901A and the second end 912A. The angled segment 925A can be a bent portion of the body 924A. When included, the angled segment 925A allows the first end 901A to be offset from the second end 912A. For example, a first longitudinal axis A1 of the first end 901A is spaced apart but parallel to a second longitudinal axis A2 of the second end 912A. The first longitudinal axis A1 can be a normal axis of the crankshaft bore 927A and the second longitudinal axis A2 can be a normal axis of the pin bore 929A. A third longitudinal axis A3 of the angled segment 925A is at a non-zero angle relative to both the first longitudinal axis A1 and the second longitudinal axis A2.

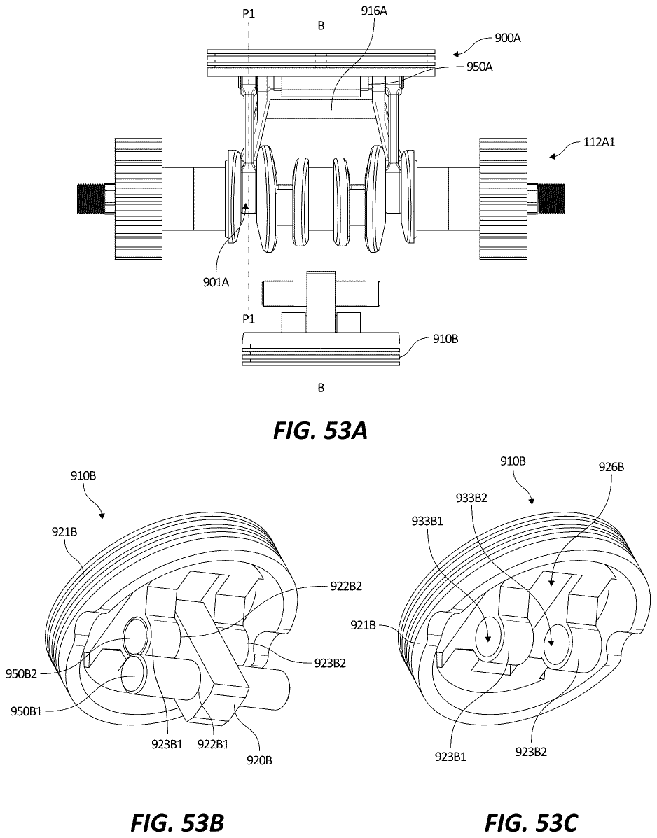

In the illustrated example, the angled segment 925A of the first arm portion 902A is angled inwardly towards the second arm portion 904A and the angled segment 925A of the second arm portion 904A is angled inwardly towards the first arm portion 902A. Accordingly, the distance between the second ends 912A is smaller than the distance between the first ends 901A. This arrangement can allow the connecting rod 916A to be coupled to the wrist pin 950A in positions adjacent to the connecting rods 918A while still allowing the first ends 901A of the connecting rod 916A to be aligned with the connecting rods 918A. For example, as shown in at least FIG. 53A, which shows the assembly 900A coupled to a pair of crankshafts 112A1, a plane P1 into the page can extend through the longitudinal axis of one connecting rod 918A and through the normal axis (e.g., axis A1) of the first end 901A of the connecting rod 916A but does not extend through the normal axis (e.g., axis A2) of the second end 912A of the connecting rod 916A. When configured in this manner, the pistons 910A and 910B can share a reciprocating axis. For illustrative purposes, portion of the assembly 900B, such as the associated connecting rods, are not shown in FIG. 53A.

In other implementations, the angled segment 925A of the first arm portion 902A can be angled outwardly away from the second arm portion 904A and the angled segment 925A of the second arm portion 904A 902A can be angled outwardly away from the first arm portion 902A. In such configurations, the distance between the second ends 912A can be greater than the distance between the first ends 901A of the connecting rod 916A.

In the illustrated example, the piston 910A is connected to a second crankshaft 112B via a pair of second connecting rods 918A of the connecting rod and piston assembly 900A. Each second connecting rod 918A can be positioned radially outward of the arm portions 902A, 904A when coupled to the piston 910A. In the illustrated example, the connecting rods 918A are constructed in a similar manner as the connecting rods 116, 118 described with reference to at least FIGS. 5A and 5B.

As shown in FIG. 53A, when coupled to the piston 910A, the first ends 154A of the connecting rods 918A can be aligned in planes (e.g., the plane P1) with second ends 912A of the connecting rod 916A. However, the second ends 156A of the connecting rods 918A can be positioned adjacent to the second ends 912A of the connecting rod 916A on the wrist pin 950A.

In other implementations, the assembly 900A can include a single second connecting rod 918A that can be similar or identical to the first connecting rod 916A. However, to facilitate connection to the same wrist pin 950A, the second ends of the second connecting rod 918A can be spaced inwardly or outwardly of the second end 912A of the first connecting rod 916A relative to the longitudinal axis of the crankshaft 112A1.

Referring back to FIG. 51 and to FIGS. 53B and 53C, the connecting rod and piston assembly 900B can include the piston 910B, a first connecting rod 916B, one or more second connecting rods 918B, a link rod 920B, a first wrist pin 950B1, and a second wrist pin 950B2. The first connecting rod 916B can be configured to connect the piston 910B to the crankshaft 112A1, which can be the first crankshaft 112A of FIG. 46A. The second connecting rod(s) 918B can be configured to connect the piston 910B to another crankshaft 112A1, which can be the second crankshaft 112B of FIG. 46A. The link rod 920B can be an intermediate connection between the piston 910B and the connecting rods 916B, 918B. For example, the link rod 920B can be coupled to the connecting rods 916B, 918B via the first wrist pin 950B1 and to the piston 910B via the second wrist pin 950B2. FIG. 53B shows an isolation view of an implementation of the piston 910B, link rod 920B, and wrist pins 950B1, 950B2, and FIG. 53C shows an isolation view of the piston 910B.

In the illustrated embodiment, the piston 910B comprises an upper portion 921B, a first lower portion 923B1, and a second lower portion 923B2 (collectively referred to as the lower portions 923B). The upper portion 921B and the lower portions 923B may comprise a single part or two or more portions that are assembled together to form the piston. In some embodiments, the upper portion 921B and the lower portions 923B can be coupled together with fasteners (e.g., bolts) or by other fastening methods of mechanisms.

Each lower portion 923B can extend away from a top of the piston 910B in the direction of the crankshaft 112A1. The first lower portion 923B1 and the second lower portion 923B2 can be spaced apart from each other relative to the width of the piston 910B, with a gap 926B therebetween. At least a portion of the link rod 920B can be received within the gap, as shown in FIG. 53B.

Each lower portion 923B can include an opening or pin bore that can be configured to receive the second wrist pin 950B. For example, the first lower portion 923B1 can include a first opening 933B1 and the second lower portion 923B2 can include a second opening 933B2. When received within the openings 933B1, 933B2, the piston 910B can rotate relative to the second wrist pin 950B2.

As shown in FIG. 51, the connecting rod 916B can be configured to connect to the crankshaft 112A1 at two locations. The connecting rod 916B can be constructed in a similar manner as the connecting rod 916A of at least FIGS. 51-52B. For example, the connecting rod 916B can include a first arm portion 902B and a second arm portion 904B. Each arm portion 902B, 904B can include an opening (e.g., a crankshaft bore) at its first ends 901B for receiving a separate crankpin 952 of the crankshaft 112A1. The crankpins 952 coupled to the connecting rod 916B can be spaced apart along the length of the crankshaft 112A1. For example, when coupled to the crankshaft 112A1 of FIGS. 48A and 48B, the connecting rod 916B can be coupled to the third and fourth crankpins 952c, 952d via the first ends 901B.

Both arm portions 902B, 904B can be joined at a central portion 906B of the connecting rod 916B. The central portion 906B can extend between the first arm portion 902B and the second arm portion 904B. In the illustrated example, the central portion 906B extends in substantially the same direction as a longitudinal axis of the crankshaft 112A1. Accordingly, the connecting rod 916B can be stirrup- or c-shaped.

The connecting rod 916B may be configured to be coupled to the first wrist pin 950B1 at two locations. For example, the connecting rod 916B can include two second ends 912B that each include a pin bore (not shown). The second ends 912B can be disposed on or extend from the central portion 906B in a direction substantially opposite the crankshaft 112A1. The second ends 912B can be spaced apart from each other relative to the longitudinal axis of the crankshaft 112A1 with a space therebetween. As shown in FIG. 51, a portion of the link rod 920B can be at least partially disposed within the space between the second ends 912B in the assembly 900B. Each second end 912B can include an opening/pin bore (not shown) for receiving opposite ends of the first wrist pin 950B1.

The link rod 920B can serve as an intermediate connection between the connecting rods 916B, 918B and the piston 910B. For example, the link rod 920B can serve as a chain-link between the connecting rods 916B, 918B and the piston 910B.

The link rod 920B can include a first pin bore/opening 922B1 for receiving the first wrist pin 950B1 and a second pin bore/opening 922B2 for receiving the second wrist pin 950B2. The first pin opening 922B1 is spaced apart from the second pin opening 922B2. In the assembled connecting rod and piston assembly 900B, the link rod 920B can be positioned with the first pin opening 922B1 positioned in the space between the second ends 912B of the connecting rod 916B and the second pin opening 922B2 positioned in the space between the lower portions 923B of the piston 910B. The link rod 920B can be sized to prevent contact between the connecting rods 916B, 918B and the piston 910B.

In the illustrated example of FIG. 51, the piston 910B would be connected to the second crankshaft 112B via the second connecting rods 918B of the connecting rod and piston assembly 900B. The second connecting rods 918B can be similar or identical to the connecting rods 918A. In other implementations, a single connecting rod 918B can be used and configured in the same or similar manner as the first connecting rod 916B. When configured in this manner, to facilitate connection to the same wrist pin 950B1, the second ends of the second connecting rod 918B can be spaced inwardly or outwardly of the second ends 912B of the first connecting rod 916B relative to the longitudinal axis of the crankshaft 112A1.

The connecting rod and piston assemblies 900A, 900B can each include unique components configured to reduce or eliminate the impact of side-to-side play between the connecting rods and their associate pistons. For example, the assembly 900A includes the wrist pin 950A with the translating portion 972A, and the assembly 900B includes the link rod 920B. Side-to-side play can occur when the connecting rods of one crankshaft are misaligned with the connecting rods of the other crankshaft (e.g., which can be due to lash). It is desirable to minimize side-to-side movement of the pistons within the bore because this movement introduces additional friction.

In the assembly 900B, the link rod 920B can be configured to allow some side-to-side play between the connecting rods 916B, 918B and the piston 910B in directions into and out of the page of FIG. 51. Use of the link rod 920B can advantageously allow the piston to maintain alignment with the central axis B (see e.g., FIG. 53) of the bore it reciprocates in, even if one of the connecting rods 916B, 918B is not directly aligned with the central axis B. Stated another way, the link rod 920B can provide the piston 910B with freedom from being constrained at the pivot point of the second wrist pin 950B2 such that the piston can maintain alignment with the central axis B without side-to-side pushing from the connecting rods 916B, 918B.

Advantages of link rod configurations include easier lubrication, rotary motion (e.g., as opposed to sliding), and/or thicker shorter connecting rods 916B, 918B. However, the link rod 920B introduces additional length or height to the assembly 900B, which may not be desirable in some cases. For example, the assembly 900B may extend a greater distance from crankshaft 112A1 than the assembly 900A.

In the assembly 900A, the translating portion 972A of the wrist pin 950A can be configured to allow some side-to-side play between the connecting rods 916A, 918A and the piston 920A in directions into and out of the page. Use of the wrist pin 950A can advantageously allow the piston to maintain alignment with the central axis B (see e.g., FIG. 53A) of the bore it reciprocates in, even is one of the connecting rods 916A, 918A is not directly aligned with the central axis B.

Advantages of translating wrist pin configurations include minimizing the distance between the pistons and the connecting rods, allowing for smaller engines. Additionally, the translating portion 972A can have large flat surfaces for transferring the forces from the piston 910A to the wrist pin 950A. However, sliding tolerances of the translating portion 972A and the opening 933A need to be precise and it may be more difficult to lubricate compared to the link rod configurations. As such, it may be desirable to utilize translating wrist pin configurations with auxiliary pistons due to the lower pressure. However, as noted above, the assemblies 900A, 900B can be configured for combustion or auxiliary use, depending on the implementation.

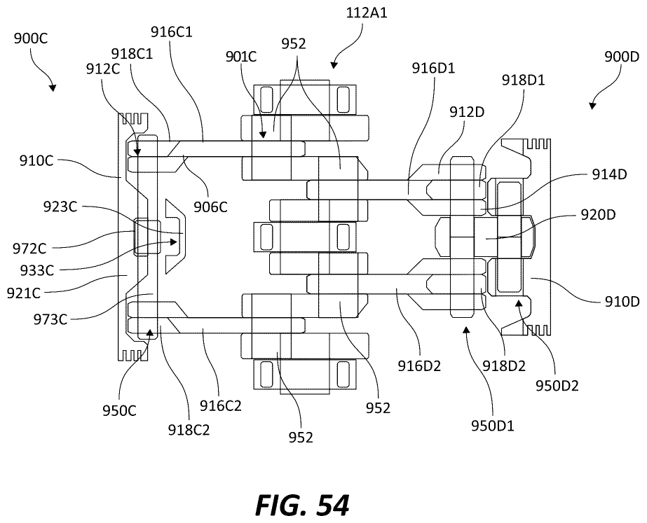

In the illustrated example of FIG. 51, the assembly 900B is coupled to the crankshaft 112A1 closer to the center of the crankshaft 112A1 than the assembly 900A. For example, the connecting rod 916B is coupled to crankpins (e.g., crankpins 952c, 952d) that are more centrally located on the crankshaft 112A1 than the crankpins (e.g., crankpins 952a, 952b) the connecting rod 916A is coupled to. In other embodiments, the positions of the assemblies 900A and 900B can be reversed. Further, in other embodiments, the assemblies 900A, 900B can be paired with other assemblies on the crankshaft 112A1 (e.g., any of the assemblies of at least FIGS. 54 and 60-63).

In some embodiments, it can be desirable for the connecting rods, or the crank-coupling portions of the connecting rods, for the combustion pistons to be positioned closer together than for auxiliary pistons because the combustion pistons experience more forces. As such, closer connecting rods for the combustion pistons can minimize side loads, misaligned, and/or energy losses.

As noted above, the piston 910B of the assembly 900B is configured as a combustion piston. Utilizing the assembly 900B for a combustion piston can provide certain benefits.

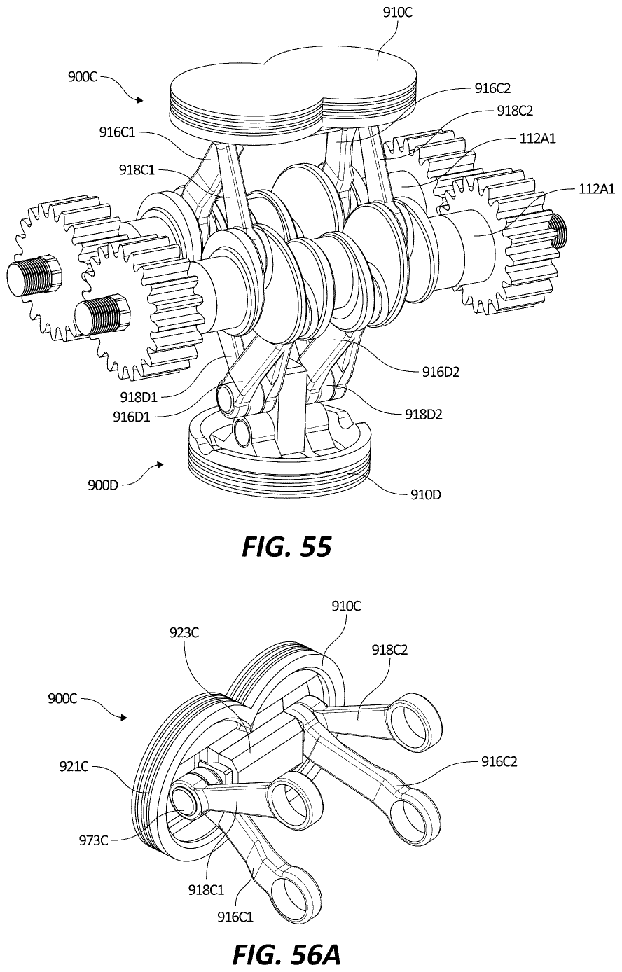

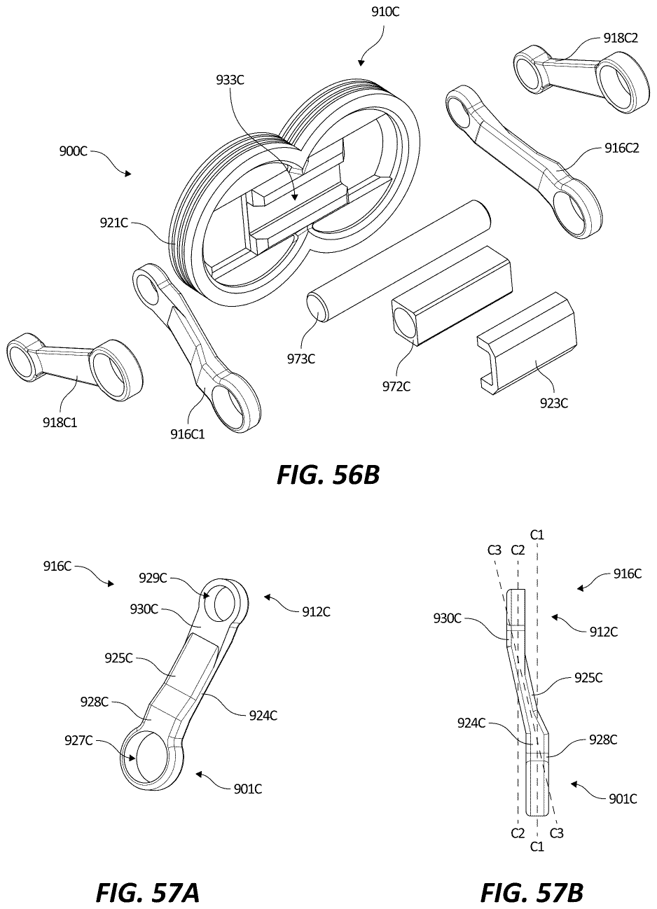

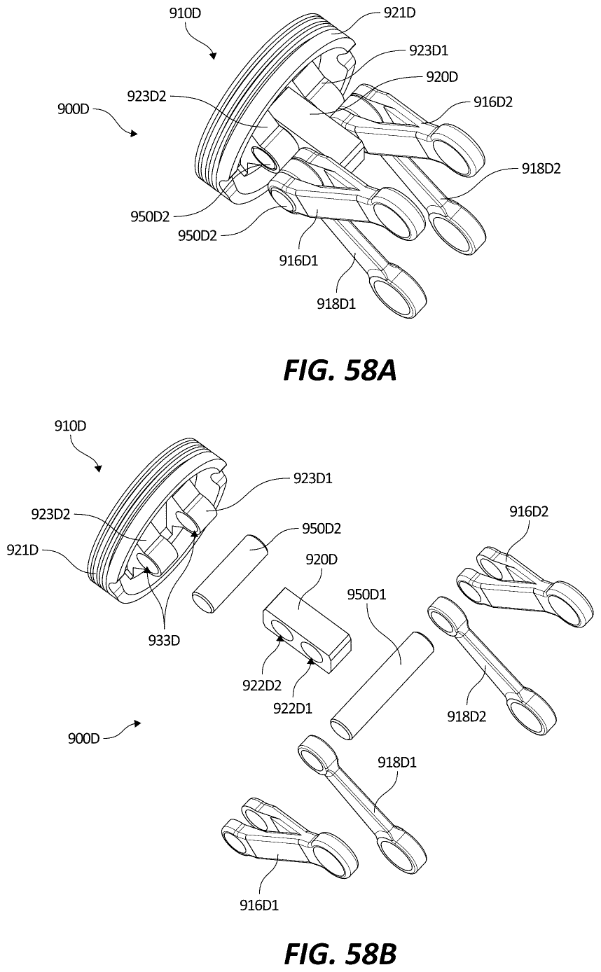

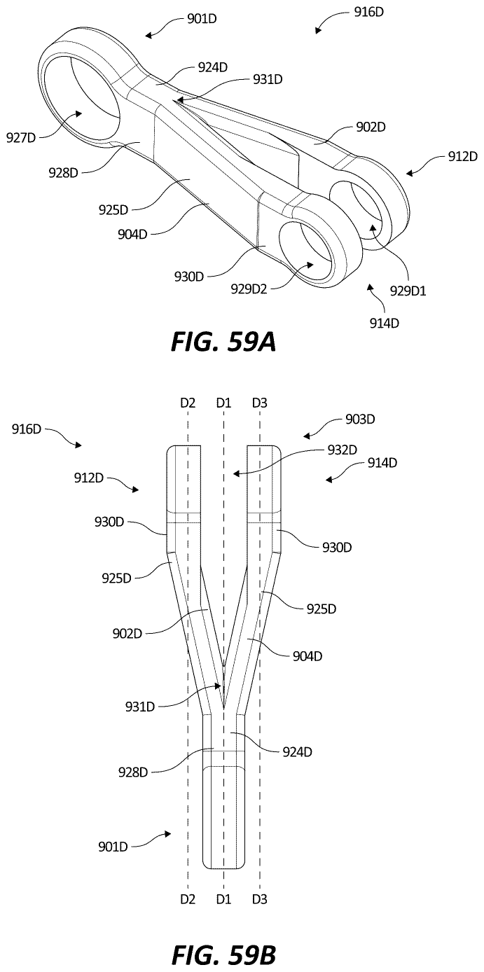

FIGS. 54-59B show various embodiments of a connecting rod and piston assembly 900C and a connecting rod and piston assembly 900D or components thereof. FIG. 54 shows a schematic section view of the assemblies 900C, 900D connected to the same crankshaft 112A1. FIG. 55 shows a perspective view of the assemblies 900C, 900D and a pair of crankshafts 112A1. FIGS. 56A and 56B show an isolation perspective view and an exploded view of the assembly 900C, while FIGS. 58A and 58B show an isolation perspective view and an exploded view of the assembly 900D. FIGS. 57A, 57B, 59A and 59B show isolation views of connecting rods that can be included in the assemblies 900C, 900D, for example.

The connecting rod and piston assembly 900C can include a piston 910C. The connecting rod and piston assembly 900D can include a piston 910D. In the illustrated example, the piston 910C is configured as an auxiliary piston and the second piston 910D is configured as a combustion piston. In the illustrated example, the piston 910C is shown as a double-C shaped piston (see, e.g., FIG. 55).

The connecting rod and piston assembly 900C can include the piston 910C, a first connecting rod 916C1, a second connecting rod 916C2, a third connecting rod 918C1, a fourth connecting rod 918C2, and a wrist pin 950C. The connecting rods 916C1, 916C2 can be similar or identical and can be referred to herein as the “connecting rod(s) 916C.” Similarly, the connecting rods 918C1, 918C2 can be similar or identical and can be referred to herein as the “connecting rod(s) 918C.” The connecting rods 916C can be configured to connect the piston 910C to the crankshaft 112A1, which can be the first crankshaft 112A of FIG. 46A. The connecting rods 918C can be configured to connect the piston 910C to another crankshaft 112A1, which can be the second crankshaft 112B of FIG. 46A. The wrist pin 950C can be used to couple the connecting rods 916C, 918C to the piston 910C.

In the illustrated example, the piston 910C is configured in the same manner as the piston 910A of FIGS. 51 and 52A. For example, the piston 910C can include an upper portion 921C, a lower portion 923C, and an opening 933C. For illustrative purposes, the lower portion 923C is shown as disconnected from the upper portion 921C in FIG. 54. Similarly, the wrist pin 950C is configured in the same manner as the wrist pin 950A of FIGS. 51 and 52A. For example, the wrist pin 950C can include a translating portion 972A, configured to be received within the opening 933C of the piston 910C, and a shaft 973C.

The piston 910C can be connected to the connecting rods 916C via the shaft 973C of the wrist pin 950C. The first connecting rod 916C1 can be coupled to the shaft 973C at a first end and the second connecting rod 916C2 can be coupled to the shaft 973C as an opposite second end (see e.g., FIG. 56A).

As shown in at least FIGS. 57A and 57B, each connecting rod 916C can include a body 924C extending between a first end 901C and a second end 912C. The first end 901C is configured to be coupled to the crankshaft 112A1. For example, the first end 901C can include an opening or crankshaft bore 927C extending therethrough for receiving a crankpin 952 of the crankshaft 112A1. The second end 912C is configured to be coupled to a wrist pin (e.g., the wrist pin 950C). For example, the second end 912C can include an opening or pin bore 929C for receiving the shaft 973C of the wrist pin 950C, in the illustrated example.

The body 924C can include a first portion/segment 928C, a second portion/segment 930C, and a third portion/segment 925C. The third segment 925C can be a connecting portion that can extend between and connect the first segment 928C to the second segment 930C. The third segment 925C can be at an angle relative to the first segment 928C and the second segment 930C. For example, the first segment 928C and the second segment 930C can be straight portions of the connecting rod 916C, with linear axes extending parallel but offset from each other and extending perpendicular to the longitudinal axis of the crankshaft 112A1. The third segment 925C can be angled relative to the linear axes of the first segment 928C and the second segment 930C. For example, a first longitudinal axis C1 of the first segment 928C is spaced apart but parallel to a second longitudinal axis C2 of the second segment 930C. The first longitudinal axis C1 can be a normal axis of the crankshaft bore 927C and the second longitudinal axis C2 can be a normal axis of the pin bore 929C. A third longitudinal axis C3 of the third/angled segment 925C is at a non-zero angle relative to both the first longitudinal axis C1 and the second longitudinal axis C2. As such, the connecting rod 916C can have a dog-leg shape.

The second connecting rod 916C2 can be similar or identical to the first connecting rod 916C1. The connecting rods 916C1, 916C2 can both be connected to separate crankpins 952 spaced apart along the length of the crankshaft 112A1. For example, when used with the crankshaft 112A1 of FIGS. 48A and 48B, the first connecting rod 916C1 can be coupled to the first crankpin 952a and the second connecting rod 916C2 can be coupled to the second crankpin 952b.

The piston 910C can be connected to a second crankshaft 112B via the connecting rods 918C of the assembly 900C. In the illustrated example, each connecting rod 918C is a straight connecting rods, without a dog-legged portion. The third and fourth connecting rods 918C1, 918C2 can be positioned adjacent the first and second connecting rods 916C1, 916C2 respectively and coupled to the shaft 973C of the wrist pin 950C. The third and fourth connecting rods 918C1, 918C2 can be aligned with the first ends 901C of the first and second connecting rods 916C1, 916C2, with the inwardly extending angled segments 925C allowing for side-by-side positioning on the wrist pin 950C. For example, in the assembly 900C, the longitudinal axis of one connecting rod 918C can be aligned the longitudinal axis C1 of the first segment 928C shown in FIG. 57B, which can define a plane extending into the page and through both longitudinal axes. In other embodiments, the third and fourth connecting rods 918C1, 918C2 can be similar or identical to the first and second connecting rods 916C1, 916C2.

With continued reference to FIG. 54, the connecting rod and piston assembly 900D can include the piston 910D, a first connecting rod 916D1, a second connecting rod 916D2, a third connecting rod 918D1, a fourth connecting rod 918D2, a link rod 920D, a first wrist pin 950D1, and a second wrist pin 950D2. The connecting rods 916D1, 916D2 can be similar or identical and can be referred to herein as the “connecting rod(s) 916D.” Similarly, the connecting rods 918D1, 918D2 can be similar or identical and can be referred to herein as the “connecting rod(s) 918D.” The connecting rods 916D can be configured to connect the piston 910D to the crankshaft 112A1, which can be arranged as the first crankshaft 112A of FIG. 46A. The connecting rods 918D can be configured to connect the piston 910D to another crankshaft 112A1, which can be arranged as the second crankshaft 112B of FIG. 46A.

In the illustrated example, the piston 910D is configured in the same manner as the piston 910B and the link rod 920D is configured in the same manner as the link rod 920B of at least FIGS. 51, 53B, and 53C. For example, the link rod 920D can be an intermediate connection between the piston 910D and the connecting rods 916D, 918D, with the link rod 920D being coupled to the connecting rods 916D, 918D via the first wrist pin 950D1 and the piston 910D via the first wrist pin 950D1.

In other embodiments, the assembly 900D may not include the link rod 920D and the first wrist pin 950D1. In such an embodiment, the connecting rods 916D, 918D can be coupled to the piston 910D via the second wrist pin 950D2.

As shown in at least FIGS. 59A and 59B, each connecting rod 916D can be a forked connecting rod. The connecting rod 916D can include a body 924D extending between a first end 901D and a second end 903D. The body 924D can include a central portion 928D and a branched portion 931D. The central portion 928D can extend from the first end 901D and the branched portion 931D can extend from the central portion 928D towards the second end 903D. The branched portion 931D can include a first arm 902D, and a second arm 904D. The arms 902D, 904D can be spaced apart from each other, with a gap 932D therebetween, and can extend from the central portion 928D towards the second end 903D. Each arm 902D, 904D can extend towards an arm end. For example, the first arm 902D can extend towards a first arm end 912D and the second arm 904D can extend towards a second arm end 914D.

The arm ends 912D, 914D can form the small end of the connecting rod 916D and the first end 901D can form the big end. For example, the central portion 928D can include an opening or crankshaft bore 927D extending therethrough. Similarly, the first arm 902D can include an opening or pin bore 929D1 extending therethrough and the second arm 904D can include an opening or pin bore 929D1 extending therethrough (“pin bores 929D”). The pin bores 929D can be axially aligned with each other. The connecting rod 916D can be coupled to the crankshaft 112A1 via the crankshaft bore 927D. The connecting rod 916D can be coupled to a wrist pin (e.g., the first wrist pin 950D1) via the pin bores 929D.

In the illustrated example, each arm 902D, 904D includes a first segment 925D and a second segment 930D. The first segment 925D extends from the central portion 928D at an angle and the second segment 930D extends from the first segment 925D. The first segment 925D can be an angled or bent portion of the arm and the second segment 930D can be a straight segment. For example, a longitudinal axis D1 of the central portion 928D can extend parallel to a longitudinal axis D2 of the second segment 930D of the first arm 902D and parallel to a longitudinal axis D3 of the second segment 930D of the second arm 904D. In this example, each longitudinal axis D1, D2, D3 is offset from each other. The angled segments 925D can be at an angle related to the longitudinal axes D1, D2, D3.

The gap 932D between the arms 902D, 904D can be sized to accommodate another connecting rod therebetween. For example, in the assembly 900D, the connecting rod 918D can extend at least partially through the gap 932D in the connecting rod 916D, as shown in at least FIG. 58A. The gap 932D can have a varying size along the length of the connecting rod 916D. For example, the gap 932D can be the largest at the second end 903D and smallest at the connection between the branched portion 931D and the central portion 928D. The length of the second segments 930D of the arms 902D, 904D and the angle of the angled segments 925D can be sized to allow relative motion between the connecting rods 916D, 918D without interference between the connecting rods 916D, 918D.

The second connecting rod 916D2 can be similar or identical to the first connecting rod 916D1. The connecting rods 916D1, 916D2 can each be connected to a separate crankpin 952 spaced apart along the length of the crankshaft 112A1.

The piston 910D can be connected to a second crankshaft 112B via the connecting rods 918D of the assembly 900D. In the illustrated example, the connecting rods 918D are straight connecting rods, without prongs/multiple arms. The third and fourth connecting rods 918D1, 918D2 can be positioned between the arms 902D, 904D of the first and second connecting rods 916D1, 916D2 respectively and coupled to the first wrist pin 950D1 (e.g., within the gaps 932D between the arms 902D, 904D). As such, the first and second connecting rods 916D1, 916D2 can have a fork-and-blade configuration with the third and fourth connecting rods 918D1, 918D2. In other embodiments, the connecting rods 918D can be similar or identical to the connecting rods 916D.

FIG. 60 shows an embodiment of a connecting rod and piston assembly 900E and an embodiment of the connecting rod and piston assembly 900A. The assemblies 900A, 900E are shown as connected to the same crankshaft 112A2. In an engine, the assemblies 900A, 900E can be coupled to a pair of crankshafts 112A2 arranged in mesh with each other like the crankshafts 112A, 112B of FIGS. 46A, 47A, and 47B. The assembly 900E can include a piston 910E. In the illustrated example, the piston 910A is configured as an auxiliary piston and the piston 910E is configured as a combustion piston.

The assembly 900E can include the piston 910E, a first connecting rod 916E, a second connecting rod 918E, and a wrist pin 950E. The first connecting rod 916E can be configured to connect the piston 910E to the crankshaft 112A2, which can be the first crankshaft 112A of FIG. 46A. The second connecting rod 918E can be configured to connect the piston 910E to another crankshaft 112A2, which can be the second crankshaft 112B of FIG. 46A.

In the illustrated example, the piston 910E is configured in the same manner as the piston 910B of at least FIGS. 51, 53B, and 53C. For example, the piston 910E includes a first lower portion 923E1, and a second lower portion 923E2 (collectively referred to as the lower portions 923E). Each lower portion 923E extends away from a top of the piston 910E in the direction of the crankshaft 112A2. The first lower portion 923E1 and the second lower portion 923E2 can be spaced apart from each other relative to the width of the piston 910E, with a gap therebetween. As shown in FIG. 60, the connecting rods 916E, 918E can be received within the gap. The first lower portion 923E1 can include a first opening 933E1 and the second wrist pin 950B can include a second opening 933E2. The openings 933E1, 933E2 can receive the wrist pin 950E such that the piston 910E can rotate relative to the wrist pin 950E.

The first connecting rod 916E can be the same or identical to the connecting rod 916D of at least FIGS. 59A and 59B. For example, the connecting rod 916E can be a forked connecting rod including a central portion 928E and a pair of arms 902E, 904E.

The arms 902E, 904E can form the small end of the connecting rod 916E and the central portion 928E can form the big end. The connecting rod 916E can be coupled to the crankshaft 112A2 via the central portion 928E and to the wrist pin 950E via the arms 902E, 904E.

The piston 910E can be connected to a second crankshaft 112B via the second connecting rod 918E. In the illustrated example, the second connecting rod 918E is a straight connecting rod, without prongs. The second connecting rod 918E can be positioned between the arms 902E, 904E of the first connecting rod 916E and coupled to the wrist pin 950E (e.g., within the gaps between the arms 902E, 904E). As such, the first connecting rod 916E can have a fork-and-blade configuration with the second connecting rod 918E. In other embodiments, the second connecting rod 918E can be similar or identical to the first connecting rod 916E.

As shown in at least FIGS. 51-60, the internal combustion engines described herein can include one or more pistons pairs that are aligned and configured to reciprocate on opposite sides of their corresponding crankshafts. For example, the internal combustion engine 100 of FIG. 1 includes two pistons 110 aligned on opposite sides of the pair of crankshafts 112. In another example, the internal combustion engine 200 of FIG. 10 includes a first pair of pistons 210A, 210B aligned on opposite sides of the four crankshafts 212 and a second pair of pistons 210C, 210D aligned on opposite sides of the four crankshafts 212. In these examples, the paired pistons can reciprocate along a shared axis (e.g., the longitudinal axes of their respective bore). In other examples, the internal combustion engines described herein can be configured to include piston groupings where one or more pistons are paired with two or more opposing pistons. For example, one piston can be arranged on a first side of one or more crankshafts and two pistons can be arranged on a second side of the one or more crankshafts. In such a configuration, the connecting rod and piston assemblies on opposite sides of the one or more crankshafts can be configured to have the same reciprocating mass. For example, the one or more crankshafts can be connected to reciprocating assemblies on opposite sides that are balanced. In such a configuration, generally none of the pistons share a longitudinal axis.

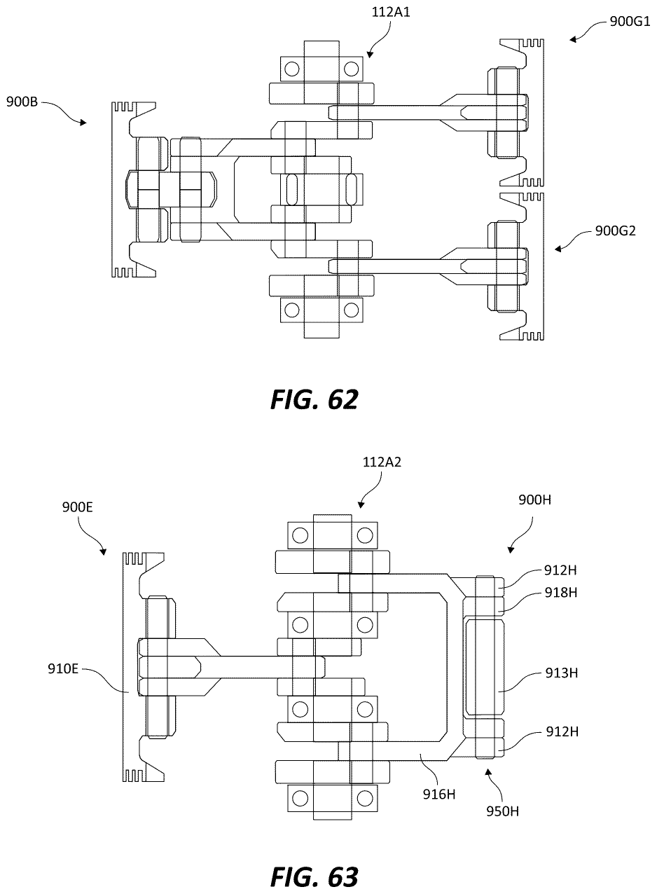

FIGS. 61 and 62 illustrate example configurations where a single piston is configured to reciprocate opposite a pair of pistons. The configurations of FIGS. 61 and 62 can be implemented in any of the internal combustion engines described herein. In such configurations, any of the pistons can be configured as auxiliary pistons and any of the pistons can be configured as combustion pistons. For example, the single piston can be a combustion piston, and the pair of pistons can be auxiliary pistons, or vice versa.

Configuring the pair of pistons as the auxiliary pistons can provide certain advantages. For example, where all pistons have the same associated stoke volume, the pair of auxiliary pistons can be used to supercharge the combustion piston. Where supercharging is not desired, the pair of auxiliary pistons can be configured with smaller stoke volumes, and still may be configured to scavenge the combustion piston. In some configurations, the pair of auxiliary pistons can have a combined stroke volume that is approximately equal to the stoke volume of the associated combustion piston.

Referring now to FIG. 61, an embodiment of a two-one piston arrangement is shown. The two-one piston arrangement of FIG. 61 can include an embodiment of a connecting rod and piston assembly 900F, an embodiment of a connecting rod and piston assembly 900G1, and an embodiment of a connecting rod and piston assembly 900G2 (collectively referred to as the assemblies 900G). The assembly 900F can operate as the single piston, and the assemblies 900G can operate as the pair of pistons. The assemblies 900F, 900G are shown as connected to the same crankshaft 112A1. The connecting rod and piston assembly 900F can include a piston 910F. The connecting rod and piston assemblies 900G can include a piston 910G1 and a piston 910G2. In the illustrated example, the piston 910F is configured as a combustion piston and the pistons 910G1, 910G2 are configured as auxiliary pistons.

The connecting rod and piston assembly 900F can include the piston 910F, a first connecting rod 916F1, a second connecting rod 916F2, a third connecting rod 918F1, a fourth connecting rod 918F2, a link rod 920F, a first wrist pin 950F1, and a second wrist pin 950F2. The first and second connecting rods 916F1, 916F2 can be configured to connect the piston 910F to the crankshaft 112A1, which can be the first crankshaft 112A of FIG. 46A. The third and fourth connecting rods 918DF1, 918F2 can be configured to connect the piston 910F to another crankshaft 112A1, which can be the second crankshaft 112B of FIG. 46A.

In the illustrated example, the piston 910F is configured in the same manner as the piston 910B and the link rod 920F is configured in the same manner as the link rod 920B of at least FIGS. 51, 53B, and 53C. For example, the link rod 920F can be an intermediate connection between the piston 910F and the connecting rods 916F1, 916F2, 918F1, 918F2, with the link rod 920F being coupled to the connecting rods 916F1, 916F2, 918F1, 918F2 via the first wrist pin 950F1 and the piston 910F via the second wrist pin 950F2.

In the illustrated example, the first and second connecting rods 916F1, 916F2 are configured in the same manner as the first and second connecting rods 916C1, 916C2 of at least FIGS. 54-57B and the third and fourth connecting rods 918F1, 918F2 are configured in the same manner as the third and fourth connecting rods 918C1, 918C2 of FIG. 54-56B. However, the connecting rods 916F1, 916F2, 918F1, 918F2 are configured to be rotatably coupled to the first wrist pin 950F1. The connecting rods of the assembly 900F may also have a shorter relative length than the connecting rods of the assembly 900C due to the inclusion of the link rod 920F, in some embodiments.

The connecting rod and piston assembly 900G1 can include the piston 910G1, a first connecting rod 916G1, a second connecting rod 918G1, and a wrist pin 950G1. The connecting rod and piston assembly 900G2 can include the piston 910G2, a first connecting rod 916G2, a second connecting rod 918G2, and a wrist pin 950G2. The first connecting rods 916G1, 916G2 can be configured to connect the pistons 910G1, 910G2 to the crankshaft 112A1 respectively, which can be the first crankshaft 112A of FIG. 46A. The second connecting rods 918G1, 918G2 can be configured to connect the pistons 910G1, 910G2 to another crankshaft 112A1 respectively, which can be the second crankshaft 112B of FIG. 46A.

In the illustrated example, the assemblies 900G are each configured in the same manner as the assembly 900E of FIG. 60. For example, the connecting rods 916G1, 916G2 can be forked and the second connecting rods 918G1, 918G2 can be blades configured to be coupled to the pistons 910G1, 910G2 via the wrist pins 950G1, 950G2 respectively.

FIG. 62 shows another embodiment of a two-one piston arrangement. The two-one piston arrangement of FIG. 62 can include the connecting rod and piston assembly 900B of at least FIGS. 51-53C, and the connecting rod and piston assemblies 900G of FIG. 61. The assembly 900B can operate as the single piston, and the assemblies 900G can operate as the pair of pistons. The assemblies 900B, 900G are shown as connected to the same crankshaft 112A1. The connecting rod and piston assembly 900B can include the piston 910B. The connecting rod and piston assemblies 900G can include the pistons 910G1, 910G2. In the illustrated example, the piston 910B is configured as a combustion piston and the pistons 910G1, 910G2 are configured as auxiliary pistons.

While FIGS. 61 and 62 show example two-one piston arrangements having specific connecting rod and piston assemblies, it is recognized that any of the connecting rod and piston assemblies, any of the translating wrist pin and piston assemblies, and/or like described herein can be incorporated into an engine having a two-one piston arrangement. Further, the internal combustion engine described herein can incorporate conventional connecting rods and/or pistons in a two-one arrangement.

As described herein, in some embodiments, it can be desirable to include opposing pistons coupled to the same crankshafts, whether the opposing pistons are configured as auxiliary pistons, combustion pistons, or one or more of each. In other embodiments, a piston can be paired with an opposing counterweight. For example, the counterweight can be coupled to the crankshaft(s) using one or more connecting rods and can balance the reciprocating piston. Such a configuration can be desirable where an auxiliary piston is not desired (e.g., to reduce costs and/or the complexity of an engine). For example, one of the pistons 110 of the internal combustion engine 100 of FIG. 1 could be replaced with a counterweight. In other examples, it can be desirable to pair an auxiliary piston with a counterweight. For example, this can be desirable to balance the auxiliary piston when the auxiliary piston provides sufficient scavenging for the engine (see e.g., the internal combustion engine 300A of FIGS. 13A-13C).

FIG. 63 illustrates an example arrangement of an embodiment of the connecting rod and piston assembly 900E paired with a counterweight assembly 900H. The assemblies 900E, 900H are shown as connected to the same crankshaft 112A2. The connecting rod and piston assembly 900E can include the piston 910E. The counterweight assembly 900H can include a counterweight 913H. The piston 910E can be configured as a combustion piston or an auxiliary piston, depending on the engine the piston 910E is incorporated into. In a single piston internal combustion engine, the piston 910E is generally configured as a combustion piston.

The counterweight assembly 900H can include the counterweight 913H, a first connecting rod 916H, a second connecting rod 918H, and a wrist pin 950H. The first connecting rod 916H can be configured to connect the counterweight 913H to the crankshaft 112A2, which can be the first crankshaft 112A of FIG. 46A. The second connecting rod 918H can be configured to connect the counterweight 913H to another crankshaft 112A2, which can be the second crankshaft 112B of FIG. 46A.

In the illustrated example, the first and second connecting rods 916H, 918H are configured in the same manner as the connecting rod 916A of at least FIGS. 51-53A. For example, the first connecting rod 916H can include ends 912H with openings (e.g., pin bores 929A) for receiving and coupling to the wrist pin 950H. The second connecting rods 918H can be coupled to the wrist pin 950H in a similar manner.

As shown in FIG. 63, the wrist pin 950H can support and/or be coupled to the counterweight 913H. In some embodiments, the counterweight 913H can be fixed to the wrist pin 950H. In other embodiments, the counterweight 913H can be rotatably coupled to the wrist pin 950H. As the piston 910E reciprocates, the counterweight 913H can also reciprocate to balance the piston 910E.

While FIG. 63 shows an example counterweight configuration having specific connecting rods, it is recognized that any of the connecting rods described herein can be utilized with a counterweight instead of a piston. For example, any of the pistons in any of the internal combustion engines described herein can be replaced with a counterweight. Further, the internal combustion engine described herein can incorporate conventional connecting rods in a counter-weight arrangement. Similarly, a counterweight assembly can be paired with any of the connecting rod and piston assemblies, any of the translating wrist pin and piston assemblies, and/or like described herein.

In some embodiments, any of the wrist pins described above can be configured to minimize or restrict lateral movement relative to the pistons and the connecting rods. For example, the ends of the wrist pins can be configured to receive pins, clips, and/or the like that prevent the wrist pins from sliding out of the connecting rods. In embodiments where the wrist pins include a translating portion, engagement between the translating portion and the opening in the piston can restrict such movement, and additional clips or pins may not be required. In some cases, restricting the movement of the wrist pins can provide a benefit of reducing friction from piston movement and/or misalignment of forces. In some cases, the c-shaped connecting rods (e.g., the connecting rod 916A) can naturally restrict such movement.

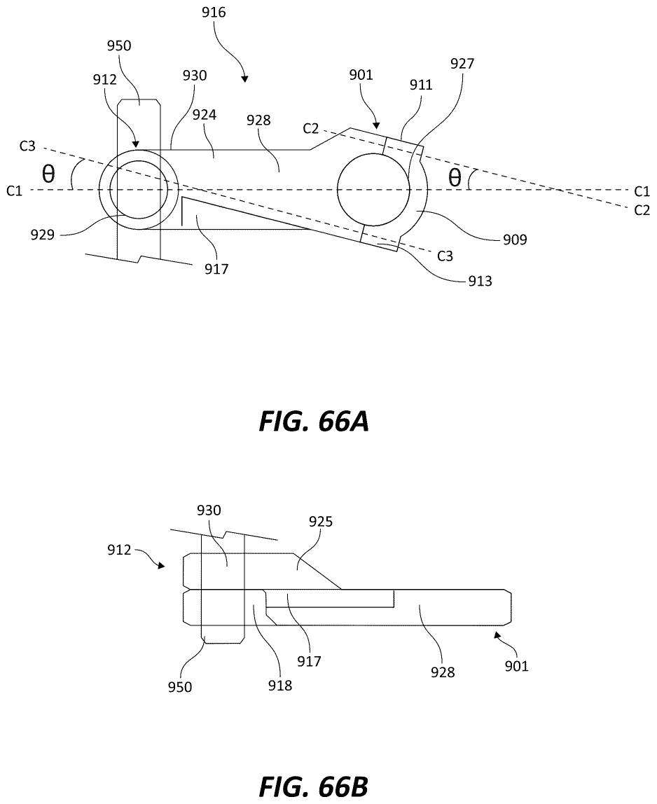

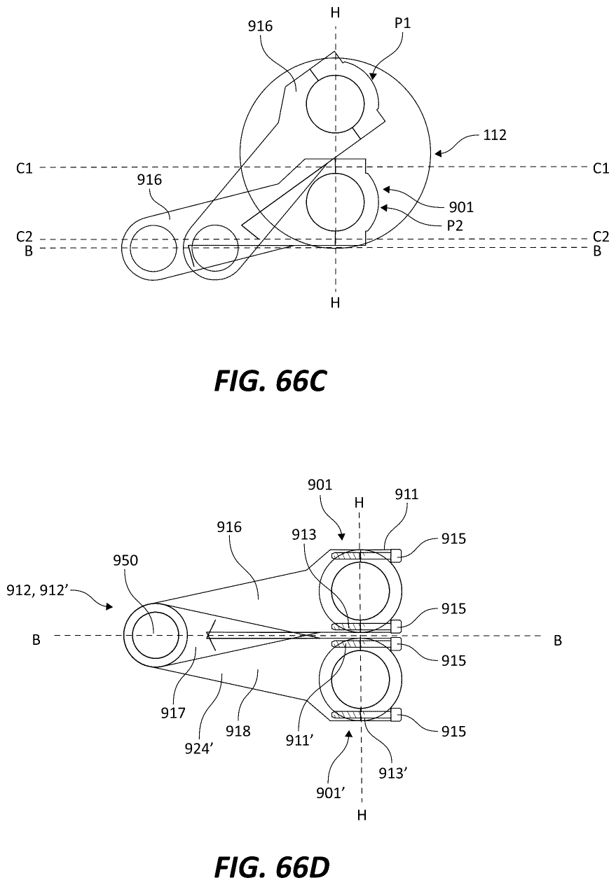

Referring now to FIGS. 66A-66D, in some configurations, it can be desirable for the crankshafts in an internal combustion engine to be positioned close together. For example, the overall size of the internal combustion engine can be reduced when adjacent crankshafts are positioned in close proximity together. However, such configurations can lead to interference between the connecting rods that couple the same piston to the adjacent crankshafts. For example, the big ends, particularly the enlarged fastener bosses, of connecting rods for the same piston can collide when side by side on the adjacent crankshafts. It can be desirable to include enlarged fastener bosses to provide a greater thickness at the big end for receiving fasteners. However, the fastener bosses extend outside of the maximum circular area of the crankshaft during rotation. Accordingly, when crankshafts are positioned near each other, it can be beneficial to configure the fastener bosses of the connecting rods at angles relative to the longitudinal axis of the connecting rods to prevent interference between the connecting rods.

With reference first to FIG. 66A, an embodiment of a connecting rod 916 and a wrist pin 950 are shown. A side view of the connecting rod 916 is shown in FIG. 66A, with the connecting rod 916 being rotated 90-degrees relative to the wrist pin 950 for illustrative purposes. Any of the connecting rods described herein can be configured as the connecting rod 916 or can include the features of the connecting rod 916 (e.g., angled fastener bosses).

The connecting rod 916 can include a body 924 that extends between a first/big end 901 and a second/small end 912. The big end 901 can be configured to be coupled to a crankshaft (e.g., the crankshaft 112A1 via a crankpin 952). For example, the big end 901 can include a big end opening 927 (e.g., a crankshaft bore) for receiving a crankpin of the crankshaft 112A1. The small end 912 can be configured to be coupled to a piston via the wrist pin 950. For example, the small end 912 can include a small end opening 929 (e.g., a pin bore 929) for receiving the wrist pin 950.

The body 924 of the connecting rod 916 can be configured differently, depending on the embodiment. In the illustrated example, the connecting rod 916 is configured in a similar manner as the connecting rod 916C1. Accordingly, the body 924 of the connecting rod 916 can include a first segment/portion 928, a second segment/portion 930, and a third segment/connecting portion 925 (see e.g., FIG. 66B). The first portion 928 can include the big end 901 and the second portion 930 can include the small end 912. In other embodiments, the connecting rod 916 can be configured as any of the connecting rods described herein, such as any of the connecting rods of FIGS. 51-63.

To couple the connecting rod 916 to the crankshaft 112, the big end 901 can include a removable end cap 909. The big end opening 927 can be partially defined by the end cap 909. The big end 901 can further include a first fastener boss 911 and/or a second fastener boss 913. In some embodiments, the fastener bosses 911, 913 can extend at least partially along the end cap 909. To couple the connecting rod 916 to the crankshaft 112, a crankpin 952 of the crankshaft 112A1 can be received within the big end opening 927 and the connecting rod 916 can be secured to the crankpin by fastening the end cap 909 to the body 924 of the connecting rod 916 (e.g., using fasteners 915 shown in FIG. 66D). Any of the connecting rods of FIGS. 51-63 can have their big ends 901 configured in a similar manner to include end caps and fastener bosses. However, such features are not shown in all drawings herein.

As shown in FIGS. 66B and 66D, the connecting rod 916 can be paired with a second connecting rod 918 to couple an associated piston to a pair of crankshafts 112. For example, as shown in FIG. 46A, the connecting rod 916 can be coupled to the first crankshaft 112A and the connecting rod 918 can be coupled to the second crankshaft 112B. The connecting rod 918 can be configured in a similar manner as the connecting rod 916 and can include a big end 901′ with fastener boss 911′, 913′ and a small end 912′.

In conventional crankshafts, the axes of the fastener bosses are generally aligned with the longitudinal axis of the connecting rod. As shown in FIG. 66A, the connecting rod 916 has a longitudinal axis C1 and the fastener bosses 911, 913 have fastener axes C2, C3 respectively. In the connecting rod 916, the fastener axes C2, C3 can be parallel to each other and at an angle θ relative to the longitudinal axis C1-C1. The angle θ can be selected based on the length of the connecting rod 916, the proximity of the crankshaft 112, and/or the size of the big end 901. In some embodiments, the angle θ can be less 90 degrees, less than 75 degrees, less than 60 degrees, less than 45 degrees, less than 30 degrees, and/or less than 15 degrees.

As shown in FIG. 66C, which shows the connecting rod 916 in a first position P1 and a second position P2, as the crankshaft 112 rotates, the position of the big end 901 changes. As such, the angle of the fastener axes C2, C3 also change relative to a central axis B of a cylinder bore the associated piston is reciprocating within. The angle θ can be selected such that the fastener axes C2, C3 are parallel to the central axis B of the cylinder bore when the big end 901 is aligned with a central axis H of the crankshaft 112. This position occurs when the piston is between top dead center and bottom dead center. As shown in FIG. 66D, at this position, the big ends 901, 901′ of the connecting rods 916, 918 are at their closest proximity to each other. However, because the second fastener boss 913 of the connecting rod 916 and the first fastener boss 911′ of the connecting rod 918 are aligned parallel to the central axis B-B of the cylinder bore at this position, the two connecting rods 916, 918 do not collide. In one example, there may be a clearance of approximately 2 mm between the big ends 901, 901′ at this position. In some embodiments, the interface between the end cap 909 and the body 924 of the connecting rod 916 can be aligned with the central axis H-H at this position and perpendicular to the central axis B-B at this position.

Referring back to FIGS. 66A, 66B, and 66D, in some embodiments, one or both of the connecting rods 916, 918 can include additional features to allow for closer positioning to each other. In the illustrated example, the body 924 of the connecting rod 916 includes a cut-out portion 917 positioned between the big end 901 and the small end 912. The cut-out portion 917 can be a portion of the body 924 having a reduced thickness relative to other portions of the body 924. For example, the cut-out portion 917 can be recessed relative to a main surface of the first portion 928. The cut-out portion 917 can be triangularly shaped. An angle of the triangularly shaped cut-out portion 917 can be the same as the angle θ, in some embodiments. As shown in FIG. 66B, for the connecting rod 916, the cut-out portion can span the length of the connecting portion 925 and a portion of the first portion 928 and the second portion 930 of the body 924. When configured in this manner, the angle of the connecting portion 925 can allow for an increase in thickness in the section of the body 924 including the cut-out portion 917 moving towards the small end 912. In some embodiments, the connecting rod 918 can include a corresponding cut-out portion (not shown).

The cut-out portion 917 of the connecting rod 916 and/or the corresponding cut-out portion of the connecting rod 918 can allow a portion of the connecting rod 918 to be in plane with or overlap with the connecting rod 916. For example, the two connecting rods 916, 918 can have a scissor-like arrangement. However, the scissor-like arrangement can allow the connecting rod 916 and the connecting rod 918 to be in-line with each other, instead of side-by-side. For example, the big ends 901, 901′ of the connecting rods 916, 918 can be aligned with each other on a plane.

As shown in FIG. 66D, when the big ends 901, 901′ of the connecting rods 916, 918 are aligned with the central axis H-H of the crankshaft 112, there is some overlap between their respective bodies 924, 924′. At this position, the cut-out portion 917 of the connecting rod 916 can be aligned with the corresponding cut-out portion of the connecting rod 918. As such, the connecting rod 916 can receive or accommodate the extension of the body 924′ of the connecting rod 918 into the connecting rod 916, and vice versa. Because of this arrangement, the connecting rods 916, 918 can be positioned closer to each other. As shown in FIG. 66B, the dog-legged portion of the connecting rod 916 (e.g., the second portion 930) allows the small end 912′ of the connecting rod 918 to be positioned adjacent the small end 912 of the connecting rod 916 on the wrist pin 950 without interference.

In some embodiments, including the cut-out portions in the connecting rods 916, 918 can allow the connecting rods 916, 918 to be in-line with each other, without requiring both connecting rods 916, 918 to include dog-legged portions. In some embodiments, the size of the second portion 930 (e.g., the dog-legged portion) of the connecting rod 916 can be reduced when the cut-out portions are included.

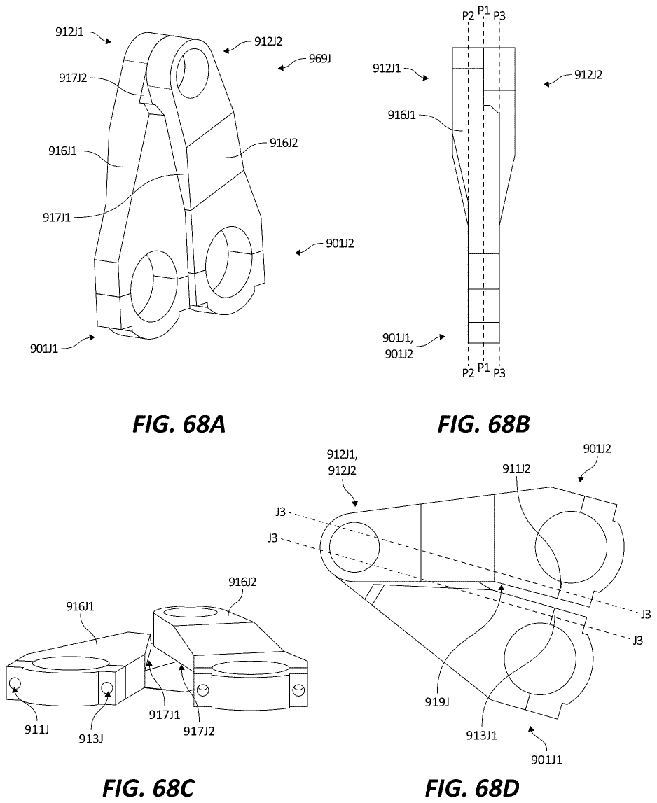

Referring now to FIGS. 67A-67C and FIGS. 68A-68D, various views of an embodiment of a connecting rod 916J and a pair of connecting rods 916J (“969J”) are shown. The connecting rod 916J can include similar features as the connecting rod 916 described above. The connecting rod 916J can be configured in a manner that allows close positioning between the connecting rod 916J and another connecting rod (e.g., another connecting rod 916J) that are coupled to the same piston and coupled to a pair of counter rotating crankshafts. For example, the connecting rod 916J can include a big end with fastener bosses that are at an angle relative to the connecting rod axis, which can prevent interference between the connecting rods during rotation of the crankshafts when positioned close together. In some configurations, the connecting rod 916J can include a clearance section that allows the connecting rod 916J to receive at least a portion of the other connecting rod during rotation of the crankshafts. For example, even though the two connecting rods may be aligned with their big ends in a plane, the clearance section of the connecting rod 916J can allow overlap of a portion of the connecting rod bodies. This configuration can allow a scissoring motion between connecting rods during rotation of the crankshafts. In some implementations, both connecting rods can include clearance sections that face each other during rotation of the crankshafts.

In the illustrated example, the connecting rod 916J includes a connecting rod body 924J (“body”) and an end cap 909J. The end cap 909J is configured to be removably coupled to the body 924J. The end cap 909J can define at least a portion of a big end/first end 901J of the connecting rod 916J. The body 924J can extend between a first body end 907J and a second body end 912J. The end cap 909J can be coupled to the body 924J at the first body end 907J. The second body end 912J (e.g., the distal end of the body 924J relative to the end cap 909J) can be the second end/small end of the connecting rod 916J and is referred to herein as such.

The connecting rod 916J includes a first opening 927J that extends through the connecting rod 916J. The first opening 927J can be at least partially defined by the body 924J and by the end cap 909J. The connecting rod 916J can be coupled to a crankpin of a crankshaft via the first opening 927J. For example, the first opening 927J can be a crankshaft bore. The connecting rod 916J includes a second opening 929J extending through the body 924J near the second end 912J. The connecting rod 916J can be coupled to a piston (e.g., via a wrist pin) via the second opening 929J. For example, the second opening 929J can be a pin bore. As shown in FIG. 67C, a connecting rod axis J1 extends between a center of the first opening 927J and a center of the second opening 929J.

To facilitate the connection between the body 924J and the end cap 909J, the connecting rod 916J can include one or more fastener bosses. For example, a first fastener boss 911J extends along a first boss axis J2 between the body 924J and the end cap 909J and a second fastener boss 913J extends along a second boss axis J3 between the body 924J and the end cap 909J. The fastener bosses 911J, 913J are shown also in FIG. 68C. The first fastener boss 911J is positioned on a first side of the first opening 927J and the second fastener boss 913J is positioned on a second side of the first opening 927J. Each boss 911J, 913J can receive a fastener.

As shown in FIG. 67C, the first boss axes J2, J3 can be at an angle relative to the rod axis J1. For example, the first boss axis J2 can be an angle theta relative to the rod axis J1 and the second boss axis J3 can be at the same angle theta relative to the rod axis J1. This configuration is different from conventional connecting rods where the fastener bosses are generally aligned with the rod axis.

As explained above, having the boss axes J2, J3 at an angle relative to the rod axis J1 can provide certain benefits, such as preventing interference between the big ends between a pair of connecting rods that are coupled to the same piston but different crankshafts. When the big ends rotate in a single plane, the angle theta can be selected so that the boss axes of each connecting rod are aligned with each other when the big ends are at the closest position to each other, which is generally somewhere between the piston's top dead center position and bottom dead center position. These advantages are described further with reference to at least FIGS. 68A-68D.

Referring back to FIGS. 67A-67C, in the illustrated example, the body 924J of the connecting rod 916J includes a first segment 928J extending from the first body end 907J, a second segment 930J extending from the second body end 912J, and a third segment 925J extending between the first segment 928J and the second segment 930J. As shown in FIG. 67B, the third segment 925J can be a portion of the body 924J that is at an angle relative to the other body segments 928J, 930J.

The first and second segments 928J, 930J can have axes that are substantially parallel to each other. For example, a longitudinal axis L1 of the first segment 928J can extend parallel to a longitudinal axis L2 of the second segment 930J. A longitudinal axis L3 of the third segment 925J can be at a non-zero angle relative to the longitudinal axes L1, L2. Accordingly, the small end 912J can be offset from the big end 901J. This arrangement results in the small end 912J traveling along a different plane than the big end 901J when coupled to a crankshaft and piston in an engine, for example. For example, the big end 901J can be offset from the small end 912J.

In the illustrated example, the connecting rod 916J includes a clearance section 917J. In some implementations, the clearance section 917J is referred to as a “cut-out portion” of the body 924J. The clearance section 917J can be included in the connecting rod 916J when constructed or can be a section where material was removed from the body 924J. The clearance section 917J can be a portion of the body 924J having a different thickness relative to at least one of the first body end 907J or the second body end 912J. For example, as shown in FIG. 67B, the body 924J may have a similar thickness in the first and second segments 928J, 930J near the ends 907J, 912J, but can have a reduced thickness in at least a portion of the clearance section 917J.

In use, the clearance section 917J can receive at least a portion of a second connecting rod. For example, the second connecting rod can rotate into the space defined by the clearance section 917J without contacting the connecting rod 916J. This arrangement can allow for closer positioning between the crankshafts in an engine, which can desirably reduce the overall size of the engine.

The clearance section 917J can define a transition region between the first portion 928J of the body 924J and the second portion 930J of the body 924J. As shown in FIG. 67B, the first portion 928J can be in a first plane into the page defined by the axis L1 and the second portion 930J can be in a second plane into the page defined by the axis L2. The planes L1, L2 are parallel to and offset from each other.

The clearance section 917J can be formed from a transitioning region between a first front surface 962J of the body 924J to a second front surface 964J of the body 924J. For example, a shoulder 966J can partially define the clearance section 917J and extend between the surfaces 962J, 964J. In the illustrated example, the shoulder 966J is substantially perpendicular to the surfaces 962J, 964J, but this is not required. In some implementations, the shoulder 966J can taper between the surfaces 962J, 964J. Further, the surfaces 962J, 964J may not be uniform and may include portions of varying depths.

In the illustrated example, the shoulder 966J is angled away from one side of the connecting rod 916J in a direction towards the opposite side of the connecting rod 916J. In some cases, the angle of the shoulder 966J can be selected based on the engine construction to prevent connecting rod interference while minimizing the portion of the connecting rod 916J with reduced thickness. In part due to the clearance section 917J, the third segment 925J can have a varying thickness along both its width and its length, in some implementations.

Referring now to FIGS. 68A-68D, a system 969J including a first connecting rod 916J1 and a second connecting rod 916J2 is shown. In the illustrated example, both connecting rods 916J1, 916J2 are configured as the connecting rod 916J of FIGS. 67A-67C and may be referred to as the connecting rods 916J. In other implementations, only one of the connecting rods in the system 969J may be configured as the connecting rod 969J.

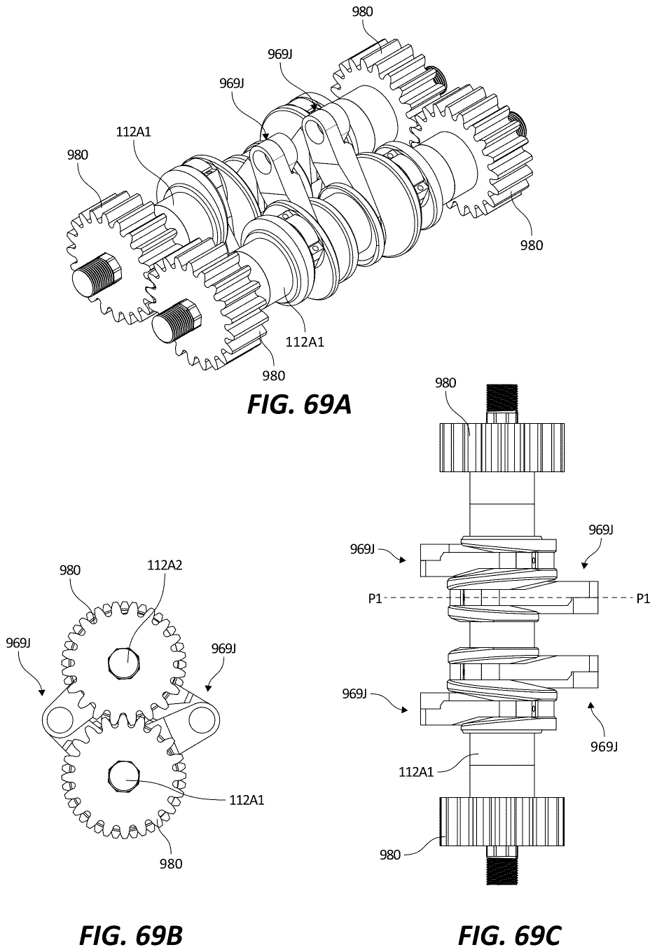

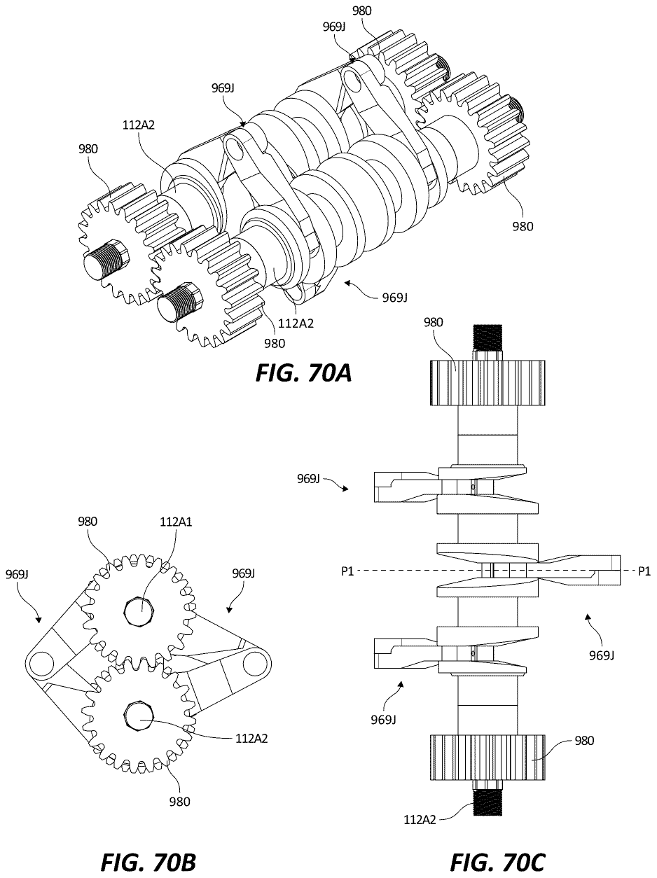

The system 969J includes the first connecting rod 916J1 and the second connecting rod 916J2. The first connecting rod 916J1 includes a big end 901J1 and a small end 912J1 while the second connecting rod 916J2 includes a big end 901J2 and a small end 912J2. The system 969J can be used to couple a piston to a pair of crankshafts. For example, FIGS. 69A-69C show various views of several systems 969J coupled to a pair of crankshafts 112A1 while FIGS. 70A-70C show various views of several systems 969J coupled to a pair of crankshafts 112A2. The first connecting rod 916J1 can be coupled to a piston (not shown in FIGS. 69A-70C) at the small end 912J1 and a first crankshaft at the big end 901J1 and the second connecting rod 916J2 can be coupled to the same piston at the small end 912J2 and a second crankshaft at the big end 901J2. Depending on the piston, the small ends 912J1, 912J2 may be coupled to a wrist pin of the piston adjacent to each other, similar to the arrangement of the connecting rods 916C1, 918C1 shown in at least FIG. 54.

As shown in FIG. 67B, which shows a side view of the system 969J, the big ends 901J1, 901J2 can be substantially aligned along a first plane P1 (into the page in FIG. 68B) during rotation of the first and second crankshafts. The term “substantially” is used to account for possible minor deviations from the plane P1 (e.g., due to manufacturing tolerances, lash, piston rocking, and/or the like). When arranged in this manner, the small end 912J1 of the first connecting rod 916J1 can travel substantially along a second plane P2 and the small end 912J2 of the second connecting rod 916J2 can travel along a third plane P3 during rotation of the first and second crankshafts. The second plane P2 is offset and parallel to the third plane P3. For example, the planes P2, P3 can be offset along the crankshaft longitudinal axes. As shown in FIG. 67B, the first plane P1 is positioned between the second and third planes P2, P3 in this arrangement. See also example arrangements of the system 969J with the plane P1 shown in FIGS. 69C and 70C.

One or both of the connecting rods 916J can include a clearance section. For example, the first connecting rod 916J1 can include a clearance section 917J1. The clearance section 917J1 is configured to receive at least a portion of the second connecting rod 916J2 during rotation of the first and second crankshafts. For example, the clearance section 917J1 can allow a scissoring motion between the connecting rods 916J in use.

In the illustrated example, the second connecting rod 916J2 also includes a clearance section 917J2. When paired together, the clearance sections 917J1, 917J2 can face each other, as shown in FIG. 68C. This arrangement can allow closer positioning of the connecting rods 916J together, which can be desirable. In this arrangement, the clearance section 917J1 of the first connecting rod 916J1 can receive a portion of the body of the second connecting rod 916J2 and the clearance section 917J2 of the second connecting rod 916J2 can receive a portion of the body of the first connecting rod 916J1. In FIG. 68C the connecting rods 916J are shown in a position that is not the closest possible position during their rotations.

FIG. 68D shows the connecting rods 916J in their closest positions to each other. This position would generally occur somewhere between the piston's top dead center and bottom dead center positions, when the connecting rods 916J are both on the internal sides of their respective crankshafts. As shown, a gap 919J can be maintained between the big ends 901J1, 901J2 of the connecting rods 916J. The gap 919J can be maintained due in part to the angle of the fastener boss axes relative to the connecting rod axes, as explained above. For example, the boss axes J3 of each connecting rod 916J are substantially parallel to each other in this position.

FIGS. 69A-69C shows four systems 969J coupled to a pair of crankshafts 112A1 and their associated gears 980. The crankshafts 112A1 are shown in a position that corresponds to the bottom dead center of the pistons that could be coupled to the connecting rods 916J. For example, the system of FIG. 69A-69C could be configured in a similar manner as the assemblies 900C, 900D of at least FIG. 54.

FIGS. 70A-70C shows three systems 969J coupled to a pair of crankshafts 112A2 and their associated gears 980. The crankshafts 112A2 are shown in a position that corresponds to the top dead center of the pistons that could be coupled to the connecting rods 916J. For example, the system of FIG. 70A-70C could be configured in a similar manner as the assemblies 900A, 900E of at least FIG. 60.

FIGS. 71A-75C illustrate example embodiments of internal combustion engines or components thereof that can incorporate the connecting rod and piston assemblies described herein as well as other features as described below and throughout this application.

With reference first to FIGS. 71A and 71B, a schematic side view and a partial schematic top view of an internal combustion engine 1000 is shown. In the illustrated example, the internal combustion engine 1000 includes embodiments of the piston and connecting rod assemblies, which can be the same as or similar to piston and connecting rod assemblies 900A, 900B, 900C, 900D, 900E, 900F described above with reference to FIGS. 51-63. In this example, the piston 1010B is configured as a combustion piston and the piston 1010A is configured as an auxiliary piston. The assemblies 900A, 900B are coupled to the counter-rotating crankshafts 112A, 112B.

The internal combustion engine 1000 can include an auxiliary housing 1080 for the piston 1010A. The auxiliary housing 1080 can be mounted to the uniblock 1002 of the internal combustion engine 1000. In operation, the reciprocation of the piston 1010A causes the delivery of intake air to the combustion chambers 1004. In the configuration of FIG. 71A, the auxiliary housing 1080 includes an intake port 1082 and an outlet port 1084. The outlet port 1084 can deliver fluid to the combustion chambers 1004 via the inlet feed pipe 1086. In the example of FIG. 71A, the inlet feed pipe 1086 directs fluid to the combustion chamber 1004 near the top of the page via the intake passage.

In the illustrated configuration, the internal combustion engine 1000 includes pushrods 1042 and rocker arms 1044. The pushrods 1042 can be driven by the rotation of the crankshafts 112, as described above. For example, the pushrods 1042 can include rollers 1045 configured to ride directly on the crankshaft 112 (e.g., on a cam lobe positioned thereon). As the crankshafts 112 rotate, the lobed portion of the cam lobs can push against the roller 1045 to move the lifters 1043 to actuate the pushrods 1042. The pushrods 1042 can transmit motion from the crankshafts 112 to the rocker arms 1044 to control the opening and/or closing of the intake valves 1024 and exhaust valves 1032.

In some embodiments, the internal combustion engine 1000 can include an exhaust restrictor 1095. The exhaust restrictor 1095 can be disposed and/or mounted in the exhaust passage 1034. The exhaust restrictor 1095 can be configured to change the exhaust backflow. For example, the exhaust restrictor 1095 can function as a choke or throttle valve for the internal combustion engine 1000. As a result, in some embodiments, the internal combustion engine 1000 can be configured to have a variable compression ratio.

In some embodiments, the exhaust restrictor 1095 can be a rotary or butterfly valve. For example, rotation of the exhaust restrictor 1095 can allow for different exhaust backflow and/or different amounts of scavenging. When the exhaust restrictor 1095 is in a completely open state, the internal combustion engine 1000 can be over-scavenged (e.g., can be supercharged via the auxiliary functioning of the piston 1010A). When over-scavenging is not desired, the exhaust restrictor 1095 can be moved between the open state and a closed state (e.g., partially closed) to create more back pressure by restricting the exhaust flow. In other embodiments, different types of valves can be used for the exhaust restrictor 1095.

In some embodiments, the internal combustion engine 1000 can be configured to have an expansion ratio of approximately 20:1. In some embodiments, the internal combustion engine 1000 can be configured to have a variable compression ratio of between approximately 12.5:1-30:1. For example, the compression ratio can be varied by changing the back pressure on the exhaust side via the exhaust restrictor 1095.

In some embodiments, the internal combustion engine 1000 can include a fuel injector pump 1092. For example, when the internal combustion engine 1000 is configured as a diesel engine, the fuel injector pump 1092 can be configured to deliver fuel during the diesel cycle (e.g., during the power stroke).

In the illustrated example, the fuel injector pump 1092 can include a roller 1093 configured to ride directly on one of the crankshafts 112 (e.g., on a cam lobe mounted on the crankshaft), instead of on a secondary shaft. As the crankshafts 112 rotate, the lobed portion of one of the cam lobe can push against the roller 1093 to actuate the fuel injector pump 1092, causing fuel to be delivered. In some embodiments, it can be preferable to configure the crankshaft 112 to run the fuel injector pump 1092 in a 2-stroke engine, because a reduction in speed for the fuel injector pump 1092 is not required.

Configuring the crankshafts 112 to drive one or both of the pushrods 1042 and the fuel injector pump 1092 can provide an advantage of reducing the total number of shafts in an engine. For example, a conventional engine may include two cam shafts and a secondary pump shaft for these functions, in addition to at least one crankshaft. Accordingly, configuring the crankshafts 112 in this manner can provide at least one less shaft in the engine. Having less shafts can decrease the weight of the engine, the complexity of the engine (e.g., less parts, less bearings), the size of the engine, and/or the cost of the engine, which is desirable.

In some cases, configuring the crankshafts 112 to drive the pushrods 1042 can allow for the overall length of the pushrods 1042 to be reduced compared to pushrods driven off of camshafts. This is because of the additional distance that can be required to accommodate the camshafts. Having shorter pushrods 1042 can provide a benefit of reducing the mass of the pushrods and the overall engine and/or can reduce the overall size of the engine. The pushrods 1042 can also be shorter than in conventional engines due to the shorter stroke enabled by the dual crankshaft configuration, as described herein.

In some embodiments, the internal combustion engine 1000 can include a transmission gear 1090. The transmission gear 1090 can be configured as a ratio-changing gear that can be paired to the two counter-rotating meshed crankshafts 112.

In the illustrated example, the transmission gear 1090 is configured as a reduction gear, having a larger pitch diameter compared to the crankshafts 112. Such a configuration may be desirable for applications where the rotation of the crankshafts 112 is too fast for the desired output (e.g., for spinning a propeller in a drone). In other embodiments, the transmission gear 1090 can be configured as an overdrive gear, having a smaller pitch diameter compared to the crankshafts 112. Such a configuration may be desirable for applications where the rotation of the crankshafts 112 is too slow for the desired output (e.g., for increasing output speed for improved fuel efficiency in automotives). In some embodiments, the transmission gear 1090 can drive a power takeoff shaft 1091 for the internal combustion engine 1000.

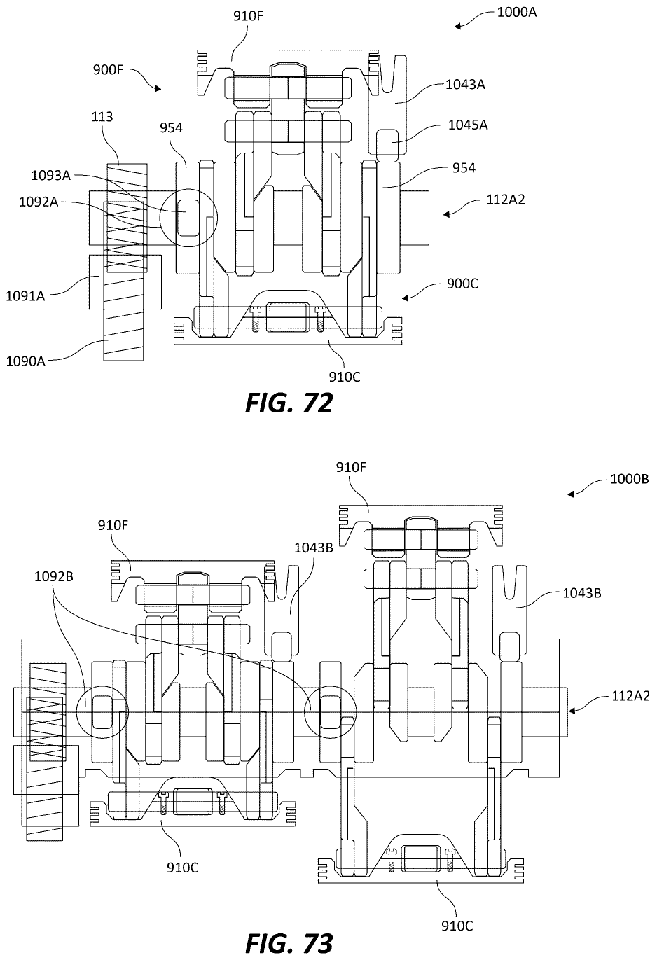

FIGS. 72 and 73 show side or top views of select assemblies 1000A and 1000B, respectively, that can be used in internal combustion engines, for example. In the illustrated example, the assemblies 1000A and 1000B can each incorporate embodiments of the assemblies 900C, 900F.

Referring first to FIG. 72, the assembly 1000A is configured with a single pair of opposed pistons 910C, 910F. The assembly 1000A includes two counter-rotating crankshafts. In the illustrated example, the crankshafts are configured as the crankshaft 112A2.

As shown in FIG. 72, the connecting rod and piston assemblies 900C, 900F can be coupled to the crankshaft 112A2. The crankshaft 112A2 can include a gear 113 that is in mesh with the transmission gear 1090A of a power takeoff or output shaft 1091A. Cam lobes 954 can be configured to drive the fuel injector pump 1092A and at least one pushrod lifter 1043A. For example, the roller 1093A for the fuel injector pump 1092A can engage the web 954 on the left-most side of the page. Similarly, the roller 1045A for the pushrod can engage the web 954 on the right-most side of the page. The other crankshaft of the internal combustion engine 1000A (not shown) can be configured to drive the other pushrod, in some embodiments.

Referring now to FIG. 73, the assembly 1000B can differ from the internal assembly 1000A in that the internal combustion engine 1000B is configured as a dual-piston engine (having two pairs of opposed pistons). For example, the internal combustion engine 1000B can include two pistons 910F for combustion and two auxiliary pistons 910C configured for scavenging. Because there are two combustion pistons 910F, the internal combustion engine 1000B can further include additional pushrod lifters 1043B and fuel injector pumps 1092B, and the crankshaft 112A2 can be longer.

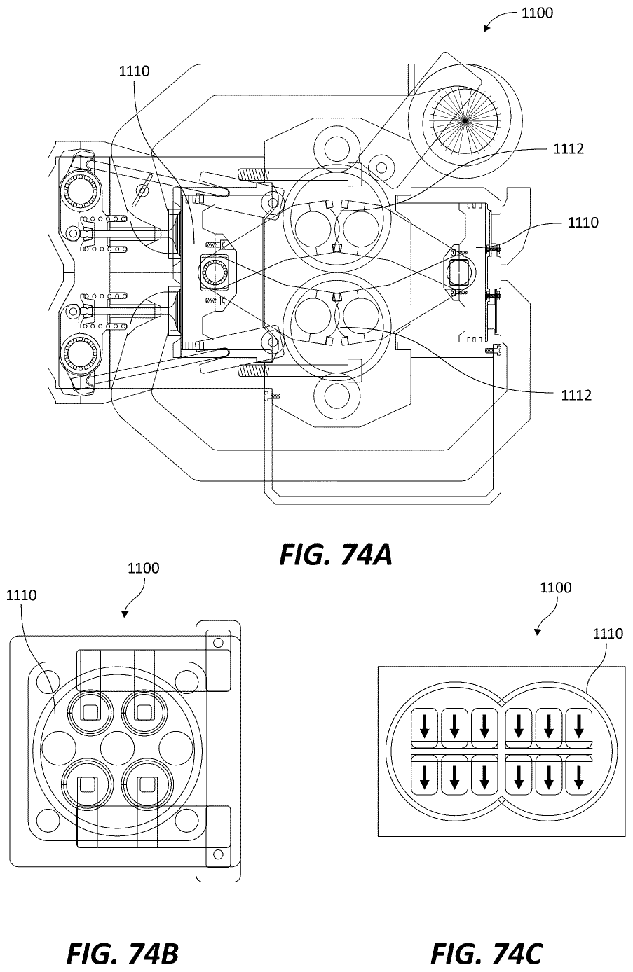

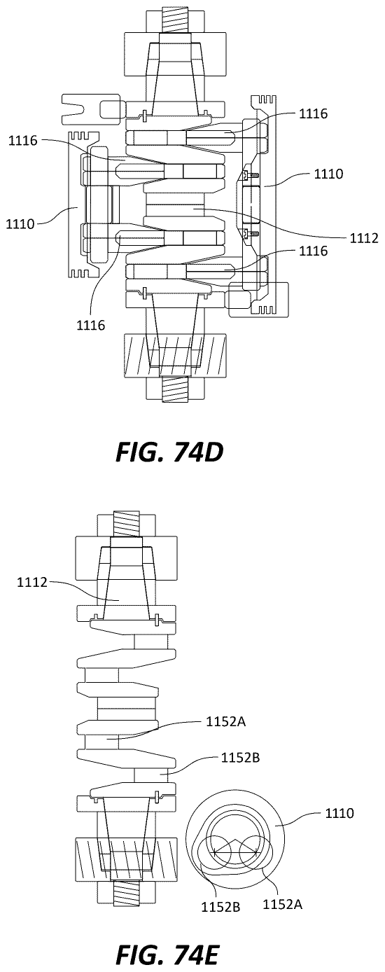

FIGS. 74A-74F illustrate a schematic views of an example embodiment of an internal combustion engine 1100. FIG. 74A illustrates a partial cross-sectional schematic side view of the internal combustion engine 1100. As shown, in this embodiment, the internal combustion engine 1100 includes a pair of in mesh, counter rotating crankshafts 1112. Each crankshaft 1112 is connected by a plurality of connecting rods to pistons 1110. In the illustrated embodiment the piston 1110 on the left of the figure is configured as a combustion piston and the piston 1110 on the right is configured as a scavenging piston 1110.

FIG. 74B shows a partial side view of the internal combustion engine 1100, illustrating schematically the combustion piston/cylinder side of the engine. As shown, in this embodiment, the combustion piston 1110 is cylindrical. This view also illustrates a plurality of intake and exhaust ports as well as associated lifter components. FIG. 74C illustrates another partial side view of the internal combustion engine 1100, illustrating the auxiliary piston/cylinder side of the engine. As shown, in this configuration, the auxiliary piston comprises a double-C shaped piston. A plurality of intake and exhaust ports, in this instance configured as reed valves are also shown.

FIG. 74D illustrates a side view of a crankshaft 1112, connecting rods 1116, and piston 1110 assembly for the internal combustion engine 1100. As shown, each piston 1110 is connected to the crankshaft 1112 by two connecting rods 1116. Each piston is also connected to the additional crankshaft 1112 (not visible in FIG. 74D because it is positioned directly below the visible crankshaft 1112) by two additional connecting rods 1116. Each piston 1110 is coupled to four connecting rods 1116, with two connecting rods 1116 coupling to one crankshaft 1112 and two connecting rods 1116 connecting to the other crankshaft. The connecting rods 1116 can be configured with a scissoring configuration as previously described.

FIG. 74E illustrates that, for the illustrated embodiment, an angle may exist between different crank pins 1152A, 1152B on the crankshaft 1112 that connect different connecting rods 1116 to a piston 1110 (such angle being referred to herein as the crankpin offset). For example, the crankpin offset can be the angle between different crankpins in a crankshaft about the longitudinal/rotational axis of the crankshaft.

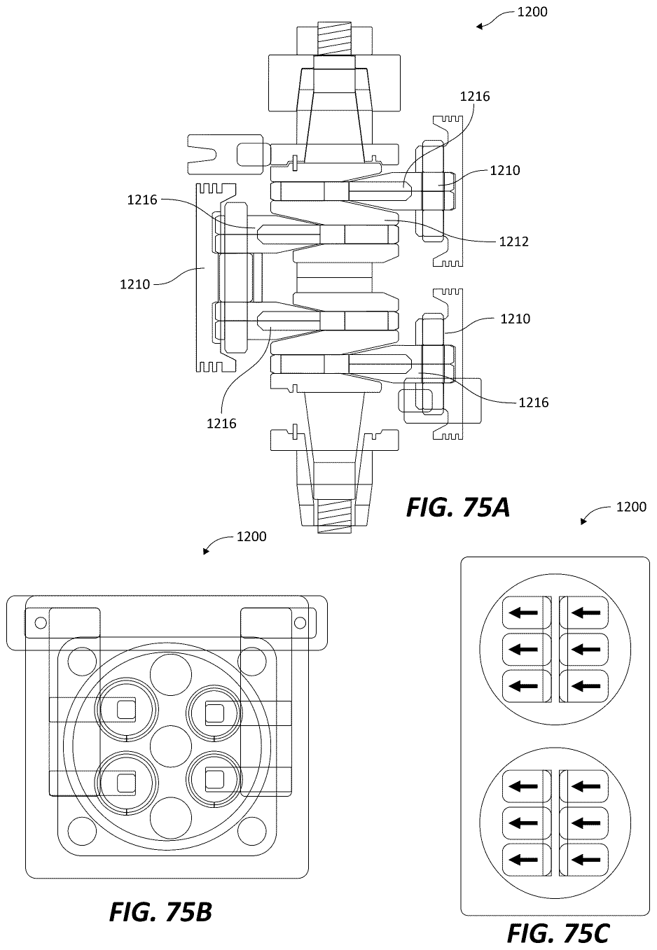

FIG. 75A-75C illustrate various views of components of an internal combustion engine 1200. The internal combustion engine 1200 is in many respects similar to the internal combustion engine 1100, except that the single auxiliary piston 1110 has been replaced with two auxiliary pistons 1210. In this embodiment, the combustion piston 1210 (left side) is coupled to the crankshafts 1212 by two pairs of scissoring connecting rods 1216 with two connecting rods coupling to one crankshaft 1212 and two connecting rods 1216 connecting to the other crankshaft 1212 (not visible in FIG. 75A because it is below the visible crankshaft). Each auxiliary piston 1210 (right side) is coupled to two scissoring connecting rods 1216, with one connecting rod 1216 coupling to each of the two crankshafts. FIGS. 75A and 75B show side views associated with combustion piston/cylinder and auxiliary pistons, respectively.

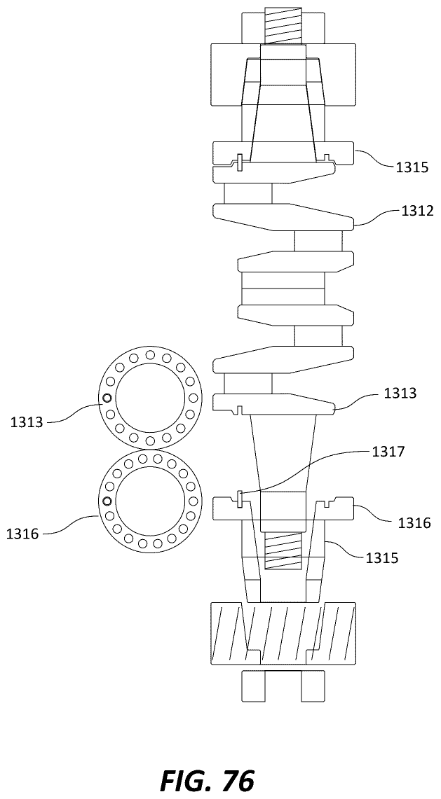

FIG. 76 illustrates an embodiment of a crankshaft 1312 that includes an indexable and adjustable cam (or cam lobe or lobe) 1315. As shown, a web 1313 of the crankshaft 1312 can include a plurality of alignment holes. The cam 1315 can be configured to include a sleeved body configured to fit over the crankshaft 1312 and also includes a body 1316 comprising a plurality of alignment holes. A pin 1317 can be used to couple an alignment hole of the crankshaft 1312 with an alignment hole of the cam 1315. By varying the rotational position of the cam 1315 to the crankshaft 1312 different positions for lobes on the cam 1315 can be achieved to adjust, for example, valve timing. Further, the cam 1315 can be removed and replaced with a different cam 1315 having different lobe profiles. Other configurations may also be possible.

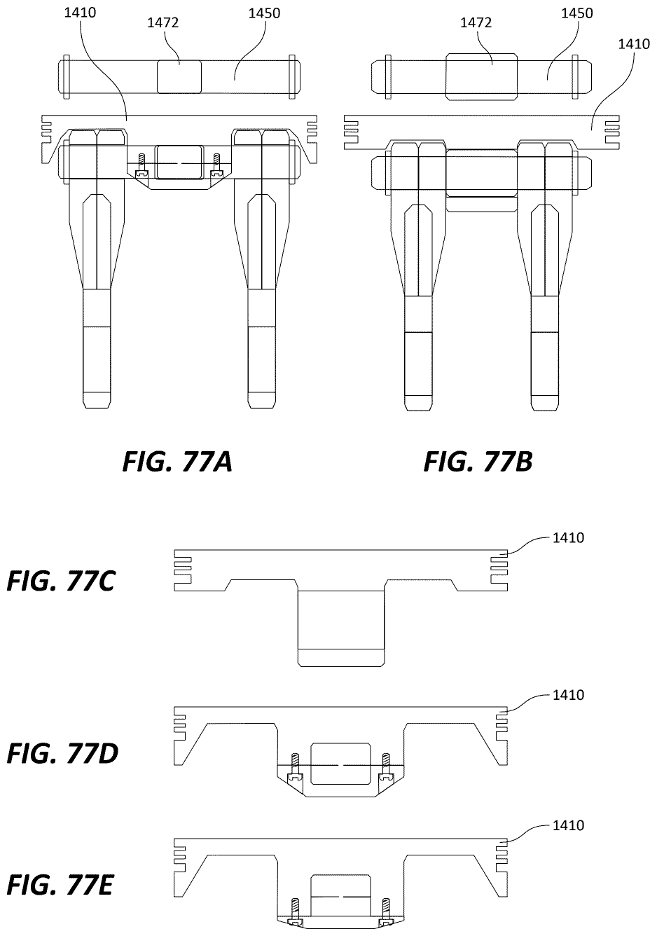

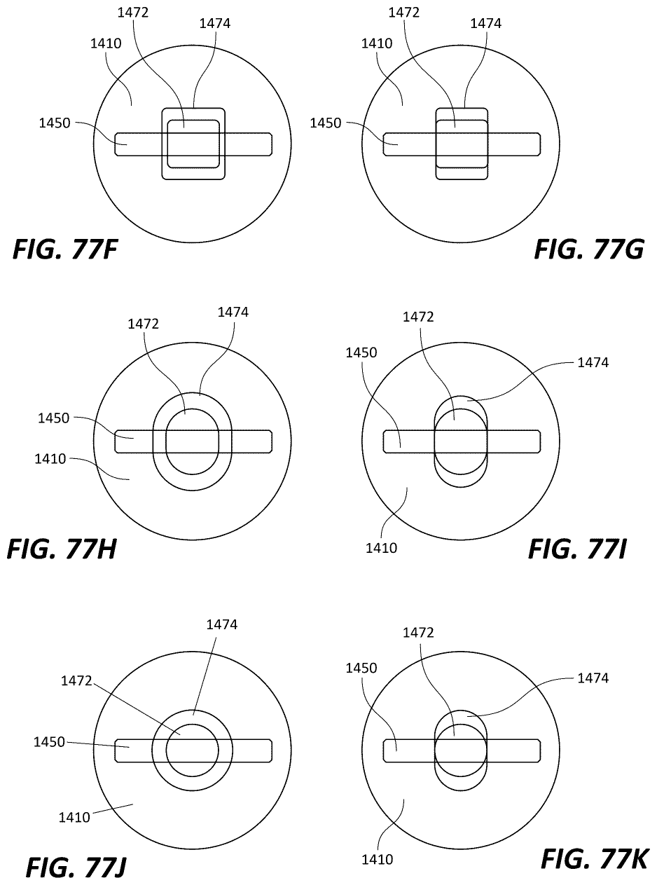

FIGS. 77A-77K illustrate various configurations for coupling a wrist pin 1450 to a piston 1410 in a manner that provides one or more degrees of freedom. As shown in FIGS. 77A, 77B, and 77F-77K, the wrist pin 1450 can include a translating portion 1472 positioned or formed thereon. The translating portion 1472 can be received within a recess or opening 1474 formed in the piston such that the translating portion 1472 can translate in one or more degrees of freedom relative to the piston.

FIG. 77A illustrates an embodiment where the piston 1410 comprises two components that can be fastened together around the wrist pin 1450 and translating portion 1472. FIG. 77B illustrates an embodiment where the piston comprises a single component and the wrist pin 1450 and translating portion 1472 can be slid into and through an opening in the piston from the side.

FIGS. 77C-77D illustrate embodiments of pistons 1410 configured for use with wrist pins 1450 and translating portions 1472. FIG. 77C shows a single piece piston 1410 wherein the wrist pin 1450 and translating portion 1472 would be slid in from the side. FIGS. 77D and 77E illustrate two-piece pistons 1410 that can be fastened around the wrist pin 1450 and translating portion 1472.

FIGS. 77F-77K illustrate cross-section views of wrist pin 1450 and translating portion 1472 positioned within corresponding recesses 1474 of a piston 1410 to provide one or more degrees of freedom therebetween. FIG. 77F illustrates an embodiment with a square shaped translating portion 1472 received within a square shaped recess 1474 that is larger than the translating portion 1472 in each direction thereby allowing more than one degree of freedom of relative motion. FIG. 77G illustrates an embodiment with a square shaped translating portion 1472 received within a square shaped recess 1474 that is larger than the translating portion 1472 in only a single direction thereby only one degree of freedom of relative motion. FIG. 77H illustrates an embodiment with an oval shaped translating portion 1472 received within an oval shaped recess 1474 that is larger than the translating portion 1472 in each direction thereby allowing more than one degree of freedom of relative motion. FIG. 77I illustrates an embodiment with an oval shaped translating portion 1472 received within an oval shaped recess 1474 that is larger than the translating portion 1472 in only a single direction thereby only one degree of freedom of relative motion. FIG. 77J illustrates an embodiment with a circle shaped translating portion 1472 received within a circle shaped recess 1474 that is larger than the translating portion 1472 in each direction thereby allowing more than one degree of freedom of relative motion. FIG. 77K illustrates an embodiment with a circle shaped translating portion 1472 received within an oval shaped recess 1474 that is larger than the translating portion 1472 in only a single direction thereby only one degree of freedom of relative motion. Other embodiments are also possible.

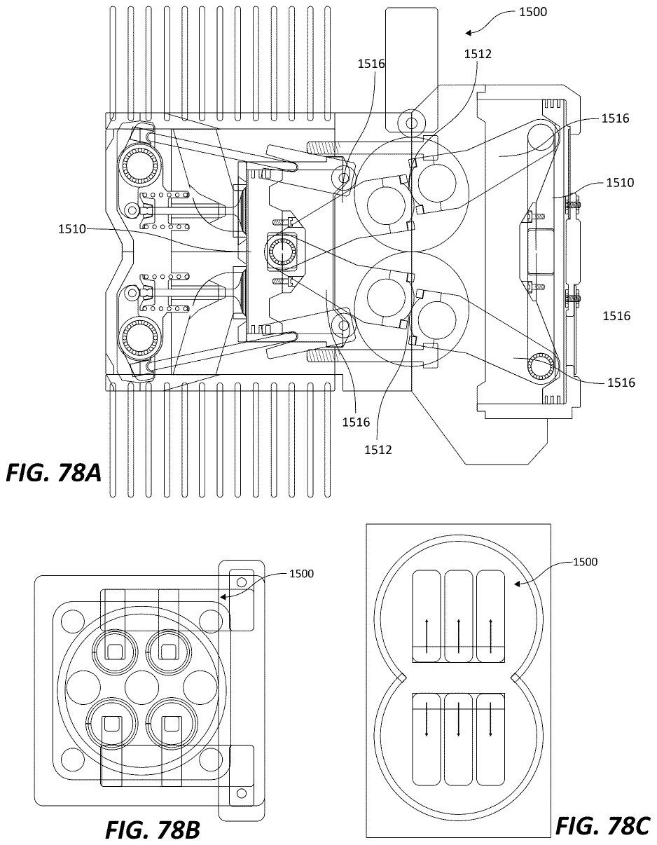

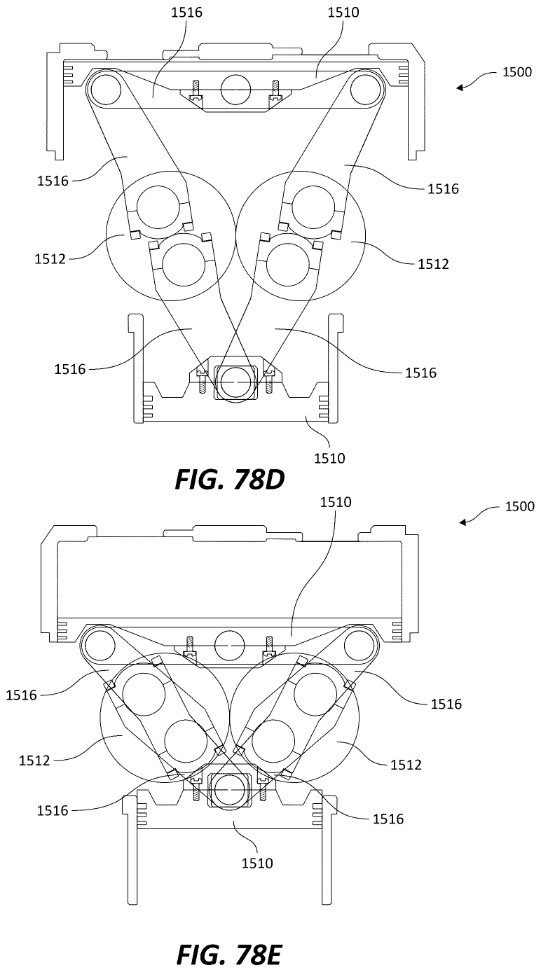

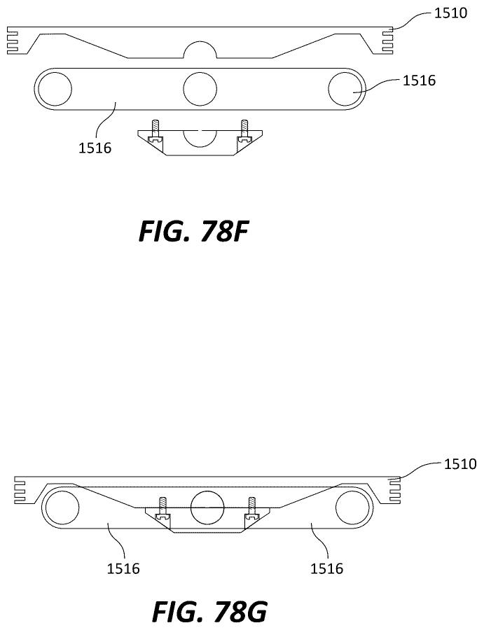

FIGS. 78A-78G illustrate an embodiment of an internal combustion engine 1500 and various components thereof. As shown, in this embodiment, the internal combustion engine 1500 includes a pair of in mesh, counter rotating crankshafts 1512. Each crankshaft 1512 is connected by a plurality of connecting rods 1516 to pistons 1510. In the illustrated embodiment the piston 1510 on the left of the figure is a combustion piston and the piston 1510 on the right is a scavenging piston 1510. Notably, the connecting rods 1516 coupled to the combustion piston 1510 (left side) toe-in or converge towards the combustion piston 1510, while the connecting rods 1516 that couple to the auxiliary piston 1510 (right side) toe-out or diverge towards the auxiliary piston 1510. The diverging connecting rods 1516 are coupled to the piston 1510 by a third, cross-linking connecting rod 1516.

FIG. 78B shows a partial side view of the internal combustion engine 1500, illustrating the combustion piston/cylinder side of the engine. As shown, in this embodiment, the combustion piston 1510 is cylindrical. This view also illustrates a plurality of intake and exhaust ports as well as associated lifter components. FIG. 78C illustrates another partial side view of the internal combustion engine 1500, illustrating the auxiliary piston/cylinder side of the engine. As shown, in this configuration, the auxiliary piston comprises a double-C shaped piston. A plurality of intake and exhaust ports, in this instance configured as reed valves are also shown.

FIGS. 78D and 78E show the pistons 1510 at top dead center and bottom dead center positions, respectively.

FIGS. 78F and 78G illustrate exploded and assembled views, respectively, of the auxiliary piston 1510 and its coupling to the third connecting rod 1516.

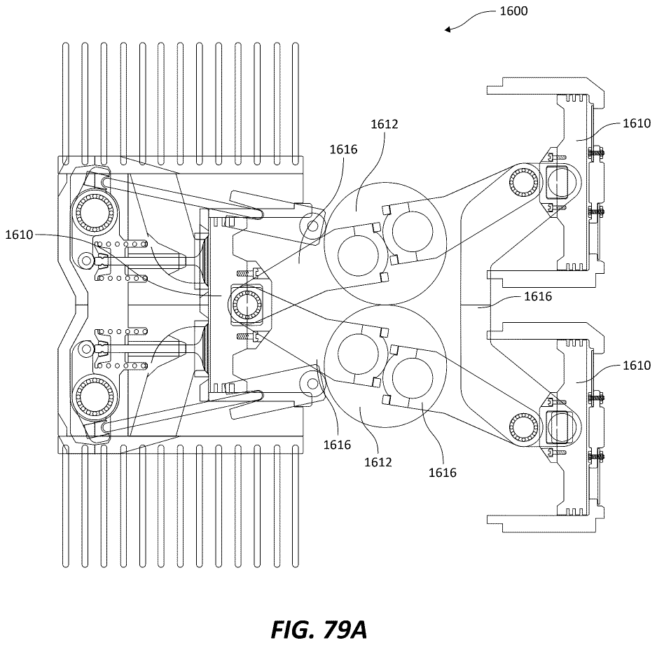

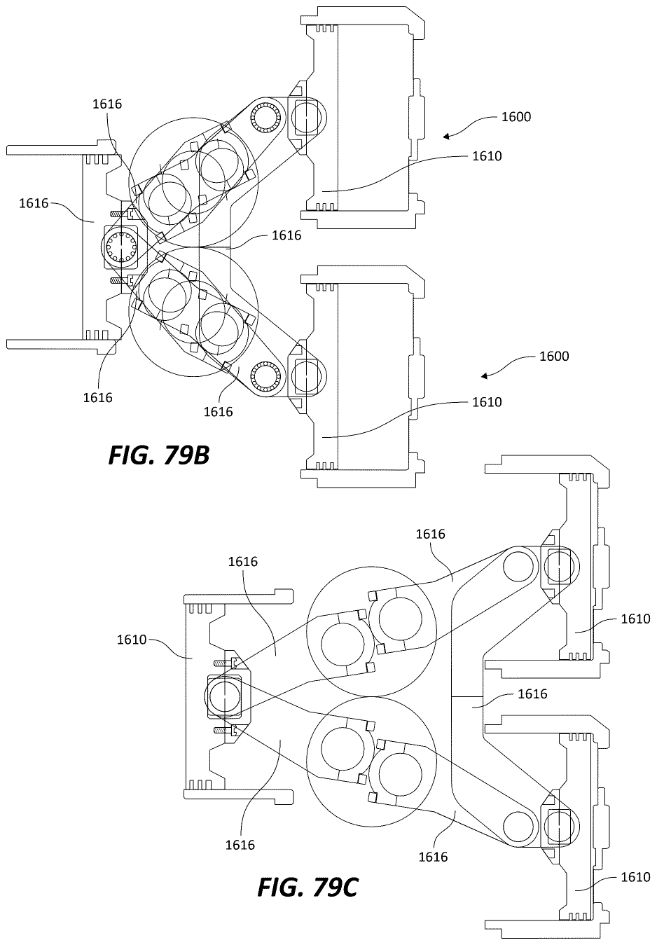

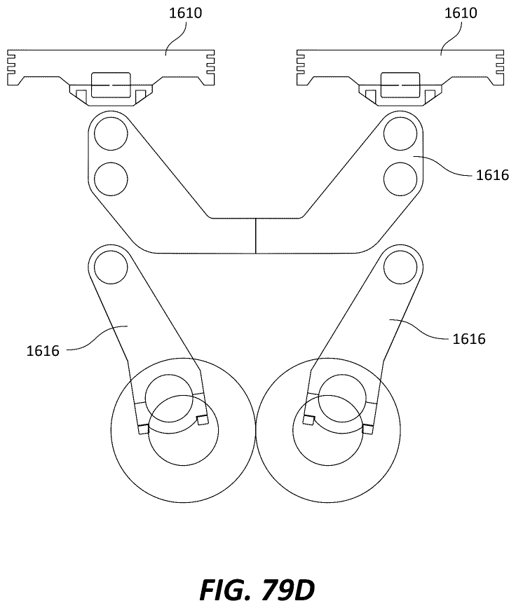

FIG. 79A-79D illustrate various views of components of an internal combustion engine 1600. The internal combustion engine 1600 is in many respects similar to the internal combustion engine 1500, except that the single auxiliary piston 1510 has been replaced with two auxiliary pistons 1610. The third connecting rod 1516 that couples to each of the auxiliary pistons 1610 is modified to include a U- or bowed-shape so as to allow travel of the pistons. FIGS. 79B and 79C show the pistons at bottom dead center and top dead center respectively. FIG. 79D is a partially exploded view illustrating the connecting rods that couple to the auxiliary pistons 1610.

FIGS. 80A-81D illustrate various views of an embodiment of an internal combustion engine 1700 and components thereof. FIGS. 80A-80C show perspective views and a side view of the engine 1700 and FIGS. 81A-81D show various partial, section, and exploded views of components of the engine 1700.

The engine 1700 can be similar to the engine 100 of FIG. 1. However, the engine 1700 differs from the engine 100 at least in that the engine 1700 does not include a linkage assembly 150 in the illustrated example. In the illustrated example, the engine 1700 includes a pair of counter-rotating crankshafts 1712 configured to be driven by one or more pistons 1710. As described further herein, the crankshafts 1712 can be coupled to the pistons by a plurality of connecting rods 1716.

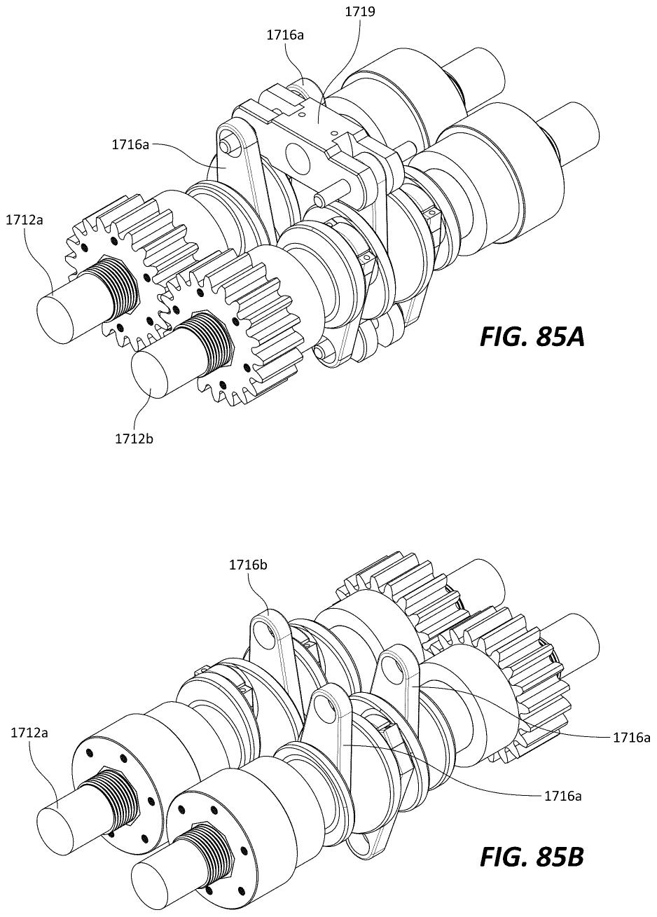

In some embodiments, a pair of crankshafts 1712 can be connected to a pair of pistons 1710 by six connecting rods 1716. For example, for each pair of pistons 1710, each crankshaft 1712 can be configured to support three connecting rods 1716 (e.g., via three crankpins). In such configurations, each piston 1710 can be coupled to two, three, or four connecting rods 1716. For example, one piston 1710a can be coupled to two connecting rods 1716 and the other piston 1710b can be coupled to four connecting rods 1716, or vice versa. In another example, each piston 1710 can be coupled to three connecting rods 1716. These configurations are described further below with reference to at least FIGS. 82A-82C and 85A-85B.

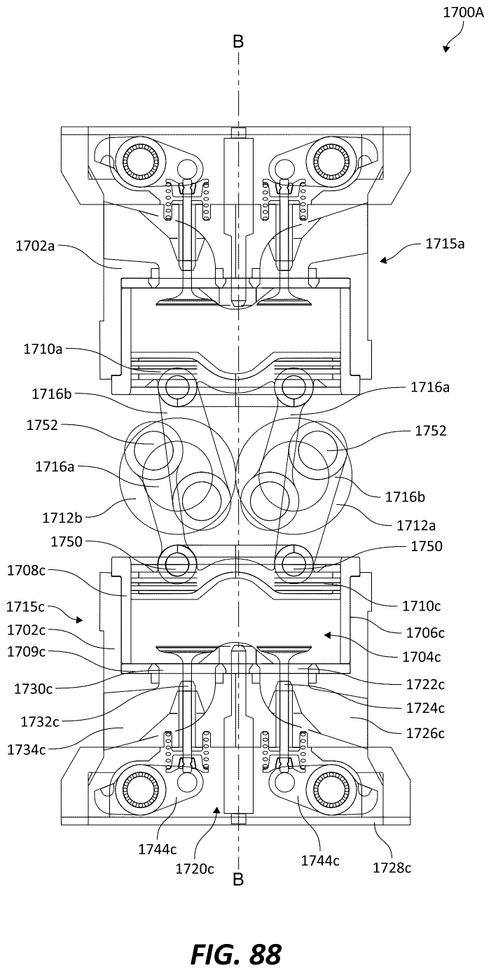

As shown in FIGS. 80A-81D, in the illustrated example, the engine 1700 is a stacked dual-chamber assembly, including a first block 1702a for a first engine assembly 1715a and a second block 1702b for a second engine assembly 1715b. The first engine assembly 1715a can be configured for combustion, and the second engine assembly 1715b can be configured to scavenging the first engine assembly 1715a (e.g., can include an auxiliary piston). In other implementations, both engine assemblies can be configured for combustion (see e.g., the engine 1700A of FIG. 88). In other implementations, the engine 1700 may only include one block 1702a and the first engine assembly 1715a.

The first block 1702a can be a uniblock. For example, the first block 1702a can be a single component that defines what would be considered the cylinder head and cylinder block in a conventional reciprocating internal combustion engine. As shown in at least FIG. 81D, the block 1702a can be a monolithic component that defines a first bore 1706a and a combustion chamber 1704a. In some implementations, the first block 1702a can define multiple cylinder bores 1706a. In other implementations, the engine 1700 can include distinct cylinder block and cylinder head assemblies, similar to a conventional engine.

In some implementations, the second block 1702b can also be a uniblock, but this is not required. In the illustrated example, the second block 1702b is similar to a uniblock construction in that the block 1702b defines a second bore 1706b and an auxiliary chamber 1704b. However, because the second block 1702b is configured for an auxiliary piston in the illustrated example, additional structure for a valve train are not defined in the second block 1702b or included in the second engine assembly 1715b.

The first block 1702a can enclose, envelope, and/or surround both of the combustion chamber 1704a and at least a portion of the bore 1706a that is associated with the combustion chamber 1704a. In some configurations, the block 1702a encloses, envelopes, and/or surrounds the combustion chamber 1704a and at least a majority of the bore 1706a. In some configurations, the block 1702a encloses, envelopes, and/or surrounds the combustion chamber 1704a and all of the bore 1706a. In other words, the combustion chamber 1704a and the bore 1706a can be defined within the first block 1702a.

In the illustrated example, the blocks 1702a, 1702b are stacked end-to-end with a housing 1736 disposed between. The housing 1736 can join the two blocks 1702a, 1702b together. For example, each block 1702a, 1702b can be coupled with the housing 1736. In other implementations, the blocks 1702a, 1702b can be positioned side-by-side.

The housing 1736 can at least partially house the crankshafts 1712 of the engine 1700 within its internal volume 1738. The housing 1736 may be referred to as the “crankcase” herein. Depending upon the configuration of the engine 1700, the number of crankshafts 1712 and/or their rotation relative to one another can vary. In the illustrated configuration, the engine 1700 carries a first crankshaft 1712a and a second crankshaft 1712b (referred to herein as the crankshafts 1712). The two crankshafts 1712 can be counterrotating. For example, each crankshaft 1712 can include at least one gear 1780 that is in mesh with the gear 1780 of the other crankshaft 1712 (see e.g., FIG. 83). The two crankshafts 1712 can be at least partially housed or enclosed within the housing 1736.

In the illustrated configuration, the two crankshafts 1712 are fully housed within the housing 1736. As shown in at least FIG. 81D, the housing 1736 can include crankshaft containing passages/portions 1753 configured to allow the crankshafts 1712 to rotate within. For example, one or more main bearings 1767 can be positioned within the crankshaft containing passage 1753 to engage the bearing journals of the crankshafts 1712 to allow rotation the crankshafts 1712 relative to the housing 1736. For illustrative purposes, a single bearing 1767 is shown in FIG. 81D.

In the illustrated example, the engine 1700 is configured for two crankshafts 1712 and the housing 1736 includes two adjacent crankshaft containing passages 1753, which can be bores extending through the housing 1736 (e.g., crankshaft bores). In other configurations, the two crankshafts 1712 may be housed at least partially or fully within one or both of the blocks 1702a, 1702b. Further, additional passages 1753 may be included for implementations of the engine 1700 that includes additional crankshafts, similar to the engines 1800A, 1800B, and 1800C of FIGS. 92A-92C.

As shown in FIG. 81B, which shows a section view of the engine 1700, the engine 1700 includes a first piston 1710a and a second piston 1710b (“pistons 1710”). In other implementations, additional or fewer pistons 1710 can be included. The two crankshafts 1712 are positioned between the two pistons 1710. The center axes (i.e., the axes of rotation) of the crankshafts 1712 can be disposed between the bottoms of the bores 1706a, 1706b. For example, the center axes of the crankshafts 1712 remain below the first piston 1710a when at bottom dead center and above the second piston 1710b when at bottom dead center.

The first piston 1710a is positioned within the bore first 1706a. The bore 1706a can has a shaft corresponding to the piston 1710a. For example, when the piston 1710a is cylindrical, the bore 1706a can be a cylinder bore. The piston 1710a is configured to reciprocate within the bore 1706a. In some configurations, the piston 1710a is inserted into the block 1702a from the bottom of the block 1702a. In other words, when the combustion chamber 1704a and the bore 1706a are formed inwardly from the bottom of the block 1702a (i.e., similar to a blind hole), the piston 1710a can be inserted into the bore 1706a from the bottom of the first block 1702a.

The second piston 1710b is positioned within the second bore 1706b. The bore 1706b can has a shaft corresponding to the piston 1710b. For example, when the piston 1710b is cylindrical, the bore 1706b can be a cylinder bore. The piston 1710b is configured to reciprocate within the bore 1706b. In some configurations, the piston 1710b is inserted into the block 1702b from the bottom of the block 1702b.

The first bore 1706a and the second bore 1706b (“bores 1706”) can each have central bore axis that are aligned with each other. For example, a bore axis B can define the central axis of both bores 1706. This configuration is possible in part due to the construction of the crankshafts 1712, as described further herein.

Having opposing bores 1706 with a shared central axis B can prevent or reduce the bending loads, torsional vibrations, and secondary forces on the crankshafts 1712. As a result, the crankshafts 1712 can be smaller and lighter, resulting in a more efficient, smaller, and/or lighter engine 1700. Additionally, the opposite pistons 1710 can be completely opposed to each other, resulting in a more balanced configuration.

According to some configurations, a top end of one or both of the bores 1706 can be lined with a top plate and/or the side wall of the bores 1706 can be lined with a liner. In the illustrated example, the first bore 1706a is lined with a top plate 1708 (e.g., a cylinder top plate) and is lined with a liner 1709 (e.g., a cylinder liner). The liner 1709 and the top plate 1708 can be integrated or separately formed. In some configurations, the liner 1709 can abut the top plate 1708 and hold the top plate 1708 adjacent to the top end of the bore 1706a. In some configurations, the liner 1709 and/or the top plate 1708 can be formed from, or can comprise a layer of, Inconel or similar materials that have a very low thermal conductivity.

In some implementations, the second bore 1706b can be lined in a similar manner. However, in the illustrated example, the second bore 1706b does not include top plate or a liner because the second bore 1706b is configured for an auxiliary piston. However, in some configurations, the second bore 1706b may still include one or both of a top plate and liner, even used for an auxiliary piston.

Each piston 1710 is connected to the two crankshafts 1712 by one or more connecting rods 1716. In the illustrated example, wrist pins 1750 are used for connecting the connecting rods 1716 to the pistons 1710. The connecting rods 1716 convert the linear motion of the piston(s) 1710 into the rotational motion of the crankshafts 1712. In the view of FIG. 81B, the connecting rods for the second piston 1710b are not visible. The pistons 1710 can be coupled to the crankshafts 1712 using any of the connecting rods described herein. Several possible connecting rod arrangements and constructions for the connecting rod 1716 are described further herein with reference to at least 82A-87C.

Combustion materials (e.g., fuel and air) are delivered to the engine 1700 for combustion in at least one of the chambers 1704. In the illustrated example, only the first chamber 1704a is configured for combustion, and the first block 1702a includes various components and structures to facilitate the combustion events. In other configurations, both chambers 1704 can be configured for combustion and the engine 1700 can be modified accordingly (see e.g., engine 1700A of FIG. 88).

In the illustrated configuration, the first block 1702a includes at least one intake valve opening 1722 and/or at least one fuel injector (not shown). Flow into the combustion chamber 1704a through each intake valve opening 1722 can be controlled by an intake valve 1724. Air for the combustion chamber 1704a can be received via one or more intake passages 1726. The intake passage(s) 1726 can extend though a side surface of the first block 1702a.

The engine 1700 can expel exhaust products through at least one exhaust valve opening 1730. Flow out of the combustion chamber 1704a through the exhaust valve opening(s) 1730 can be controlled by exhaust valve(s) 1732. The exhaust gases that pass through the exhaust valve opening(s) 1730 enter into exhaust passage(s) 1734. In the first block 1702a, the exhaust passages(s) 1734 originate at the exhaust valve opening(s) 1730 and extends upward and outward in the illustrated configuration. The exhaust passage(s) 1734 can be formed within the first block 1702a in any suitable manner. In configurations featuring multiple exhaust valve openings 1730, the exhaust passage 1734 can comprise multiple runners with each runner terminating at the respective exhaust valve opening 1730. Other configurations are also possible.

In the illustrated configuration, the second piston 1710b is an auxiliary piston that is configured to supply intake air to the combustion chamber 1704a. For example, the second block 1702b can include one or more intake ports 1782 and one or more outlet ports 1784 in fluid communication with the auxiliary chamber 1704b. The ports 1782, 1784 can include one-way valves that allow fluid to travel through the second block 1702b in only one direction. For example, the intake ports 1782 can allow fluid into the auxiliary chamber 1704b but not out of the auxiliary chamber 1704b while the outlet ports 1784 can allow fluid out of the auxiliary chamber 1704b but not into the auxiliary chamber 1704b. As the second piston 1710b moves from top dead center to bottom dead center, the pressure difference between the external environment and the auxiliary chamber 1704b can cause air to enter the auxiliary chamber 1704b via the intake ports 1782. Similarly, as the piston 1710b moves from bottom dead center to top dead center, air can be forced out of the auxiliary chamber 1704b through the outlet ports 1784.

To deliver the air from the auxiliary chamber 1704b to the combustion chamber 1704a, the engine 1700 can include a feed pipe 1786. The feed pipe 1786 connects the outlet ports 1784 to the intake passage(s) 1726. As the piston 1710a reciprocates, the linear motion of the piston 1710a can cause the rotational motion of the crankshafts 1712, which in turn can cause the second piston 1710b to reciprocate, generating intake air for delivery to the combustion chamber 1704a. Further details on auxiliary piston related configurations are described in PCT Application No. US2025/041540, any of which can be used in the engine 1700.

The engine 1700 can include a valve train 1720 to control the opening and closing of the valves 1724, 1732. The valve train 1720 can be mainly positioned within a chamber defined by a valve train cover 1728 and a recess defined within the upper surface of the first block 1702a. Fasteners (not shown) can be used to secure the valve train cover 1728 to the first block 1702a. A sealing gasket (not shown) can be positioned between the valve train cover 1728 and the first block 1702a.

FIG. 81A shows a top perspective view of the engine 1700 with the first block 1702a and a majority of the valve train 1720 removed, exposing the top plate 1708 and the liner 1709 of the combustion chamber 1704a as well as the valves 1724, 1732 and push rods 1742. With reference to FIGS. 81A and 81B, the valve train 1720 can include one or more pushrods 1742 and one or more rocker arms 1744. In the illustrated example, the pushrods 1742 are actuated directly by cam lobes 1746 (see e.g., FIGS. 82A-83) on the crankshafts 1712. The pushrods 1742 can transmit motion from the crankshafts 1712 to the rocker arms 1744 to control the opening and/or closing of the intake valves 1724 and exhaust valves 1732. The number of pushrods 1742 can vary depending on the number of valves 1724, 1732 and rocker arms 1740, and how they are connected to each other.

In the illustrated example, the second block 1702b does not house a valve train because the second piston 1710b is configured for auxiliary use. In other examples, the second block 1702b may include a similar valve train to the valve train 1720 and pushrods may be used to control the valve actuation.

In other implementations, different configurations for the valve train 1720 are possible. For example, the engine 1700 may include camshafts for actuating the pushrods 1742, may include one or more camshafts as part of an overhead cam system, and/or may include other valve actuating systems. In some configurations, the engine 1700 can utilize the valve actuating systems described in PCT Application No. US2024/054996.

Referring back to FIGS. 80A and 80B, one or both of the blocks 1702 can include cooling structures, such as cooling fins 1799. The cooling fins 1799 can extend around at least a portion of one or both of the blocks 1702. In the illustrated example, both blocks 1702 include cooling fins 1799. In cases where the second block 1702b is configured for auxiliary purposes, cooling fins 1799 may not be utilized.

The engine 1700 can include an oil pan 1751. The oil pan 1751 is a structural reservoir affixed to housing 1736 in the illustrated example. The oil pan 1751 can be configured to collect, store, and contain lubricating oil during engine operation and shutdown, while also facilitating oil circulation by providing a sump (not shown) from which oil is drawn by a pump and to which oil returns by gravity after lubricating internal components of the engine 1700. In some cases, the oil pan 1751 can serve secondary functions such as heat dissipation, contamination settling, and accommodation of sensors or drain features, thereby supporting lubrication system performance, engine durability, and serviceability.

FIGS. 81C and 81D show an exploded view and an exploded section view of the structural components of the engine 1700 with most of the internal components removed. As shown, the engine 1700 can be formed by the first block 1702a, second block 1702b, housing 1736, oil pan 1751, and valve train cover 1728, which can be coupled together to form the housing of the engine 1700. In some implementations, any of these components can be integrated together or separated into subcomponents.

Referring now to FIGS. 82A-82C, a perspective view, a perspective exploded view, and a side view of an assembly that can be included in the engine 1700 are shown. The assembly can include a pair of counter-rotating crankshafts 1712 that includes a first crankshaft 1712a configured to rotate in a first direction and a second crankshaft 1712b configured to rotate in a second opposite direction. The assembly can further include a first piston 1710a and a second piston 1710b. The first piston 1710a is coupled to and positioned on a first side of the crankshafts 1712 and the second piston 1710b is coupled to and positioned on a second side of the crankshafts 1712. The assembly can also include six connecting rods 1716 for coupling the first piston 1710a and the second piston 1710b to the pair of counter-rotating crankshafts 1712.

Depending on the implementation, the connecting rods 1716 can be configured differently from each other and distributed differently between the pistons 1710. In the example of FIGS. 82A-82B, the first piston 1710a is coupled to four connecting rods 1716 and the second piston 1710b is coupled to two connecting rods 1716. In other implementations, the first piston 1710a can be coupled to two connecting rods 1716 and the second piston 1710b can be coupled to four connecting rods 1716.

In some cases, the first piston 1710a is coupled to three connecting rods 1716 and the second piston 1710b is coupled to three different connecting rods 1716. Such an implementation is shown in FIGS. 85A and 85B with the pistons 1710 not shown for illustrative purposes. FIG. 85A shows a top perspective view of the crankshafts 1712 and connecting rods 1716 and FIG. 85A shows a corresponding bottom perspective view. As shown, three connecting rods 1716 can be coupled to the first crankshaft 1712a and three connecting rods 1716 can be coupled to the second crankshaft 1712b.

In FIG. 85A, a piston connecting rod 1719 is also shown and may be included in the engine 1700 in some implementations. In other implementations, the connecting rods 1716 can be coupled to the pistons 1710 without the piston connecting rod 1719.

As shown in FIGS. 85A and 85B, in a 3×3 connecting rod construction, two first connecting rods 1716a and one second connecting rod 1716b can be used to connect the first piston 1710a to the crankshafts 1712. Similarly, two first connecting rods 1716a and one second connecting rod 1716b can be used to connect the second piston 1710b to the crankshafts 1712.

In these example assemblies, one or more of the connecting rods can be configured as a connecting rod 1716a and one or more of the connecting rods can be configured as a connecting rod 1716b. The connecting rods 1716a, 1716b can be constructed in a similar manner as any of the connecting rods described herein, depending on the implementation of the engine 1700. In some implementations, the connecting rods 1716a differ from the connecting rods 1716b in their mass. For example, each connecting rod 1716a can have a mass substantially equal to half the mass of the connecting rod 1716b. When configured in this manner, the connecting rods 1716a, 1716b can be distributed between the pistons 1710 to obtain the same reciprocating mass of the pistons and connecting rods on each side of the crankshafts 1712.

In the example of FIGS. 82A-82, four connecting rods 1716a are positioned on one side of the crankshafts 1712 and two connecting rods 1716b are positioned the opposite side of the crankshafts 1712. The mass of the four lighter connecting rods 1716a equals the mass of the two heavier connecting rods 1716b. When the pistons 1710a, 1710b have the same mass, the reciprocating assemblies on both sides of the crankshafts 1712 are balanced. In configurations when the pistons 1710a, 1710b have different masses, the connecting rods 1716a, 1716b can be balanced accordingly.

In the example of FIGS. 85A and 85B, each crankshaft can be coupled to two lighter connecting rods 1716a and one heavier connecting rod 1716b. Further, the two lighter connecting rods 1716a can be positioned opposite the heavier connecting rod 1716b. For example, the first crankshaft 1712a is coupled to two connecting rods 1716a on one side, shown in FIG. 85A and one connecting rod 1716b on the opposite side, shown in FIG. 85B. The second crankshaft 1712b is arranged is a similar but opposite manner.

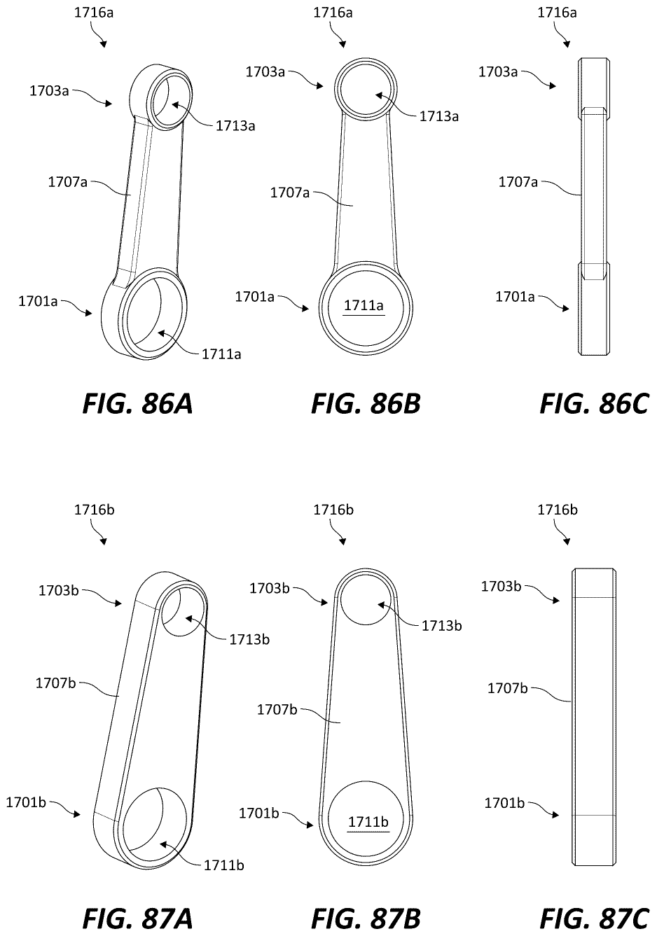

FIGS. 86A-86C show various views of an example implementation of a connecting rod 1716a and FIGS. 87A-87C show various views of an example implementation of a connecting rod 1716b. In the illustrated example, the connecting rods 1716a, 1716b are shown as straight connecting rods. In other implementations, the connecting rods 1716a, 1716b can be configured as any of the connecting rods described herein.

As shown in FIGS. 86A-86C, the connecting rod 1716a can include a body 1707a extending between a first/big end 1701a and a second/small end 1703a. The first end 1701a can include a first opening/crankshaft bore 1711a. The second end 1703a can include a second opening/pin bore 1713a. The connecting rod 1716a can be coupled to a crankshaft (e.g., one of the crankshafts 1712) by the first end 1701a and to a piston (e.g., via a wrist pin 1750) by the second end 1703a.

As shown in FIGS. 87A-87C, the connecting rod 1716b can include a body 1707b extending between a first/big end 1701b and a second/small end 1703b. The first end 1701b can include a first opening/crankshaft bore 1711b. The second end 1703b can include a second opening/pin bore 1713b. The connecting rod 1716b can be coupled to a crankshaft (e.g., one of the crankshafts 1712) by the first end 1701b and to a piston (e.g., via a wrist pin 1750) by the second end 1703b.

In the illustrated example, the body 1707b of the connecting rod 1716b is thicker over at least a portion of its length compared to the body 1707a of the connecting rods 1716a. The added thickness can result in the connecting rod 1716b having a greater mass than the connecting rods 1716a.

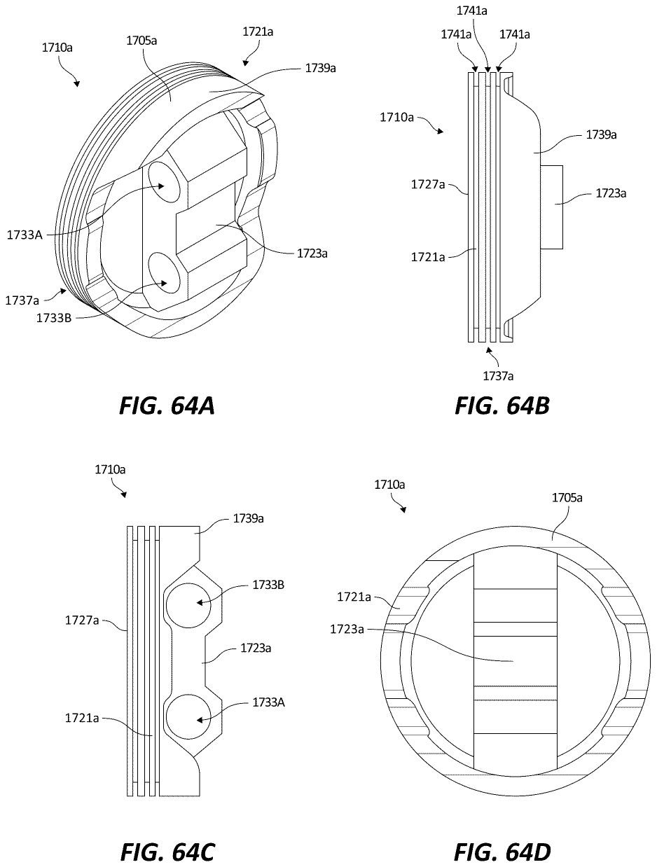

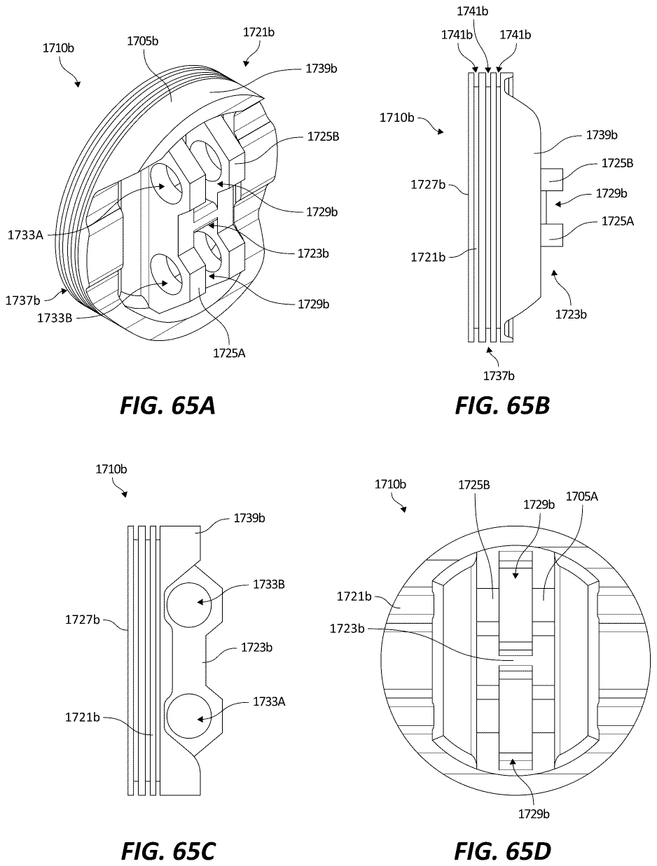

Referring now to FIGS. 64A-64D and FIGS. 65A-65D various views of an implementation of the first piston 1710a and an implementation of the second piston 1710b are shown respectively. The pistons 1710a, 1710b can be configured to be connected to one or more crankshafts by two, three, or four connecting rods, depending on the configuration. The pistons 1710a, 1710b are described for use with the engine 1700 and the connecting rods 1716 but can be used with any engine and connecting rods described herein or with alternative connecting rod constructions for different systems.

FIGS. 64A-64D show a perspective view, first side view, second side view, and bottom view respectively of an implementation of the first piston 1710a. In the illustrated example, the piston 1710a comprises a piston body 1705a. The body 1705a can include an upper portion 1721a and/or a lower portion 1723a. The lower portion 1723a can be used to couple the piston 1710a to one or more connecting rods and can be referred to herein as the “connecting portion 1723a.” The body 1705a can have a piston crown 1727a and an outer piston wall 1737a. The outer wall 1737a can extend from the piston crown 1727a.

The outer wall 1737a can have a shape that matches the shape of the bore (e.g., the bore 1706a) that the piston 1710a will be reciprocating within. For example, the outer wall 1737a can be circular-shaped, oval-shaped, double-c-shaped, and/or the like, depending on the configuration.

The outer wall 1737a can include one or more grooves 1741a for receiving piston rings (not shown). In use, the piston rings can slide along the wall of the bore the piston 1710a is disposed in. The piston rings can provide sealing of the bore. While three grooves 1741a are shown in FIGS. 64A-64D to receive three piston rings, the number of grooves 1741a and piston rings can be determined based upon the application and construction of the internal combustion engine including the piston 1710a. For example, there can be as few as one or more than five piston rings per piston 1710a.

The connecting portion 1723a can include one or more bores for coupling the piston 1710a to one or more connecting rods (e.g., via wrist pins). In the illustrated example, the lower portion 1723a includes a first piston bore 1733A and a second piston bore 1733B. The first bore 1733A can be configured to receive a first wrist pin and the second bore 1733B can be configured to receive a second wrist pin.

The spacing between the bores 1733A, 1733B can vary, depending on configuration. In some cases, the center of the bores 1733A, 1733B can be chosen for the particular engine so that the connecting rods coupled to the piston (e.g., the connecting rods 1716) can be arranged in a neutral configuration. For example, the spacing between the center of the bores 1733A, 1733B can be the same as the spacing between the reciprocating axes of the crankshafts the piston 1710a is connected to. In some configurations, the spacing of the bores 1733A, 1733B can be greater than the spacing between the reciprocating axes of the crankshafts when the piston 1710a is in a toed-out configuration. In some configurations, the spacing of the bores 1733A, 1733B can be narrower than the spacing between the reciprocating axes of the crankshafts when the piston 1710a is in a toed-in configuration. For a complete towed-in configuration, the piston 1710a may only include a single bore. In such cases, each connecting rod 1716 coupled to the piston 1710a can share a wrist pin.

In some implementations the connecting portion 1723a can be integrally formed with the upper portion 1721a and/or the piston body 1705a. In other implementations, the piston body 1705a can primarily comprise the upper portion 1721a, and the connecting portion 1723a can be coupled to the piston body 1705a. In some examples, the coupling may be removable (e.g., fasteners can be used). In other examples, the coupling may be permanent (e.g., the lower portion 1723a may be welded to the upper portion 1721a).

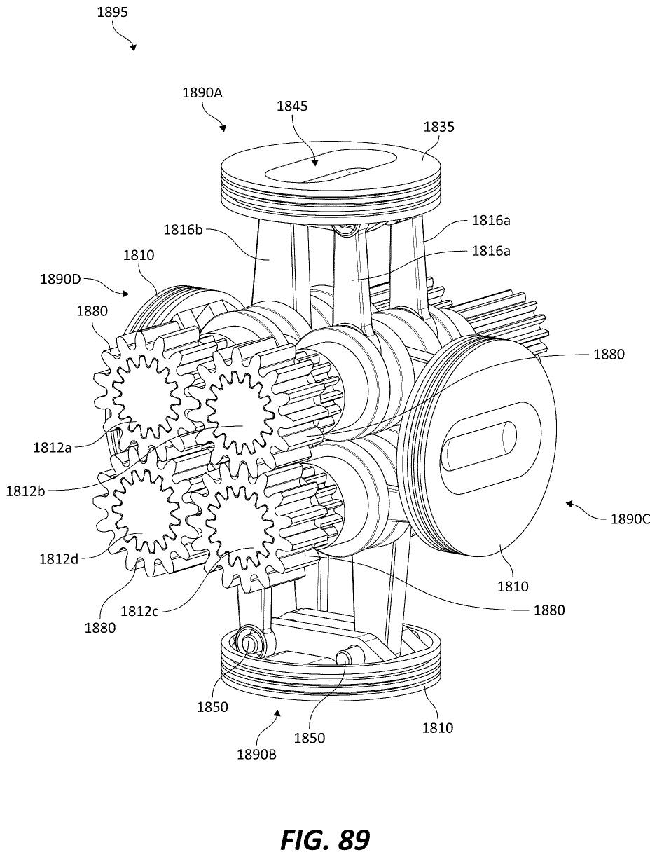

In some implementations, the piston 1710a can include a piston top plate (not shown). When included the piston top plate can be coupled to the piston crown 1727a. The piston top plate can be flat or can have different structural features, such as a recess. For example, the recess could be in the shape of a frustoconical region, a cylindrical region, and/or the like (see e.g., the recess 1845 in the top plate 1835 FIG. 89). When the piston 1710a is used as a combustion piston, a piston top plate may be desirable to reduce heat conduction from the combustion gases into the body 1705a of the piston 1710a. However, when the piston 1710a is used as an auxiliary piston, a piston top plate may not be required.

In the illustrated example, the piston 1710a includes a piston skirt 1739a. The piston skirt 1739a is not required and the piston 1710a may not include a piston skirt 1739a in other constructions. When included, the piston skirt 1739a can extend downwardly from the bottom of the piston body 1705a. The piston skirt 1739a can be in contact with or near the walls of the bore 1706a when installed in the engine 1700 of FIG. 80A. The piston skirt 1739a can help to prevent or limit motion of the piston 1710a in directions other than along the axis B (see e.g., FIG. 81B) of the bore 1706a. For example, the piston skirt 1739a can limit lateral movement of the piston 1710a and rotating of the piston 1710a.

In the example of FIGS. 82A-82C, the piston 1710a is connected to the pair of crankshafts 1712 by four connecting rods 1716a. Two of the connecting rods 1716a are coupled to the piston at the first bore 1733A (e.g., by a first wrist pin) and two of the connecting rods 1716a are coupled to the piston at the second bore 1733B (e.g., by a second wrist pin). In other examples, the piston 1710a can be connected to a different number of connecting rods, such as two or three connecting rods.

FIGS. 65A-65D show a perspective view, first side view, second side view, and bottom view respectively of an implementation of the second piston 1710b. The second piston 1710b can be similar to the first piston 1710a with several differences described below. For example, the piston 1710b includes a piston body 1705b. The body 1705b can include an upper portion 1721n and/or a lower portion 1723b. The lower portion 1723b can be used to couple the piston 1710a to one or more connecting rods and can be referred to herein as the “connecting portion.” The body 1705b can have a piston crown 1727b and an outer piston wall 1737b. The outer wall 1737b can extend from the piston crown 1727b and can include one or more grooves 1741a for receiving piston rings (not shown).

The lower portion 1723b of the second piston 1710b can differ from the lower portion 1723b of the first piston 1710a of FIGS. 64A-64D in that the lower portion 1723b can include a first connecting portion 1725A and a second connecting portion 1725B. The connecting portions 1725A, 1725B can be spaced apart with a gap 1729b therebetween. The gap 1729b may span the entire lengths of the connecting portions 1725A, 1725B or the connecting portions 1725A, 1725B can be joined with gaps 1729b on either side of one or more joints.

The lower portion 1723b can include one or more bores for coupling the piston 1710b to one or more connecting rods (e.g., via wrist pins). In the illustrated example, each connecting portion 1725A, 1725B includes a first piston bore 1733A and a second piston bore 1733B. For example, the first piston bore 1733A can extend through both connecting portions 1725A, 1725B and the second piston bore 1733B can extend through both connecting portions 1725A, 1725B. The first bore 1733A can be configured to receive a first wrist pin and the second bore 1733B can be configured to receive a second wrist pin.

Like the piston 1710a, spacing between the bores 1733A, 1733B of the piston 1710b can vary, depending on configuration. For example, the spacing can be set for neutral, toed-in, or toed-in out configurations.

In some implementations, one or both of the connecting portions 1725A, 1725B can be integrally formed with the upper portion 1721b and/or the piston body 1705b. In other implementations, the piston body 1705b can primarily comprise the upper portion 1721b, and the connecting portions 1725A, 1725B can be coupled to the piston body 1705b.

In some implementations, the piston 1710b can include a piston top plate (not shown). In some implementations, the piston 1710b includes a piston skirt 1739b.

In the example of FIGS. 82A-82C, the piston 1710b is connected to the pair of crankshafts 1712 by two connecting rods 1716b. One connecting rod 1716b can be positioned within the gap 1729b between the connecting portions 1725A, 1725B and coupled to the piston 1710b at the first bore 1733A (e.g., by a first wrist pin) and one connecting rod 1716b can be positioned within the gap 1729b between the connecting portions 1725A, 1725B and coupled to the piston 1710b at the second bore 1733B (e.g., by a second wrist pin).

In other examples, the piston 1710b can be connected to a different number of connecting rods, such as two or three connecting rods. For example, when the piston 1710b is coupled to three connecting rods, like in the configuration of FIGS. 85A and 85B, one connecting rod 1716b can be positioned within the gap 1729b between the connecting portions 1725A, 1725B and coupled to the piston 1710b at the first bore 1733A (e.g., by a first wrist pin). The other two connecting rods 1716a can be disposed outside of the gaps 1729b (e.g., one on each outer side of the connecting portions 1725A, 1725B) and coupled to the piston 1710b at the second bore 1733B (e.g., by a second wrist pin). In this arrangement, the connecting rod 1716b can be positioned between the connecting rods 1716a relative to the longitudinal axes of the crankshafts 1712.

While FIGS. 80A-81D show one piston 1710a and one piston 1710b included in the engine assemblies 1715a, 1715b respectively, either or both assemblies 1715a, 1715b can include the piston 1710a, the piston 1710b, or a different piston, depending on the configuration. In some cases, the engine 1700 may include two pistons 1710a, two pistons 1710b, or may not include either pistons 1710a, 1710b.

Referring now to FIGS. 84A and 84B, a perspective view and a side view of an example implementation of the crankshaft 1712 are shown. The crankshaft 1712 can be used in any of the engines described herein, such as the engine 1700. When used in the engine 1700, two crankshafts 1712 can be used, a first crankshaft 1712a and a second crankshaft 1712b. FIGS. 84A and 84B illustrate, for example, crankshaft 1712 comprising a first main bearing journal and a second main bearing journal, and a first crankpin, a second crankpin, and a third crankpin are positioned between the first main bearing journal and the second main bearing journal, wherein the third crankpin is positioned between the first crankpin and the second crankpin, optionally wherein the first crankpin and the third second crankpin are aligned along a common axis and the third second crankpin is rotationally offset from the first and secondthird crankpins about a longitudinal axis of the crankshaft by a crankpin offset, optionally wherein the crankpin offset is 0 degrees, optionally wherein the crankpin offset is 60 degrees, optionally wherein the crankpin offset is 90 degrees, optionally wherein the crankpin offset is 120 degrees, optionally wherein the crankpin offset is 180 degrees. Other crankpin offsets are also possible.

The crankshaft 1712 can be similar to the crankshaft 112A1 of at least FIGS. 48A and 48B and similar to the crankshaft 112A2 of at least FIGS. 48A and 48B. Accordingly, like reference numbers are used to describe similar components and features, with the differences described.

The crankshaft 1712 extends along a longitudinal axis L1 that defines an axis of rotation of the crankshaft 1712. The crankshaft 1712 can include a plurality of MBJs 965 positioned along the longitudinal axis L1. The crankshaft 1712 further includes a plurality of crankpins 1752 and a plurality of crank webs 1754 (“webs”). In the illustrated configuration, each crankpin 1752 extends between a pair of webs 1754.

In the illustrated example, the crankshaft 1712 includes a first MBJ 1765a and a second MBJ 1765b. When configured for use with two opposed pistons, the first and second MBJs 1765a, 1765b can be the only MBJs of the crankshaft 1712. For example, there can be no MBJs between the first and second MBJs 1765a, 1765b. In other implementations, the crankshafts 1712 can include additional MBJs when configured for use with more than two pistons in a two-crankshaft engine, for example.

In the illustrated example, the crankshaft 1712 includes three crankpins 1752. Each of the three crankpins 1752 are positioned between the first and second MBJs 1765a, 1765b. A first crankpin 1752a and a second crankpin 1752b can be aligned along a longitudinal axis L2. A third crankpin 1752c can be positioned between the first crankpin 1752a and the second crankpin 1752b. The third crankpin 1752c can extend along a longitudinal axis L3. Each of the longitudinal axes L1, L2, L3 can be parallel to each other. In other implementations, when the crankshafts 1712 is configured for use with multiple opposed piston pairs, additional crankpins 1752 may be included. In the illustrated example, each crankpin 1752 extends between a pair of webs 1754.

In the illustrated example, the longitudinal axis L2 and the longitudinal axis L3 are 180-degrees rotationally offset from each other about the rotational axis L1 of the crankshaft 1712. When used in the engine 1700 for example, this arrangement can allow the first piston 1710a and second piston 1710b to be in an opposed configuration.

In the example of FIGS. 82A-82C, the first piston 1710a is coupled to the first and second crankpins 1752a, 1752b on both crankshafts 1712a, 1712b and the second piston 1710b is coupled to the third crankpins 1752c on both crankshafts 1712a, 1712b. Because the longitudinal axis L2 and the longitudinal axis L3 are 180-degrees rotationally offset from each other in this arrangement, the pistons 1710a, 1710b can reciprocate in an opposed manner to each other.

In the example of FIGS. 85A and 85B, one piston (e.g., the first piston 1710a) can be coupled to the first and second crankpins 1752a, 1752b on the first crankshaft 1712a via two connecting rods 1716a and can be coupled to the third crankpin 1752c on the second crankshaft 1712b via one connecting rod 1716b. Similarly, another piston (e.g., the second piston 1710b) can be coupled to the first and second crankpins 1752a, 1752b on the second crankshaft 1712b via two connecting rods 1716a and can be coupled to the third crankpin 1752c on the first crankshaft 1712a via one connecting rod 1716b.

In other implementations, the longitudinal axis L2 (e.g., of the first and second crankpins 1752a, 1752b) and the longitudinal axis L3 (e.g., of the third crankpin 1752c) can be rotationally offset from each other about the rotational axis L1 of the crankshaft 1712 by a different amount. For example, the axes L2, L3 can be at any angle between 0 degrees and 360 degrees relative to each other. The offset between the axes L2, L3 can be referred to herein as the “crankpin offset”. Different advantages can be achieve in engines incorporating one or more of the crankshafts 1712 for different degrees of crankpin offset. For example, some configures can provide benefits in terms of piston/engine firing order, power overlap, power interruption and/or the like. In another example, some configurations can provide benefits in terms of engine balance. In another example, some configurations can provide benefits in terms of scavenging and/or super charging (e.g., in engines including an auxiliary piston, such as the engine 1700).

When the axes L2, L3 are 0-degrees offset from each other in a two-crankshaft engine, such as the engine 1700, the piston 1710a can be at top dead center while the piston 1710b is at bottom dead center and vice-versa.

When the axes L2, L3 are 180-degrees offset from each other in a two-crankshaft engine, such as the engine 1700, the pistons 1710a, 1710b can both be completely opposed to each other (e.g., at top dead center at the same time and at bottom dead center at the same time).

When the axes L2, L3 are 180-degrees offset from each other in a four-crankshaft engine, such as the engine 1800A of FIG. 92A, the pistons 1810a, 1810b can be completely opposed to each other and the pistons 1810c, 1810d can be completely opposed to each other. However, the pistons 1810a, 1810b are at top dead center and bottom dead center at different times than the pistons 1810c, 1810d.

When the axis L3 is 90-degrees or 270-degrees offset from the axis L2 in a four-crankshaft engine, such as the engine 1800A of FIG. 92A, all of the pistons 1810 can be at top dead center and bottom dead center at the same time. Alternatively, in this arrangement, the pistons 1810a, 1810b can be at top dead center when the pistons 1810c, 1810d are at bottom dead center, and vice-versa.

The axes L3 and L2 can be offset from each other in different degrees than the examples above in two and four crankshafts configurations, which can be desirable in some cases. In some implementations, the crankpin offset of one crankshaft 1712 can be different than the crankpin offset of another crankshaft 1712 in an engine including multiple crankshafts 1712.

In engines including six crankshafts, such as the engines or assemblies of at least FIGS. 24-28, the crankshafts can be configured as the crankshafts 1712, and the axis L3 can be 120-degrees or 240-degrees offset from the axis L3 in one or more the crankshafts 1712.

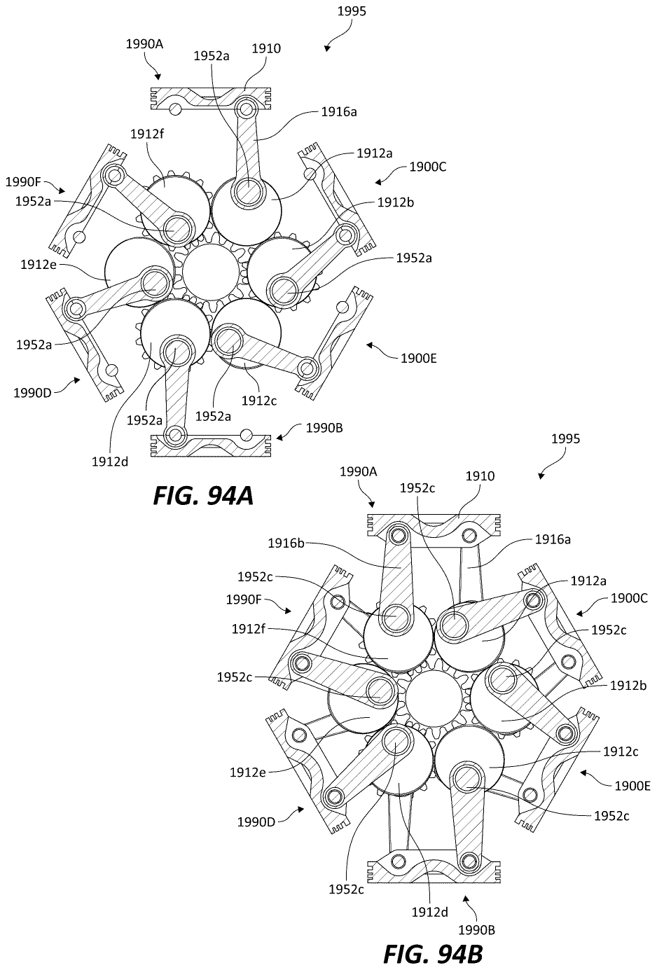

In other six crankshaft configurations, different degrees of offset between the axes L2, L3 can be utilized or combinations of different crankpin offsets can be utilized. For example, one of more of the crankshafts 1712 can have 60-degree offset between the axes L2, L3 and one or more of the crankshafts 1712 can have 180-degree offset between the axes L2, L3. This arrangement is shown and described with reference to at least FIGS. 94A and 94B.

With continued reference to FIGS. 84A and 84B, the crankshaft 1712 can include a first shaft portion 1776 that extends to and defines a first end 1775 of the crankshaft 1712 and a second shaft portion 1778 that extends to and defines a second end 1777 of the crankshaft 1712.

In the illustrated example, the first shaft portion 1776 includes a tapered portion 1760 that extends along a length and has a varying diameter along its length. For example, the tapered portion 1760 has a minimum diameter at the end closest to the first end 1775. The diameter of the tapered portion 1760 can increase moving away from the first end 1775 and towards the second end 1777. In use, the tapered portion 1760 can engage a portion of a gear (e.g., the gear 1780), as shown in FIG. 83. In some implementations, the gear 1780 can be configured in a similar manner as the gear 980 of at least FIGS. 50A-50C.

In some implementations, the tapered portion 1760 can extend from or abut the first MBJ 1765a. In other implementations, a portion of the first shaft portion 1776 may be positioned between the tapered portion 1760 and the first MBJ 1765a. For example, a portion of the first shaft portion 1776 may comprise or may be configured to support a cam lobe 1746 between the tapered portion 1760 and the first outer MBJ 1765a. In some implementations, the cam lobe 1746 can include a tapered bore and may be coupled to the crankshaft 1712 and supported by the tapered portion 1760. In the engine 1700, the cam lobe 1746 can be used to actuate valve(s) of the engine 1700 via the pushrod 1742.

In the illustrated example, the first shaft portion 1776 further includes a registration portion 1758 positioned between the tapered portion 1760 and the first end 1775. The registration portion 1758 has a polygonal cross-section, in the illustrated example. The registration portion 1758 may also interface with a portion of the gear 1780. For example, the registration portion 1758 can allow the rotational position of the crankshaft 1712 to be changed relative to the gear 1780 and any other crankshafts the crankshaft 1712 is used in conjunction with.

The first shaft portion 1776 may include a threaded portion 1756. The threaded portion 1756 can be used to secure another component to the crankshaft 1712, such as the gear 1780 using a threaded collar 1771 (see e.g., FIG. 82A), for example. The threaded portion 1756 can extend from the registration portion 1758. In other configurations, different coupling mechanisms known in the art can be used to secure the gear 1780 to the crankshaft 1712.

In the illustrated example, the second shaft portion 1778 is configured in the same manner as the first shaft portion 1776. For example, the second shaft portion 1778 can be configured to support and engage another gear 1780, as shown in FIG. 83. In other configurations, the second shaft portion 1778 may be configured differently than the first shaft portion 1776 and/or may not be configured to support a gear. For example, the second shaft portion 1778 may be an output shaft of a system including the crankshaft 1712.

In some configurations, the threaded portion 1756 can extend to or close to the ends 1775, 1777 of the crankshaft 1712, like the second crankshaft 1712b of FIG. 83. In other configurations, the crankshaft 1712 can include one or more output shaft portion(s) 1769 at one or both ends 1775, 1777, like the first crankshaft 1712a of FIG. 83. The output shaft portion 1769 can deliver the rotational power to of the engine 1700 to another system (e.g., a drivetrain). As shown in at least FIGS. 80A and 80B, the output shaft portion(s) 1769 can extend through the walls of the housing 1736 in the engine 1700. While the crankshaft 1712 of FIGS. 84A and 84B includes two output shaft portion 1769, in some configurations, the crankshaft 1712 may include only a single output shaft portion 1769 on one end 1775, 1777.

FIG. 83 shows a top view of the first and second crankshaft 1712a, 1712b as they can be arranged in the engine 1700. As shown, each crankshaft 1712a, 1712b can support at least one gear 1780 that is in mesh with another gear 1780 such that the crankshafts 1712a, 1712b can counterrotate together.

Referring back to FIGS. 80A-81D, in the illustrated example of the engine 1700, both pistons 1710 and bores 1706 are cylindrical. In other implementations of the engine 1700, one or both of the pistons 1710 can have a double-c shape and the bores 1706 can have a corresponding double-c shape. For example, any combination of double-c shaped pistons and cylindrical shaped pistons can be used in the engine 1700 and in any of the engines described herein.

When double-c shaped pistons are used in an engine, such as the engine 1700, the long axis of the double-c shaped piston may be arranged in a parallel orientation with respect to the longitudinal axis of the crankshaft(s) or may be arranged to be in a perpendicular orientation with respect to the longitudinal axis of the crankshaft(s). When multiple double-c pistons are used, one or more double-c piston can be arranged in the longitudinal orientation and one or more can be arranged in the perpendicular orientation.

Referring now to FIG. 88, a schematic section view of an internal combustion engine 1700A is shown. The engine 1700A can similar to the engine 1700 of at least FIGS. 80A-81D. Accordingly, like reference numbers are used to describe similar components and features, with the differences described.

The engine 1700A differs from the engine 1700 in that the engine 1700A includes two pistons configured for combustion and does not include an auxiliary piston in the illustrated example. The engine 1700A can include a first engine assembly 1715a and a second engine assembly 1715c. The first engine assembly 1715a is configured in the same manner as described with reference to at least FIGS. 80A-81D.

The second engine assembly can be configured in a same or similar manner as the first engine assembly 1715a. For example, the first engine assembly 1715a can include a piston 1710c that can be constructed as the piston 1710a of FIGS. 64A-64D, as the piston 1700b of FIGS. 65A-65D, or as any other piston described herein. The piston 1710c can reciprocate within a bore 1706c at least partially defined within a block 1702c. The bore 1706c can at least partially define a combustion chamber 1704c.

The piston 1710c can be coupled to the first and second crankshafts 1712a, 1712b by one or more connecting rods and wrist pins 1750. In the illustrated example, the piston 1710c is coupled to the crankshafts 1712 by at least one connecting rod 1716a and at least one connecting rod 1716b, which can be arranged in any of the configurations described herein. In one example, the engine 1700A can include six connecting rods 1716 arranged as shown in FIGS. 82A-82C or in FIGS. 85A and 85B. In the latter example, the piston 1710c can be coupled to two connecting rods 1716a and one connecting rod 1716b. Because the second engine assembly 1715c is configured for combustion, the bore 1706c can be lined with a top plate 1708c and/or a liner 1709c, in some implementations.

The second engine assembly 1715c can further include at least one intake valve opening 1722c and/or at least one fuel injector (not shown). Flow into the combustion chamber 1704c through each intake valve opening 1722c can be controlled by an intake valve 1724c. Air for the combustion chamber 1704c can be received via one or more intake passages 1726 that extend though a side surface of the block 1702c. Similarly, the second engine assembly 1715c can expel exhaust products through at least one exhaust valve opening 1730c. Flow out of the combustion chamber 1704c through the exhaust valve opening(s) 1730c can be controlled by exhaust valve(s) 1732c. The exhaust gases that pass through the exhaust valve opening(s) 1730c enter into exhaust passage(s) 1734c.

The second engine assembly 1715c can include a valve train 1720c to control the opening and closing of the valves 1724c, 1732c. The valve train 1720c can be mainly positioned within a chamber defined by a valve train cover 1728c and a recess defined within the upper surface of the block 1702c. The valve train 1720c can include one or more pushrods (not shown) and one or more rocker arms 1744c. The pushrods can be actuated directly by cam lobes (not shown) on the crankshafts 1712, in some implementations.

The engine 1700A can include a housing (not shown) for the housing the crankshafts 1712, such as the housing 1736 described with reference to FIGS. 80A-81D. The housing of the engine 1700A is not shown for illustrative purposes. Both blocks 1702a, 1702c can be coupled to the housing. In some implementations, the engine 1700A can include an oil pan and/or the cooling fins, as described herein. The engine 1700A can further include any feature described with reference to the engine 1700 or elsewhere herein.

Referring now to FIG. 89, an example implementation of a four-crankshaft assembly 1895 is shown. The assembly 1895 can be included in an engine, as described further herein with reference to at least FIGS. 92A-92C. The assembly 1895 can include a first crankshaft 1812a, a second crankshaft 1812b, a third crankshaft 1812c, and a fourth crankshaft 1812d (“crankshafts 1812”).

The first and second crankshafts 1812a, 1812b can be disposed adjacent each other and in mesh with each other. For example, each crankshaft 1812a, 1812b can support at least one gear 1880. The first crankshaft 1812a can rotate in the first direction and the second crankshaft 1812b can counter-rotate in the second direction. The third and fourth crankshafts 1812c, 1812d can be disposed adjacent each other and in mesh with each other. For example, each crankshaft 1812c, 1812d can support at least one gear 1880. The fourth crankshaft 1812d can rotate in the first direction and the third crankshaft 1812c can counter-rotate in the second direction. Optionally, the third crankshaft 1812c can be in mesh with and counter-rotate with the second crankshaft 1812b and/or the fourth crankshaft 1812d can be in mesh with and counter-rotate with the first crankshaft 1812a.

Each of the crankshafts 1812 can be constructed in a similar or identical manner as any of the crankshafts described herein. In the illustrated example, each of the crankshafts 1812 is configured as the crankshaft 1712 of at least FIGS. 84A and 84B. In the illustrated example, each of the gears 1880 can be configured as the gear 980 of FIGS. 50A-50C.

The assembly 1895 can include one or more piston and connecting rod sub-assemblies 1890. In the illustrated example, the assembly 1895 includes a first sub-assembly 1890A, a second sub-assembly 1890B, a third sub-assembly 1890C, and a fourth sub-assembly 1890D (“sub-assemblies 1890”). In other implementations, fewer sub-assemblies 1890 can be included.

Each sub-assembly 1890 can include a piston 1810 and one or more connecting rods 1816. The pistons 1810 can be constructed as any of the pistons described herein. In the illustrated example, the pistons 1810 are configured as the pistons 1710b of FIGS. 65A-65D. In the illustrated example, the pistons 1810 include a top plate 1835 with a recess 1845. The top plate 1835 can provide certain advantages but is not required and may not be included in all pistons 1810.

Generally, each piston 1810 can be coupled to two, three, or four connecting rods 1816. For example, the pistons 1810 can be connected to the connecting rods 1816 in a similar manner as the pistons 1710 and connecting rods 1716 as described with reference to at least FIGS. 82A-82C and/or FIGS. 85A and 85B. In the illustrated example, each piston 1810 is coupled to three connecting rods, one connecting rod 1816b and two connecting rods 1816a. The connecting rods 1816a can be configured as the connecting rod 1716a of at least FIGS. 86A-86C. The connecting rods 1816b can be configured as the connecting rod 1716b of at least FIGS. 87A-87C. Connecting rods of the assembly 1895 are referred to herein generically as “connecting rods 1816.” Wrist pins 1850 can be used to couple the connecting rods 1816 to the pistons 1810.

As shown in FIG. 89, the sub-assembly 1890A can be opposite the sub-assembly 1890B and the sub-assembly 1890C can be opposite the sub-assembly 1890D. In some cases, the sub-assemblies 1890A, 1890B can share a reciprocating axis B1 and the sub-assemblies 1890C, 1890D can share a reciprocating axis B2 (see e.g., the engine 1800A of FIG. 92A). Any of the pistons 1810 can be configured as combustion pistons and any of the pistons 1810 can be configured as auxiliary pistons.

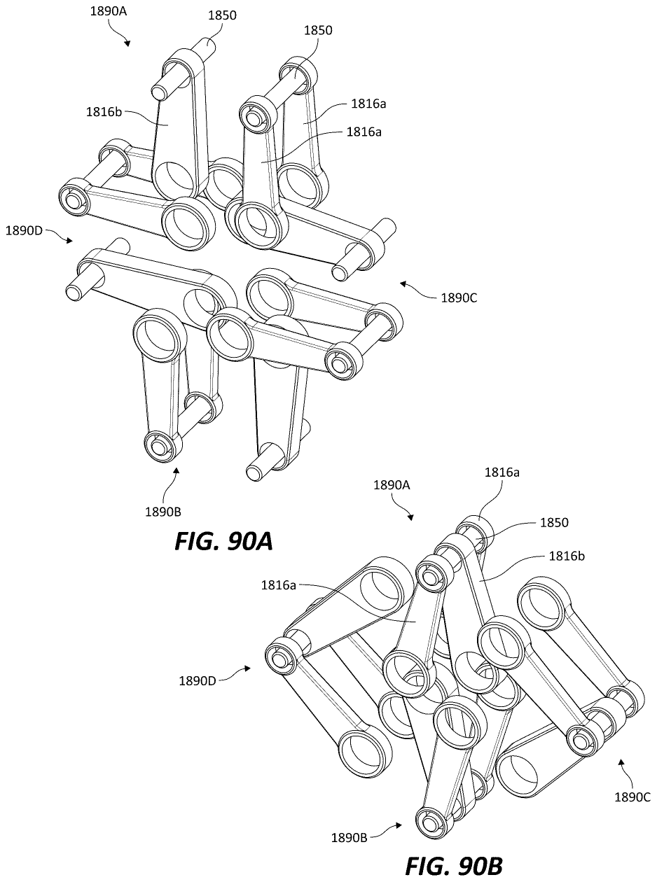

The pistons 1810 and the connecting rods 1816 of the assembly 1895 can be arranged in a neutral configuration, a toed-out configuration, a toed-in configuration, or a complete toed-in configuration, or any combination thereof. FIG. 90A shows an example arrangement of the connecting rods 1816 of the assembly 1895 when in the neutral configuration. In the neutral configuration, the axes of the connecting rods 1816 in each sub-assembly 1890 can be parallel to each other when the associated piston 1810 is at top dead center and bottom dead center. As such, each set of connecting rods 1816 in a sub-assembly 1890 can be coupled to the piston 1810 using multiple wrist pins 1850. For example, in the first sub-assembly 1890A, the connecting rod 1816b can be coupled to the piston 1810 by a first wrist pin 1850 and the connecting rods 1816a can be coupled to the piston 1810 by a second wrist pin 1850.

FIG. 90B shows an example arrangement of the connecting rods 1816 of the assembly 1895 when in the complete toed-in configuration. In the complete toed-in configuration, each connecting rod 1816 in each sub-assembly 1890 can be coupled to their respective piston 1810 along a same axis. For example, in the first sub-assembly 1890A, the connecting rod 1816b can be coupled to the piston 1810 by a wrist pin 1850 and the connecting rods 1816a can be coupled to the piston 1810 by the same wrist pin 1850. In other implementations, one or more of the sub-assemblies 1890 can be in a different configuration (e.g., neutral, toed-in, toed-out, or complete toed-in) compared to one or more of the other sub-assemblies 1890.

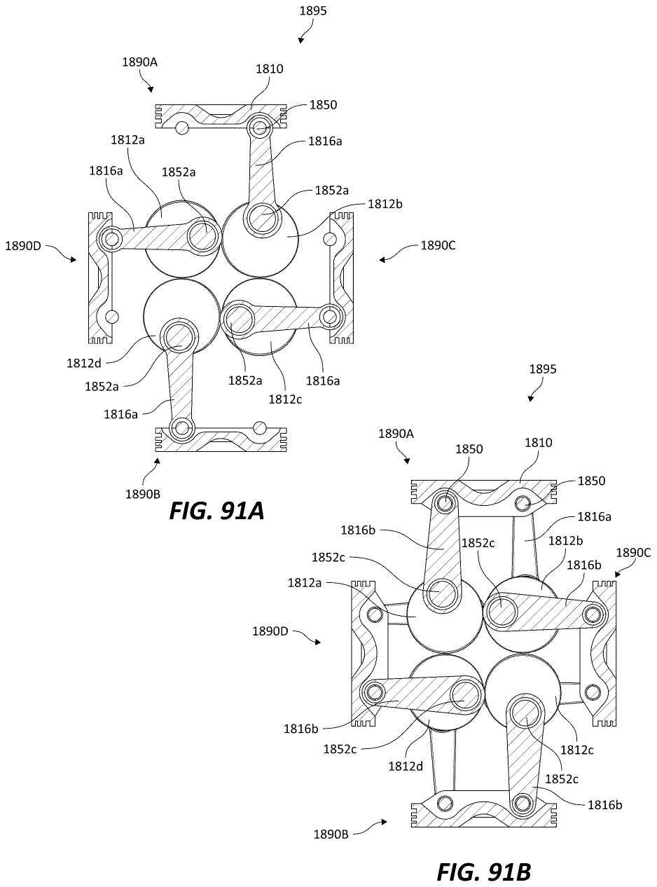

FIGS. 91A and 91B show cross-sectional views of an implementation of the assembly 1895. The cross-section of FIG. 91A extends through the first crankpins 1852a of the crankshafts 1812. The cross-section of FIG. 91B extends through the third crankpins 1852c of the crankshafts 1812. As described with reference to at least FIGS. 84A and 84B, the second crankpin (not shown) of a crankshaft configured as the crankshaft 1712 can be axially aligned with the first crankpin. For example, the crankshafts 1812 include a second crankpin (not shown) axially aligned with the first crankpin 1852a. In the crankshafts 1812, the third crankpin 1852c is between the first crankpin 1852a and the second crankpin along the longitudinal axis of the crankshaft 1812. In some configurations, the third crankpin 1852c is rotationally offset relative to the first crankpin 1852a.

In the illustrated example of FIGS. 91A and 91B, the third crankpins 1852c are 90-degrees offset from the first crankpins 1852a. For example, the third crankpins 1852c in the first and third crankshafts 1812a, 1812c are 270-degrees offset from the first crankpins 1852a clockwise about an axis into the page and the third crankpins 1852c in the second and fourth crankshafts 1812b, 1812d are 90-degrees offset from the first crankpins 1852a clockwise about the axis into the page. This arrangement results in the pistons 1810 of the first and second sub-assemblies 1890A, 1890B being at top dead center when the pistons 1810 of the third and fourth sub-assemblies 1890C, 1890D are at bottom dead center, and vice versa.

In another implementation, the third crankpins 1852c in the first and third crankshafts 1812a, 1812c can be 90-degrees offset from the first crankpins 1852a clockwise about the axis into the page and the third crankpins 1852c in the second and fourth crankshafts 1812b, 1812d can be 270-degrees offset from the first crankpins 1852a clockwise about the axis into the page. This arrangement results in the pistons 1810 all sub-assemblies 1890 being at top dead center at the same time and bottom dead center at the same time.

In other implementations, the assembly 1895 can include crankshafts 1812 with different crankpin offsets than the examples described above.

Referring now to FIG. 92A, a schematic section view of an internal combustion engine 1800A is shown. The engine 1800A can be similar to the engine 1700 of at least FIGS. 80A-81D and the engine 1700A of FIG. 88. Accordingly, like reference numbers are used to describe similar components and features, with the differences described.

The engine 1800A differs from the engines 1700 and 1700A in that the engine 1800A includes four crankshafts 1812 instead of two crankshafts 1712. For example, the engine 1800A can include the assembly 1895. Each sub-assembly 1890 of the assembly 1895 can form part of an engine assembly. For example, the sub-assembly 1890A includes a piston 1810a and can be part of an engine assembly 1815a, the sub-assembly 1890B includes a piston 1810b and can be part of an engine assembly 1815b, the sub-assembly 1890C includes a piston 1810c and can be part of an engine assembly 1815c, and the sub-assembly 1890D includes a piston 1810d and can be part of an engine assembly 1815d. In the example of FIG. 92A, each piston 1810 is configured as a combustion piston and each engine assembly 1815 is configured in a similar manner as the first engine assembly 1715a of the engine 1700 of at least FIGS. 80A-81D and can include the same or similar components. For ease of reference, not all subcomponents of the engine assemblies 1815 are labeled in FIG. 92A.

In the engine 1800A, the pistons 1810a, 1810b can be configured to reciprocate along a shared axis B1 and the pistons 1810c, 1810d can be configured to reciprocate along a shared axis B2.

The engine 1800A can include a housing (not shown) for the housing the crankshafts 1812, similar to the housing 1736 described with reference to FIGS. 80A-81D. However, the housing for the engine 1800A includes four crankshaft containing passages to accommodate the four crankshafts 1812. The housing of the engine 1800A is not shown for illustrative purposes. The blocks of engine assemblies 1815 can be coupled to the housing. In some implementations, the engine 1800A can include an oil pan and/or the cooling fins, as described herein. The engine 1800A can further include any feature described with reference to the engine 1700 or elsewhere herein.

Referring now to FIG. 92B, a schematic section view of an internal combustion engine 1800B is shown. The engine 1800B can be similar to the engine 1800A of FIG. 92A. Accordingly, like reference numbers are used to describe similar components and features, with the differences described.

The engine 1800B differs from the engine 1800A of FIG. 92A in that the engine 1800A includes an engine assembly 1815e and an engine assembly 1815f instead of the engine assemblies 1815c, 1815d. The engine 1800B can include a modified version of the assembly 1895 of FIG. 89 where two of the pistons 1810 are configured as auxiliary pistons. For example, the engine assembly 1815e can include an auxiliary piston 1810e and the engine assembly 1815f can include an auxiliary piston 1810f. The engine 1800B can include the engine assemblies 1815a, 1815b with combustion pistons 1810a, 1810b.

The engine assemblies 1815e, 1815f can be configured in a similar manner as the second engine assembly 1715b of at least FIGS. 80A-81D. For example, the engine assembly 1815e can include a block 1802e that defines a bore 1806e and an auxiliary chamber 1804e. Similarly, the engine assembly 1815f can include a block 1802f that defines a bore 1806f and an auxiliary chamber 1804f. The pistons 1810e, 1810f can reciprocate within their respective bores 1806e, 1806f to supply intake air to the combustion chambers 1804a, 1804b of the engine assemblies 1815a, 1815b. For example, each block 1802e, 1802f can include one or more intake ports 1882 and one or more outlet ports 1884 in fluid communication with the auxiliary chambers 1804e, 1804f. Intake air from the engine assemblies 1815e, 1815f can be directed to the combustion chambers 1804a, 1804b of the engine assemblies 1815a, 1815b using one or more feed pipes (not shown) as described herein.

The engine 1800B can include a housing (not shown) for the housing the crankshafts 1812, similar to the housing 1736 described with reference to FIGS. 80A-81D. However, the housing for the engine 1800B includes four crankshaft containing passages to accommodate the four crankshafts 1812. The housing of the engine 1800A is not shown for illustrative purposes. The blocks of engine assemblies 1815 of the engine 1800B can be coupled to the housing. The engine 1800B can further include any feature described with reference to the engine 1700 or elsewhere herein.

Referring now to FIG. 92C, a schematic section view of an internal combustion engine 1800C is shown. The engine 1800C can be similar to the engine 1800B of FIG. 92B. Accordingly, like reference numbers are used to describe similar components and features, with the differences described.

The engine 1800C differs from the engine 1800B of FIG. 92B in that the engine 1800C includes a counterweight 1810g instead of the piston 1810e. The engine 1800C can include a modified version of the assembly 1895 of FIG. 89 where pistons 1810a, 1810b are configured as combustion pistons, piston 1810f is configured as an auxiliary piston, and a counterweight 1810g reciprocates opposite the piston 1810f. For example, an engine assembly (not shown) can include the counterweight 1810g and be positioned opposite the engine assembly 1815f. For illustrative purposes, the structures of the engine assembly 1815f described with reference to FIG. 92B are not shown in FIG. 92C.

The counterweight 1810g can be coupled to two of the crankshafts 1812 by one or more connecting rods 1816 and a wrist pin 1850. In the illustrated example, the counterweight 1810g is coupled to the connecting rods 1816 in a complete toed-in configuration. The piston 1810f can be coupled to two of the crankshafts 1812 by one or more connecting rods 1816. In the illustrated example, the piston 1810f is coupled to the connecting rods 1816 in toed-out configuration.

The engine 1800C can include a housing (not shown) for the housing the crankshafts 1812, similar to the housing 1736 described with reference to FIGS. 80A-81D. However, the housing for the engine 1800C includes four crankshaft containing passages to accommodate the four crankshafts 1812. The housing of the engine 1800A is not shown for illustrative purposes. The blocks of engine assemblies 1815 of the engine 1800C can be coupled to the housing. The engine 1800C can further include any feature described with reference to the engine 1700 or elsewhere herein.

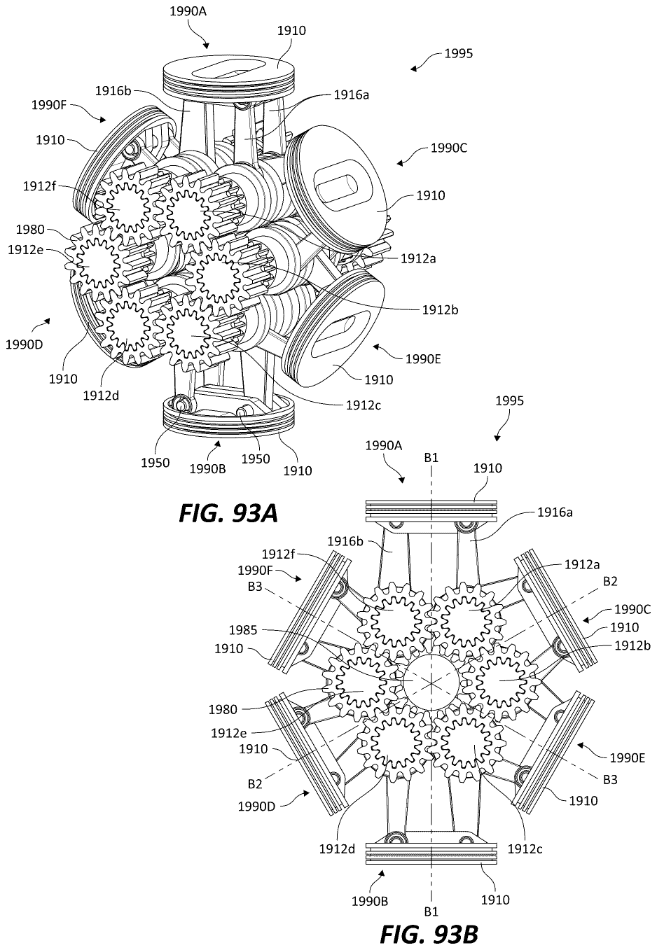

Referring now to FIGS. 93A and 93B, an example implementation of a six-crankshaft assembly 1995 is shown. The assembly 1995 can be included in an engine, such as any of the engines described with reference to at least FIGS. 23A-28. The assembly 1995 can include a first crankshaft 1912a, a second crankshaft 1912b, a third crankshaft 1912c, and a fourth crankshaft 1912d, a fifth crankshaft 1912e, and a sixth crankshaft 1912f (“crankshafts 1912”).

Each of the crankshafts 1912 can be disposed adjacent to two other crankshafts 1912 and can be in mesh with at least one of the adjacent crankshafts 1912. For example, each crankshaft 1912 can support at least one gear 1980. Only one gear 1980 is labeled in FIGS. 93A and 93B for illustrative purposes. Optionally, one or more of the crankshafts 1912 can be in mesh with a gear of an output shaft 1985.

Each of the crankshafts 1912 can be constructed in a similar or identical manner as any of the crankshafts described herein. In the illustrated example, each of the crankshafts 1912 are configured as the crankshaft 1712 of at least FIGS. 84A and 84B. In the illustrated example, each of the gears 1980 can be configured as the gear 980 of FIGS. 50A-50C.

The assembly 1995 can include one or more piston and connecting rod sub-assemblies 1990. In the illustrated example, the assembly 1995 includes a first sub-assembly 1990A, a second sub-assembly 1990B, a third sub-assembly 1990C, and a fourth sub-assembly 1990D, a fifth sub-assembly 1990E, and a sixth sub-assembly 1990F (“sub-assemblies 1990”). In other implementations, fewer sub-assemblies 1990 can be included.

Each sub-assembly 1990 can include a piston 1910 and one or more connecting rods 1916. The pistons 1910 can be constructed as any of the pistons described herein. In the illustrated example, the pistons 1910 are configured as the pistons 1710b of FIGS. 65A-65D.

Generally, each piston 1910 can be coupled to two, three, or four connecting rods 1916. For example, the pistons 1910 can be connected to the connecting rods 1916 in a similar manner as the pistons 1710 and connecting rods 1716 as described with reference to at least FIGS. 82A-82C and/or FIGS. 85A and 85B. In the illustrated example, each piston 1910 is coupled to three connecting rods, one connecting rod 1916b and two connecting rods 1916a. For illustrative purposes, only the connecting rods for the sub-assembly 1990A are labeled. The connecting rods 1916a can be configured as the connecting rod 1716a of at least FIGS. 86A-86C. The connecting rods 1916b can be configured as the connecting rod 1716b of at least FIGS. 87A-87C. Connecting rods of the assembly 1995 are referred to herein generically as “connecting rods 1916.” Wrist pins 1950 can be used to couple the connecting rods 1916 to the pistons 1910.

As shown in FIG. 93B, the sub-assembly 1990A can be opposite the sub-assembly 1990B, the sub-assembly 1990C can be opposite the sub-assembly 1990D, and the sub-assembly 1990E can be opposite the sub-assembly 1990F. In some cases, the sub-assemblies 1990A, 1990B can share a reciprocating axis B1, the sub-assemblies 1990C, 1990D can share a reciprocating axis B2, and the sub-assemblies 1990E, 1990F can share a reciprocating axis B3. Any of the pistons 1910 can be configured as combustion pistons and any of the pistons 1910 can be configured as auxiliary pistons. Further in some cases, one or more of the pistons 1910 may be replaced with a counterweight (see e.g., the counterweight 1810g of FIG. 92C). The pistons 1910 and the connecting rods 1916 of the assembly 1995 can be arranged in a neutral configuration, a toed-out configuration, a toed-in configuration, or a complete toed-in configuration, or any combination thereof.

FIGS. 94A and 94B show cross-sectional views of an implementation of the assembly 1995. The cross-section of FIG. 94A extends through the first crankpins 1952a of the crankshafts 1912. The cross-section of FIG. 94B extends through the third crankpins 1952c of the crankshafts 1912. As described with reference to at least FIGS. 84A and 84B, the second crankpin (not shown) of a crankshaft configured as the crankshaft 1712 can be axially aligned with the first crankpin. For example, the crankshafts 1912 include a second crankpin (not shown) axially aligned with the first crankpin 1952a. In the crankshafts 1912, the third crankpin 1952c is between the first crankpin 1952a and the second crankpin along the longitudinal axis of the crankshaft 1912. In some configurations, the third crankpin 1952c is rotationally offset relative to the first crankpin 1952a.

In the illustrated example of FIGS. 94A and 94B, three of the crankshafts 1912 have a third crankpin 1952c that is 60-degrees/300-degrees offset from the respective first crankpin 1952a and three of the crankshafts 1912 have a third crankpin 1952c that is 180-degrees offset from the respective first crankpin 1952a. For example, the third crankpins 1952c in the first, third, and fifth crankshafts 1912a, 1912c, 1912e are 300-degrees offset from the first crankpins 1952a clockwise about an axis into the page and the third crankpins 1952c in the second, fourth, and sixth crankshafts 1912b, 1912d, 1912f are 180-degrees offset from the first crankpins 1952a clockwise about the axis into the page. This arrangement results in the pistons 1910 opposite each other being completely opposed to each other. For example, the pistons 1910 in the sub-assemblies 1990A, 1990B are at top dead center and bottom dead center at the same time. This arrangement also results in each set of opposed pistons 1910 reaching top dead center at a different time than any of the other sets of opposed pistons 1910.

In some implementations, four of the crankshafts 1912 may have a third crankpin 1952c that is 60-degrees/300-degrees offset from the respective first crankpin 1952a and two of the crankshafts 1912 may have a third crankpin 1952c that is 180-degrees offset from the respective first crankpin 1952a.

In another implementation, the third crankpins 1952c in each of the crankshafts 1912 can be 120-degrees/240-degrees offset from the respective first crankpins 1952a. This arrangement results in every other piston 1910 circumferentially being at top dead center at the same time and bottom dead center at the same time. For example, the pistons 1910 in the sub-assemblies 1990A, 1990E, 1990D can be at top dead center while the pistons 1910 in the sub-assemblies 1990C, 1990B, 1990F are at bottom dead center, and vice-versa.

In other implementations, the assembly 1995 can include crankshafts 1912 with different crankpin offsets than the examples described above.

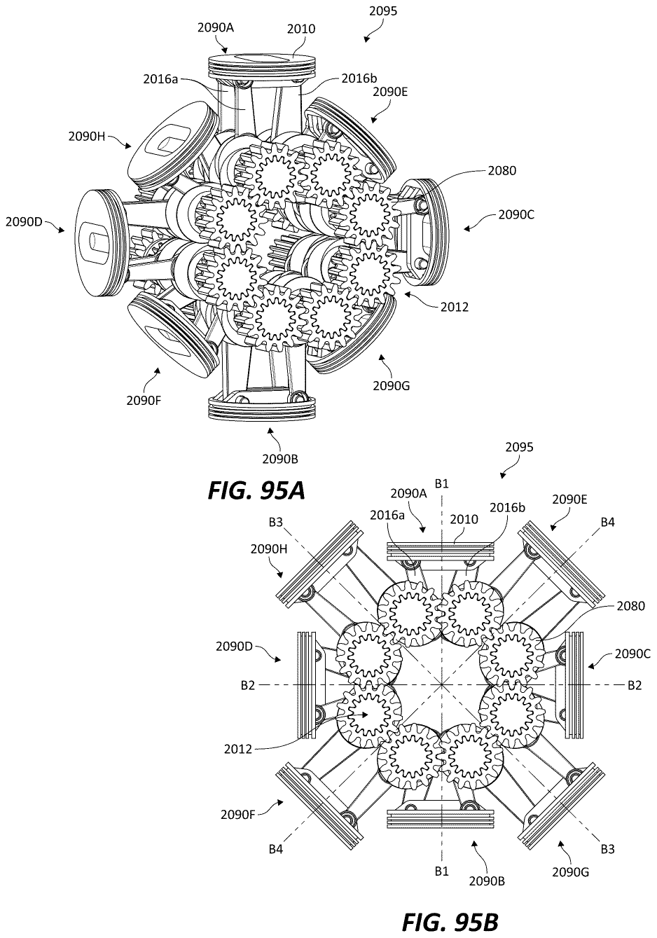

Referring now to FIGS. 95A and 95B, an example implementation of an eight-crankshaft assembly 2095 is shown. The assembly 2095 can be included in an engine with any of the features described herein. The assembly 2095 includes eight crankshafts 2012. Each of the crankshafts 2012 can be disposed adjacent to two other crankshafts 2012 and can be in mesh with at least one of the adjacent crankshafts 2012. For example, each crankshaft 2012 can support at least one gear 2080. Only one gear 2080 is labeled in FIGS. 95A and 95B for illustrative purposes.

Each of the crankshafts 2012 can be constructed in a similar or identical manner as any of the crankshafts described herein. In the illustrated example, each of the crankshafts 2012 are configured as the crankshaft 1712 of at least FIGS. 84A and 84B. In the illustrated example, each of the gears 2080 can be configured as the gear 980 of FIGS. 50A-50C.

The assembly 2095 can include one or more piston and connecting rod sub-assemblies 2090. In the illustrated example, the assembly 2095 includes a sub-assemblies 2090A, 2090B, 2090C, 2090D, 2090E, 2090F, 2090G, and 2090H (“sub-assemblies 2090”). In other implementations, fewer sub-assemblies 2090 can be included.

Each sub-assembly 2090 can include a piston 2010 and one or more connecting rods 2016. The pistons 2010 can be constructed as any of the pistons described herein. In the illustrated example, the pistons 2010 are configured as the pistons 1710b of FIGS. 65A-65D.

Generally, each piston 2010 can be coupled to two, three, or four connecting rods 2016. For example, the pistons 2010 can be connected to the connecting rods 2016 in a similar manner as the pistons 1710 and connecting rods 1716 as described with reference to at least FIGS. 82A-82C and/or FIGS. 85A and 85B. In the illustrated example, each piston 2010 is coupled to three connecting rods, one connecting rod 2016b and two connecting rods 2016a. For illustrative purposes, only the connecting rods for the sub-assembly 2090A are labeled. The connecting rods 2016a can be configured as the connecting rod 1716a of at least FIGS. 86A-86C. The connecting rods 2016b can be configured as the connecting rod 1716b of at least FIGS. 87A-87C. Connecting rods of the assembly 2095 are referred to herein generically as “connecting rods 2016.” Wrist pins 2050 can be used to couple the connecting rods 2016 to the pistons 2010.

As shown in FIG. 95B, the sub-assembly 2090A can be opposite the sub-assembly 2090B, the sub-assembly 2090C can be opposite the sub-assembly 2090D, the sub-assembly 2090E can be opposite the sub-assembly 2090F, and the sub-assembly 2090G can be opposite the sub-assembly 2090H. In some cases, the sub-assemblies 2090A, 2090B can share a reciprocating axis B1, the sub-assemblies 2090C, 2090D can share a reciprocating axis B2, the sub-assemblies 2090H, 2090G can share a reciprocating axis B3, and the sub-assemblies 2090E, 2090F can share a reciprocating axis B4. Any of the pistons 2010 can be configured as combustion pistons and any of the pistons 2010 can be configured as auxiliary pistons. Further in some cases, one or more of the pistons 2010 may be replaced with a counterweight (see e.g., the counterweight 1810g of FIG. 92C). The pistons 2010 and the connecting rods 2016 of the assembly 2095 can be arranged in a neutral configuration, a toed-out configuration, a toed-in configuration, or a complete toed-in configuration, or any combination thereof. The crankpins of the crankshafts 2012 can have any crankpin offset to achieve a desired firing order of any of the pistons 2010.

The various internal combustion engines shown and described herein can utilize one or more uniblocks. Using one or more uniblocks can provide the internal combustion engines with certain advantages over traditional internal combustion engine configurations, as described further below. While the following description references the internal combustion engine 100 and one of the uniblocks 102, it is understood that such advantages and configurations can apply to any of the other internal combustion engines utilizing uniblock(s) described herein.

The uniblock 102 provides the internal combustion engine 100 using the uniblock 102 with some distinct advantages over traditional internal combustion engine configurations. For example, defining the combustion chamber 104 within the uniblock 102 enables the internal combustion engine 100 to withstand extremely high compression pressures. This results because there no longer is a gasketed junction between the cylinder head and the cylinder block, which is a location for high compression pressure failures. For example, in the illustrated internal combustion engine 100 that employes the uniblock 102, the compression ratio can be about 10:1, about 20:1, about 30:1, about 40:1, about 50:1, about 75:1, about 100:1, any value between these values, or more or less depending upon the particular engine design. In other words, depending upon the desired compression ratio, the illustrated internal combustion engine 100 can be modified to obtain that desired compression ratio.

By contrast, conventional internal combustion engines have compression ratios between about 6:1 to about 10:1 for engines that burn gasoline and between about 12:1 and 20:1 for engines that burn diesel fuel. Thus, the internal combustion engines 100 using the uniblock 102 can have higher final compression ratios than typically is found in engines for many use cases. In some configurations, the final compression ratio can exceed 50:1. In some configurations, an engine according to the present disclosure can have a final compression ratio of 200:1 or higher. Such high compression ratios can result from the constructions that generally reduce the regions most likely to fail under the high pressures that result from the high compression ratios.

These higher than standard compression ratios can be more simply achieved in the internal combustion engine 100 that uses the uniblock 102. The benefits of the configurations of the internal combustion engine 100 employing the uniblock 102 can be scaled in size. The ability to scale in size results in engines with maximum power outputs from one horsepower to one million horsepower, for example.

The internal combustion engine 100 using the uniblock 102 can be flexible regarding the type of fuel at least in part because of the high compression pressures that can be generated within the combustion chamber 104. For example, certain features, aspects, and advantages of the internal combustion engine 100 with the uniblock 102 can be used with compression ignition fuels, while others can be used with spark ignition fuels, and still others can be used with any fuel, including spark ignition and/or compression ignition fuels.

The uniblock 102 construction also enables the internal combustion engine 100 using the uniblock 102 to be lighter than a conventional reciprocating internal combustion engine of equivalent power. The internal combustion engine 100 using the uniblock 102 also can achieve other advantages. For example, some of the other advantages can include, but are not limited to, reduced fuel energy going to waste heat, increased and more efficient cooling, increased charge air compression, reduced parts counts, reduced production costs, reduced stress risers in high temperature and high pressure areas of the uniblock, improved metal grain structure in high pressure and high temperature uniblock regions, increased engine longevity, increased engine working environments, increased service intervals and/or elimination of engine and engine parts failures due to engine block to engine head failures.

By combining the cylinder head and the cylinder block into a uniblock 102, issues like stress on head gaskets used to seal the connection between the cylinder block and the cylinder head can be avoided. In some configurations, the uniblock 102 facilitates constructions of the internal combustion engine 100 that can have reduced waste heat production, improved heat dissipation, or both. In some configurations, the uniblock 102 facilitates constructions of the internal combustion engine 100 that can make more efficient use of space and volume. For example, according to some configurations, the internal combustion engine 100 using the uniblock 102 can have reduced size for a given horsepower when compared with conventional reciprocating engine designs.

In some configurations, the internal combustion engine 100 using the uniblock 102 can have reduced volume and/or weight per maximum horsepower output when compared to conventional inline, “V”, “VR”, “W”, “X”, opposed, boxer, flat, and/or radial piston constructions. The internal combustion engines 100 using the uniblock 102 can have reduced volume and/or weight per maximum horsepower output compared to radial engine constructions, including older engine constructions, such as Wankel engines, and newer engine constructions, including liquid piston and related constructions. The internal combustion engine 100 using the uniblock 102 can have reduced volume and/or weight per maximum horsepower output compared to the majority of gas turbine engines.

This consistently reduced volume and/or weight per maximum horsepower outputs means that some configurations of the internal combustion engine 100 using the uniblock 102 are well suited for applications where small size and/or weight for given power outputs are desirable, such as, in air transportation vehicles. In another example, the internal combustion engine 100 using the uniblock 102 can be paired with an electric motor in a hybrid drive vehicle (e.g., which can include use as a range extender in an electric vehicle), including in air transportation vehicles. In yet another example, the internal combustion engine 100 using the uniblock 102 can provide benefits in engine retrofit applications where reduced size and/or weight provides ease of and flexibility in retrofit applications, such as when owners of existing vehicles desire increased efficiency, reduced emissions, and/or increased power.

In some configurations, the internal combustion engine 100 using the uniblock 102 can have reduced piston speed for a given horsepower as compared with some other reciprocating engines, which can offer several benefits. For example, reduced piston speeds in the internal combustion engine 100 using the uniblock 102 can help reduce engine failures, increase durability, and/or increase maintenance intervals, which may make such engines more suitable for continuous use or for use in aircrafts.

While increased compression ratios can be one advantage of the internal combustion engines 100 using the uniblock 102, there can also be other advantages in addition or alternatively to achieving higher compression ratios. For example, in some configurations, the uniblock 102 provides be more flexibility in the placement of fuel injectors, spark plugs, and the like because there is no seam between a cylinder head and a cylinder block. For example, in an engine design with a separable cylinder head and cylinder block, it can be important to avoid the seam between the cylinder head and the cylinder block because interfering with the seam could compromise sealing, structural integrity, or both. The internal combustion engine 100 that uses the uniblock 102, as compared to conventional engines, allows for many additional advantages, including better lubrication, better balance, better heat management, and smaller and lighter engines for any given power input.

The uniblock 102 can be formed using any suitable technique and using any suitable materials. For example, materials can be chosen for particular use cases. In some configurations, the uniblock 102 can be manufactured from various metals and/or alloys, including but not limited to aluminum or aluminum alloys, which can reduce weight of the internal combustion engine 100 using the uniblock 102 relative to conventional engines having similar horsepower output. As another example, the uniblock 102 can be manufactured from iron, for example but without limitation, which can offer increased strength, reduced cost, or both.

The geometry of the uniblock 102 can enable multiple ways of implementing constructions featuring two pistons 110 that are arranged in opposed relationships. Such opposed relationships are described further in described in PCT Application No. US2024/015639. In the illustrated configurations, the axis along which the pistons 110 reciprocate can intersect with the two crankshafts 112. In an “opposed balanced” construction, both of the pistons 110 can be at top dead center at the same time. In such a construction, because the pistons 110 move along the same central axis, forces are better balanced. In an “opposed compact” construction, the pistons 110 can offset each other with one piston 110 being at top dead center when the other piston 110 is at bottom dead center. In both cases, and depending on the number of pistons, primary, secondary, and/or rocking forces may be substantially or completely canceled, which can improve the overall balance of the internal combustion engine 100 using the uniblock 102. According to some configurations, in the opposed balanced constructions, the primary, secondary, and/or rocking forces can be canceled with any even number of the pistons 110, including two pistons 110, while the opposed pistons 110 operate in a synchronized manner such that they are at the same point in the cycle at the same time. According to some configurations, an “opposed compact” construction can provide a significant space advantage.

In some configurations, an “opposed compact” construction can utilize captive free pistons, which may offer improved space and/or weight savings as compared to an opposed compact construction that is not using the captive free piston construction for a given engine stroke volume. In some configurations, the captive free piston may provide benefits such as, for example, reducing forces that go into connecting rods and/or crankshafts. For example, during an expansion stage of a cycle of one piston, forces can be transmitted to the opposing piston, which is in a compression stage of a cycle. In some configurations, the captive free piston engine according to some configurations herein can have improved balance as compared to some other engines.

In some configurations (e.g., dual crankshafts or quad crankshafts), the internal combustion engines can result in a highly balanced configuration due to, not only the counterrotating nature of the dual crankshafts, but also the balanced motions of pairs of connecting rods.

Inline constructions also are contemplated. According to some configurations, an inline construction can have a downward stroke (e.g., from top dead center to bottom dead center) that is a greater percentage of a cycle than an upward stroke (e.g., from bottom dead center to top dead center). Such an approach can result in a power stroke that is more than half of the cycle, which can occur in both two-stroke and four-stroke engine constructions. For example, there can be more degrees of power per cycle. In the two-stroke engine variant, this can enable continuous power and/or substantial power overlap even if only two cylinders are used.

Preferably, if there are multiple cylinder bores 106, which may be positioned side-by-side, then center to center spacing between the cylinder bores 106 can be between about 10% and about 20% (e.g., from 10% to 20%) of the diameter of the cylinder bores 106. In some configurations, the center-to-center spacing of the cylinder bores 106 can be greater than 20%. In some configurations, the spacing between the cylinder bores 106 can be less than 10%. In some configurations, the spacing can be between about 5% to about 10%. The spacing between the cylinder bores 106 can provide space between cylinder bores 106 for cylinder liners, crank bearings, cam bearings, and so forth. When calculating the percentage of the diameter of the cylinder bore 106, the diameter is calculated as narrowed by any cylinder liner.

### ADDITIONAL EMBODIMENTS

Conditional language used herein, such as, among others, “can,” “could,” “might,” “may,” “e.g.,” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or that one or more configurations necessarily include these features, elements and/or states.

Clause 1. An internal combustion engine comprising: a block at least partially defining a bore; a housing coupled to the block; a piston capable of reciprocating within the bore between top dead center and bottom dead center; a first crankshaft configured to rotate in a first direction within the housing; a second crankshaft configured to rotate in a second direction within the housing, the second direction opposite the first direction, the second crankshaft in mesh with the first crankshaft such that the second crankshaft counterrotates with rotation of the first crankshaft; a first connecting rod having a first end rotatably coupled to the first crankshaft and a second end opposite the first end; a second connecting rod having a first end rotatably coupled to the second crankshaft and a second end opposite the first end; a third connecting rod extending between a first end and a second end, the third connecting rod rotatably coupled to the second end of the first connecting rod at a first location, the third connecting rod rotatably coupled the second end of the second connecting rod at a second location; and a wrist pin rotatably coupling the third connecting rod to the piston at a third location.

Clause 2. The internal combustion engine of clause 1, wherein the first location is at the first end of the third connecting rod and the second location is at the second end of the third connecting rod.

Clause 3. The internal combustion engine of clause 1 or clause 2, wherein the third location is between the first location and the second location.

Clause 4. The internal combustion engine of clause 3, wherein the third location is located on a line extending between the first location and the second location.

Clause 5. The internal combustion engine of clause 3, wherein a line extending between the first location and the second location does not pass through the third location.

Clause 6. The internal combustion engine of clause 5, wherein the third location is further from a crown or top plate of the piston than the first location and the second location.

Clause 7. The internal combustion engine of any of clauses 1 to 6, wherein a first distance between the first end of the first connecting rod and the first end of the second connecting rod is substantially equal to a second distance between the second end of the first connecting rod and the second end of the second connecting rod when the piston is top dead center or bottom dead center.

Clause 8. The internal combustion engine of any of clauses 1 to 7, wherein the first connecting rod is aligned with a first vertical axis of the first crankshaft and the second connecting rod is aligned with a second vertical axis of the second crankshaft when the piston is at top dead center.

Clause 9. The internal combustion engine of any of clauses 1 to 8, wherein the first connecting rod has a first length and the second connecting rod has a second length, the first length equal to the second length.

Clause 10. The internal combustion engine of clause 9, wherein a first distance between the first end of the first connecting rod and the first end of the second connecting rod is substantially equal to the first length.

Clause 11. The internal combustion engine of clause 1, wherein a first distance between the first end of the first connecting rod and the first end of the second connecting rod is smaller than a second distance between the second end of the first connecting rod and the second end of the second connecting rod when the piston is top dead center or bottom dead center.

Clause 12. The internal combustion engine of clause 1, wherein a first distance between the first end of the first connecting rod and the first end of the second connecting rod is larger than a second distance between the second end of the first connecting rod and the second end of the second connecting rod when the piston is top dead center or bottom dead center.

Clause 13. The internal combustion engine of any of clauses 1 to 12, further comprising: a second piston capable of reciprocating between second top dead center and second bottom dead center; a fourth connecting rod having a first end rotatably coupled to the first crankshaft and a second end opposite the first end; a fifth connecting rod having a first end rotatably coupled to the second crankshaft and a second end opposite the first end; a sixth connecting rod extending between a first end and a second end, the third connecting rod rotatably coupled to the second end of the fourth connecting rod at a fourth location, the sixth connecting rod rotatably coupled the second end of the fifth connecting rod at a fifth location; and a second wrist pin rotatably coupling the sixth connecting rod to the second piston at a sixth location.

Clause 14. The internal combustion engine of clause 13, further comprising a second block defining a second bore, the second piston capable of reciprocating within the second bore.

Clause 15. The internal combustion engine of clause 14, wherein the housing is between the block and the second block.

Clause 16. The internal combustion engine of any of clauses 13 to 15, wherein the first end of the first connecting rod is coupled to a first crankpin of the first crankshaft, wherein the first end of the fourth connecting rod is coupled to a second crankpin of the first crankshaft, and wherein first crankpin is rotationally offset from the second crankpin about a longitudinal axis of the first crankshaft by a crankpin offset of 180-degrees.

Clause 17. The internal combustion engine of clause 16, wherein the piston is at top dead center when the second piston is at second top dead center.

Clause 18. The internal combustion engine of any of clauses 13 to 15, wherein first end of the first connecting rod and the first end of the fourth connecting rod as rotatably coupled the first crankshaft at a same crankpin.

Clause 19. The internal combustion engine of clause 18, wherein the piston is at top dead center when the second piston is at second bottom dead center.

Clause 20. An assembly comprising the first connecting rod, the second connecting rod, and the third connecting rod of any of clauses 1 to 12.

Clause 21. An internal combustion engine comprising: a block at least partially defining a bore; a housing coupled to the block; a piston capable of reciprocating within the bore between top dead center and bottom dead center; a first crankshaft configured to rotate in a first direction within the housing; a second crankshaft configured to rotate in a second direction within the housing, the second direction opposite the first direction, the second crankshaft in mesh with the first crankshaft such that the second crankshaft counterrotates with rotation of the first crankshaft; a first connecting rod having a first end rotatably coupled to the first crankshaft and a second end opposite the first end; a second connecting rod having a first end rotatably coupled to the second crankshaft and a second end opposite the first end; and a translating wrist pin rotatably coupling the second end of the first connecting rod and the second end of the second connecting rod to the piston, the translating wrist pin comprising: a wrist pin portion comprising a shaft extending through the second end of the first connecting rod and the second end of the second connecting rod; a first rail positioned on a first end of the shaft and extending perpendicularly to the shaft; and a second rail positioned on a second end of the shaft and extending perpendicularly to the shaft and parallel to the first rail, wherein the first rail is at least partially received within and configured for translational movement along a first guide of the piston, and the second rail is at least partially received within and configured for translational movement along a second guide of the piston.

Clause 22. The internal combustion engine of clause 21, wherein the translating wrist pin comprises an H-shape.

Clause 23. The internal combustion engine of clause 21 or clause 22, wherein the translating wrist pin comprises: a first component comprising the first rail and a first portion of the wrist pin portion; and a second component comprising the second rail and a second portion of the wrist pin portion.

Clause 24. The internal combustion engine of any of clauses 21-23, wherein each of the first connecting rod and the second connecting rod comprise a wishbone shape having a non-forked end and a forked end.

Clause 25. The internal combustion engine of clause 24, wherein: the first end of the first connecting rod comprises the non-forked end of the first connecting rod, and the second end of the first connecting rod comprises the forked end of the first connecting rod; the first end of the second connecting rod comprises the forked end of the second connecting rod, and the second end of the second connecting rod comprises the non-forked end of the first connecting rod; and the non-forked, second end of the second connecting rod is received between the forked, second end of the first connecting rod.

Clause 26. The internal combustion engine of clause 21-23, wherein: the first connecting rod comprises a single arm extending between the first end and the second end; the second connecting rod comprises a first arm and a second arm each extending between the first end and the second end; and the second end of the single arm, first connecting rod is received between the second end of the first arm and the second arm of the second connecting rod.

Clause 27. An internal combustion engine comprising: a block at least partially defining a bore; a housing coupled to the block; a piston capable of reciprocating within the bore between top dead center and bottom dead center; a first crankshaft configured to rotate in a first direction within the housing; a second crankshaft configured to rotate in a second direction within the housing, the second direction opposite the first direction, the second crankshaft in mesh with the first crankshaft such that the second crankshaft counterrotates with rotation of the first crankshaft; a first connecting rod having a first end rotatably coupled to the first crankshaft and a second end opposite the first end; a second connecting rod having a first end rotatably coupled to the second crankshaft and a second end opposite the first end; and a translating wrist pin rotatably coupling the second end of the first connecting rod and the second end of the second connecting rod to the piston, the translating wrist pin comprising at least a first flat upper bearing surface on a first end and a second flat upper bearing surface on a second end, wherein the first end of the translating wrist pin is received within a first guide on the piston such that the first flat upper bearing surface contacts and is capable of sliding along a first corresponding bearing surface of the first guide, and the second end of the translating wrist pin is received within a second guide on the piston such that the second flat upper bearing surface contacts and is capable of sliding along a second corresponding bearing surface of the second guide.

Clause 28. The internal combustion engine of clause 27, wherein the translating wrist pin further comprises: a first flat lower bearing surface on the first end of the translating wrist pin, the first flat lower bearing surface parallel to and positioned opposite from the first flat upper bearing surface; and a second flat lower bearing surface on the second end of the translating wrist pin, the second flat lower bearing surface parallel to and positioned opposite from the second flat upper bearing surface.

Clause 29. The internal combustion engine of clause 28, wherein the first flat upper bearing surface and the second flat upper bearing surface are each larger than the first flat lower bearing surface and the second flat lower bearing surface.

Clause 30. The internal combustion engine of clause 28 or clause 29, wherein the first flat upper bearing surface and the second flat upper bearing surface are not symmetric about a midplane of the translating wrist pin relative to the first flat lower bearing surface and the second flat lower bearing surface.

Clause 31. The internal combustion engine of clause 28, wherein the first flat upper bearing surface and the second flat upper bearing surface are each the same size as the first flat lower bearing surface and the second flat lower bearing surface.

Clause 32. The internal combustion engine of clause 28 or clause 31, wherein the first flat upper bearing surface and the second flat upper bearing surface are symmetric about a midplane of the translating wrist pin relative to the first flat lower bearing surface and the second flat lower bearing surface.

Clause 33. The internal combustion engine of any of clauses 27-32, wherein each of the first connecting rod and the second connecting rod comprise a wishbone shape having a non-forked end and a forked end.

Clause 34. The internal combustion engine of clause 33, wherein: the first end of the first connecting rod comprises the non-forked end of the first connecting rod, and the second end of the first connecting rod comprises the forked end of the first connecting rod; the first end of the second connecting rod comprises the forked end of the second connecting rod, and the second end of the second connecting rod comprises the non-forked end of the first connecting rod; and the non-forked, second end of the second connecting rod is received between the forked, second end of the first connecting rod.

Clause 35. The internal combustion engine of any of clauses 27-32, wherein: the first connecting rod comprises a single arm extending between the first end and the second end; the second connecting rod comprises a first arm and a second arm each extending between the first end and the second end; and the second end of the single arm, first connecting rod is received between the second end of the first arm and the second arm of the second connecting rod.

Clause 36. An internal combustion engine comprising: a first block at least partially defining a first bore; a second block at least partially defining a second bore; a housing positioned between the first block and the second block; a first piston capable of reciprocating within the first bore between first top dead center and first bottom dead center; a second piston capable of reciprocating within the second bore between second top dead center and second bottom dead center; a first crankshaft configured to rotate in a first direction within the housing; a second crankshaft configured to rotate in a second direction within the housing, the second direction opposite the first direction, the second crankshaft in mesh with the first crankshaft such that the second crankshaft counterrotates with rotation of the first crankshaft; a third crankshaft configured to rotate in the first direction with the housing; and a fourth crankshaft configured to rotate in the second direction the housing, the fourth crankshaft in mesh with the third crankshaft such that the fourth crankshaft counterrotates with rotation of the third crankshaft.

Clause 37. The internal combustion engine of clause 36, wherein the first crankshaft is in mesh with the fourth crankshaft and/or wherein the second crankshaft is in mesh with the third crankshaft.

Clause 38. The internal combustion engine of clause 36 or clause 37, further comprising: a first connecting rod connecting the first piston to the first crankshaft; and a second connecting rod connecting the first piston to the second crankshaft.

Clause 39. The internal combustion engine of clause 38, wherein the first connecting rod is connected to the first piston at a first location and the second connecting rod is connected to the first piston at a second location, the second location spaced apart from the first location.

Clause 40. The internal combustion engine of clause 39, wherein the first connecting rod is aligned with a first vertical axis of the first crankshaft and the second connecting rod is aligned with a second vertical axis of the second crankshaft when the first piston is at first top dead center.

Clause 41. The internal combustion engine of clause 38, wherein the first connecting rod and the second connecting rod are both connected to the first piston via a first wristpin.

Clause 42. The internal combustion engine of any of clauses 38 to 41, wherein the first connecting rod and the second connecting rod have a same first length.

Clause 43. The internal combustion engine of any of clauses 36 to 42, further comprising: a third connecting rod connecting the second piston to the third crankshaft; and a fourth connecting rod connecting the second piston to the fourth crankshaft.

Clause 44. The internal combustion engine of clause 43, wherein the third connecting rod is connected to the second piston at a third location and the fourth connecting rod is connected to the second piston at a fourth location, the fourth location spaced apart from the third location.

Clause 45. The internal combustion engine of clause 44, wherein the third connecting rod is aligned with a third vertical axis of the third crankshaft and the fourth connecting rod is aligned with a fourth vertical axis of the fourth crankshaft when the second piston is at second top dead center.

Clause 46. The internal combustion engine of clause 43, wherein the third connecting rod and the fourth connecting rod are both connected to the second piston via a second wristpin.

Clause 47. The internal combustion engine of any of clauses 43 to 46, wherein the third connecting rod and the fourth connecting rod have a same second length.

Clause 48. The internal combustion engine of any of clause 36 to 47, further comprising an output shaft, the output shaft in mesh with at least two of the first crankshaft, the second crankshaft, the third crankshaft, and the fourth crankshaft.

Clause 49. The internal combustion engine of clause 48, wherein a central output shaft axis of the output shaft extends between central axes of the first crankshaft, the second crankshaft, the third crankshaft, and the fourth crankshaft.

Clause 50. The internal combustion engine of any of clauses 36 to 49, further comprising: a third piston; a fifth connecting rod connecting the third piston to the second crankshaft; and a sixth connecting rod connecting the third piston to the third crankshaft.

Clause 51. The internal combustion engine of clause 50, further comprising: a fourth piston; a seventh connecting rod connecting the fourth piston to the first crankshaft; and an eighth connecting rod connecting the fourth piston to the fourth crankshaft.

Clause 52. The internal combustion engine of clauses 51, wherein the first piston and the second piston reciprocate along a first axis and the third piston and the fourth piston reciprocate along a second axis, the first axis orthogonal to the second axis.

Clause 53. The internal combustion engine of clause 51 or clause 52, wherein at least one of the first piston or the second piston is configured for combustion and at least one of the third piston and or the fourth piston is configured for scavenging one or more combustion chambers associated with the first piston or the second piston.

Clause 54. An internal combustion engine comprising: a block at least partially defining a bore; a housing coupled to the block; a piston capable of reciprocating within the bore between top dead center and bottom dead center; a first crankshaft configured to rotate in a first direction within the housing; a second crankshaft configured to rotate in a second direction within the housing, the second direction opposite the first direction, the second crankshaft in mesh with the first crankshaft; a first connecting rod connecting the piston to the first crankshaft; and a second connecting rod connecting the piston to the second crankshaft.

Clause 55. The internal combustion engine of clause 54, wherein the first connecting rod is connected to the piston at a first location and the second connecting rod is connected to the piston at a second location, the second location spaced apart from the first location.

Clause 56. The internal combustion engine of clause 55, wherein the first connecting rod is aligned with a first vertical axis of the first crankshaft and the second connecting rod is aligned with a second vertical axis of the second crankshaft when the piston is at top dead center.

Clause 57. The internal combustion engine of clause 54, wherein the first connecting rod and the second connecting rod are both connected to the piston via a same wristpin.

Clause 58. The internal combustion engine of any of clauses 54 to 57, wherein the first connecting rod and the second connecting rod have a same length.

Clause 59. An internal combustion engine comprising: a first block at least partially defining a first bore; a second block at least partially defining a second bore; a housing positioned between the first block and the second block; a first piston capable of reciprocating within the first bore between first top dead center and first bottom dead center; a second piston capable of reciprocating within the second bore between second top dead center and second bottom dead center; a first crankshaft configured to rotate in a first direction within a first passage of the housing; a second crankshaft configured to rotate in a second direction within a second passage of the housing, the second direction opposite the first direction, the second crankshaft in mesh with the first crankshaft; a first connecting rod connecting the first piston to the first crankshaft; a second connecting rod connecting the first piston to the second crankshaft; a third connecting rod connecting the second piston to the first crankshaft; and a fourth connecting rod connecting the second piston to the second crankshaft.

Clause 60. The internal combustion engine of clause 59, wherein the first passage and the second passage are between the first bore and the second bore.

Clause 61. The internal combustion engine of clause 59 or clause 60, wherein the first connecting rod is connected to the first crankshaft by a first crankpin and the third connecting rod is connected to the first crankshaft via a second crankpin, and wherein first crankpin is rotationally offset from the second crankpin about a longitudinal axis of the first crankshaft by a crankpin offset of 180-degrees.

Clause 62. The internal combustion engine of clause 61, wherein the first piston is at first top dead center when the second piston is at second top dead center.

Clause 63. The internal combustion engine of clause 59 or clause 60, wherein the first connecting rod and the third connecting rod are connected to the first crankshaft via a first crankpin and the second connecting rod and the fourth connecting rod are connected to the second crankshaft via a second crankpin.

Clause 64. The internal combustion engine of clause 59 or clause 60, wherein the first connecting rod and the third connecting rod are connected to the first crankshaft by axially aligned crankpins and the second connecting rod and the fourth connecting rod are connected to the second crankshaft by axially aligned crankpins.

Clause 65. The internal combustion engine of clause 63 or clause 64, wherein the first piston is at first top dead center when the second piston is at second bottom dead center.

Clause 66. The internal combustion engine of any of clauses 59 to 65, wherein the first connecting rod is connected to the first piston at a first location and the second connecting rod is connected to the first piston at a second location, the second location spaced apart from the first location.

Clause 67. The internal combustion engine of clause 66, wherein the first connecting rod is aligned with a first vertical axis of the first crankshaft and the second connecting rod is aligned with a second vertical axis of the second crankshaft when the first piston is at first top dead center.

Clause 68. The internal combustion engine of any of clauses 59 to 65, wherein the first connecting rod and the second connecting rod are connected to the first piston via a third wristpin.

Clause 69. The internal combustion engine of any of clauses 59 to 68, wherein the first connecting rod and the second connecting rod have a same length.

Clause 70. An internal combustion engine comprising: a base housing, at least two pairs of crankshafts positioned within the base housing, each pair of crankshafts comprising: a first crankshaft configured to rotate in a first direction, a second crankshaft configured to rotate in a second direction, the second direction being opposite the first direction, the second crankshaft in mesh with the first crankshaft such that the second crankshaft counterrotates with rotation of the first crankshaft; an output shaft positioned within the base housing, the output shaft in mesh with the first crankshaft of each of the at least two pairs of crankshafts; at least two blocks, each block at least partially defining a bore; and at least two pistons, each piston positioned within a bore of a block of the at least two blocks, each piston capable of reciprocating within the bore between top dead center and bottom dead center, and each piston coupled to the first crankshaft and the second crankshaft of one of the at least two pairs of crankshafts by a connecting rod linkage assembly such that rotation of the first crankshaft and the second crankshaft causes the connecting rod linkage assembly to reciprocate the piston within the bore.

Clause 71. The internal combustion engine of clause 70, wherein rotation of the output shaft synchronizes rotation of the first crankshaft of each of the at least two pairs of crankshafts.

Clause 72. The internal combustion engine of clause 70 or clause 71, wherein for each of the at least two pairs of crankshafts, the second crankshaft of the pair of crankshafts is in mesh with the first crankshaft of an adjacent pair of crankshafts.

Clause 73. The internal combustion engine of clause 70 or clause 71, wherein for each of the at least two pairs of crankshafts, the second crankshaft of the pair of crankshafts is not in mesh with the first crankshaft of an adjacent pair of crankshafts.

Clause 74. The internal combustion engine of any of clauses 70-73, further comprising: at least two additional blocks, each additional block defining an additional bore; and at least two additional pistons, each additional position positioned within an additional bore of an additional block of the at least two additional blocks, each additional piston capable of reciprocating within the additional bore between top dead center and bottom dead center, and each additional piston coupled to the second crankshaft of one of the at least two pairs of crankshafts and the first crankshaft of an adjacent pair of crankshafts of the at least two pairs of crankshafts by an additional connecting rod linkage assembly such that rotation of the second crankshaft of the one of the at least two pairs of crankshafts and rotations of the first crankshaft of the adjacent pair of crankshafts causes the additional connecting rod linkage assembly to reciprocate the additional piston within the additional bore.

Clause 75. The internal combustion engine of clause 74, wherein each additional piston is configured to provide scavenging of at least one combustion chamber of the internal combustion engine.

Clause 76. The internal combustion engine of clause 75, wherein each additional bore includes a one-way inlet valve and a one-way outlet valve, the one-way outlet valve connected by a passageway to an inlet of an adjacent bore.

Clause 77. The internal combustion engine of any of clauses 70-73, wherein: the at least two pairs of crankshafts comprise three pairs of crankshafts; the at least two blocks comprise three blocks; and the at least two pistons comprise three pistons.

Clause 78. The internal combustion engine of clauses 77, wherein the three pairs of crankshafts, the three blocks, and the three pistons are radially arranged around the output shaft at about 120 degree intervals.

Clause 79. The internal combustion engine of any of clauses 74-76, wherein: the at least two pairs of crankshafts comprise three pairs of crankshafts; the at least two blocks comprise three blocks; the at least two additional blocks comprise three blocks; the at least two pistons comprise three pistons; and the at least two additional pistons comprise three additional pistons.

Clause 80. The internal combustion engine of clauses 79, wherein: the three pairs of crankshafts, the three blocks, and the three pistons are radially arranged around the output shaft at about 120-degree intervals.

Clause 81. The internal combustion engine of clauses 70-73, wherein: the at least two pairs of crankshafts comprise four pairs of crankshafts; the at least two blocks comprise four blocks; and the at least two pistons comprise four pistons.

Clause 82. The internal combustion engine of clauses 81, wherein the four pairs of crankshafts, the four blocks, and the four pistons are radially arranged around the output shaft at about 90-degree intervals.

Clause 83. An assembly comprising: a pair of counter-rotating crankshafts comprising: a first crankshaft configured to rotate in a first direction; and a second crankshaft configured to rotate in a second direction opposite the first direction; a first piston coupled to and positioned on a first side of the pair of counter-rotating crankshafts; a second piston coupled to and positioned on a second side of the pair of counter-rotating crankshafts; and six connecting rods coupling the first piston and the second piston to the pair of counter-rotating crankshafts.

Clause 84. The assembly of clause 83, wherein each of the six connecting rods comprises a first end and a second end, wherein the first ends are coupled to one of the first crankshaft or the second crankshaft, and wherein the second ends are coupled to one of the first piston or the second piston.

Clause 85. The assembly of clause 83 or clause 84, wherein the first piston is coupled to three connecting rods of the six connecting rods, and wherein the second piston is coupled to three different connecting rods of the six connecting rods.

Clause 86. The assembly of any of clauses 83 to 85, wherein the first piston is coupled to a first connecting rod of the six connecting rods by a first wrist pin and coupled to a second connecting rod and a third connecting rod by a second wrist pin.

Clause 87. The assembly of clause 86, wherein the second connecting rod and the third connecting rod have a mass substantially equal to half a mass of the first connecting rod.

Clause 88. The assembly of clause 83 or clause 84, wherein the first piston is coupled to four of the six connecting rods, and wherein the second piston is coupled to two of the six connecting rods.

Clause 89. The assembly of any of clauses 83, 84, or 88, wherein the first piston comprises: a first connecting portion having a first side and a second side, the first connecting portion comprising: a first piston bore extending between the first side and the second side, the first piston bore configured to receive a first wrist pin; and a second piston bore extending between the first side and the second side, the second piston bore configured to receive a second wrist pin, wherein the first piston bore is spaced apart from the second piston bore.

Clause 90. The assembly of clause 89, wherein the first piston is coupled to a first connecting rod and a second connecting rod of the six connecting rods via the first wrist pin, wherein the first connecting rod is positioned on the first side of the first connecting portion and the second connecting rod is positioned on the second side of the first connecting portion, wherein the first piston is coupled to a third connecting rod and a fourth connecting rod of the six connecting rods via the second wrist pin, and wherein the third connecting rod is positioned on the first side of the first connecting portion and the fourth connecting rod is positioned on the second side of the first connecting portion.

Clause 91. The assembly of any of clauses 83, 84, or 88 to 90, wherein the second piston comprises: a first connecting portion having a first outer side and first inner side, the first connecting portion comprising: a first piston bore extending between the first outer side and the first inner side, the first piston bore configured to receive a third wrist pin; and a second piston bore extending between the first outer side and the first inner side, the second piston bore configured to receive a fourth wrist pin; and a second connecting portion have a second outer side and second inner side, the second connecting portion comprising: a third piston bore extending between the second outer side and the second inner side, the third piston bore configured to receive the third wrist pin; and a fourth piston bore extending between the second outer side and the second inner side, the fourth piston bore configured to receive the fourth wrist pin, wherein there is a gap between the first connecting portion and the second connecting portion.

Clause 92. The assembly of clause 91, wherein the second piston is coupled to a fifth connecting rod via the third wrist pin and a sixth connecting rod via the fourth wrist pin, and wherein the fifth connecting rod and sixth connecting rod are at least partially positioned with the gap between the first connecting portion and the second connecting portion of the second piston.

Clause 93. The assembly of clause 92, wherein the first connecting rod, the second connecting rod, the third connecting rod, and the fourth connecting rod have a combined mass that is substantially equal to the combined mass of the fifth connecting rod and the sixth connecting rod.

Clause 94. The assembly of any of clauses 89 to 93, wherein the first connecting portion of the first piston is coupled to a main body of the first piston.

Clause 95. The assembly of clause 94, wherein the first connecting portion of the first piston is coupled to the main body of the first piston via a bearing.

Clause 96. The assembly of any of clauses 89 to 93, wherein the first connecting portion of the first piston is integrally formed with a main body of the first piston.

Clause 97. The assembly of any of clauses 89 to 96, wherein the first connecting portion and the second connecting portion of the second piston are coupled to a main body of the second piston.

Clause 98. The assembly of clause 94, wherein the first connecting portion and the second connecting portion of the second piston are coupled to the main body of the second piston via a bearing.

Clause 99. The assembly of any of clauses 89 to 96, wherein the first connecting portion and the second connecting portion of the second piston are integrally formed with a main body of the second piston.

Clause 100. The assembly of any of clauses 83 to 99, wherein the first end of at least one of the six connecting rods is laterally offset relative to its second end.

Clause 101. The assembly of any of clauses 83 to 100, wherein the first end of at least one of the six connecting rods is aligned along a longitudinal axis with its second end.

Clause 102. A crankshaft assembly comprising: a longitudinal axis defining an axis of rotation of the crankshaft assembly; a first main bearing journal; a second main bearing journal; and three crankpins comprising: a first crankpin; a second crankpin; and a third crankpin, wherein the third crankpin is positioned between the first crankpin and the second crankpin along the longitudinal axis, and wherein the three crankpins are positioned between the first main bearing journal and the second main bearing journal along the longitudinal axis.

Clause 103. The crankshaft assembly of clause 102, wherein there are no main bearing journals between the first main bearing journal and the second main bearing journal.

Clause 104. The crankshaft assembly of clause 102 or clause 103, further comprising a plurality crank webs, wherein each of the three crankpins extends between a pair of crank webs of the plurality of crank webs.

Clause 105. The crankshaft assembly of any of clauses 102 to 104, wherein a longitudinal axis of the first crankpin is aligned with a longitudinal axis of the second crankpin.

Clause 106. The crankshaft assembly of clause 105, wherein a longitudinal axis of the third crankpin is 180 degrees offset from the longitudinal axis of the first crankpin about the axis of rotation.

Clause 107. The crankshaft assembly of any of clauses 102 to 106, wherein the first crankpin and the second crankpin are configured to connect a first piston to the crankshaft assembly via a pair of connecting rods.

Clause 108. The crankshaft assembly of clause 107, wherein the third crankpin is configured to connect a second piston to the crankshaft assembly via a single connecting rod.

Clause 109. The crankshaft assembly of any of clauses 102 to 108, further comprising: a first shaft portion defining a first end of the crankshaft assembly; and a second shaft portion defining a second end of the crankshaft assembly.

Clause 110. The crankshaft assembly of clause 109, wherein the first shaft portion comprises a tapered portion extending along a first length and having a varying diameter along the first length, wherein the tapered portion has a minimum diameter at an end closest to the first end of the crankshaft assembly.

Clause 111. The crankshaft assembly of clause 110, wherein the first shaft portion further comprises a registration portion having a polygonal cross-section, wherein the registration portion is positioned between the tapered portion and the first end of the crankshaft assembly.

Clause 112. The crankshaft assembly of clause 111, wherein the first shaft portion further comprises a threaded portion adjacent to the registration portion.

Clause 113. The crankshaft assembly of clause 112, further comprising a gear, wherein the first shaft portion is configured to receive the gear, and wherein the gear is configured to be coupled to the first shaft portion by threading a collar on the threaded portion.

Clause 114. The crankshaft assembly of clause 113, wherein the gear comprises: a first side; a second side; and an opening extending between the first side and the second side, wherein a first portion of the opening is a registration opening configured to interface with the registration portion, and wherein the registration opening has a corresponding polygonal cross-section to the registration opening.

Clause 115. The crankshaft assembly of clause 114, wherein a second portion of the opening of the gear is a tapered opening having a varying diameter, wherein the tapered opening is configured to interface with the tapered portion of the first shaft portion.

Clause 116. A piston assembly comprising: a piston body comprising: a piston crown; and a piston wall extending from the piston crown, the piston wall including one or more grooves for receiving piston rings; and a piston connecting portion comprising: a first piston bore configured to receive a first wrist pin; and a second piston bore configured to receive a second wrist pin, wherein the first piston bore is offset from the second piston bore.

Clause 117. The piston assembly of clause 116, wherein the piston connecting portion is integrally formed with the piston body.

Clause 118. The piston assembly of clause 116, wherein the piston connecting portion is coupled to the piston body.

Clause 119. The piston assembly of any of clauses 116 to 118, wherein the piston assembly is configured to be coupled to two connecting rods via the first wrist pin and two connecting rods via the second wrist pin.

Clause 120. The piston assembly of any of clauses 116 to 118, wherein the piston assembly is configured to be coupled to one connecting rod via the first wrist pin and one connecting rod via the second wrist pin.

Clause 121. The piston assembly of any of clauses 116 to 118, wherein the piston assembly is configured to be coupled to one connecting rod via the first wrist pin and two connecting rods via the second wrist pin.

Clause 122. The piston assembly of any of clauses 116 to 121, wherein the piston connecting portion comprises: a first connecting portion; and a second connecting portion, wherein a gap is defined between the first connecting portion and the second connecting portion, and wherein the first piston bore and the second piston bore extend through both the first connecting portion and the second connecting portion and across the gap.

Clause 123. The piston assembly of any of clauses 116 to 122, wherein the piston body further comprises a piston skirt extending from the piston wall away from the piston crown.

Clause 124. A crankshaft comprising: a first longitudinal axis defining an axis of rotation of the crankshaft; a plurality of main bearing journals positioned along the first longitudinal axis; a plurality of crankpins; and a plurality of crank webs, wherein each crankpin extends between a pair of crank webs of the plurality of crank webs.

Clause 125. The crankshaft of clause 124, further comprising: a first shaft portion defining a first end of the crankshaft assembly; and a second shaft portion defining a second end of the crankshaft assembly.

Clause 126. The crankshaft of clause 125, wherein the first shaft portion comprises a tapered portion extending along a first length and having a varying diameter along the first length, wherein the tapered portion has a minimum diameter at an end closest to the first end of the crankshaft.

Clause 127. The crankshaft of clause 126, wherein the first shaft portion further comprises a registration portion having a polygonal cross-section, wherein the registration portion is positioned between the tapered portion and the first end of the crankshaft assembly.

Clause 128. The crankshaft of clause 127, wherein the first shaft portion further comprises a threaded portion adjacent to the registration portion.

Clause 129. The crankshaft of any of clauses 125 to 128, wherein the plurality of main bearing journals comprise a first outer main bearing journal and a second outer main bearing journal, wherein the first shaft portion extends from the first outer main bearing journal, and wherein the second shaft portion extends from the second outer main bearing journal.

Clause 130. The crankshaft of clause 129, wherein the plurality of main bearing journals further comprise a central main bearing journal positioned between the first outer main bearing journal and the second outer main bearing journal.

Clause 131. The crankshaft of clause 130, wherein the central main bearing journal is the only main bearing journal between the first outer main bearing journal and the second outer main bearing journal.

Clause 132. The crankshaft of any of clauses 124 to 131, wherein the plurality of crankpins comprise: a first crankpin and a second crankpin aligned along a second longitudinal axis; and a third crankpin and a fourth crankpin aligned along a third longitudinal axis.

Clause 133. The crankshaft of clause 132, wherein the third crankpin and fourth crankpin are positioned between the first crankpin and the second crankpin relative to the first longitudinal axis.

Clause 134. The crankshaft of clause 132 or clause 133, wherein the second longitudinal axis is 180-degrees rotationally offset from the third longitudinal axis about the rotational axis.

Clause 135. The crankshaft of any of clauses 132 to 134 when dependent on clause 129, wherein each of the plurality of crankpins is positioned between the first outer main bearing journal and the second outer main bearing journal.

Clause 136. The crankshaft of clause 135, wherein the first crankpin is positioned adjacent the first outer main bearing journal, the second crankpin is positioned adjacent the second outer main bearing journal, and the third crankpin and fourth crankpin are positioned adjacent the central main bearing journal.

Clause 137. The crankshaft of clause 129, wherein the plurality of main bearing journals further comprise a first central main bearing journal and a second central main bearing positioned between the first outer main bearing journal and the second outer main bearing journal.

Clause 138. The crankshaft of clause 135, wherein the first central main bearing journal and the second central main bearing journals are the only main bearing journals between the first outer main bearing journal and the second outer main bearing journal.

Clause 139. The crankshaft of any of clauses 124 to 129 or clause 137 or clause 138, wherein the plurality of crankpins comprise: a first crankpin and a second crankpin aligned along a second longitudinal axis; and a third crankpin extending along a third longitudinal axis.

Clause 140. The crankshaft of clause 139, wherein the third crankpin is positioned between the first crankpin and the second crankpin.

Clause 141. The crankshaft of clause 139 or clause 140, wherein the second longitudinal axis is 180-degrees rotationally offset from the third longitudinal axis about the axis of rotation.

Clause 142. A connecting rod comprising: a first arm portion comprising a first body extending between a first end and a second end; a second arm portion comprising a second body extending between a first end and a second end; and a connecting portion extending between the first body and the second body, the connecting portion connected to the first body between its first end and its second end and connected to the second body between its first end and its second end.

Clause 143. The connecting rod of clause 142, wherein a first crankshaft bore extends through the first end of the first body and a second crankshaft bore extends through the first end of the second body, and wherein a first pin bore extends through the second end of the first body and a second pin bore extends through the second end of the second body.

Clause 144. The connecting rod of clause 143, wherein a first bore axis extends through both the first crankshaft bore and the second crankshaft bore, and wherein a second bore axis extends through both the first pin bore and the second pin bore.

Clause 145. The connecting rod of any of clauses 142 to 144, wherein the first body comprises an angled segment between the first end and the second end of the first body.

Clause 146. The connecting rod of clause 145, wherein a first longitudinal axis of the first end of the first body extends parallel to a second longitudinal axis of the second end of the first body, and wherein a third longitudinal axis of the angled segment is at a non-zero angle relative to the first longitudinal axis and the second longitudinal axis.

Clause 147. The connecting rod of clause 146, wherein the first end of the first body is offset from the second end of the first body such that the first longitudinal axis is spaced apart from the second longitudinal axis.

Clause 148. The connecting rod of any of clauses 145 to 147, wherein the angled segment is angled inwardly towards the second arm portion.

Clause 149. A connecting rod comprising: a body extending between a first end and a second end, the body comprising: a first segment; a second segment; and a third segment, wherein the third segment is between the first segment and the second segment and is at an angle relative to the first segment and the second segment; and a crankshaft bore extending through the body near the first end; and a pin bore extending through the body near the second end.

Clause 150. The connecting rod of clause 149, wherein a first longitudinal axis of the first segment extends parallel to a second longitudinal axis of the second segment, and wherein a third longitudinal axis of the third segment is at a non-zero angle relative to the first longitudinal axis and the second longitudinal axis.

Clause 151. The connecting rod of clause 150, wherein the first end is offset from the second end such that the first longitudinal axis is spaced apart from the second longitudinal axis.

Clause 152. A connecting rod assembly comprising: a first arm portion comprising the connecting rod of any of clauses 149 to 151; a second arm portion comprising the connecting rod of any of clauses 149 to 151; and a connecting portion extending between first arm portion and the second arm portion such that the first arm portion is spaced apart from the second arm portion.

Clause 153. A connecting rod comprising: a body extending between a first end and a second end, the body comprising: a central portion extending from the first end of the body; and a branched portion extending from the central portion towards the second end of the body; the branched portion comprising: a first arm extending towards a first arm end; and a second arm extending towards a second arm end, wherein the first arm end and the second arm end define the second end of the body; a first opening extending through the central portion near the first end of the body; a second opening extending through first arm near the first arm end; and a third opening extending through the second arm near the second arm end.

Clause 154. The connecting rod of clause 153, wherein the first opening comprises a crankshaft bore, the second opening comprises a first pin bore, and the third opening comprises a second pin bore.

Clause 155. The connecting rod of clause 154, wherein the first pin bore is axially aligned with the second pin bore.

Clause 156. The connecting rod of any of clauses 153 to 155, wherein the first arm comprises an first segment and a second segment, wherein the first segment extends from the central portion and is at an angle relative to the central portion, and wherein the second segment extends from the first segment.

Clause 157. The connecting rod of clause 156, wherein a first longitudinal axis of the central portion extends parallel to a second longitudinal axis of the second segment of the first arm, the second longitudinal axis being offset from the first longitudinal axis.

Clause 158. The connecting rod of clause 157, wherein the second arm comprises an first segment and a second segment, wherein the first segment of the second arm extends from the central portion and is at an angle relative to the central portion, and wherein the second segment of the second arm extends from the first segment of the second arm.

Clause 159. The connecting rod of clause 158, wherein a third longitudinal axis of the second segment of the second arm extends parallel to both the first longitudinal axis and the second longitudinal axis.

Clause 160. A connecting rod comprising: a body; an end cap configured to be removably coupled to the body, the end cap defining a first end of the connecting rod, and a distal end of the body relative to the end cap defining a second end of connecting rod; a first opening extending through the connecting rod, the first opening being partially defined by the body and partially defined by the end cap; a second opening extending through the body near the second end, wherein a connecting rod axis of the connecting rod extends between a first center of the first opening and a second center of the second opening; a first fastener boss extending along a first boss axis between the body and the end cap on a first side of the first opening; and a second fastener boss extending along a second boss axis between the body and the end cap on a second side of the first opening, wherein the first boss axis is at an angle relative to the connecting rod axis and the second boss axis is at the angle relative to the connecting rod axis.

Clause 161. The connecting rod of clause 160, wherein the body comprises: a first segment extending from a first end of the body; a second segment extending from a second end of the body; and a third segment, wherein the third segment is between the first segment and the second segment and is at an angle relative to the first segment and the second segment.

Clause 162. The connecting rod of clause 161, wherein a first longitudinal axis of the first segment extends parallel to a second longitudinal axis of the second segment, and wherein a third longitudinal axis of the third segment is at a non-zero angle relative to the first longitudinal axis and the second longitudinal axis.

Clause 163. The connecting rod of clause 162, wherein the first end of the body is offset from the second end of the body such that the first longitudinal axis is spaced apart from the second longitudinal axis.

Clause 164. The connecting rod of any of clauses 160 to 163, wherein the third segment has a varying thickness across a width of the third segment relative to the connecting rod axis.

Clause 165. The connecting rod of any of clauses 160-164, wherein at least a portion of the third segment has a varying thickness across a length of the third segment relative to the connecting rod axis.

Clause 166. The connecting rod of any of clauses 160-165, wherein the body further comprises a clearance section, the clearance section being a portion of the body having a different thickness relative to at least one of a first end of the body or a second end of the body.

Clause 167. The connecting rod of clause 166, wherein the clearance section is configured to receive at least a portion of a second connecting rod in use.

Clause 168. The connecting rod of clause 166 or 167, wherein the clearance section defines a transition region between a first portion of the body and a second portion of the body, the first portion being in a first plane and the second portion being in a second plane, wherein the first plane is parallel to and offset from the second plane.

Clause 169. A system comprising: a first connecting rod comprising a first big end and a first small end, the first connecting rod coupled to a first crankshaft at the first big end, the first connecting rod coupled to a piston at the first small end; and a second connecting rod comprising a second big end and a second small end, the second connecting rod coupled to a second crankshaft at the second big end, the second connecting rod coupled to the piston at the second small end, wherein the first big end and the second big end are substantially aligned along a first plane during rotation of the first crankshaft and the second crankshaft.

Clause 170. The system of clause 169, wherein the first connecting rod comprises a clearance section configured to receive at least a portion of the second connecting rod during rotation of the first crankshaft and the second crankshaft.

Clause 171. The system of clause 170, wherein the clearance section is configured to a allowing a scissoring motion between the first connecting rod and the second connecting rod during rotation of the first crankshaft and the second crankshaft.

Clause 172. The system of any of clauses 169 to 171, wherein the first small end is positioned adjacent to the second small end when coupled to the piston.

Clause 173. The system of any of clauses 169 to 172, wherein the first small end travels substantially along a second plane and the second small end travels substantially along a third plane during rotation of the first crankshaft and the second crankshaft, the second plane offset and parallel to the third plane.

Clause 174. The system of clause 173, wherein the first plane is between the second plane and the third plane.

Clause 175. The system of any of clauses 169 to 174, wherein the first connecting rod and the second connecting rod are coupled to the piston by a wrist pin.

Clause 176. The system of any of clauses 169 to 175, wherein a gap is maintained between the first big end and the second big end during rotation of the first crankshaft and the second crankshaft.

Clause 177. The system of any of clauses 169 to 176, wherein the first connecting rod comprises the connecting rod of any of clauses 160 to 168, and/or wherein the second connecting rod comprise the connecting rod of any of clauses 160 to 168.

Clause 178. An assembly comprising: a pair of crankshafts, the pair of crankshafts comprising a first crankshaft and a second crankshaft, wherein the first crankshaft is engaged with the second crankshaft such that rotation of the first crankshaft causes counterrotation of the second crankshaft; a piston; and a plurality of connecting rods coupling the pair of crankshafts to the piston such that rotation of the pair of crankshafts causes reciprocating motion of the piston, the plurality of connecting rods comprising at least one connecting rod coupling the first crankshaft to the piston and at least one connecting rod coupling the second crankshaft to the piston.

Clause 179. The assembly of clause 178, wherein, for the plurality of connecting rods: the at least one connecting rod coupling the first crankshaft to the piston comprises two connecting rods; and the at least one connecting rod coupling the second crankshaft to the piston comprises one connecting rod.

Clause 180. The assembly of clause 179, wherein a total mass of the two connecting rods of the at least one connecting rod coupling the first crankshaft to the piston is substantially equal to a total mass of the one connecting rod of the at least one connecting rod coupling the second crankshaft to the piston.

Clause 181. The assembly of any of clauses 178-180, wherein the plurality of connecting rods coupling the pair of crankshafts to the piston are configured in one of: a toed-in configuration, a fully toed-in configuration, a toed-out configuration, or a neutral configuration.

Clause 182. The assembly of any of clauses 178-181, wherein the piston comprises one of: a circular-shaped piston; an oval-shaped piston, wherein a long axis of the oval-shaped piston is oriented to be parallel or perpendicular to longitudinal axes of the pair of crankshafts; or a double-c shaped piston, wherein a long axis of the double-c shaped piston is oriented to be parallel or perpendicular to the longitudinal axes of the pair of crankshafts.

Clause 183. The assembly of any of clauses 178-182, wherein, for the pair of crankshafts, the first crankshaft and the second crankshaft both comprise one of: a crankshaft comprising a first main bearing journal, a second main bearing journal, and a third main bearing journal, a pair of crankpins positioned between the first main bearing journal and the second main bearing journal, and a pair of crankpins positioned between the second main bearing journal and the third main bearing journal, optionally wherein for each pair of crankpins a first crankpin is rotationally offset from a second crankpin about a longitudinal axis of the crankshaft by a crankpin offset, optionally wherein the crankpin offset is 0 degrees, optionally wherein the crankpin offset is 180 degrees; a crankshaft comprising a first main bearing journal, a second main bearing journal, a third main bearing journal, and a fourth main bearing journal, a first crankpin positioned between the first main bearing journal and the second main bearing journal, a second crankpin positioned between the fourth main bearing journal and the third main bearing journal, and a third crankpin positioned between the second main bearing journal and the third main bearing journal, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 180 degrees; or a crankshaft comprising a first main bearing journal and a second main bearing journal, and a first crankpin, a second crankpin, and a third crankpin are positioned between the first main bearing journal and the second main bearing journal, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 180 degrees.

Clause 184. The assembly of any of clauses 178-183, wherein the plurality of connecting rods coupling the pair of crankshafts to the piston are configured in a fully toed-in configuration, and wherein the plurality of connecting rods are coupled to the piston by a translating wrist pin.

Clause 185. The assembly of any of clauses 178-184, wherein the piston comprises a first piston, and the plurality of connecting rods comprise a first plurality of connecting rods coupling the pair of crankshafts to the first piston, and wherein the assembly further comprises: a second piston; and a second plurality of connecting rods coupling the pair of crankshafts to the second piston such that rotation of the pair of crankshafts causes reciprocating motion of the second piston, the second plurality of connecting rods comprising at least one connecting rod coupling the first crankshaft to the second piston and at least one connecting rod coupling the second crankshaft to the second piston, wherein each of the first piston and the second piston reciprocate along a common axis.

Clause 186. The assembly of clause 185, wherein: for the first plurality of connecting rods: the at least one connecting rod coupling the first crankshaft to the first piston comprises two connecting rods, and the at least one connecting rod coupling the second crankshaft to the first piston comprises one connecting rod; and for the second plurality of connecting rods: the at least one connecting rod coupling the first crankshaft to the second piston comprises one connecting rod, and the at least one connecting rod coupling the second crankshaft to the second piston comprises two connecting rods.

Clause 187. The assembly of clause 185, wherein: for the first plurality of connecting rods: the at least one connecting rod coupling the first crankshaft to the first piston comprises two connecting rods, and the at least one connecting rod coupling the second crankshaft to the first piston comprises two connecting rods; and for the second plurality of connecting rods: the at least one connecting rod coupling the first crankshaft to the second piston comprises one connecting rod, and the at least one connecting rod coupling the second crankshaft to the second piston comprises one connecting rod.

Clause 188. The assembly of clause 185, wherein: for the first plurality of connecting rods: the at least one connecting rod coupling the first crankshaft to the first piston comprises two connecting rods, and the at least one connecting rod coupling the second crankshaft to the first piston comprises two connecting rods; and for the second plurality of connecting rods: the at least two connecting rods coupling the first crankshaft to the second piston comprises one connecting rod, and the at least two connecting rods coupling the second crankshaft to the second piston comprises one connecting rod.

Clause 189. The assembly of any of clauses 185-188, wherein the second plurality of connecting rods coupling the pair of crankshafts to the piston are configured in one of: a toed-in configuration, a fully toed-in configuration, a toed-out configuration, or a neutral configuration, optionally wherein a configuration of the first plurality of connecting rods is the same as a configuration of the second plurality of connecting rods, optionally wherein the configuration of the first plurality of connecting rods is different than the configuration of the second plurality of connecting rods.

Clause 190. The assembly of any of clauses 185-189, wherein the second piston comprises one of: a circular-shaped piston; an oval-shaped piston, wherein a long axis of the oval-shaped piston is oriented to be parallel or perpendicular to longitudinal axes of the pair of crankshafts; or a double-c shaped piston, wherein a long axis of the double-c shaped piston is oriented to be parallel or perpendicular to the longitudinal axes of the pair of crankshafts, optionally wherein a type of the first piston is the same as a type of the second piston, optionally wherein the type of the first piston is different than the type of the second piston.

Clause 191. The assembly of any of clauses 185-190, wherein the plurality of connecting rods coupling the pair of crankshafts to the second piston are configured in a fully toed-in configuration, and wherein the plurality of connecting rods are coupled to the second piston by a translating wrist pin.

Clause 192. An internal combustion engine comprising: the assembly of any of clauses 178-184; a block defining a bore at least partially defining a combustion chamber, the piston configured to reciprocate within the bore between top dead center and bottom dead center; an inlet valve configured to allow air to enter the combustion chamber; and an outlet valve configured to allow exhaust to exit the combustion chamber.

Clause 193. The internal combustion engine of clause 192, wherein at least one of the inlet valve or the outlet valve comprises a rotary valve having a conical shape, a multi-faceted conical shape, an hourglass shape, or a split tailored shape, optionally wherein the rotary valve is positioned to at least partially intersect with a peripheral wall of the bore, and optionally wherein the rotary valve is positioned to at least partially intersect an upper edge of the bore.

Clause 194. An internal combustion engine comprising: the assembly of any of clauses 185-191; a first block defining a first bore at least partially defining a first combustion chamber, the first piston configured to reciprocate within the first bore between top dead center and bottom dead center; a first inlet valve configured to allow air to enter the first combustion chamber; a first outlet valve configured to allow exhaust to exit the first combustion chamber; a second block defining a second bore at least partially defining a second chamber, the second piston configured to reciprocate within the second bore between top dead center and bottom dead center.

Clause 195. The internal combustion engine of clause 194, further comprising a second inlet valve configured to allow fluid to enter the second chamber, and a second outlet valve configured to allow fluid to exit the second chamber.

Clause 196. The internal combustion engine of clause 194 or clause 195, wherein at least one of the first inlet valve, the first outlet valve, the second inlet valve, or the second outlet valve comprises a rotary valve having a conical shape, a multi-faceted conical shape, an hourglass shape, or a split tailored shape, optionally wherein the rotary valve is positioned to at least partially intersect with a peripheral wall of the first bore or the second bore, and optionally wherein the rotary valve is positioned to at least partially intersect an upper edge of the first bore or an upper edge of the second bore.

Clause 197. The internal combustion engine of any of clauses 194-196, wherein the second chamber comprises a combustion chamber.

Clause 198. The internal combustion engine of clause 194 or clause 196, further comprising at least one inlet port configured to allow fluid to enter the second chamber and at least one outlet port configured to allow fluid to exit the second chamber, wherein the second chamber comprises a non-combustion or auxiliary chamber, and optionally wherein the internal combustion engine is further configured to direct fluid from the at least one outlet port to an inlet passage of the first combustion chamber.

Clause 199. The internal combustion engine of clause 198, wherein the second piston comprises a double-acting piston.

Clause 200. An assembly comprising: at least two pairs of crankshafts, each pair of crankshafts comprising a first crankshaft and a second crankshaft, wherein, in each pair of crankshafts, the first crankshaft is engaged with the second crankshaft such that rotation of the first crankshaft causes counterrotation of the second crankshaft; at least one piston associated with each pair of crankshafts; and for each pair of crankshafts, a plurality of connecting rods coupling the pair of crankshafts to the associated piston such that rotation of the pair of crankshafts causes reciprocating motion of the associated piston, the plurality of connecting rods comprising at least one connecting rod coupling the first crankshaft of the pair of crankshafts to the associated piston and at least one connecting rod coupling the second crankshaft of the pair of crankshafts to the associated piston.

Clause 201. The assembly of clause 200, wherein, for each pair of crankshafts, the first crankshaft is engaged with a second crankshaft of an adjacent pair of crankshafts such that rotation of the first crankshaft causes counter rotation of the second crankshaft of the adjacent pair of crankshafts.

Clause 202. The assembly of clause 200, further comprising: a timing gear; and wherein, for each pair of crankshafts, the first crankshaft is engaged with the timing gear such that rotation of the first crankshaft causes rotation of the timing gear.

Clause 203. The assembly of any of clauses 200-202, wherein the at least two pairs of crankshafts comprise exactly two pairs of crankshafts.

Clause 204. The assembly of any of clauses 200-202, wherein the at least two pairs of crankshafts comprise three pairs of crankshafts.

Clause 205. The assembly of any of clauses 200-202, wherein the at least two pairs of crankshafts comprise four pairs of crankshafts.

Clause 206. The assembly of any of clauses 200-202, wherein the at least two pairs of crankshafts comprise five pairs of crankshafts.

Clause 207. The assembly of any of clauses 200-206, wherein, for each plurality of connecting rods: the at least one connecting rod coupling the first crankshaft to the associated piston comprises two connecting rods; and the at least one connecting rod coupling the second crankshaft to the associated piston comprises one connecting rod.

Clause 208. The assembly of clause 207, wherein a total mass of the two connecting rods of the at least one connecting rod coupling the first crankshaft to the piston is substantially equal to a total mass of the one connecting rod of the at least one connecting rod coupling the second crankshaft to the piston.

Clause 209. The assembly of clause 207 or clause 208, wherein each of the plurality of connecting rods coupling the pair of crankshafts to the associated piston is configured in one of: a toed-in configuration; a fully toed-in configuration; a toed-out configuration; or a neutral configuration.

Clause 210. The assembly of any of clauses 200-209, wherein one or more of the plurality of connecting rods coupling a pair of crankshafts to an associated piston is configured in a fully toed-in configuration, and the plurality of connecting rods are coupled to the piston by a translating wrist pin.

Clause 211. The assembly of any of clauses 200-210, wherein the at least two pairs of crankshafts are radially disposed about a central axis, and wherein the associated piston with each pair of crankshafts is radially disposed about the central axis.

Clause 212. The assembly of clause 211, further comprising one or more additional pistons, each additional piston of the one or more additional pistons coupled by a plurality of connecting rods to a first crankshaft of one pair of crankshafts and a second crankshaft of an adjacent one pair of crankshafts, the plurality of connecting rods comprising at least one connecting rod coupling the additional piston to first crankshaft of the one pair of crankshafts and at least one connecting rod coupling the additional piston to the second crankshaft of the adjacent one pair of crankshafts.

Clause 213. The assembly of clause 212, wherein each additional piston is radially disposed between two associated pistons associated with two adjacently positioned pairs of crankshafts.

Clause 214. The assembly of clause 213, wherein the number of associated crankshafts is equal to the number of pairs of crankshafts, and the number of additional crankshafts is also equal to the number of pairs of crankshafts.

Clause 215. The assembly of any of clauses 200-214, wherein each piston comprises one of: a circular-shaped piston; an oval-shaped piston, wherein a long axis of the oval-shaped piston is oriented to be parallel or perpendicular to longitudinal axes of the pair of crankshafts; or a double-c shaped piston, wherein a long axis of the double-c shaped piston is oriented to be parallel or perpendicular to the longitudinal axes of the pair of crankshafts.

Clause 216. The assembly of any of clauses 200-215, wherein, for each pair of crankshafts, the first crankshaft and the second crankshaft both comprise one of: a crankshaft comprising a first main bearing journal, a second main bearing journal, and a third main bearing journal, a pair of crankpins positioned between the first main bearing journal and the second main bearing journal, and a pair of crankpins positioned between the second main bearing journal and the third main bearing journal, optionally wherein for each pair of crankpins a first crankpin is rotationally offset from a second crankpin about a longitudinal axis of the crankshaft by a crankpin offset, optionally wherein the crankpin offset is 0 degrees, optionally wherein the crankpin offset is 60 degrees, optionally wherein the crankpin offset is 90 degrees, optionally wherein the crankpin offset is 120 degrees, optionally wherein the crankpin offset is 180 degrees; a crankshaft comprising a first main bearing journal, a second main bearing journal, a third main bearing journal, and a fourth main bearing journal, a first crankpin positioned between the first main bearing journal and the second main bearing journal, a second crankpin positioned between the third main bearing journal and the fourth main bearing journal, and a third crankpin positioned between the second main bearing journal and the third main bearing journal, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 60 degrees, optionally wherein the crankpin offset is 90 degrees, optionally wherein the crankpin offset is 120 degrees, optionally wherein the crankpin offset is 180 degrees; a crankshaft comprising a first main bearing journal and a second main bearing journal, and a first crankpin, a second crankpin, and a third crankpin are positioned between the first main bearing journal and the second main bearing journal, wherein the third crankpin is positioned between the first crankpin and the second crankpin, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 60 degrees, optionally wherein the crankpin offset is 90 degrees, optionally wherein the crankpin offset is 120 degrees, optionally wherein the crankpin offset is 180 degrees.

Clause 217. An internal combustion engine comprising the assembly of any of clauses 200-216.

Clause 218. The internal combustion engine of clause 217, wherein at least one piston is associated with a non-combustion or auxiliary chamber.

Clause 219. The internal combustion engine of clause 218, wherein the non-combustion or auxiliary chamber is configured to provide scavenging for at least one combustion chamber and to direct air into the at least one combustion chamber.

Clause 220. An assembly comprising: a block at least partially defining a bore; a piston positioned within the bore and configured for reciprocal motion within the bore; an intake or exhaust passage at least partially formed in the block for permitting fluid flow into or out of the bore; and a rotary valve positioned at least partially within the intake or exhaust passage, the rotary valve comprising: a valve shaft, and at least one valve body positioned on the valve shaft such that rotation of the valve shaft causes rotation of the valve body, the valve body comprising at least one passage formed through the valve body, wherein at a first rotational position the at least one passage of the valve body permits fluid flow through the intake or exhaust passage, and at a second rotational position the valve body blocks fluid flow through the intake or exhaust passage, and wherein the valve body comprises a conical shape, a multi-faceted conical shape, an hourglass shape, or a split tailored shape.

Clause 221. The assembly of clause 220, further comprising a valve seat, wherein the valve seat is configured with a shape that corresponds to a shape of the valve body.

Clause 222. The assembly of clause 220 or clause 221, wherein the intake or exhaust passage is formed at least partially through a peripheral wall of the bore.

Clause 223. The assembly of any of clauses 220-222, wherein the rotary valve is positioned at an upper edge of the bore.

Clause 224. The assembly of any of clauses 220-223, wherein the intake or exhaust passage forms a slit at a location that interests the bore.

Clause 225. The assembly of clause 224, wherein the slit is longer in a circumferential direction of the bore than a longitudinal direction of the bore.

Clause 226. The assembly of any of clauses 220-225, wherein the rotary valve is positioned in a space laterally outside of the bore.

Clause 227. The assembly of any of clauses 220-226, wherein the rotary valve is not positioned in a space above or below the bore.

Clause 228. The assembly of any of clauses 220-227, wherein the bore is associated with a combustion chamber or a non-combustion chamber.

Clause 229. The assembly of any of clauses 220-228, wherein a cross-sectional shape of the bore is round, oval, or double-c shaped.

Clause 230. An internal combustion engine, comprising: a housing; a pair of crankshafts at least partially positioned within and supported by the housing, the pair of crankshafts comprising a first crankshaft and a second crankshaft, wherein the first crankshaft is engaged with the second crankshaft such that rotation of the first crankshaft causes counterrotation of the second crankshaft; a first block coupled to a first side of the housing, the first block at least partially defining a first bore; a second block coupled to the second side of the first housing, the second block at least at least partially defining a second bore; a first piston positioned to reciprocate within the first bore; a second piston positioned to reciprocate within the second bore; a plurality of connecting rods coupling the pair of crankshafts to the first piston and to the second piston such that rotation of the pair of crankshafts cause reciprocating motion of the first piston and the second piston.

Clause 231. The internal combustion engine of clause 230, wherein the plurality of connecting rods comprise six connecting rods.

Clause 232. The internal combustion engine of clause 230 or clause 231, wherein the plurality of connecting rods comprise: a first set of three connecting rods coupling the pair of crankshafts to the first piston; and a second set of three connecting rods coupling the pair of crankshafts to the second piston.

Clause 233. The internal combustion engine of clause 232, wherein: the first set of three connecting rods comprises two connecting rods coupled to the first crankshaft and one connecting rod coupled to the second crankshaft; and the second set of three connecting rods comprises one connecting rod coupled to the first crankshaft and one connecting rod coupled to the second crankshaft.

Clause 234. The internal combustion engine of clause 230 or clause 231, wherein the plurality of connecting rods comprise: a first set of four connecting rods coupling the pair of crankshafts to the first piston; and a second set of two connecting rods coupling the pair of crankshafts to the second piston.

Clause 235. The internal combustion engine of clause 234, wherein: the first set of four connecting rods comprises two connecting rods coupled to the first crankshaft and two connecting rod coupled to the second crankshaft; and the second set of two connecting rods comprises one connecting rod coupled to the first crankshaft and one connecting rod coupled to the second crankshaft.

Clause 236. The internal combustion engine of any of clauses 232-235, wherein each of the first crankshaft and the second crankshaft comprises: a crankshaft comprising a first main bearing journal, a second main bearing journal, a third main bearing journal, and a fourth main bearing journal, a first crankpin positioned between the first main bearing journal and the second main bearing journal, a second crankpin positioned between the third main bearing journal and the fourth main bearing journal, and a third crankpin positioned between the second main bearing journal and the third main bearing journal, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 180 degrees; a crankshaft comprising a first main bearing journal and a second main bearing journal, and a first crankpin, a second crankpin, and a third crankpin positioned between the first main bearing journal and the second main bearing journal, wherein the third crankpin is positioned between the first crankpin and the second crankpin, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 180 degrees; or a crankshaft comprising a first main bearing journal, a second main bearing journal, and a third main bearing journal, a pair of crankpins positioned between the first main bearing journal and the second main bearing journal, and a pair of crankpins positioned between the second main bearing journal and the third main bearing journal, optionally wherein for each pair of crankpins a first crankpin is rotationally offset from a second crankpin about a longitudinal axis of the crankshaft by a crankpin offset, optionally wherein the crankpin offset is 0 degrees, optionally wherein the crankpin offset is 180 degrees.

Clause 237. The internal combustion engine of any of clauses 230-236, wherein a rotational position of the second crankshaft is rotated by 180 degrees with respect to a rotational position of the first crankshaft.

Clause 238. The internal combustion engine of any of clauses 230-237, wherein the first block and the first bore at least partially define a combustion chamber, and wherein the internal combustion engine further comprises: at least one intake port configured to allow fluid into the combustion chamber; at least one intake valve configured to selectively open and close the at least one intake port; at least one exhaust port configured to allow fluid out of the combustion chamber; and at least one exhaust valve configured to selectively open and close the at least one exhaust port.

Clause 239. The internal combustion engine of clause 238, wherein further comprising: a first cam lobe positioned on the first crankshaft, wherein rotation of the first cam lobe is configured to selectively open and close the at least one intake valve; and a second cam lobe positioned on the second crankshaft wherein rotation of the second cam lobe is configured to selectively open and close the at least one exhaust valve.

Clause 240. The internal combustion engine of clause 239, further comprising: at least one push rod and at least one rocker arm operationally coupling the first cam lobe to the at least one intake valve; and at least one push rod and at least one rocker arm operationally coupling the second cam lobe to the at least one exhaust valve.

Clause 241. The internal combustion engine of any of clauses 238-240, wherein the second block and the second bore at least partially define a second combustion chamber, the internal combustion engine further comprising: at least one intake port configured to allow fluid into the second combustion chamber; at least one intake valve configured to selectively open and close the at least one intake port; at least one exhaust port configured to allow fluid out of the second combustion chamber; and at least one exhaust valve configured to selectively open and close the at least one exhaust port.

Clause 242. The internal combustion engine of any of clauses 238-240, wherein the second block and the second bore at least partially define an auxiliary chamber, the internal combustion engine further comprising: at least one intake port configured to allow fluid into the auxiliary chamber; at least one intake valve configured as a one-way valve configured to allow fluid into the auxiliary chamber; at least one exhaust port configured to allow fluid out of the second combustion chamber; and a feed pipe fluidly connecting the at least one exhaust port to an intake passage of the combustion chamber.

Clause 243. The internal combustion engine of any of clauses 232-242, wherein each of the first set of connecting rods and the second set of connecting rods comprise one of: a toed-in configuration, a fully toed-in configuration; a toed-out configuration; or a neutral configuration.

Clause 244. The internal combustion engine of any of clauses 230-243, wherein each of the first piston and the second piston comprise one of: a circular-shaped piston; an oval-shaped piston, wherein a long axis of the oval-shaped piston is oriented to be parallel or perpendicular to longitudinal axes of the pair of crankshafts; or a double-c shaped, wherein a long axis of the double-c shaped piston is oriented to be parallel or perpendicular to the longitudinal axes of the pair of crankshafts.

Clause 245. A system or assembly comprising: a pair of crankshafts comprising a first crankshaft and a second crankshaft, the first crankshaft comprising the crankshaft assembly of any of clauses 102-115 or the crankshaft of any of clauses 124-141, the second crankshaft comprising the crankshaft assembly of any of clauses 102-115 or the crankshaft of any of clauses 124-141

Clause 246. The system or assembly of clause 245, wherein the first crankshaft is configured to counterrotate with the second crankshaft.

Clause 247. The system or assembly of clause 245 or clause 246, further comprising at least one connecting rod comprising the connecting rod of any of clauses 142-148, the connecting rod of any of clauses 149-151, the connecting rod of any of clauses 153-159, or the connecting rod of any of clauses 161-168.

Clause 248. The system or assembly of clause 247, further comprising a first piston connected to the pair of crankshafts by the at least one connecting rod.

Clause 249. The system or assembly of clause 248, wherein the first piston comprises the piston assembly of any of clauses 116-123.

Clause 250. The system or assembly of clause 248 or clause 249, further comprising a second piston connected to the pair of crankshafts by the at least one second connecting rod.

Clause 251. The system or assembly of clause 250, wherein the at least one second connecting rod comprises the connecting rod of any of clauses 142-148, the connecting rod of any of clauses 149-151, the connecting rod of any of clauses 153-159, or the connecting rod of any of clauses 161-168.

Clause 252. The system or assembly of clause 251 or clause 252, wherein the second piston comprises the piston assembly of any of clauses 116-123.

Clause 253. A system comprising any feature of any of clauses 1 to 252.

Clause 254. An assembly comprising: a pair of crankshafts, the pair of crankshafts comprising a first crankshaft and a second crankshaft, wherein the first crankshaft is engaged with the second crankshaft such that rotation of the first crankshaft causes counterrotation of the second crankshaft; a piston; a link rod coupled to the piston; and a plurality of connecting rods coupling the pair of crankshafts to the link rod such that rotation of the pair of crankshafts causes reciprocating motion of the piston, the plurality of connecting rods comprising at least one connecting rod coupling the first crankshaft to the link rod and at least one connecting rod coupling the second crankshaft to the link rod.

Clause 255. The assembly of clause 254, wherein: the plurality of connecting rods are coupled to the link rod by a first wrist pin; and the link rod is coupled to the piston by a second wrist pin.

Clause 256. The assembly of clause 255, wherein the first wrist pin extends along a first axis and the second wrist pin extends along a second axis, and the first axis is parallel to the second axis.

Clause 257. The assembly of any of clauses 254 to 256, wherein, for the plurality of connecting rods: the at least one connecting rod coupling the first crankshaft to the link rod comprises two connecting rods; and the at least one connecting rod coupling the second crankshaft to the link rod comprises two connecting rod.

Clause 258. The assembly of clause 257, wherein: the two connecting rods coupling the first crankshaft to the link rod comprise a pair of scissoring connecting rods; and the two connecting rods coupling the second crankshaft to the link rod comprise a pair of scissoring connecting rods.

Clause 259. The assembly of any of clauses 254 to 256, wherein, for the plurality of connecting rods: the at least one connecting rod coupling the first crankshaft to the link rod comprises one connecting rod; and the at least one connecting rod coupling the second crankshaft to the link rod comprises one connecting rod.

Clause 260. The assembly of clause 257, wherein: the one connecting rod coupling the first crankshaft to the link rod comprises a dual-arm connecting rod; and the one connecting rod coupling the second crankshaft to the link rod comprises a dual-arm connecting rod.

Clause 261. The assembly of any of clauses 254 to 260, wherein the plurality of connecting rods coupling the pair of crankshafts to the link rod are configured in one of: a toed-in configuration, a fully toed-in configuration, a toed-out configuration, or a neutral configuration.

Clause 262. The assembly of any of clauses 254-261, wherein the piston comprises one of: a circular-shaped piston; an oval-shaped piston, wherein a long axis of the oval-shaped piston is oriented to be parallel or perpendicular to longitudinal axes of the pair of crankshafts; or a double-c shaped piston, wherein a long axis of the double-c shaped piston is oriented to be parallel or perpendicular to the longitudinal axes of the pair of crankshafts.

Clause 263. The assembly of any of clauses 254-262, wherein, for the pair of crankshafts, the first crankshaft and the second crankshaft both comprise one of: a crankshaft comprising a first main bearing journal, a second main bearing journal, and a third main bearing journal, a pair of crankpins positioned between the first main bearing journal and the second main bearing journal, and a pair of crankpins positioned between the second main bearing journal and the third main bearing journal, optionally wherein for each pair of crankpins a first crankpin is rotationally offset from a second crankpin about a longitudinal axis of the crankshaft by a crankpin offset, optionally wherein the crankpin offset is 0 degrees, optionally wherein the crankpin offset is 180 degrees; a crankshaft comprising a first main bearing journal, a second main bearing journal, a third main bearing journal, and a fourth main bearing journal, a first crankpin positioned between the first main bearing journal and the second main bearing journal, a second crankpin positioned between the fourth main bearing journal and the third main bearing journal, and a third crankpin positioned between the second main bearing journal and the third main bearing journal, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 180 degrees; or a crankshaft comprising a first main bearing journal and a second main bearing journal, and a first crankpin, a second crankpin, and a third crankpin are positioned between the first main bearing journal and the second main bearing journal, optionally wherein the first crankpin and the second crankpin are aligned along a common axis and the third crankpin is rotationally offset from the first and second crankpins about a longitudinal axis of the crankshaft by a crankpin offset, optionally wherein the crankpin offset is 0 degrees, optionally wherein the crankpin offset is 180 degrees.

Clause 264. The assembly of any of clauses 254-263, wherein the piston comprises a first piston, and the plurality of connecting rods comprise a first plurality of connecting rods coupling the pair of crankshafts to the first piston, and wherein the assembly further comprises: a second piston; and a second plurality of connecting rods coupling the pair of crankshafts to the second piston such that rotation of the pair of crankshafts causes reciprocating motion of the second piston, the second plurality of connecting rods comprising at least one connecting rod coupling the first crankshaft to the second piston and at least one connecting rod coupling the second crankshaft to the second piston, wherein each of the first piston and the second piston reciprocate along a common axis.

Clause 265. The assembly of clause 264, wherein the second piston comprises one of: a circular-shaped piston; an oval-shaped piston, wherein a long axis of the oval-shaped piston is oriented to be parallel or perpendicular to longitudinal axes of the pair of crankshafts; or a double-c shaped piston, wherein a long axis of the double-c shaped piston is oriented to be parallel or perpendicular to the longitudinal axes of the pair of crankshafts, optionally wherein a type of the first piston is the same as a type of the second piston, optionally wherein the type of the first piston is different than the type of the second piston.

Clause 266. The assembly of any of clauses 264 to 265, wherein the plurality of connecting rods coupling the pair of crankshafts to the second piston are configured in a fully toed-in configuration, and wherein the plurality of connecting rods are coupled to the second piston by a translating wrist pin.

Clause 267. An internal combustion engine comprising: the assembly of any of clauses 254-263; a block defining a bore at least partially defining a combustion chamber, the piston configured to reciprocate within the bore between top dead center and bottom dead center; an inlet valve configured to allow air to enter the combustion chamber; and an outlet valve configured to allow exhaust to exit the combustion chamber.

Clause 268. The internal combustion engine of clause 267, wherein at least one of the inlet valve or the outlet valve comprises a rotary valve having a conical shape, a multi-faceted conical shape, an hourglass shape, or a split tailored shape, optionally wherein the rotary valve is positioned to at least partially intersect with a peripheral wall of the bore, and optionally wherein the rotary valve is positioned to at least partially intersect an upper edge of the bore.

Clause 269. An internal combustion engine comprising: the assembly of any of clauses 264-266; a first block defining a first bore at least partially defining a first combustion chamber, the first piston configured to reciprocate within the first bore between top dead center and bottom dead center; a first inlet valve configured to allow air to enter the first combustion chamber; a first outlet valve configured to allow exhaust to exit the first combustion chamber; a second block defining a second bore at least partially defining a second chamber, the second piston configured to reciprocate within the second bore between top dead center and bottom dead center.

Clause 270. The internal combustion engine of clause 269, further comprising a second inlet valve configured to allow fluid to enter the second chamber, and a second outlet valve configured to allow fluid to exit the second chamber.

Clause 271. The internal combustion engine of clause 269 or clause 270, wherein at least one of the first inlet valve, the first outlet valve, the second inlet valve, or the second outlet valve comprises a rotary valve having a conical shape, a multi-faceted conical shape, an hourglass shape, or a split tailored shape, optionally wherein the rotary valve is positioned to at least partially intersect with a peripheral wall of the first bore or the second bore, and optionally wherein the rotary valve is positioned to at least partially intersect an upper edge of the first bore or an upper edge of the second bore.

Clause 272. The internal combustion engine of any of clauses 269-271, wherein the second chamber comprises a combustion chamber.

Clause 273. The internal combustion engine of clause 269 further comprising at least one inlet port configured to allow fluid to enter the second chamber and at least one outlet port configured to allow fluid to exit the second chamber, wherein the second chamber comprises a non-combustion or auxiliary chamber, and optionally wherein the internal combustion engine is further configured to direct fluid from the at least one outlet port to an inlet passage of the first combustion chamber.

Clause 274. The internal combustion engine of clause 273, wherein the second piston comprises a double-acting piston.

Clause 275. A system comprising any feature of any of clauses 1 to 274.

### ADDITIONAL CONSIDERATIONS AND TERMINOLOGY

Conditional language used herein, such as, among others, “can,” “could,” “might,” “may,” “e.g.,” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or that one or more configurations necessarily include these features, elements and/or states.

Conjunctive language, such as the phrase “at least one of X, Y, and Z,” unless specifically stated otherwise, or otherwise understood within the context as used, is generally intended to convey that an item, term, etc. may be either X, Y, or Z. Thus, such conjunctive language is not generally intended to imply that certain configurations require the presence of at least one of X, at least one of Y, and at least one of Z.

While the above detailed description may have shown, described, and pointed out novel features as applied to various configurations, it may be understood that various omissions, substitutions, and/or changes in the form and details of any particular configuration may be made without departing from the spirit of the disclosure. As may be recognized, certain configurations may be embodied within a form that does not provide all of the features and benefits set forth herein, because some features may be used or practiced separately from others.

Additionally, features described in connection with one configuration can be incorporated into another of the disclosed configurations, even if not expressly discussed herein, and configurations having the combination of features still fall within the scope of the disclosure. For example, features described above in connection with one configuration can be used with a different configuration described herein and the combination still fall within the scope of the disclosure.

It should be understood that various features and aspects of the disclosed configurations can be combined with, or substituted for, one another in order to form varying modes of the configurations of the disclosure. Thus, it is intended that the scope of the disclosure herein should not be limited by the particular configurations described above. Accordingly, unless otherwise stated, or unless clearly incompatible, each configuration of this disclosure may comprise, additional to or in place of its features described herein, one or more features as described herein from each other configuration disclosed herein.

Features, materials, characteristics, or groups described in conjunction with a particular aspect, configuration, or example are to be understood to be applicable to any other aspect, configuration, or example described in this section or elsewhere in this specification unless incompatible therewith. All of the features disclosed in this specification (including any accompanying claims, abstract, and drawings), and/or any or all of the steps of any method or process so disclosed, may be combined in any combination, except combinations where at least some of such features and/or steps are mutually exclusive. The protection is not restricted to the details of any foregoing configurations. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some configurations, the actual steps taken in the processes illustrated and/or disclosed may differ from those shown in the figures. Depending on the configuration, certain of the steps described above may be removed, others may be added.

Furthermore, the features and attributes of the specific configurations disclosed above may be combined in different ways to form additional configurations, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular configuration. Thus, for example, those skilled in the art will recognize that the disclosure may be embodied or carried out in a manner that achieves one advantage or a group of advantages as taught herein without necessarily achieving other advantages as may be taught or suggested herein.

Language of degree, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain configurations, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred configurations in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise,” “comprising,” and the like are to be construed in an inclusive sense as opposed to an exclusive or exhaustive sense, that is to say, in the sense of “including, but not limited to.”

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements, and features referred to or indicated in the description of the application, individually or collectively, in any or all combinations of two or more of those parts, elements, or features.

Where, in the foregoing description, reference has been made to integers or components having known equivalents, those integers or components are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred configurations described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present configurations. Accordingly, the scope of protection is intended to be defined only by the claims.

1-36. (canceled)

37. An assembly comprising:
a first block at least partially defining a first bore;
a second block at least partially defining a second bore;
a housing positioned between the first block and the second block;
a first piston capable of reciprocating within the first bore between first top dead center and first bottom dead center;
a second piston capable of reciprocating within the second bore between second top dead center and second bottom dead center;
a first crankshaft configured to rotate in a first direction within the housing;
a second crankshaft configured to rotate in a second direction within the housing, the second direction opposite the first direction, the second crankshaft in mesh with the first crankshaft such that the second crankshaft counterrotates with rotation of the first crankshaft;
a third crankshaft configured to rotate in the first direction with the housing; and
a fourth crankshaft configured to rotate in the second direction the housing, the fourth crankshaft in mesh with the third crankshaft such that the fourth crankshaft counterrotates with rotation of the third crankshaft.

38. The assembly of claim 37, wherein the first crankshaft is in mesh with the fourth crankshaft and/or wherein the second crankshaft is in mesh with the third crankshaft.

39. The assembly of claim 37, further comprising an output shaft, the output shaft in mesh with at least one of the first crankshaft, the second crankshaft, the third crankshaft, and the fourth crankshaft.

40. The assembly of claim 39, wherein a central output shaft axis of the output shaft extends between central axes of the first crankshaft, the second crankshaft, the third crankshaft, and the fourth crankshaft.

41. The assembly of claim 37, further comprising:
a third piston;
a fifth connecting rod connecting the third piston to the second crankshaft; and
a sixth connecting rod connecting the third piston to the third crankshaft.

42. The assembly of claim 41, further comprising:
a fourth piston;
a seventh connecting rod connecting the fourth piston to the first crankshaft; and
an eighth connecting rod connecting the fourth piston to the fourth crankshaft.

43. The assembly of claim 42, wherein the first piston and the second piston reciprocate along a first axis and the third piston and the fourth piston reciprocate along a second axis, the first axis orthogonal to the second axis.

44. The assembly of claim 42, wherein at least one of the first piston or the second piston is configured for combustion and at least one of the third piston and or the fourth piston is configured for scavenging one or more combustion chambers associated with the first piston or the second piston.

45. An assembly comprising:
at least two pairs of crankshafts, each pair of crankshafts comprising a first crankshaft and a second crankshaft, wherein, for each pair of crankshafts, the first crankshaft is engaged with the second crankshaft such that rotation of the first crankshaft causes counterrotation of the second crankshaft;
at least one piston associated with each pair of crankshafts; and
for each pair of crankshafts, a plurality of connecting rods coupling the pair of crankshafts to the associated piston such that rotation of the pair of crankshafts causes reciprocating motion of the associated piston, the plurality of connecting rods comprising at least one connecting rod coupling the first crankshaft of the pair of crankshafts to the associated piston and at least one connecting rod coupling the second crankshaft of the pair of crankshafts to the associated piston.

46. The assembly of claim 45, wherein, for each pair of crankshafts, the first crankshaft is engaged with a second crankshaft of an adjacent pair of crankshafts such that rotation of the first crankshaft causes counter rotation of the second crankshaft of the adjacent pair of crankshafts.

47. The assembly of claim 45, further comprising a timing gear, wherein, for each pair of crankshafts, the first crankshaft is engaged with the timing gear such that rotation of the first crankshaft causes rotation of the timing gear.

48. The assembly of claim 45, wherein the at least two pairs of crankshafts comprise exactly two pairs of crankshafts.

49. The assembly of claim 45, wherein the at least two pairs of crankshafts comprise three pairs of crankshafts.

50. The assembly of claim 45, wherein the at least two pairs of crankshafts comprise four pairs of crankshafts.

51. The assembly of claim 45, wherein the at least two pairs of crankshafts comprise five pairs of crankshafts.

52. The assembly of claim 45, wherein the at least two pairs of crankshafts are radially disposed about a central axis, and wherein the associated piston with each pair of crankshafts is radially disposed about the central axis.

53. The assembly of claim 45, further comprising one or more additional pistons, each additional piston of the one or more additional pistons coupled by a plurality of connecting rods to a first crankshaft of one pair of crankshafts and a second crankshaft of an adjacent one pair of crankshafts, the plurality of connecting rods comprising at least one connecting rod coupling the additional piston to first crankshaft of the one pair of crankshafts and at least one connecting rod coupling the additional piston to the second crankshaft of the adjacent one pair of crankshafts.

54. The assembly of claim 53, wherein each additional piston is radially disposed between two associated pistons associated with two adjacently positioned pairs of crankshafts.

55. The assembly of claim 54, wherein the number of associated pistons is equal to the number of pairs of crankshafts, and the number of additional pistons is also equal to the number of pairs of crankshafts.

56. An assembly comprising:
a first crankshaft configured to rotate in a first rotational direction;
a second crankshaft configured to rotate in a second rotational direction, the second rotational direction opposite the first rotational direction, the second crankshaft in mesh with the first crankshaft such that the second crankshaft counterrotates with rotation of the first crankshaft;
a third crankshaft configured to rotate in the first rotational direction; and
a fourth crankshaft configured to rotate in the second rotational direction, the fourth crankshaft in mesh with the third crankshaft such that the fourth crankshaft counterrotates with rotation of the third crankshaft.

57. The assembly of claim 56, further comprising:
a first piston;
a first connecting rod connecting the first piston to the first crankshaft; and
a second connecting rod connecting the first piston to the second crankshaft.

58. The assembly of claim 57, wherein the first connecting rod is connected to the first piston at a first location and the second connecting rod is connected to the first piston at a second location, the second location spaced apart from the first location.

59. The assembly of claim 58, wherein the first connecting rod is aligned with a first vertical axis of the first crankshaft and the second connecting rod is aligned with a second vertical axis of the second crankshaft when the first piston is at top dead center.

60. The assembly of claim 57, wherein the first connecting rod and the second connecting rod are both connected to the first piston via a first wristpin.

61. The assembly of claim 57, further comprising:
a second piston;
a third connecting rod connecting the second piston to the third crankshaft; and
a fourth connecting rod connecting the second piston to the fourth crankshaft.

62. The assembly of claim 61, wherein both the first piston and the second piston reciprocate along a shared central axis.

63. The assembly of claim 61, wherein the first piston is configured for combustion, and wherein the second piston is configured for scavenging a combustion chamber associated with the first piston.
